(19) United States
(12) Patent Application Publication
(10) Pub. No.: US 2009/0020924 A1
(43) Pub. Date: Jan. 22, 2009

(54) Drying-mediated self-assembly of ordered or hierarchically ordered micro- and sub-micro scale structures and their uses as multifunctional materials

(75) Inventor: Zhiqun Lin, Ames, IA (US)

Correspondence Address: MCKEE, VOORHEES & SEASE, P.L.C., 801 GRAND AVENUE, SUITE 3200, DES MOINES, IA, 50309-2721, US

(73) Assignee: IOWA STATE UNIVERSITY RESEARCH FOUNDATION, INC., Ames, IA (US)

(21) Appl. No.: 12/070,795

(22) Filed: Feb. 21, 2008

Related U.S. Application Data
(60) Provisional application No. 60/902,464, filed on Feb. 21, 2007.

(51) Int. Cl. B28B 1/29

(52) U.S. Cl. 264/605; 425/375

(57) ABSTRACT

Methods, apparatus, and systems of fabricating ordered or hierarchically ordered small-scale structures (e.g. micro- or sub-micro size) without the need for lithographic techniques or external fields. The methods use irreversible solvent evaporation to deposit the solute on a surface. A spherical lens is brought down into contact with the droplet. By selection and control of one or more relevant parameters, various characteristics or features of the resulting structures can be controlled. Nano-scale structures or materials can be formed or included in the micro- or sub-micro-scale formed structures. The nano-scale structures or materials can self-assembly in hierarchical order by selection and control of certain process parameters.

### CROSS REFERENCE TO RELATED APPLICATIONS

This application claims priority under 35 U.S.C. § 119 to a provisional application U.S. Ser. No. 60/902,464 filed Feb. 21, 2007, herein incorporated by reference in its entirety.

Table of Contents

| I. | BACKGROUND OF INVENTION | | 2 |
|---|---|---|---|
| | A. | Field of the Invention | 2 |
| | B. | Problems in the Art | 2 |
| II. | SUMMARY OF THE INVENTION | | 3 |
| III. | BRIEF SUMMARY OF THE DRAWINGS | | 5 |
| IV. | DETAILED DESCRIPTION OF EXEMPLARY | | 6 |
| | EMBODIMENTS | | |
| | A. | Overview | 6 |
| | B. | Exemplary Methodology in General | 6 |
| | C. | Specific Examples | 8 |
| | | 1. Example 1 | 10 |
| | | 2. Example 2 | 19 |
| | | 3. Example 3 | 30 |
| | | 4. Example 4 | 40 |
| | | 5. Example 5 | 84 |
| | | 6. Example 6 | 96 |
| | | 7. Example 7 | 104 |
| | | 8. Example 8 | 113 |
| | D. | Options and Alternatives | 127 |

| | | |
|---|---|---|
| V. | CLAIMS | 129 |
| VI. | ABSTRACT OF THE DISCLOSURE | 134 |

### GRANT REFERENCE

This invention was made with government support under grant number CBET-0730611 awarded by the National Science Foundation. The government has certain rights in the invention.

### I. BACKGROUND OF INVENTION

A. Field of the Invention

The present invention relates to methods, apparatus, and systems for forming very small well-ordered structures by irreversible solvent evaporation, and in particular, for forming micro-scale or sub-micro scale ordered structures without the need for lithography techniques or external fields.

B. Problems in the Art

The evolution and advancement of micro- and nano-technologies continues to rapidly progress and expand. Examples are production of nanostructured materials used in devices such a photovoltaic cells, biosensors, and light-emitting diode assemblies. However, fabrication of well-ordered structures at the micro- and sub-micro-scale is difficult because of the small feature sizes involved. Also, fabrication of such small-scale structures for useful functions is difficult.

Present techniques tend to be complex and interactive. Many lack repeatability or accuracy in regularity of shapes of the structures they produce. For example, for many applications, it is desirable to control the spatial arrangement of the structures. It can also be important in some applications to control the spatial arrangement of materials in the structures.

Many present methods use some form of lithography (e.g. photolithography, electron beam lithography, or soft lithography) as the principal way to produce the small structures. With such traditional techniques, an iterative, multi-step procedure is required, making the process more complex and less reliable. Lithography is also very time consuming and expensive. For example, photolithographic or electron beam lithographic processes require a clean room, a mask aligner, a UV light source, and possibly a scanning electron microscope to perform the multi-step processes.

Another example of small-scale fabrication of structures is dynamic self-assembly of nonvolatile solutes through irreversible solvent evaporation of a droplet placed on a surface. It is a non-lithography route to produce small-scale structures. However, the flow instabilities within the evaporating droplet often result in irregular dissipative structures, e.g. stochastic “coffee ring” shapes. Evaporation-induced self-assembly, in general, gives rise to stochastic dissipative structures due to lack of control over complex evaporation processes and associated capillary flow.

Recently, several techniques for achieving small-scale hierarchical structures have emerged, including a template-assisted self-assembly, a combination of reaction-and-diffusion process with lithography, and a combination of self-assembly with breath figure formation. However, most of these still involve the use of lithography or other methods as a first step to acquire either an ordered template or patterns that will be subsequently be implemented to guide the self-assembly or reaction-diffusion process.

Thus, there remains room for advancement in the art of forming micro- or sub-micro-scale well-ordered structures without relying on lithographic procedures or external field.

### II. SUMMARY OF THE INVENTION

It is therefore a principal object, feature, aspect, or advantage of the present invention to improve over or advance the state of the art with respect to fabrication of regular structures at the micro- or sub-micro-scale.

The invention pertains to the use of droplet evaporation techniques by constraining a droplet in confined geometry consisting of a spherical lens in contact with a flat substrate (i.e., sphere-on-flat geometry). The sphere-on-flat geometry renders the formation of very regular small-scale structures of residual solute after solvent evaporation. The droplets comprise a solution of a solvent and a solute. By selection and control of one or more parameters from a set of parameters found to affect the evaporation process, various characteristics of the resulting structures can be controlled. One set of parameters comprises solvent effect, concentration effect, solute molecular weight (MW) effect, interfacial interaction effect (i.e., the interfaction between solute and substrate). Another parameter relates to variation of shape of the sphere by selection and manipulation of the components of the droplet solution and the evaporation process.

Another aspect of the invention pertains to nature of the solute used in the solution. Different solutes produce different structures and different functional structures. One example is polymers. Use of homopolymers can produce certain regular shapes. Use of certain homopolymers can produce structures of different shapes or characteristics. Two examples of homopolymers are polystyrene (PS) and poly(methyl methacryalate) (PMMA). Another example is diblock copolymer. A still further example is semicrystalline polymer.

Another aspect of the invention is use of nanomaterials as or in the solute. An example is the use of nanoparticles. By selection of process parameters, the nanoparticles can self-assemble into regular ordered structures.

Another aspect of the invention relates to self-assembly, in hierarchical order, of nanomaterials or nanostructures relative to the small-scale ordered structures formed during evaporation of the solution. For example, small nano-scale structures (e.g. nanocylinders) can form hierarchically ordered structures over a multi-length scale that are formed from evaporation by selection of certain process parameters and appropriate solution components (e.g., diblock copolymer and nanoparticles). On the other hand, certain process steps can introduce nanomaterials into the micro-scale ordered structures.

Another aspect of the invention relates to use of the droplet evaporation techniques to create templates for functional uses. An example is creation of regularly ordered micro-scale structures that can either be applied to a functional substrate, or could be coated with a functional material. The ordered micro-scale structures form a template for the functional materials. An example of the functional material is an electrically conductive metal.

Another aspect of the invention pertains to design or prediction of structure characteristics based on modeling of formation processes.

These and other objects, features, aspects, or advantages of the invention will become apparent with reference to the accompanying specification and claims.

### III. BRIEF SUMMARY OF THE DRAWINGS

Several illustrations are appended and referred to herein by Figure number. These Figures are summarized below.

FIGS. 1.1(a)-(f), 1.2, and 1.3(a) and (b) are illustrations of aspects of an exemplary embodiment according to the present invention called Example 1 and discussed later in detail.

FIGS. 2.1, 2.2(a) and (b), 2.3 (a) and (b), 2.4(a)-(e), and 2.5(a)-(e) are illustrations of aspects of an exemplary embodiment according to the present invention called Example 2 and discussed later in detail.

FIGS. 3.1, 3.2, 3.3, 3.4, and 3.5(a)-(e) are illustrations of aspects of an exemplary embodiment according to the present invention called Example 3 and discussed later in detail.

FIGS. 4.1, 4.2, 4.3, 4.4, 4.5, 4.6, 4.7, 4.8, 4.9, 4.10, 4.11, and 4.12 are illustrations of aspects of an exemplary embodiment according to the present invention called Example 4 and discussed later in detail.

FIGS. 5.1(a) and (b), 5.2(a)-(d), 5.3(a)-(f), 5.4(a)-(c), 5.5(a)-(f) are illustrations of aspects of an exemplary embodiment according to the present invention called Example 5 and discussed later in detail.

FIGS. 6.1(a)-(d), 6.2, 6.3(a)-(c), 6.4, and 6.5 (a) and (b) are illustrations of aspects of an exemplary embodiment according to the present invention called Example 6 and discussed later in detail.

FIGS. 7.1(a)-(c), 7.2(a)-(c), 7.3(a)-(c), 7.4(a) and (b), and 7.5(a)-(e) are illustrations of aspects of an exemplary embodiment according to the present invention called Example 7 and discussed later in detail.

FIGS. 8.1(a) and (b), 8.2(a)-(d), 8.3(a)-(d), 8.4(a)-(c), 8.5, 8.6(a)-(d), 8.7(a)-(c), 8.8(a)-(c), and 8.9(a)-(d) are illustrations of aspects of an exemplary embodiment according to the present invention called Example 8 and discussed later in detail.

### IV. DETAILED DESCRIPTION OF EXEMPLARY EMBODIMENTS

### A. Overview

To assist in an understanding of the invention, exemplary embodiments will now be described in detail. It is to be appreciated that the following exemplary embodiments and detailed discussion of aspects of the invention are by way of example only and are not exclusive or inclusive of all forms and embodiments the invention can take.

B. Exemplary Methodology in General

It has been discovered that imposition of a spherical lens into a solution droplet of volatile solvent and non-volatile solute (i.e., constraining a droplet of solution containing nonvolatile solute in a restricted geometry consisting of a spherical lens sitting on a flat substrate (sphere-on-flat geometry)) can produce quite regular self-assembled small structures during solvent evaporation. This discovery promises development of processes which could allow the practical design and manufacture of small-scale structures having a variety of possible functional applications.

The concept of using crossed cylinders to supply a restricted geometry for droplet evaporation is reported in Z. Q. Lin, S. Granick, J. Am. Chem. Soc. 2005, 127, 2816-2817, which is incorporated by reference herein in its entirety. This document provides background information about the non-trivial issues of trying to use irreversible droplet evaporation to produce useful small-scale structures.

The concept of using a sphere and flat surface to supply a restricted geometry for droplet evaporation is reported in S. W. Hong, J. Xu, J. Xia, Z. Q. Lin, F. Qiu, Y. L. Yang, Chem. Mater. 2005, 17, 6223-6226, which is also incorporated by reference herein in its entirety. An attempt to mathematically describe the basic “stick and slip” evaporative solute deposition process is reported in J. Xu, J. Xia, S. W. Hong, Z. Q. Lin, F. Qiu, Y. L. Yang, Phys. Rev. Lett. 2006, 96, 066104, pp.-1-4, which is incorporated by reference herein in its entirety.

The sphere-on-flat geometry allows creation of multifunctional materials based on irreversible solvent evaporation from a solution droplet constrained by a spherical shape imposed into the droplet during the evaporative process.

One or more tailored parameters can be relevant to the formation of the material. An example of a set of such parameters is as follows:

(a) Solvent effect. The properties of the solvent can influence center-to-center distance between adjacent rings, as well as ring height, of concentric rings formed through evaporation of the solvent and deposition of the solvent in a “stick and slip” phenomena.

(b) Concentration effect. The concentration of the solution can likewise effect ring-to-ring distance and ring height.

(c) Molecular weight (MW) effect. Regularity of structures can be the result of sufficient MW of polymers used as or in the solute of the solution.

(d) Curvature effect. Smaller curvature of the spherical shape imposed in the droplet can influence the structural features of the structures.

(e) Humidity effect. Carrying out the evaporation process in a sealed humid chamber under conditions which encourage condensation of micron-sized water droplets on forming or formed concentric rings can result in formation of practical and ordered additional features or shapes in the rings themselves.

(f) Surface chemistry effect. Structure formation can be influenced by the interfacial interaction between solutes and substrates of various characteristics.

(g) External perturbation. Movement of the spherical lens relative to the droplet can effect structure formation.

(h) Temperature effect. Temperature control of the lower substrate and spherical lens can control solvent evaporation and effect structure shape or formation.

(i) Shape effect. Variation of the shape of spherical lenses can alter structure shape.

There can be interdependency or antagonism between different of the above-listed effects. The unifying feature between their selective use and control is that they are practiced with a spherical lens imposed in the solution droplet.

Another variable that can be considered an effect is the solute selected for the solution. Examples of different solutes and their effect on the form and/or function of the resulting structures are described in certain of the specific examples below. One primary example is that different types of polymers can influence form and/or function. Also, it has been demonstrated that nano-particles can themselves comprise a solute and can, with use of certain parameters, self-assembly into hierarchical order.

Nano-scale structural characteristics can form hierarchically in the larger scale regularly ordered rings.

Moreover, the formed concentric rings can also be used as templates for the formation of specific features. One example is use of the concentric rings of polymer as a template to form very regular electrically-conductive rings.

It can therefore be seen that by selection and control of one or more tailored parameters used with a sphere-on-flat geometry allows drying-mediated self-assembly of ordered or hierarchically ordered micro- and sub-micro-scale structures and uses as multifunctional materials. Also, modeling of processes involved in the structure formation allows prediction of characteristics of the structure. This can be useful in research and design applications.

Applications and functions of several different embodiments according to the invention, as well as the resulting structures, are given in the specific examples set forth below. As will be appreciated, the examples provide details regarding how tailoring of one or more of the parameters can allow the design or prediction of specific structural characteristics, whether ordered or hierarchically ordered. Some examples provide a predictive mathematical model that can be used in such designs of multifunctional micro- or sub-micro-scale materials.

### C. Specific Examples

These specific examples describe several different exemplary embodiments according to aspects of the present invention. Some examples describe several embodiments within the single example. Table 1 summarizes the examples, as well as points out specific types of tailored parameters and other features that are highlighted in each example.

TABLE 1

| | | Structure | Solvent | | Parameter | |
|---|---|---|---|---|---|---|
| Example | Geometry | Formed | Used | Solute Employed | Tailored | Other |
| 1 | Sphere-on-Flat | Rings | Toluene | CdSe/ZnS | Concentration | |
| | | Spokes | | nanoparticles | Nanoparticle size | |
| 2 | Sphere-on-Flat | Rings | Toluene | Homopolymers | Molecular weight | |
| | | Rings with | | (polystyrene (PS)) | Curvature of | |
| | | fingering | | | upper sphere | |
| | | instabilities | | | | |
| | | Punch-hole- | | | | |
| | | like structures | | | | |
| 3 | Sphere-on-Flat | Rings | Toluene | Homopolymers | Interfacial | Theoretical |
| | | Rings with | | (PS and | interaction between | prediction of |
| | | fingering | | poly(methyl | solute (e.g., PS and | wavelength of |
| | | instabilities | | methacrylate) | PMMA) and | fingers |
| | | Punch-hole- | | (PMMA)) | substrate (e.g., Si | |
| | | like structures | | | surface) | |
| 4 | Sphere-on-Flat, | Rings | Toluene | CdSe and | Molecular weight | Theoretical |
| | Modified- | Hier- | | CdSe/ZnS | Solvent | prediction of |
| | Sphere-on-Flat | archically | | nanoparticles | Curvature | wavelength of |
| | (i.e., | ordered | | Homopolymers | Humidity | concentric |
| | triangular-slice | structures, | | (PMMA and | Surface | rings and |
| | sphere, | including (a) | | poly[2-methoxy-5- | chemistry | height of rings |
| | quadrangular- | concave holes | | (2- | External | Theoretical |
| | slice sphere, | residing within | | ethylhexyloxy)- | perturbation | prediction of |
| | and | microscopic | | 1,4- | Temperature | wavelength of |
| | hexagonal- | rings, (b) | | phenylenevinylene] | Shape of upper | fingers |
| | slice sphere on | nanocylinders | | (MEH-PPV)) | sphere | |
| | flat substrate) | in concentric | | Diblock | | |
| | | rings, (c) | | copolymers | | |
| | | nanocylinders | | (poly(4-vinyl | | |
| | | in webs | | pyridine)- | | |
| | | | | blockpoly (methyl | | |
| | | | | methacrylate) | | |
| | | | | (P4VP-b-PMMA) | | |
| | | | | and polystyrene- | | |
| | | | | block-poly(methyl | | |
| | | | | methacrylate) | | |
| | | | | (PS-b-PMMA)) | | |
| 5 | Sphere-on-Flat | Rings | Aceto- | Semicrystalline | Molecular weight | |
| | | Spirals | nitrile | polymers | | |
| | | within rings | | (poly(ethylene | | |
| | | | | oxide) (PEO)) | | |
| 6 | Sphere-on-Flat | Metal and | Toluene | Homopolymer | | |
| | | metal oxide | | (MEH-PPV) | | |
| | | rings | | | | |
| 7 | Sphere-on-Flat | Gold rings | Toluene | Homopolymer | | |
| | | | | (MEH-PPV and | | |
| | | | | PMMA) | | |
| 8 | Sphere-on-Flat | Carbon | Toluene | Homopolymer | | |
| | | nanotube | | (MEH-PPV and | | |
| | | (CNT) rings | | PMMA) and CNTs | | |

### 1. Example 1

### Overview

Various nanoparticles with easily tailored optical and electronic properties can be dynamically self-assembled into spatially ordered, two-dimensional patterns simply by allowing a drop of nanoparticle solution to evaporate in a confined, axial symmetric geometry. This approach, which dispenses with the need for lithography and external fields, is fast, cost-effective and robust.

### Discussion

Self-assembly of nanoscale materials to form ordered structures promises new opportunities for developing miniaturized electronic, optoelectronic, and magnetic devices.^{[1-4]} In this regard, several elegant methods based upon self-assembly have emerged,^{[5-8]} for example, self-directed self-assembly^{[5]} and electrostatic self-assembly.^{[8]} Self-assembly of nanoparticles via irreversible solvent evaporation has been recognized as an extremely simple route to intriguing structures.^{[9-12]} However, these dissipative structures are often randomly organized without controlled regularity. Herein, we show a simple, one-step technique to produce concentric rings and spokes consisting of quantum dots and gold nanoparticles with high fidelity and regularity by allowing a drop of nanoparticle solution to evaporate in a sphere-on-flat geometry. The rings and spokes are nanometers high, submicrons to a few microns wide, and millimeters long. This technique, which dispenses with the need for lithography and external fields, is fast, cost-effective and robust. As such, it represents a powerful strategy for creating highly structured, multifunctional materials and devices.

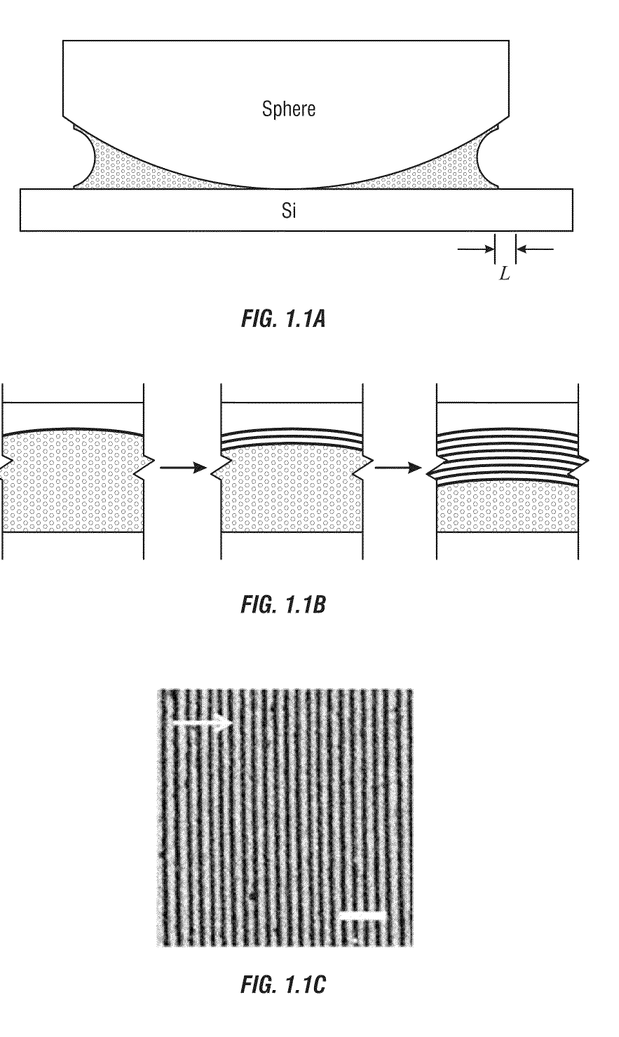

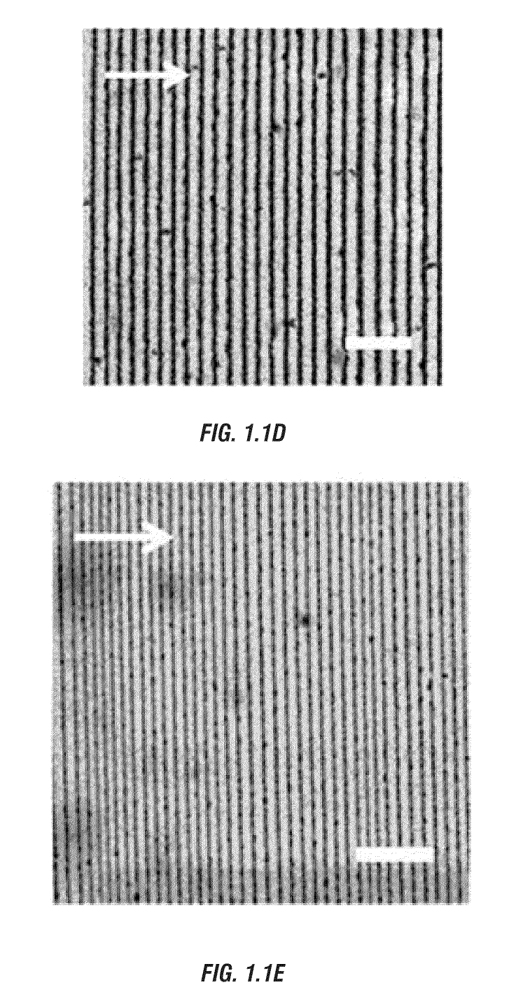

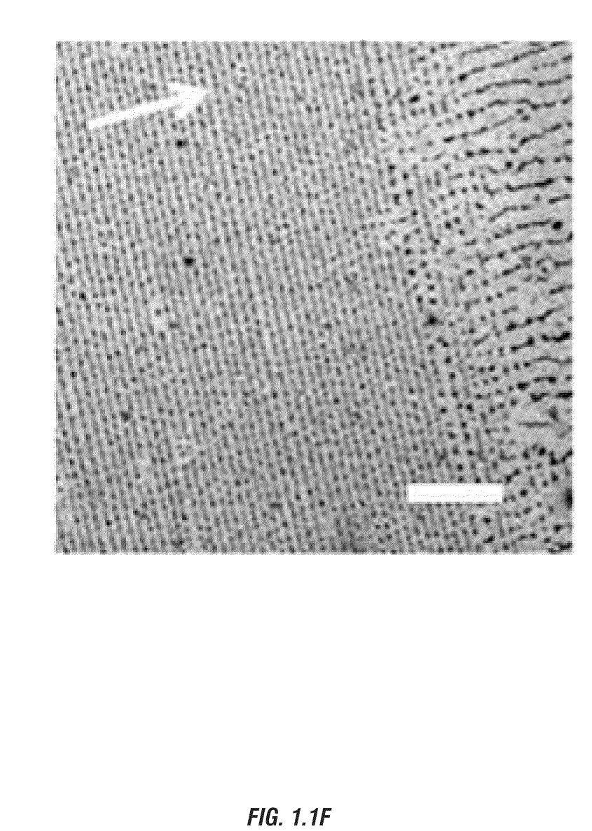

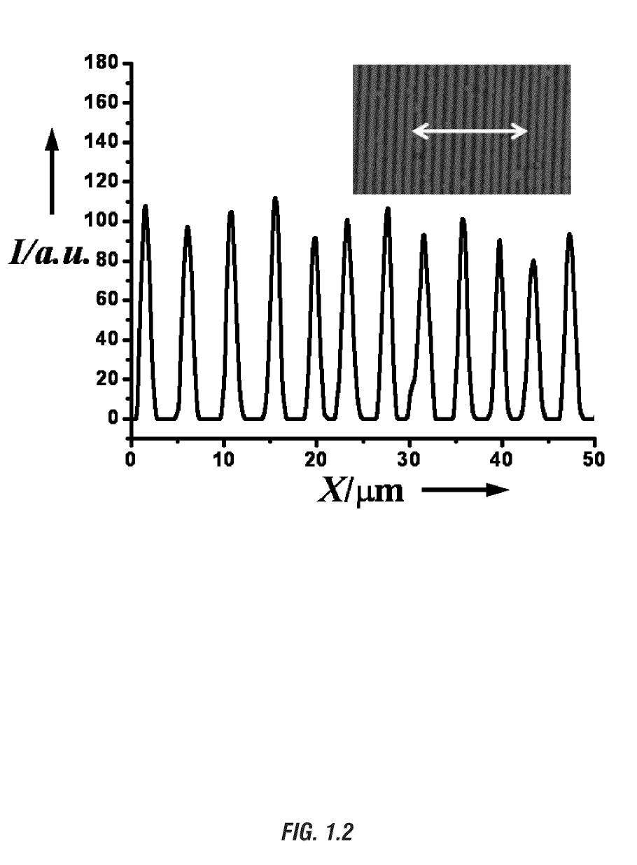

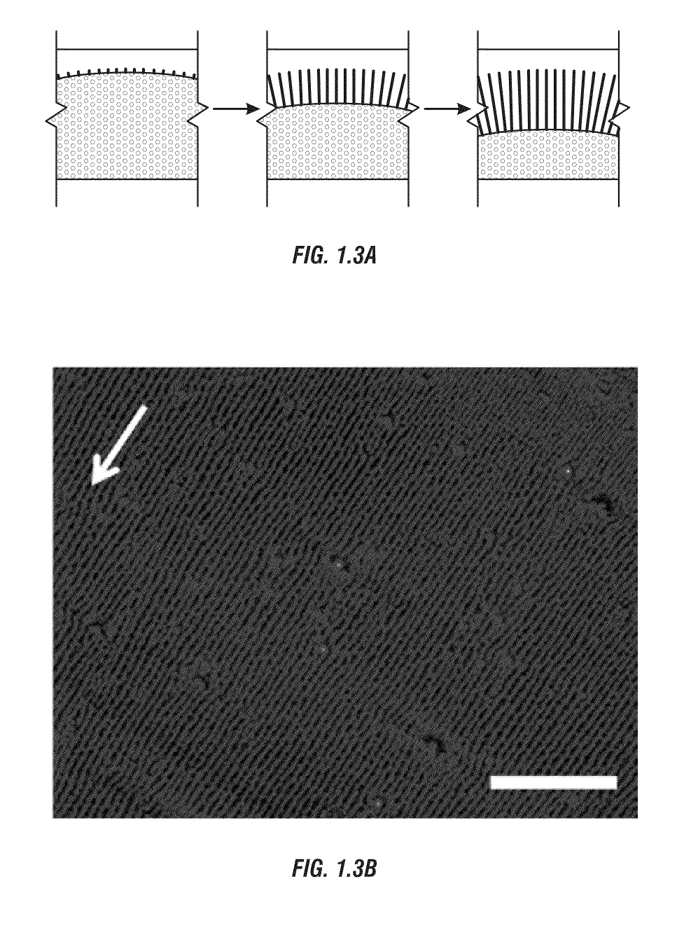

Quantum dots (QDs) are highly emissive, spherical, inorganic nanoparticles with a few nanometers in diameter. They provide a functional platform for a new class of materials for use in light emitting diodes (LEDs),^{[13]} photovoltaic cells,^{[14]} and bio-sensors.^{[15]} Due to the quantum-confined nature of QDs such as CdSe, the variation of particle size provides continuous and predictable changes in fluorescence emission. Passivating the vacancies and trap sites on the CdSe surface with higher band gap materials, such as ZnS, produces CdSe/ZnS core/shell QDs that possess strong photoluminescence.^{[16]} Here, two CdSe/ZnS core/shell QDs (4.4 nm and 5.5 nm in diameter, respectively) were used as the first nonvolatile solutes in our experiments. The surface of CdSe/ZnS was passivated with a monolayer of tri-n-octylphosphine oxide (TOPO) to impart solubility with the host environment and retain the spectroscopic properties of the materials by preventing them from aggregations. A drop of CdSe/ZnS toluene solution was loaded in a confined geometry consisting of a spherical silica lens in contact with a Si substrate (i.e., sphere-on-flat geometry) (see Experimental Section),^{[17-21]} leading to the formation of a capillary bridge of the solution as schematically illustrated in FIG. 1.1a. The in-situ optical microscopy (OM) observation revealed two main types of pattern formations, namely, concentric rings and spokes, depending on whether fingering instabilities of thin film of the evaporating front took place or not.

The formation of ring-like deposits in an evaporating drop containing nonvolatile solutes on a single surface is well known as the “coffee ring” phenomenon.^{[9, 10, 22, 23]} Maximum evaporative loss of the solvent at the perimeter triggers the jamming of the solutes and creates the local roughness (i.e., the pinning of the contact line). This leads to the transportation of solutes to the edge, thus forming a coffee ring stain.^{[9, 10, 22, 23]} The repeated “stick-slip” motions of the contact line produce concentric rings governed by the competition between the capillary force and the pinning force.^{[18]} However, stochastic rings (i.e., irregular multi-rings) are generally formed on a single surface.^{[22,23]} n sharp contrast, highly ordered concentric rings composed of 5.5-nm CdSe/ZnS QDs over a distance of hundreds of micrometers were created by drying the 0.25 mg/ml QD toluene solution in the sphere-on-flat geometry (FIG. 1.1b and 1.1c). This is a direct consequence of the controlled, repetitive pinning and depinning cycles of the contact line (FIG. 1.1b), resembling our recent findings on the self-assembly of polymeric materials.^{[17, 18, 24]} According to in situ OM observation, it took about 7 sec for a ring to deposit (“stick”); a 0.5 sec “slip” followed. Thus, the solution front speed was estimated to be v=9 μm sec⁻¹ (“slip” over a distance of 4.7 μm in 0.5 sec). Locally, the concentric rings appeared as parallel stripes. The center-to-center distance between the adjacent rings, λ_{C-C}, and the width of the ring, w, were 4.7 μm and 2.2 μm, as determined by the fast Fourier transform of the AFM images and the SEM images, respectively. The average height of the ring measured by AFM was 13.2 nm. The observations of QD rings with remarkable regularity highlight the significance of utilizing a sphere-on-Si geometry, which is extremely easy to implement, to guide solvent evaporation and control capillary flow in a drying drop.

FIGS. 1.1d-e show that a family of periodic rings of QDs was also obtained at lower solution concentrations (c=0.15 mg ml⁻¹ in FIG. 1.1d and 0.05 mg ml⁻¹ in FIG. 1.1e). The scrutiny of the ring patterns in FIG. 1.1c-e revealed a noteworthy influence of the concentration on the resulting dimension of the QDs. For the 5.5-nm QD toluene solution, the ring width w decreased from 2.2 μm at c=0.25 mg ml⁻¹ (FIG. 1.1c) to 1.5 μm at c=0.15 mg ml⁻¹ (FIG. 1.1d) to 630 nm at c=0.05 mg ml⁻¹ (FIG. 1.1e). It should be noted that these submicron-wide rings (i.e., 630 nm) were, for the first time, obtained via solvent evaporation in a sphere-on-flat geometry.^{[17-18}] A similar trend was seen in λ_{C-C}, which decreased from 4.7 μm at c=0.25 mg ml⁻¹ to 4.0 μm at c=0.15 mg ml⁻¹ to 2.9 μm at c=0.05 mg ml⁻¹ (FIGS. 1.1c-e). The average height of rings, h was 6.9 nm and 5.5 nm at c=0.15 mg ml⁻¹ and 0.05 mg ml⁻¹, respectively. A larger value of h implies a longer pinning time of QDs at the three-phase contact line, which, in turn, causes a larger w and a greater evaporative volume loss of toluene during pinning.^{[18]} As a result, it leads to a larger pull of the contact line to a new position. Thus, a larger AC-C was observed at the higher concentration of the solution.^{[18, 23, 25]} Moreover, it is noteworthy that constant values of λ_{C-C} and w were observed at a given concentration. This can be attributed to the fact that a uniform h of the QDs was deposited on the substrates, suggesting a constant pinning time. Thus, the evaporative loss of the solvent was steady, leading to the formation of concentric rings with constant AC-C and w.

It is worth noting that at the late stage of drying, all three 5.5-nm CdSe/ZnS QD toluene solutions (c=0.25, 0.15, and 0.05 mg ml⁻¹) in which the solution front was very closer to the center of the sphere/Si contact, exhibited a transition from concentric rings to radially aligned wire-like patterns (see the upper right side in FIG. 1.1f). This can be rationalized as follows: The velocity of the displacement of the meniscus (i.e., the solution front in FIG. 1.1a), v, in a capillary bridge is inversely proportional to the distance from the capillary entrance to the meniscus, L (i.e., v˜1/L).^{[26]} v deceases as the meniscus moves inward as a result of an increase in L (FIG. 1.1a). It has been numerically demonstrated that the formation of fingering instability in an evaporating film is dictated by v: a faster v stabilizes the front, while a slower v leads to the development of fingering instabilities at a propagating front.^{[27]} In the present study, as the solution front retracted, the evaporation rate of the solvent decreased, which caused a reduction in v. As a consequence, the concentration and the viscosity of the solution at the meniscus decreased, leading to instabilities.^{[27]}

A fluorescence microscopic image of concentric rings obtained from self-assembling 5.5-nm CdSe/ZnS QDs after toluene evaporated (c=0.15 mg ml⁻¹) is shown in FIG. 1.2 as an inset. The fluorescence intensity (FIG. 1.2) oscillates almost evenly over a 50-μm scanning distance (i.e., arrow in the inset), signifying that the rings possess uniform height and width. A periodic spacing between rings is also clearly evident. The ability to deposit fluorescent nanoparticles with well-defined dimension in the concentric ring mode presented here may open an extremely simple route to manipulating linear micron- to submicron-wires of semiconductors into a ring structure for use in ring resonator lasers.^{[28]}

It should be noted that a film with chaotic structures was observed from a control sample in which the QD toluene solution (V=12 μL; c=0.25 mg ml⁻¹; D=5.5 nm) was allowed to evaporate on a silicon substrate with or without a cover for preventing possible convections. This justified the necessity of employing the sphere-on-flat configuration to control the evaporation process and associated capillary flow. In a second control experiment, an extra amount of coordinating ligand, TOPO, was added into the QD solutions. Irregular, discontinuing patterns were seen. Therefore, to obtain well-ordered rings, the excessive TOPO was removed, leaving only TOPO-covered nanoparticles that were used in the experiments.

Instead of concentric rings as seen parallel to the three-phase contact line at the early stage of the solvent evaporation when the 5.5-nm CdSe/ZnS QDs were used (FIGS. 1.1 and 1.2), spokes were produced exclusively throughout the entire dying process when a smaller-sized CdSe/ZnS QD (D=4.4 nm) was used. The solution front speed, moving in a continuous manner, was v=1 μm sec⁻¹ during the formation of spokes, as evaluated from in-situ OM observation. The dynamic formation of spokes is attributed to the “fingering instabilities” of the evaporating front,^{[6, 7, 27, 29-31]} as schematically illustrated in FIG. 1.3a. At the early stage of the drying process, the fingers formed at the three-phase contact line (first panel in FIG. 1.3a). They serve as nucleation sites and grow into stripes locally that orient normal to the evaporating front, by transporting the QDs from the surrounding solution (second panel in FIG. 1.3a) as they propagated inward. This results in spoke patterns (last panel in FIG. 1.3a).^{[7]} The process is analogous to the molecular combing of DNA chains, in which DNA chains are aligned perpendicular to the contact line of a drying drop.^{[32]} FIG. 1.3b shows a typical fluorescence microscopic image of a dried film, consisting of 4.4-nm CdSe/ZnS QDs. Each stripe in the spoke was 22 nm high, 1.8 μm wide and millimeters long. The distance between adjacent stripes, λ_{F} was 5 μm. The movement of the solution front in the 4.4-nm QDs case (v=1 μm sec⁻¹) was much slower than that of the 5.5-nm QDs (v=9 μm sec⁻¹ per “slip”) at the same concentration (c=0.25 mg ml⁻¹). The smaller v facilitated the formation of fingering instability at the solution front.[^{27]} Thus, spokes were formed in the 4.4-nm QDs, while rings were produced in the 5.5 nm QDs.

To further demonstrate that a wide variety of nanoparticles can be used to produce regular patterns in the sphere-on-flat geometry, CdTe nanorods (7 nm in diameter and 20 nm in length) and Au nanoparticles (6 nm in diameter) were also employed (see Experimental Section). Concentric ring patterns consisting of CdTe nanorods and Au nanoparticles were observed. We note that the sizes of CdTe nanorods and Au nanoparticles are bigger than that of CdSe/ZnS QDs. Larger surface roughness and a stronger pinning force are expected with larger nanoparticles. Therefore, rather than spokes, the concentric rings dominated exclusively in CdTe and Au nanoparticles despite the fact that the nanopaticles (i.e., CdSe/ZnS, CdTe and Au) used in the studies were all passivated with a same ligand, TOPO.

In summary, we have demonstrated that constrained evaporation (i.e., drying in a confined, axial symmetric geometry to provide control over the solvent evaporation and the associated capillary flow) can be exploited as a simple, cost-effective, and robust strategy for self-assembling various nanoparticles with easily tailored optical and electronic properties into spatially ordered, two-dimensional patterns of single layer or several layers of particle thickness on the micrometer to submicron scale. These self-organized patterns of functional nanoscale materials over large areas offer a tremendous potential for applications in optoelectronic devices, light emitting diodes, solar cells and biosensors.

### Experimental Section

Materials. Two kinds of tri-n-octylphosphine oxide (TOPO) functionalized CdSe/ZnS core/shell QDs^{[16]} were prepared according to the literature.^{[33]} The diameters of the QDs were 4.4 nm and 5.5 nm, respectively, as determined by TEM, corresponding to the growth of two to three atomic layers of ZnS, provided that the original CdSe are 3.0 nm and 4.0 nm in diameter. The 4.4-nm QDs were orange emitting with the maximum emission, λₘₐₓ, at 598 nm. The 5.5-nm QDs were red emitting with λₘₐₓ at 632 nm. The QDs were purified twice using anti-solvent precipitation from the reaction mixture in chloroform, thus removing excessive amount of TOPO ligands. They were subsequently vacuum-dried and dissolved in toluene to make the 1 mg/ml stock solution. Finally, QD toluene solutions with different concentration (e.g., 0.25 mg ml⁻¹, 0.15 mg ml⁻¹ and 0.05 mg ml⁻¹ for the 5.5-nm QDs) were prepared by diluting the filtered 1 mg/ml solution (syringe filter with 200-nm pore size). TOPO-covered CdTe short nanorods (7 nm in diameter and 20 nm in length; inset in FIG. S3b) and TOPO-covered Au nanoparticles (6 nm in diameter) were also synthesized and purified according to the literatures.^{[33, 34]}
Pattern Formation in the sphere-on-flat geometry. A drop of 12 μL nanoparticles toluene solution (CdSe/ZnS QDs, CdTe nanorods or Au nanoparticles) was loaded in a small gap between a spherical silica lens and a SiO₂-coated Si wafer (i.e., thermally coat 300 nm thick SiO₂ on Si). The sphere and Si were firmly and respectively fixed at the top and bottom of sample holders inside a sealed chamber. The temperature inside the chamber was rigorously monitored and was found to be constant during the experiment. The two surfaces (sphere and Si) were brought into contact, forming a capillary bridge of the solution.^{[17, 18}] The diameter and radius of curvature of the sphere were 1 cm and 2 cm, respectively. In such sphere-on-flat geometry, evaporation occurred only at the capillary edge. It took approximately 30 min for the evaporation to complete. Finally, the two surfaces were separated and the patterns on the Si wafer were examined.
Characterizations. In-situ optical microscope (OM) observation was performed (Olympus BX51 OM) in reflective mode under the bright field. Atomic force microscopy (AFM) imaging of patterns on the Si surface was obtained using a Digital Instruments Dimension 3100 scanning force microscope in the tapping mode. Scanning electron microscopy (SEM) studies were performed on a Hitachi S-4000 Field Emission Scanning Electron Microscope, operating at 10 kV accelerating voltage. The transmission electron microscopy (TEM) studies were performed on a JEOL 1200EX scanning/transmission electron microscope, operating at 80 kV.

### Figure Captions

FIG. 1.1 (a) Schematic illustration of the sphere-on-flat geometry in which a drop of nanoparticle solution is constrained, bridging the gap between the spherical lens and Si substrate. (b) Schematic stepwise representation of formation of concentric rings, propagating from the capillary edge of the drop toward the center of the sphere/Si contact. (c)-(f) SEM images of concentric rings produced via evaporation induced self-assembly of 5.5-nm CdSe/ZnS QDs formed by drying 0.25 mg ml⁻¹ (c), 0.15 mg ml⁻¹ (d), and 0.05 mg ml⁻¹ (e) and (f) toluene solution. A transition from rings to wire-like structures (c=0.05 mg ml⁻¹) is shown in the right (f). The scale bar is 20 μm in (c-e) and μm in (f). The arrow on the upper left marks the direction of the movement of the solution front.

FIG. 1.2. Fluorescence intensity scan along the arrow indicated in the fluorescence microscopic image (converted to grey scale) of CdSe/ZnS rings. The rings were produced by self-assembling 5.5-nm CdSe/ZnS QDs after toluene evaporated from the 0.15 mg ml⁻¹ solution.

FIG. 1.3 (a) Schematic drawing illustrating the formation of spoke patterns upon the evaporation from the capillary bridge in the sphere-on-flat geometry. (b) Optical micrograph showing the spokes formed by drying 4.4-nm CdSe/ZnS toluene solution (c=0.25 mg ml⁻¹). The scale bar is 100 μm. The arrow on the upper left indicates the direction of the movement of the solution front.

### REFERENCES FOR EXAMPLE 1

[1] G. M. Whitesides, B. Grzybowski, Science 2002, 295, 2418.
[2] T. Thurn-Albrecht, J. Schotter, C. A. Kastle, N. Emley, T. Shibauchi, L. Krusin-Elbaum, K. Guarini, B. C. T., M. T. Tuominen, T. P. Russell, Science 2000, 290,
[3] V. V. Tsukruk, H. Ko, S. Peleshanko, Phys. Rev. Lett. 2004, 92, 065502.
[4] H. Ko, V. V. Tsukruk, Nano Lett. 2006, 6, 1443.
[5] Y. Lin, A. Boker, J. He, K. Sill, H. Xiang, C. Abetz, X. Li, J. Wang, T. Emrick, S. Long, Q. Wang, A. Balazs, T. P. Russell, Nature 2005, 434, 55.
[6] M. Gleiche, L. F. Chi, H. Fuchs, Nature 2000, 403, 173.
[7] J. Huang, F. Kim, A. R. Tao, S. Connor, P. D. Yang, Nature Mater 2005, 4, 896.
[8] A. M. Kalsin, M. Fialkowski, M. Paszewski, S. K. Smoukov, K. J. M. Bishop, B. A. Grzybowski, Science 2006, 312, 420.
[9] R. D. Deegan, O. Bakajin, T. F. Dupont, G. Huber, S. R. Nagel, T. A. Witten, Nature 1997, 389, 827.
[10] R. D. Deegan, O. Bakajin, T. F. Dupont, G. Huber, S. R. Nagel, T. A. Witten, Phys. Rev. E 2000, 62, 756.
[11] E. Rabani, D. R. Reichman, P. L. Geissler, L. E. Brus, Nature 2003, 426, 271.
[12] T. P. Bigioni, X. M. Lin, T. T. Nguyen, E. I. Corwin, T. A. Witten, H. M. Jaeger, Nature Mater. 2006, 5, 265.
[13] V. L. Colvin, M. C. Schlamp, A. P. Alivisatos, Nature 1994, 370, 354.
[14] W. U. Huynh, J. J. Dittmer, A. P. Alivisatos, Science 2002, 295, 2425.
[15] I. L. Medintz, H. T. Uyeda, E. R. Goldman, H. Mattoussi, Nature Mater. 2005, 4,
[16] J. Xu, J. Xia, J. Wang, J. Shinar, Z. Q. Lin, Appl. Phys. Lett. 2006, 89, 133110.
[17] S. W. Hong, J. Xu, J. Xia, Z. Q. Lin, F. Qiu, Y. L. Yang, Chem. Mater. 2005, 17,
[18] J. Xu, J. Xia, S. W. Hong, Z. Q. Lin, F. Qiu, Y. L. Yang, Phys. Rev. Lett. 2006, 96, 066104.
[19] S. W. Hong, J. Xu, Z. Q. Lin, Nano Lett. 2006, 6.
[20] S. W. Hong, S. Giri, V. S. Y. Lin, Z. Q. Lin, Chem. Mater. 2006, 18, 5164.
[21] S. W. Hong, J. Xia, Z. Q. Lin, Adv. Mater. 2006, (revised manuscript submitted).
[22] E. Adachi, A. S. Dimitrov, K. Nagayama, Langmuir 1995, 11, 1057.
[23] L. Shmuylovich, A. Q. Shen, H. A. Stone, Langmuir 2002, 18, 3441.
[24] Z. Q. Lin, S. Granick, J. Am. Chem. Soc. 2005, 127, 2816.
[25] N. D. Denkov, D. Velev, P. A. Kralchevsky, I. B. Ivanov, H. Yoshimura, K. Nagayamat, Langmuir 1992, 8, 3183.
[26] N. V. Churaev, Liquid and vapor flows in porous bodies: surface phenomena, Vol. 13, Gordon and Breach Science, University of Salford, UK, 2000.
[27] A. V. Lyushnin, A. A. Golovin, L. M. Pismen, Phys. Rev. E 2002, 65, 021602.
[28] P. J. Pauzauskie, D. J. Sirbuly, P. D. Yang, Phys. Rev. Lett. 2006, 96, 143903.
[29] A. M. Cazabat, F. Heslot, S. M. Troian, P. Carles, Nature 1990, 346, 824.
[30] O. Karthaus, L. Grasjo, N. Maruyama, M. Shimomura, Chaos 1999, 9, 308.
[31] I. Leizerson, S. G. Lipson, A. V. Lyushnin, Langmuir 2004, 20, 291.
[32] X. Michalet, R. Ekong, F. Fougerousse, S. Rousseaux, C. Schurra, N. Hornigold, M. van Slegtenhorst, J. Wolfe, S. Povey, J. S. Beckmann, A. Bensimon, Science 1997, 277, 1518.
[33] X. Peng, L. Manna, W. D. Yang, J. Wickham, E. Scher, C. Kadavanich, A. P. Alivisatos, Nature 2000, 404, 59.
[34] M. Green, P. O'Brian, Chem. Comm. 2000, 183.

### 2. Example 2

### Overview

Polymer solutions, when evaporated under confinement (i.e., sphere-on-flat geometry), produced a variety of intriguing surface patterns. These mesoscale patterns were strongly dependent on the molecular weight (MW) of the polymer. Dotted arrays were formed at low MW; concentric rings were produced at intermediate MW; concentric rings, rings with fingers, and punch-hole-like structures, however, were yielded at high MW. Moreover, a decrease in the curvature of the sphere led to an earlier onset of the formation of fingers and punch-hole-like structures when the high MW polymer was used.

A drop of polymer solution was constrained in a sphere-on-flat geometry, resulting in a liquid capillary bridge. As solvent evaporated, intriguing surface patterns of polymer formed, which were strongly dependent on the molecular weight (MW) of polymer. Dotted arrays were formed at low MW; concentric rings were produced at intermediate MW; concentric rings, rings with fingers, and punch-hole-like structures, however, were yielded at high MW. Rings with fingers as well as punch-hole-like structures were manifestations of simultaneous occurrence of the “stick-slip” motion of the contact line and the fingering instabilities of rings. In addition, the curvature of the sphere in the sphere-on-flat geometry was found to affect the pattern formation. A decrease in the curvature of the sphere led to an earlier onset of the formation of punch-hole-like structures when high MW polymer was employed as the nonvolatile solute.

### Introduction

Dissipative structures, such as convection patterns¹⁻⁴ and fingering instabilities,⁵⁻⁷ are formed when a droplet containing nonvolatile solutes (e.g., polymers, nanoparticles, colloids, or DNA) is allowed to evaporate on a solid surface.^{8, 9} However, these self-organized structures are, in general, irregular. The evaporation is, in principle, a non-equilibrium process.⁹ Therefore, to fully exploit the dynamic self-assembly via irreversible solvent evaporation as a simple, lithography- and external field-free route to achieve well-ordered mesoscale structures that may have potential technological applications, it requires delicate control over the evaporation process and the associated capillary flow. To this end, several elegant methods have emerged.^{8, 10, 11} Recently, regular polymer pattern have been produced continuously from a receding meniscus, formed between two parallel plates, by controlling the speed of the upper sliding plate at a constant velocity while keeping the lower plate stationary.⁸ In our previous work, we reported that concentric rings of electrically conducting polymer and organometallic polymer of high regularity were formed naturally and spontaneously via controlled, repetitive “stick-slip” motion of the three-phase contact line when a drop of polymer solution was confined either between two crossed cylindrical mounts covered with the single crystals of mica sheets¹⁰ or between a spherical lens made of silica and a Si substrate (sphere-on-flat geometry), resulting in a capillary-held polymer solution (i.e., capillary bridge).¹⁻¹⁷ The evaporation in this geometry was restricted to the edge of the droplet, the “stick-slip” cycles resulted in hundreds of concentric rings with regular spacing, very much resembling a miniature archery target. Each ring was nanometers high and several microns wide.¹⁰⁻¹² By tuning the interfacial interaction between the polymer and the substrate that governed the stability of the thin films, the intriguing, ordered dissipative structures can be produced as a result of synergy of controlled self-assemblies of the polymer and its destabilization mediated by the interfacial interaction.¹⁵

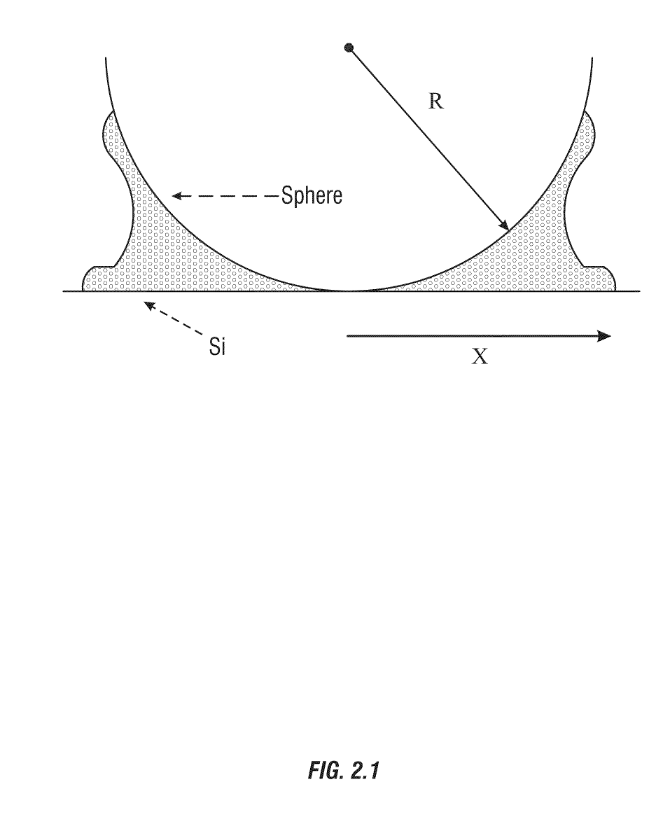

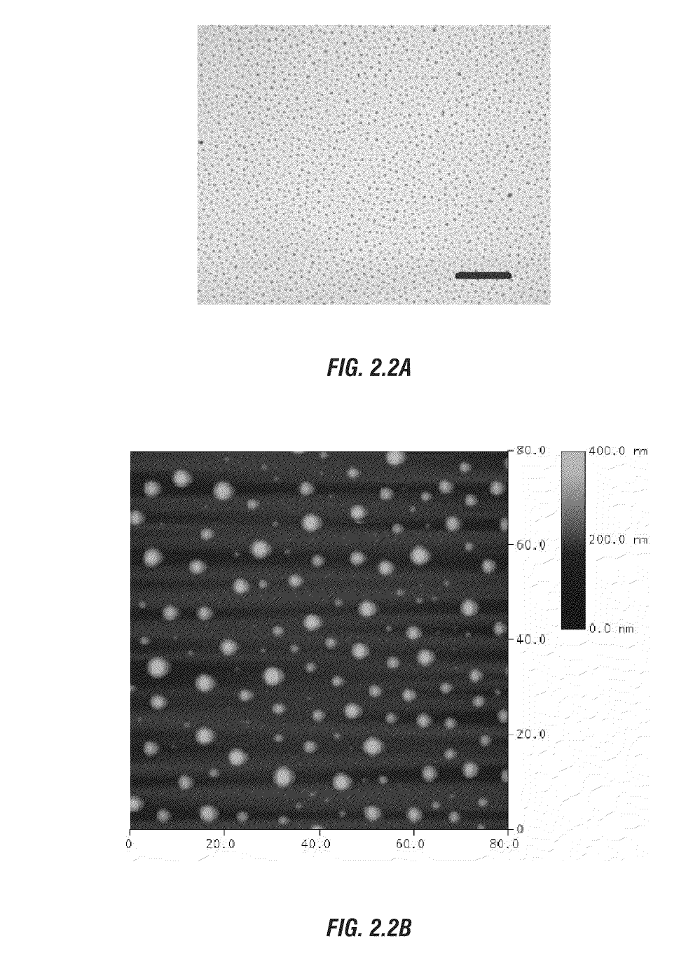

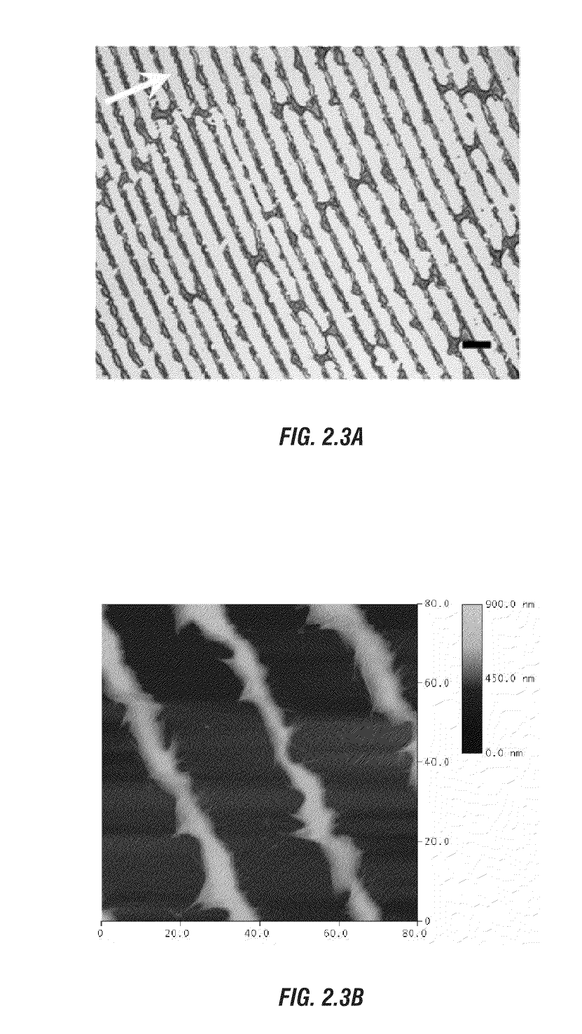

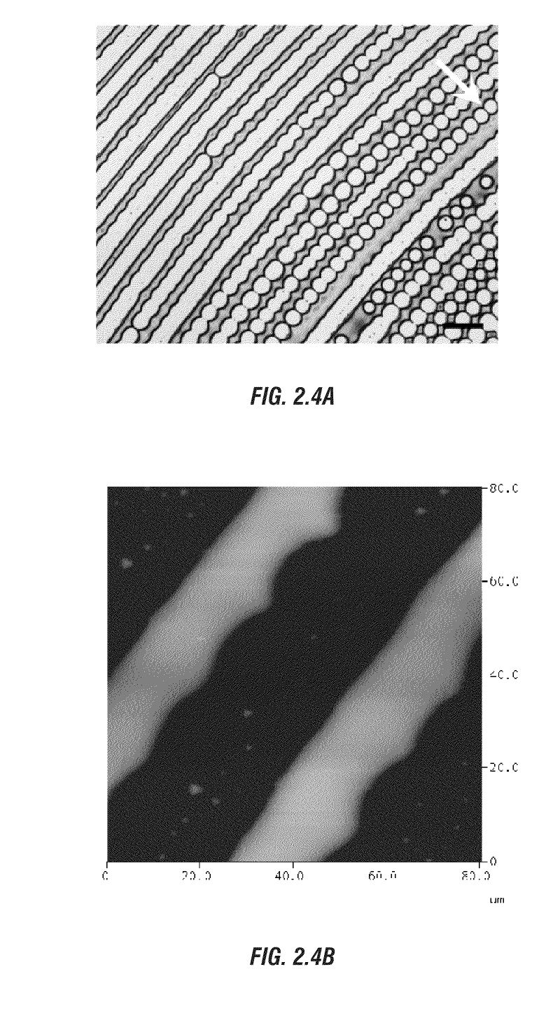

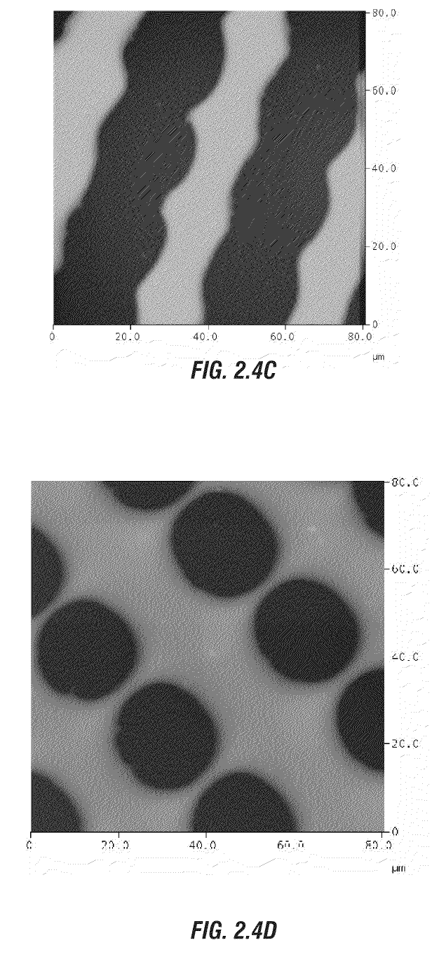

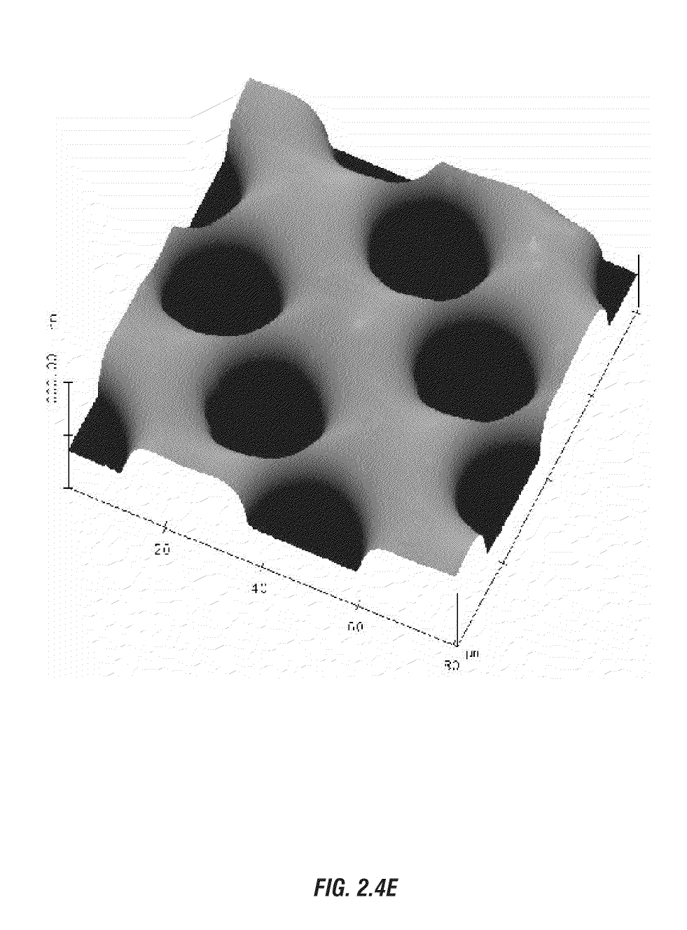

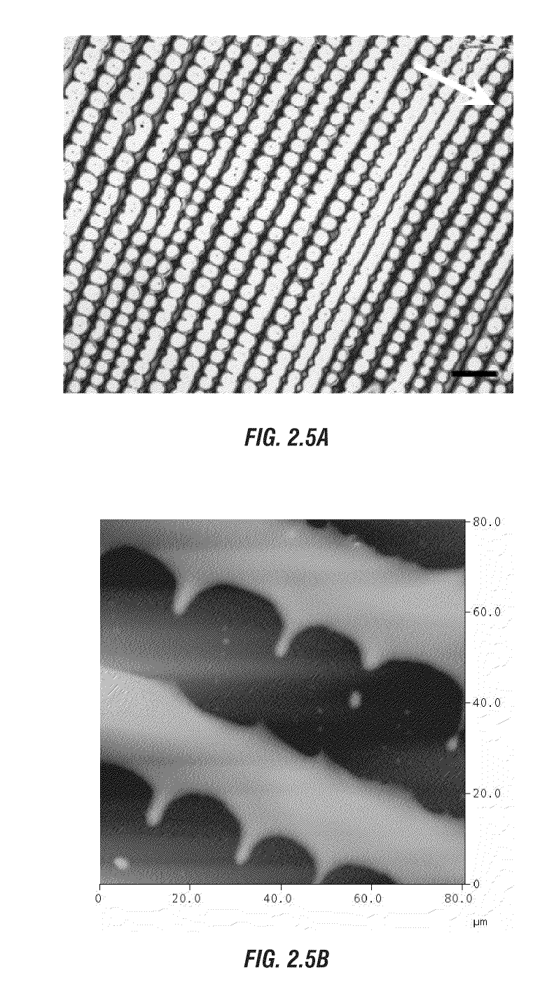

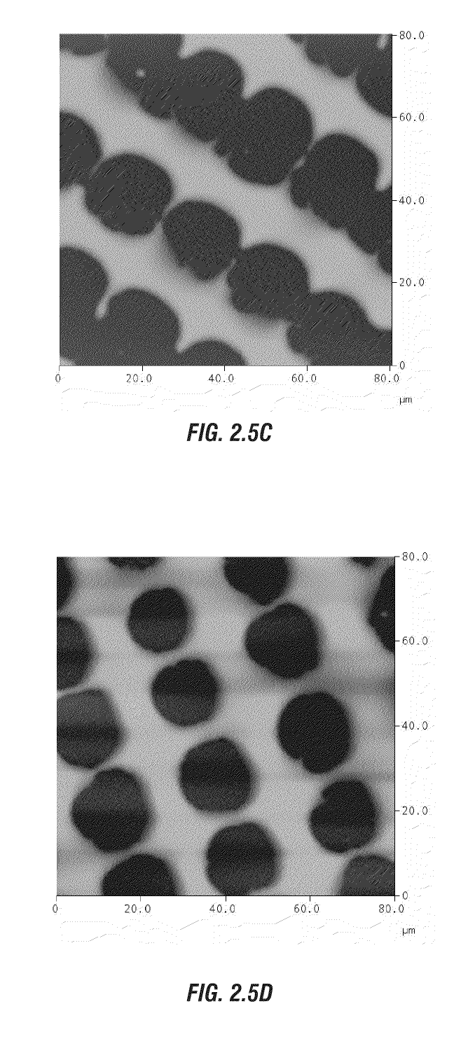

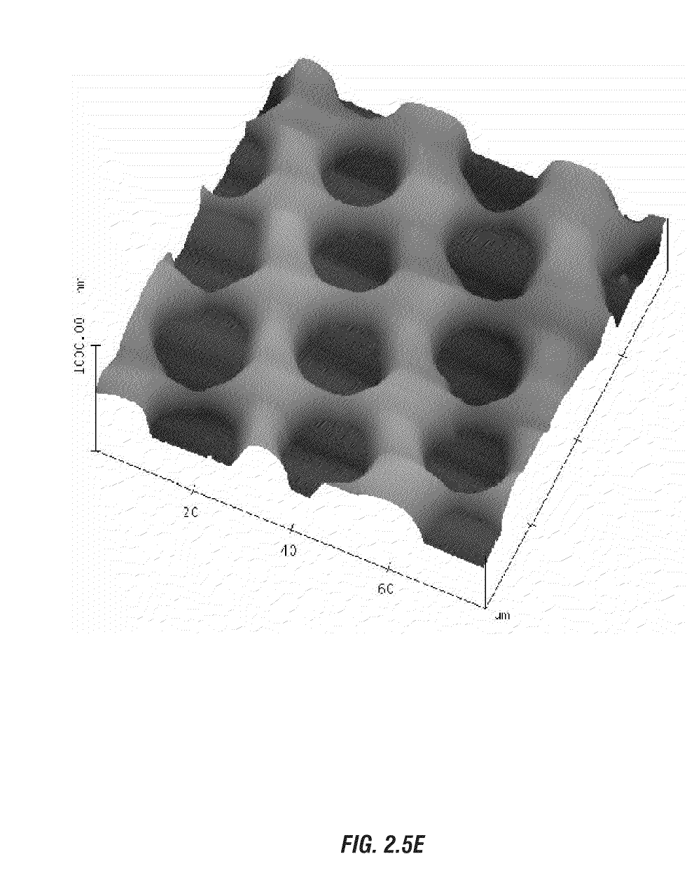

We have reported that the use of solutions with different concentration and different solvents effectively mediated the pattern formation in an evaporating droplet containing nonvolatile solutes.¹¹ In this paper, we extend our previous work to investigate the molecular weight (MW) effect on the mesoscale polymer patterns formed by drying a drop of polymer solution in a sphere-on-flat geometry (i.e., a spherical lens (or a push-pin) on a Si substrate) as depicted in FIG. 2.1. The patterns, ranging from dotted arrays at low MW to concentric rings at intermediate MW to concentric rings and punch-hole-like structures at high MW, were observed. A qualitative explanation was given to understand the pattern formation. Moreover, the curvature effect of the sphere was also studied by replacing the spherical lens (radius of curvature, R˜2.0 cm) with the push-pin (R˜2.5 cm). As the curvature decreased (i.e., from 1/R˜1/2.0 cm⁻¹ to 1/2.5 cm⁻¹), represented as a decrease in the distance between the sphere and Si, an earlier onset of fingering instabilities of polymer were observed owing to a reduction in the velocity of the displacement of the meniscus (i.e., the liquid-vapor interface) in the capillary bridge.

### Experimental Section

### Materials

Four polystyrene homopolymers (PS) (Polymer Source, Inc) with different molecular weight were used in the studies. The number average MW, Mₙ (and weight average MW, M_{w}) of PS were 60 K (62.5 K), 112 K (118 K), 420 K (483 K), and 876 K (1050 K). These four PS denoted PS-60K, PS-112K, PS-420K, and PS-876K, respectively. All PS were dissolved in toluene to prepare the PS toluene solutions at the concentration of 0.25 mg/ml. Subsequently, the solutions were purified with 0.2 μm hydrophobic membrane filter.

The spherical lens made from fused silica with a radius of curvature, R˜2.0 cm, the push-pin made from stainless steel with R˜2.5 cm, and silicon wafers were cleaned by the mixture of sulfuric acid and Nochromix™. Subsequently, they were rinsed with DI water extensively and blow-dried with N2.

### Sample Preparation

To construct a confined geometry, a spherical lens (or a push-pin) and a Si wafer were used. The sphere (i.e., the spherical lens or the push-pin) and Si were firmly fixed at the top and bottom of sample holders inside a sealed chamber, respectively. To implement a confined geometry, an inchworm motor with a step motion of a few micrometers was used to place the upper sphere into contact with the lower stationary Si surface. Before they contacted (i.e., separated by approximately a few hundred micrometers apart), a drop of ˜23 μL PS toluene solutions were loaded and trapped within the gap between the sphere and Si due to the capillary force. The sphere was finally brought into contact with Si substrate by the inchworm motor such that a capillary-held PS solution formed with evaporation rate highest at the extremity (FIG. 2.1). It is noteworthy that the use of a sealed chamber ensured a stable solvent evaporation against the possible external influences such as the air convection and the humidity in an open space.

The evaporation took about half an hour to complete. Afterward, the sphere and Si were separated. The intriguing structures were produced on both the sphere and Si surfaces. Due to the curving effect of the sphere, only the patterns formed on Si were evaluated by the optical microscope (OM; Olympus BX51 in the reflection mode) and the atomic force microscopy (AFM; Dimension 3100 scanning force microscope in the tapping mode (Digital Instruments)). BS-tap300 tips (Budget Sensors) with spring constants ranging from 20 to 75N/m were used as scanning probes.

### Results and Discussion

### 1. Molecular Weight Effect

The structures shown in FIGS. 2.2-4 were obtained by drying the four PS toluene solutions placed between the spherical lens (R˜2 cm) and Si substrate. The evaporation took place under controlled conditions (i.e., the constant temperature (room temperature) and the same initial polymer concentration, c=0.25 mg/ml). For the PS with the MW of 60K, irregular dotted arrays were formed exclusively on the Si substrate by drying the PS-60K toluene solution in the sphere-on-Si geometry (FIG. 2.1). A typical optical micrograph of randomly distributed PS-60K aggregates is shown in FIG. 2.2a. The average height of PS-60K aggregates was 204 nm and 126 nm for bigger and smaller PS dots, respectively (FIG. 2.2b). It is important to note that similar patterns were observed for other PS-60K samples at different concentrations (from 0.125 mg/ml to 5 mg/ml), suggesting that (a) the formation of isolated, randomly dispersed PS-60K aggregates was governed by the dewetting;⁸ (b) the force exerted by the deposition of PS-60K was not strong enough to pin the three-phase contact line (i.e., form a “coffee ring”).¹⁸⁻²⁰ Thus, the thin liquid film ruptured on the surfaces into randomly distributed PS dots to minimize the surface energy.^{5, 8}

When a higher MW PS was used (i.e., PS-112K), microscopic concentric rings of PS-112K were obtained as shown in FIG. 2.3a. The formation of concentric rings was a direct consequence of repetitive “stick-slip” motion of the contact line (i.e., the competition between the pinning force (“stick”) and the depinning force (“slip”)) toward the center of sphere/Si contact with elapsed time as discussed in our previous work.^{10-12, 15} The solution front was arrested at the capillary edge as toluene evaporated (FIG. 2.1). The local viscosity of the contact line was then increased with time. This led to the vitrification of a PS-112K ring before the solution front jumped to the next position where it was arrested again. The average jumping distance (i.e., the center-to-center distance between adjacent rings), λ_{C-C} and the average height of the ring, h are 30.2 μm and 228 nm, respectively, as determined by AFM (FIG. 2.3b). Locally, the rings appeared as parallel stripes; and the shape of each ring was, however, non-uniform. No PS-112K was deposited between the rings (FIG. 2.3b).

A set of intriguing surface patterns emerged when the PS with the MW of 420K (i.e., PS-420K) was employed. FIG. 2.4a shows an optical micrograph of the pattern of PS-420K produced at different stages of “stick-slip” motion of the contact line as toluene evaporated from the capillary edge. The 2D AFM height images of surface patterns, roughly corresponding to the locations in the upper left, middle, and lower right of the optical micrograph in FIG. 2.4a, are shown in FIGS. 2.4b-d. The concentric rings and rings with fingering instabilities⁵⁻⁷ were formed at distances far away from the center of sphere/Si contact (i.e., at larger X) (upper left of optical micrograph in FIG. 2.4a and FIG. 2.4b). The fingering instabilities represented as the surface perturbation with a well-defined wavelength at edges of a ring. The fingers appeared on both sides of a ring at intermediate X (FIG. 2.4c). When the solution front was closer to the center of sphere/Si contact (i.e., at small X), the punch-hole-like structures were produced by interconnecting the fingers from adjacent rings (FIGS. 2.4d-e). The characteristic distance between adjacent PS-420K fingers on a ring, λ_{F} and the height of the ring, h were 25.35 μm and 379 nm at X=3190 μm (FIG. 2.4b), 25.26 μm and 335 nm at X=3090 μm (FIG. 2.4c), and 24.90 μm and 327 nm at X=2950 μm (FIG. 2.4d). The average width and height of fingers at the center connecting two adjacent rings were 3.74 μm and 195 nm (FIGS. 2.4d-e).

The emergence of PS-420K surface patterns from rings to rings having fingering instabilities to punch-hole-like structures has been qualitatively understood based on the fact that the velocity of the displacement of the meniscus at the capillary edge, v was inversely proportional to the distance from the capillary entrance to the meniscus.^{15, 22} A faster v stabilized the front, while a slower v led to the development of fingering instabilities at a propagating front.²³ As the solution front progressed toward the center of the sphere/Si contact, v decreased owing to a decrease in the evaporation rate of toluene. As a result, fewer PS-420K were available to transport and pin the contact line. This caused the formation of fingering instabilities. The center-to-center distance between two adjacent rings, λ_{C-C} decreased gradually as the solution front approached the center of sphere/Si contact. This facilitated the fingers from adjacent rings to connect each other. As a result, the sequence of microscopic holes was produced with increasing proximity to the center of sphere/Si contact (low right of the optical micrograph in FIG. 2.4a and FIGS. 2.4d-e). Similar surface patterns were observed from the drying of 0.25 mg/ml PS-876K toluene solution, i.e., forming rings, rings with fingers, and a periodic array of punch-holes progressively with a decrease in X (FIG. 2.1).

We now turn our attention to further address qualitatively the molecular weight effect on the structure formation based on the overlap concentration argument. de Gennes et al presented three concentration regimes for polymer random coils in solution; they are dilute, semidilute, and concentrated solutions, corresponding to separated chains, overlapping chains, and entangled chains, respectively.^{24, 25} The overlap concentration, C* from dilute to semidilute solution is defined as the concentration at which the polymer coils touch each other.^{24, 26}

$${C}^{*} = \frac{3 M}{4 π {R}_{g}^{3} {N}_{A}} \qquad ( 1 )$$

where M, R_{g}, and N_{A} are the molecular weight of polymer, radius of gyration, and Avogadro's number, respectively. R_{g}=1.107×10⁻²M^{0.605} for PS in toluene. The overlap concentration from semidilute to concentrated solution, C** is, however, independent of molecular weight and can be estimated from the equation²⁴

$${C}^{**} = \frac{0.77}{{[ η ]}^{**}} \qquad ( 2 )$$

where[η]**=2.5N_{A}Vₑ/M**, Vₑ=(4/3)R_{g,θ}³, R_{g,θ} is the unperturbed root-mean-square end-to-end distance of a polymer chain having a molecular weight of M**. For PS, the entanglement MW, M** is ˜20,000,²⁷ and R_{g,θ} is ˜3 nm.²⁴ As toluene evaporated from the capillary edge in the sphere-on-flat geometry, the concentration of the solution front at the contact line gradually increased with time, undergoing from dilute to semidilute to concentrated solution; and eventually forming a glassy polymer ring. From eq. (1) and (2), the C* for PS with different molecular weights can be calculated, yielding C*=36 mg/ml for PS-60K, 21 mg/ml for PS-112K, 6.8 mg/ml for PS-420K, and 3.6 mg/ml for PS-876K. The C** for all PS solutions is 90 mg/ml.

Based on the values of C* obtained above, we argue that, for PS-60K, the polymer coils cannot overlap because the solution cannot reach such a high C* (i.e., 36 mg/ml) during the course of the solvent evaporation. Accordingly, the viscosity (related to the pinning force) of the solution front was so low that no contact line was pinned to reduce the speed of the displacement of the meniscus at the capillary edge (FIG. 2.1). A steady movement of the solution front was resulted in. A thin layer of polymer solution was, thus, left behind. Eventually, isolated polymer dots (FIG. 2.2) were formed due to the rupture of the liquid thin film driven by unfavorable interfacial interaction between liquid-like PS film and the substrate (i.e., possessing a positive Hamaker constant, A for PS, thereby causing thin film unstable and dewetting).

For PS-112K, the C* is relatively low (i.e., 21 mg/ml). The polymer coils may overlap, leading to an increase in the viscosity of the solution front (the intrinsic viscosity, [η] is proportional to the square root of MW, i.e., [η]=K\sqrt{M}α³, where K is Mark-Houwink constant, and α is chain expansion factor). Thus, the speed of the displacement of the meniscus at the capillary edge decreased during the solvent evaporation and the pinning of the contact line occurred. As a consequence, more polymers were transported by the capillary flow to the capillary edge, thereby forming a ring. The contact angle of the meniscus decreased due to the evaporative loss of the solvent. When the contact angle was smaller than the critical contact angle, at which the capillary force became larger than the pinning force, the solution front jumped inward to a new position.¹¹ Repetitive deposition and recession cycles of the contact line in the sphere-on-Si geometry resulted in the formation of concentric rings of PS-112K as shown in FIG. 2.3.¹¹

It is easy to understand that the speed of the solution front decreased more significant when the higher MW PS was used (i.e., PS-420K and PS-876K). The formation of concentric rings is clearly evident (FIG. 2.4). The polymer coils of PS-420K and PS-876K overlapped significantly since C* was only 6.8 mg/ml and 3.6 mg/ml, respectively. The viscosity increased dramatically during the solvent evaporation as compared to that of PS-112K. The higher the molecular weight of the polymer, the faster is the rate of increase in viscosity due to the increase in concentration as a result of the solvent evaporation. This caused a reduction in the speed of solution front, v,²⁹ thereby leading to the development of fingering instabilities at a propagating front.²³ Rings with fingers as well as punch-hole-like structures were manifestations of simultaneous occurrence of the “stick-slip” motion of the contact line and the fingering instabilities of rings.

### 2. Curvature Effect

The mesoscale surface patterns formed by drying the PS toluene solution in a sphere-on-Si geometry can be dynamically tuned by proper choice of the curvature of the sphere. The optical micrograph of the surface pattern produced by drying the 0.25 mg/ml PS-420K toluene solution is shown in FIG. 2.5a. In this study, the spherical lens with curvature of ½ cm⁻¹ was replaced with a push-pin with curvature of 1/2.5 cm⁻¹. Compared to the patterns in FIG. 2.4, an important piece of information was readily gained from FIG. 2.5: more fingers and punch-holes were obtained under the same range of ΔX (i.e., the same image size in FIG. 2.4 and 2.5) as the curvature of the sphere decreased. This is simply because the evaporation rate of toluene in the sphere-on-Si geometry slowed down with a large R of the upper sphere. As a result, the displacement of the meniscus at the capillary edge, v reduced. A slower v triggered the earlier onset of fingering instabilities, and thus the punch-hole-like structures subsequently (e.g., the punch-hole-like structures formed at X=3250 μm (FIG. 2.5d-e) as compared to those at X=2950 μm (FIG. 2.4d-e)). The uniform zone of the punch-hole-like structure increased. This suggested the possibility of obtaining well-ordered punch-holes structures over larger surface area by manipulating the curvature of the sphere.

The 2D AFM height images, representing the patterns formed at the different stages of the dying process (i.e., progressed from fingering instabilities on the rings to punch-hole-like structures), are shown in FIG. 2.5b-e. The characteristic distance between adjacent PS fingers on a ring, λ_{F} and the height of the ring, h were 24.36 μm, 339 nm at X=4100 μm (FIG. 2.5b), 20.60 μm, 303 nm at X=3450 μm (FIG. 2.5c), and 18.99 μm, 289 nm at X=3250 μm (FIG. 2.5d-e). Further scrutiny of the rings having fingers at their edges in FIG. 2.5b-c revealed the formation of isolated dots, residing (FIG. 2.5b-c) or connecting (FIG. 2.5c) between two adjacent fingers, driven by the Rayleigh instability. As the solution front neared the center of the push-pin/Si contact, the mass transportation was facilitated owing to a closer distance between two adjacent rings. This led to the formation of more punch-hole-like structures. The average width and height of fingers at the center connecting two adjacent rings is 5.9 μm and 228 nm as measured by AFM (FIGS. 2.5d-e).

### Conclusion

Mesoscale polymer patterns were formed by evaporation of a polymer solution in the capillary formed by a sphere resting on a plate (i.e., sphere-on-flat geometry). The change in the polymer molecular weight (MW) led to very pronounced morphological change in the resulting structures. At low MW, the dewetting process occurred, leaving behind randomly distributed dots at the surface. At intermediate MW, the self-assembled concentric rings were formed by repetition of the deposition and recession cycle of the contact lines. At high MW, concentric rings, rings with fingers, and punch-hole-like structures were produced. Furthermore, the change in the radius of curvature of the upper sphere was found to affect the pattern formation. A smaller curvature caused an earlier onset of the formation of fingers and punch-hole-like structures when the high MW PS was utilized as a nonvolatile solute. The present studies provide valuable insights into the rationale of creating intriguing polymer patterns by varying the molecular weight and tuning the radius of curvature of the sphere in the sphere-on-flat geometry, which in turn render the control over the solvent evaporation and associated flow.

### Figure Captions

FIG. 2.1. Schematic illustration of a drop of polymer solution placed between sphere and Si substrate (i.e., sphere-on-flat geometry), forming a capillary-held liquid bridge. The radius of curvature of upper sphere is R. The absolute position of the ring away from the sphere/Si contact center is X.

FIG. 2.2. (a) Optical micrograph of randomly dispersed PS-60K aggregates on Si substrate after the evaporation of toluene in the sphere-on-flat geometry. The initial concentration of the PS-60K toluene solution, c is 0.25 mg/ml. Scale bar=25 μm. (b) AFM image of PS-60K aggregates, showing the details of dewetted patterns. The image Size is 80 μm×80 μm.

FIG. 2.3. (a) Optical micrograph of concentric ring patterns of PS-112K on Si substrate after the evaporation of toluene in the sphere-on-flat geometry. The initial concentration of the PS-112K toluene solution, c is 0.25 mg/ml. Scale bar=50 μm. The arrow on the upper left marks the direction of the movement of the solution front. (b) A typical 2D AFM height image of PS-112K rings. The image size is 80 μm×80 μm.

FIG. 2.4. (a) Optical micrograph of surface patterns of PS-420K formed by the drying mediated self-assembly in the sphere-on-flat geometry. The rings, rings with fingers, and punch-hole-like structures (colorful patterns on light gray Si substrate) were obtained. The initial concentration of the PS-420K toluene solution, c is 0.25 mg/ml. Scale bar=70 μm. The arrow on the upper right marks the direction of the movement of the solution front. (b-d) 2D AFM height images of surface patterns, roughly corresponding to the locations in the upper left, middle, and lower right of the optical micrograph in (a). The rings and rings with fingering instabilities were seen in (b) at larger X. The fingers appeared on both sides of a ring in (c) at intermediate X. The punch-hole-like structures were formed when the solution front was closer to the center of sphere/Si contact (i.e., at small X) as shown in (d). (e) A corresponding 3D AFM height image of (d). The image size is 100×100 μm.

FIG. 2.5. Curvature effect. (a) Optical micrograph of surface patterns of PS-420K produced by the evaporation induced self-assembly of the PS-420K toluene solution confined between the push-pin and Si substrate. The radius of curvature of the push-pin is 2.5 cm. The fingers and the punch-hole-like structures (colorful patterns on light gray Si substrate) are clearly evident. The initial concentration, c is 0.25 mg/ml. Scale bar=70 μm. The arrow on the upper right denotes the direction of the motion of the solution front. (b-d) 2D AFM height images of surface patterns, roughly corresponding to the locations in the upper left, middle, and lower right of the optical micrograph in (a). (e) A corresponding 3D AFM height image of (d). The image size is 100×100 μm².

### REFERENCES FOR EXAMPLE 2

1. Nguyen, V. X.; Stebe, K. J. Phys. Rev. Lett. 2002, 88, 164501.
2. Bormashenko, E.; Pogreb, R.; Musin, A.; Stanevsky, O.; Bormashenko, Y.; Whyman, G.; Barkay, Z. J. Coll. Interface Sci. 2006, 300, 293.
3. Bormashenko, E.; Pogreb, R.; Musin, A.; Stanevsky, O.; Bormashenko, Y.; Whyman, G.; Gendelman, O.; Barkay, Z. J. Coll. Interface Sci. 2006, 297, 534.
4. de Gennes, P. G. Eur. Phys. J. E 2001, 6, 421.
5. Karthaus, O.; Grasjo, L.; Maruyama, N.; Shimomura, M. Chaos 1999, 9, 308.
6. Hu, H.; Larson, R. G. Langmuir 2005, 21, 3963.
7. Cazabat, A. M.; Heslot, F.; Troian, S. M.; Carles, P. Nature 1990, 346, 824.
8. Yabu, H.; Shimomura, M. Adv. Funct. Mater. 2005, 15, 575.
9. Rabani, E.; Reichman, D. R.; Geissler, P. L.; Brus, L. E. Nature 2003, 426, 271.
10. Lin, Z. Q.; Granick, S. J. Am. Chem. Soc. 2005, 127, 2816.
11. Xu, J.; xia, J.; Hong, S. W.; Lin, Z. Q.; Qiu, F.; Yang, Y. L. Phys. Rev. Lett. 2006, 96, 066104.
12. Hong, S. W.; Xu, J.; Xia, J.; Lin, Z. Q.; Qiu, F.; Yang, Y. L. Chem. Mater. 2005, 17, 6223.
13. Hong, S. W.; Giri, S.; Lin, V. S. Y.; Lin, Z. Q. Chem. Mater. 2006, 18, 5164.
14. Hong, S. W.; Xu, J.; Lin, Z. Q. Nano Lett. 2006, 6, 2949.
15. Hong, S. W.; Xia, J.; Lin, Z. Q. Adv. Mater. 2006 (in press).
16. Xu, J.; Xia, J.; Lin, Z. Q. Angew. Chem., Int. Ed. 2007 (in press).
17. Wang, J.; xia, J.; Hong, S. W.; Qiu, F.; Yang, Y.; Lin, Z. Q. Macromolecules 2007, (submitted).
18. Deegan, R. D.; Bakajin, O.; Dupont, T. F.; Huber, G.; Nagel, S. R.; Witten, T. A. Nature 1997, 389, 827.
19. Deegan, R. D.; Bakajin, O.; Dupont, T. F.; Huber, G.; Nagel, S. R.; Witten, T. A. Phys. Rev. E 2000, 62, 756.
20. Deegan, R. D. Phys. Rev. E 2000, 61, 475.
21. Ozawa, K.; Nishitani, E.; Doi, M. Japanese J. Appl. Phys. 2005, 44, 4229.
22. Churaev, N. V., Liquid and vapor flows in porous bodies: surface phenomena. Gordon and Breach Science, University of Salford, UK: 2000; Vol. 13.
23. Lyushnin, A. V.; Golovin, A. A.; Pismen, L. M. Phys. Rev. E 2002, 65, 021602.
24. Ying, Q.; Chu, B. Macromolecules 1987, 20, 362.
25. Daoud, M.; Cotton, J. P.; Farnoux, B.; Jannink, G.; Sarma, G.; Benoit, H.; Duplessix, R.; Picot, C.; de Gennes, P.-G. Macromolecules 1975, 8, 804.
26. Stange, T. G.; Mathew, R.; Evans, D. F. Langmuir 1992, 8, 920.
27. Tsui, O. K. C.; Zhang, H. F. Macromolecules 2001, 34, 9139.
28. Poh, B. T.; Ong, B. T. Eur. Polym. J. 1984, 20, 975.
29. Reiter, G.; Sharma, A. Phys. Rev. Lett. 2001, 87, 166103.

### 3. Example 3

### Overview

The use of spontaneous self-assembly as a lithography- and external fields-free means to construct well-ordered, often intriguing structures has received many attentions due to the ease of producing complex structures with small feature sizes.^{[1-3]} Drying mediated self-assembly of nonvolatile solutes (polymers, nanoparticles, and colloids) through irreversible solvent evaporation of a sessile droplet on a solid substrate (unbound solution) represents one such case.^{[3-16]} However, irregular polygonal network structures (Benard cells)^{[14, 15]} and stochastically distributed concentric ‘coffee rings’^{[4-6, 10]} are often observed. The irregular multi-rings (‘coffee rings’) are formed via repeated pinning and depinning events (i.e., ‘stick-slip’ motion) of the contact line.^{[4-6, 10]} The evaporation flux varies spatially with the highest flux observed at the edge of the drop. Therefore, to form spatially periodic patterns at the microscopic scale, the flow field in an evaporating liquid must be delicately harnessed. In this regard, recently, a few attempts have been made to guide the droplet evaporation in a confined geometry^{[17-20]} with^{[17}] or without^{[18-22]} the use of external fields. Patterns of remarkably high fidelity and regularity have been produced.^{[18-22]} However, interfacial interactions between nonvolatile solutes and substrates govern the stability of thin films and have not been explored in these studies.^{[18-20]} The synergy of controlled self-assemblies of solutes and their destabilization mediated by the interaction between solutes and substrates during the solvent evaporation can lead to the formation of intriguing, ordered structures.

Discussion

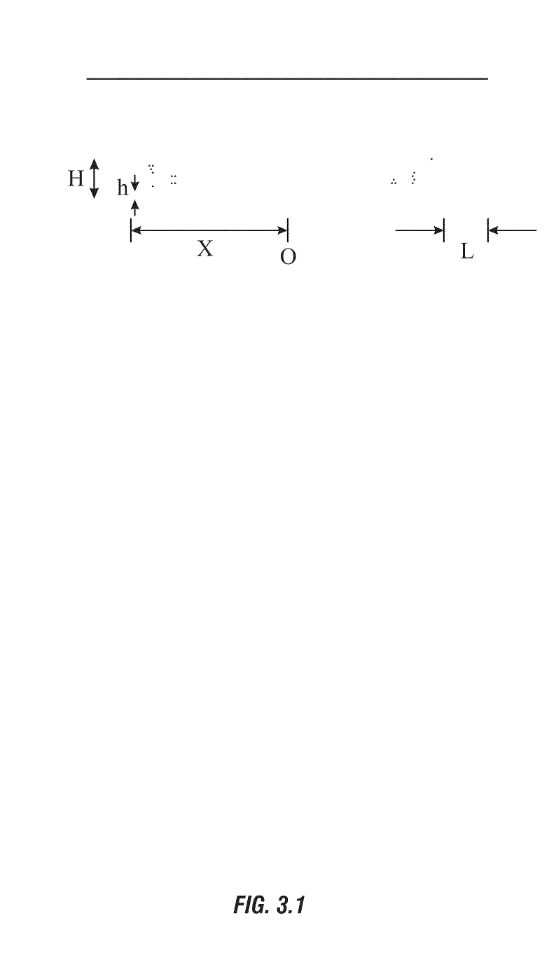

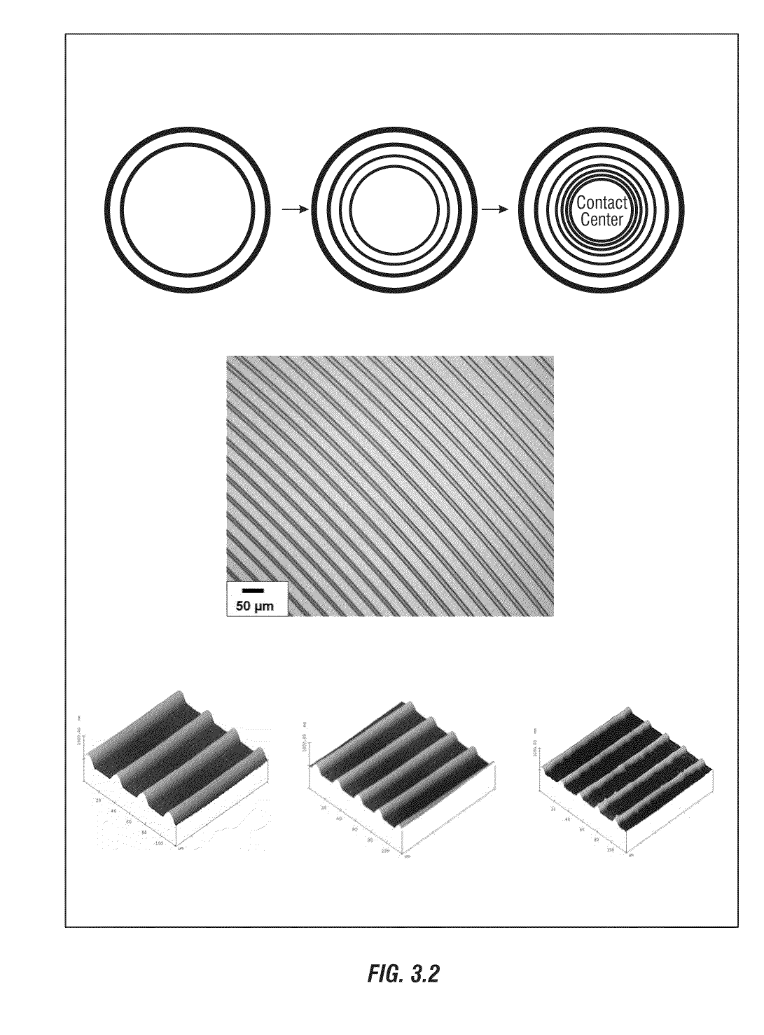

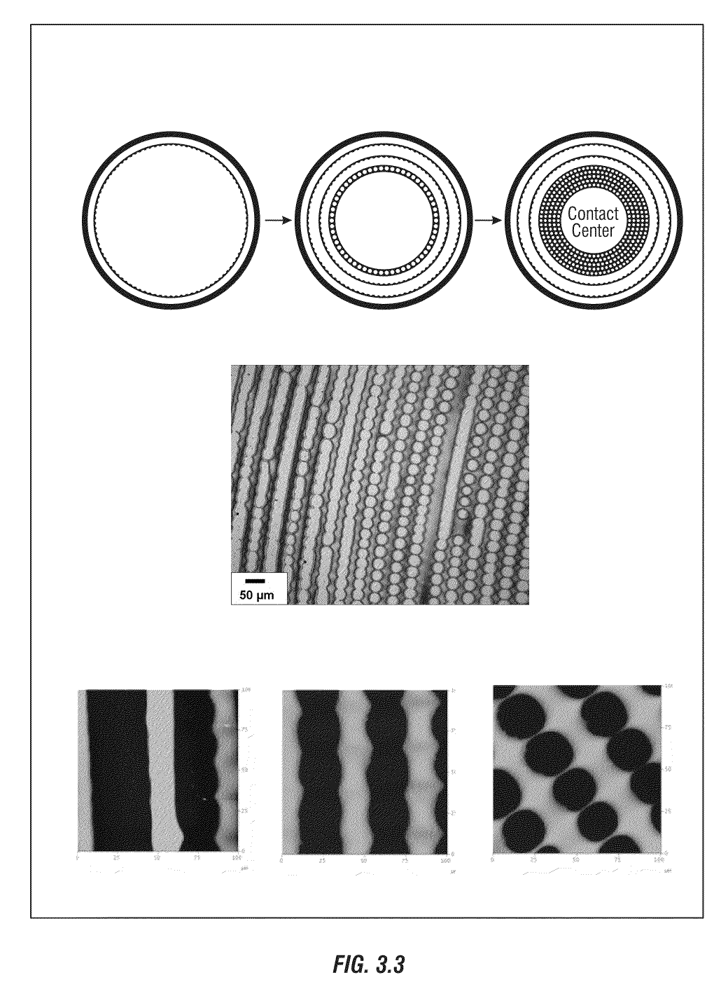

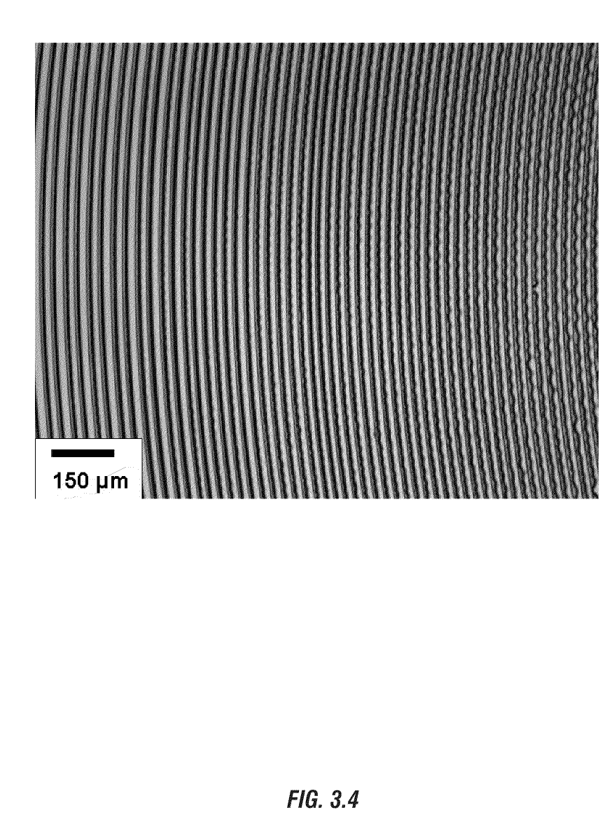

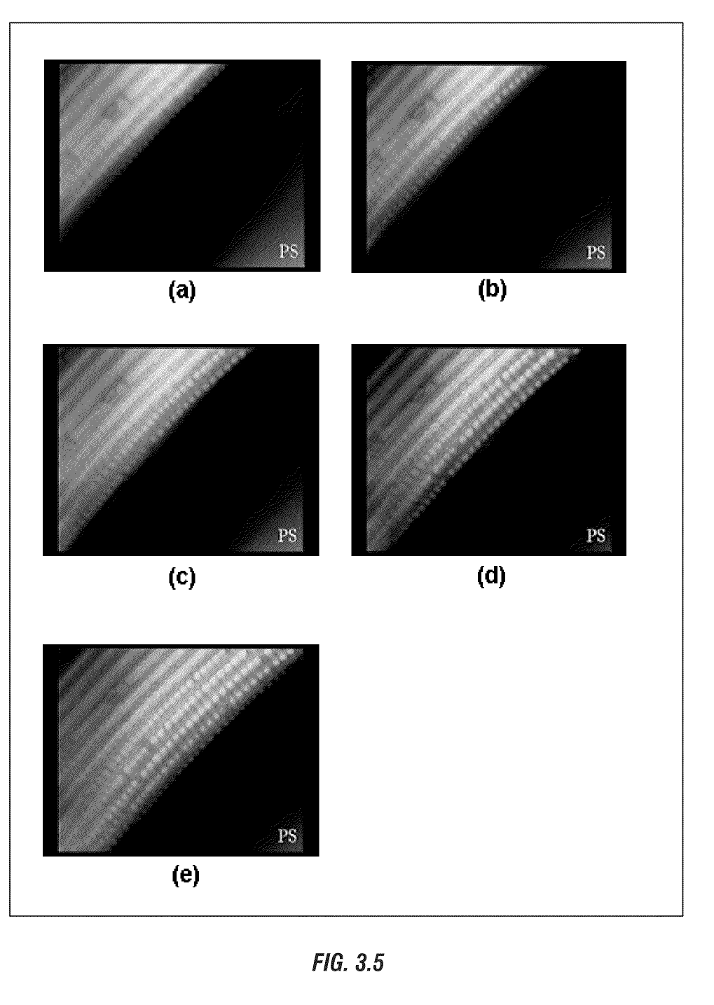

Herein, we report on the spontaneous formation of well-organized mesoscale polymer patterns during the course of solvent evaporation by constraining polymer solutions in a sphere-on-Si geometry as illustrated in FIG. 3.1 (bound solution, i.e., capillary bridge). Gradient concentric rings and self-organized punch-hole-like structures were obtained via mediating interfacial interactions between the polymer and the substrate. This facile approach opens up a new avenue for producing yet more complex patterns in a simple, controllable, and cost-effective manner.

Poly(methyl methacrylate) (PMMA), polystyrene (PS), and polystyrene-block-poly(methyl methacrylate) diblock copolymer (PS-b-PMMA) were used as nonvolatile solutes to prepare PMMA, PS, and PS-b-PMMA toluene solutions, respectively. The concentration of all the solutions is 0.25 mg/ml. The evaporation, in general, took less than 30 min to complete. The pattern formation was monitored in situ by optical microscopy (OM). After the evaporation was complete, two surfaces (spherical lens and Si) were separated and examined by OM and atomic force microscope (AFM). Only the patterns on Si were evaluated.

Highly ordered gradient concentric rings of PMMA, persisting toward the sphere/Si contact center, were obtained over the entire surfaces of the sphere and Si except the region where the sphere was in contact with Si (FIG. 3.2a). A typical optical micrograph of a small region of entire rings of PMMA is shown in FIG. 3.2b. The formation of periodic, gradient rings was a direct consequence of controlled, repetitive ‘stick-slip’ motion of the contact line, resulted from the competition of linear pinning force and nonlinear depinning force (i.e., capillary force) in the sphere-on-Si geometry^{[}20]. This is in sharp contrast with irregular concentric rings formed in an unbound liquid by stochastic ‘stick-slip’ motion of the contact line,^{[5, 6, 10]} suggesting that the use of the sphere-on-Si geometry rendered the control over the evaporation rate, and is effective in improving the stability against the convection.

The representative 3D AFM height images of PMMA rings at different radial distances, X (FIG. 3.1), away from the center of sphere/Si contact are shown in FIG. 3.2c-e. The recession (from FIG. 3.2c to 3.2e) of the center-to-center distance between adjacent rings, X_{C-C}, and the height of the ring, h, were clearly evident. As the solution front moved toward the center of sphere/Si contact due to evaporative loss of toluene (FIG. 3.2a), both λ_{C-C} and h decreased progressively from λ_{C-C}=35.2 μm, h=192 nm at X=4200 μm (FIG. 3.2c) to 27.2 μm, 141 nm at X=3300 μm (FIG. 3.2d) to 25.3 μm, 93 nm at X=2700 μm (FIG. 3.2e). The number of the rings in the 120×120 μm² scan area increased from 4 rings (FIG. 3.2c) to 4.5 rings (FIG. 3.2d) to 5 rings (FIG. 3.2e). The average width of a typical ring, w is roughly 2-3 orders of magnitude smaller than its associated length (i.e., circumference) (e.g., (2πX)/w=2π*4200/16.8=˜10³; corresponding to rings shown in FIG. 3.2c). It is noteworthy that marginal undulations at edges of the rings were seen at the very late stage of dynamic self-assembly of PMMA (FIG. 3.2e), in which the solution front was close to the center of sphere/Si contact. There was no a thin layer of PMMA deposited in the space between the two rings as confirmed by AFM measurements. Such gradient concentric PMMA rings may be explored as unique surfaces for studying cell adhesion, selective adsorption, and molecular recognition.¹⁹

Rather than a periodic family of concentric rings of PMMA formed by the ‘stick-slip’ motion of the contact line, considerable fingering instabilities^{[2, 3, 7, 13, 17, 23]} were observed in the deposition of PS as toluene evaporated, characterized by the appearance of surface perturbation with a well-defined wavelength at edges of a ring (FIG. 3.3). In the experiment, the concentric rings of PS were found to form only at distances far away from the center of sphere/Si contact (i.e., at larger X) at the early stage of dynamic self-assembly process (left panel in FIG. 3.3a), as shown in a representative AFM image (leftmost ring in FIG. 3.3c). As the solution front progressed inward, fingering instabilities emerged at both sides of a ring (middle panel in FIG. 3.3a, rightmost ring in FIG. 3.3c, and FIG. 3.3d) due to the simultaneous occurrence of the ‘stick-slip’ motion of the contact line and the fingering instabilities of the rings.^{[17]} The fingers are readily revealed in the 2D AFM height images (FIG. 3.3c and 3.3d). Eventually, the contact line jumped inward to a new position, during which it dragged fingers formed in its front with it and, thus, yielded the punch-hole-like structures, residing along the space between two adjacent rings (see snapshots (FIG. 3.5) from the real-time lapse video). An optical micrograph is shown in FIG. 3.3b, illustrating surface patterns of PS produced locally at different stages.

The center-to-center distance between adjacent PS fingers on a ring, λ_{F}, and the height of the ring, h are 26.6 μm, 374 nm at X=3195 μm (FIG. 3.3d) and 25.3 μm, 328 nm at X=3020 μm (FIG. 3.3e where λ_{F} is roughly equal to the diameter of the microscopic hole). The average width of fingers at the center connecting two adjacent rings is ˜2.6 μm as measured by AFM (FIG. 3.3e). The spatial-temporal evolution of PS surface patterns from rings to fingers to microscopic holes can be rationalized as follows. The velocity of the displacement of the meniscus (i.e., the liquid-vapor interface), v, in a capillary bridge is inversely proportional to the distance from the capillary entrance to the meniscus, L (FIG. 3.1) (i.e., v˜1/L).^{[24}] v deceases as the meniscus moves inward as a result of an increase in L. The numerical calculations have demonstrated that the formation of fingering instability in an evaporating film is dictated by v: a faster v stabilizes the front, while a slower v leads to the development of fingering instabilities at a propagating front.^{[25]} In the present study, the concentration of the solution was higher at the beginning of the evaporation process so that more solutes can deposit to form a ring, yielding a larger value of h as observed experimentally. As the solution front retracted, the evaporation rate of the solvent decreased, which, in turn, caused a reduction in v. Thus, fewer solutes were available with which to pin the contact line. As a consequence, the concentration and the viscosity of the solution at the capillary edge decreased. These led to instabilities.^{[25]} The fingers on PS rings were observed to emerge gradually (middle panel in FIG. 3.3a, and FIG. 3.3d). A slower v made fingers more stable. Furthermore, the center-to-center distance between two adjacent rings, λ_{C-C} decreased as rings near to the center of sphere/Si contact. This facilitates the continuity of fingers connecting between neighboring rings. The microscopic holes were, thus, formed with increasing proximity to the center of sphere/Si contact (right panel in FIG. 3.3a, and FIG. 3.3e).

Since the solution concentration (c=0.25 mg/ml), the loading volume (V=20 μL) and the solvent (toluene) were kept same for both PS and PMMA solutions, the difference in resulting surface patterns of PS and PMMA (i.e., rings in PMMA vs. rings together with fingers and holes in PS) can be attributed to different interfacial interaction between the polymer and the substrate. The in-situ optical microscopy observation revealed that the formation of fingers at the early stage was a thin-film instability in origin (see snapshots (FIG. 3.5) from the real-time lapse video). On the basis of linear stability analysis on a liquid-like thin film, that is, the capillary edge with the height h (FIG. 3.1) in the present study, the dispersion relation that quantifies the perturbation is given by^{[26, 27]}

$$Ω = - {q}^{4} + \frac{A}{2 π {h}^{4} γ} {q}^{2} \qquad ( 1 )$$

where Ω is the growth rate of the perturbation, q is the growth mode, γ is the surface tension of the solute, and A is Hamaker constant, signifying the interfacial interaction between the solute and the substrate. It has been shown both experimentally and theoretically that a PMMA thin film is stable on a Si surface with 2-nm thick native silicon oxide at the surface since A is negative.^{[28, 29]} In contrast, a PS thin film is unstable due to a positive value of A.^{[29-31]} Therefore, PMMA rings were stable on Si substrate while PS rings destabilized and formed fingering instabilities with a fastest growth mode,

qₘ=[1/(2h²)]*[A/πγ]^{1/2} (2)

It is worth noting that the viscosities of PS and PMMA, which contribute the pinning of the polymers, are on the same order of magnitude provided that Mₙ (PS)=420 kg/mol and Mₙ (PMMA)=534 kg/mol; however, the stabilities of the polymer rings are governed by the sign of A (eq. 1). The fingering instabilities were caused by the concentration-gradient-induced surface tension gradient.^{[17]} The deposition of polymer to form a ring reduces local surface tension of the solution, thereby leading the solution to spread to the region with higher concentration.^{[}17] The condition for equilibrium between a wetting and a meniscus is the equality of the capillary pressure and the disjoining pressure,^{[24]}

$$\frac{2 {γ}_{meniscus}}{H} ≅ \frac{\vert A \vert}{6 π {h}^{3}} \qquad ( 3 )$$

Substituting eq. (3) into eq. (2), the characteristic wavelength of fingering instabilities, λ_{F} is, thus, given by^{[24, 26, 27, 32]}

$${λ}_{F} = \frac{2 π}{{q}_{m}} = 2 {π ( \frac{6 {γ}_{meniscus}}{γ hH} )}^{- \frac{1}{2}} \qquad ( 4 )$$

where γ_{meniscus} is the surface tension of the meniscus in the capillary bridge (i.e., the surface tension of toluene in the present study, 29 mN/m), γ is the surface tension of the solute (i.e., the surface tension of PS in present study, 40.7 mN/m), and H is the height of capillary bridge at the liquid-vapor interface (FIG. 3.1) and can be calculated based on H≈X²/2R, where R is radius of curvature of the spherical lens (R˜2 cm) and X can be readily determined experimentally. Substituting the height of PS ring determined by AFM measurement and H into eq. (2) yields λ_{F}=29.6 μm at X=3195 μm and λ_{F=26.3} μm at X=3020 μm, which are in good agreement with values measured experimentally (i.e., 26.6 μm at X=3195 μm in FIG. 3.3d and 25.3 μm at X=3020 μm in FIG. 3.3e). While optimized experimental conditions are required to impart higher regularity of punch-hole-like structures (FIG. 3.3b and FIG. 3.3e), the present findings suggest that a coupling of ‘stick-slip’ motion and fingering instabilities due to unfavorable interfacial interaction between the nonvolatile solute and the substrate (i.e., possessing a positive A) may provide a unique means of organizing materials into well-ordered structures in which regular microscopic holes reside along concentric circles (FIG. 3.3e).

To further verify that unfavorable interfacial interaction between PS and Si substrate is crucial in forming fingering instabilities, a lamellar-forming diblock copolymer of polystyrene-block-poly(methyl methacrylate) (PS-b-PMMA) was employed as a nonvolatile solute in which PS blocks are covalently linked with PMMA blocks at the one end. FIG. 3.4 shows a surface pattern of PS-b-PMMA formed by drying mediated self-assembly of a 0.25 mg/ml PS-b-PMMA toluene solution in the sphere-on-Si geometry (FIG. 3.1). Well-ordered gradient concentric rings of PS-b-PMMA formed at the early stage of the solvent evaporation were seen to transform into concentric rings with fingering instabilities at their front at the final stage. The latter reflected a delicate balance of competition of unfavorable interfacial interaction between PS block and Si and favorable interfacial interaction between PMMA block and Si. The observations of PS-b-PMMA fingers at the final stage contrast significantly with those in homopolymer PMMA in which only minimal undulations were detected (FIG. 3.2). On the other hand, as compared to the case of homopolymer PS (FIG. 3.3), the punch-hole-like structures are, however, not observed in PS-b-PMMA. This can be attributed to favorable interaction between PMMA block and Si substrate. Depending on the affinity of respective block for the substrate surfaces and the film thickness, the microdomain of a block copolymer can be oriented normal to the surface of a film over large area. [33] A systematic study of microphase separation in the PS-b-PMMA rings is currently underway.

In conclusion, we have developed a simple route to produce well-ordered patterns in an easily controllable and cost-effective manner by allowing a drop to evaporate in a sphere-on-Si geometry. The interfacial interaction between the solute and the substrate effectively mediate the pattern formation. The rings and punch-hole-like structures organized in a concentric mode may offer possibilities for many applications, including annular Bragg resonators for advanced optical communications systems^{[34]} and as tissue engineering scaffold.^{[35, 36]} The present studies provide valuable insights into the rationale of harnessing the flow and the evaporation process in confined geometries and creating unprecedented regular patterns.

### Experimental Section

Sample preparation: 0.25 mg/ml polystyrene (PS) (the number average molecular weight, Mn=420 kg/mol, the polydispersity, PDI=1.15), 0.25 mg/ml poly(methyl methacrylate) (PMMA) (Mn=534 kg/mol, PDI=1.57), and 0.25 mg/ml lamellar-forming diblock copolymer of polystyrene-block-poly(methyl methacrylate) (PS-b-PMMA) (Mn_PS=130 kg/mol, Mn_PMMA=133 kg/mol, PDI=1.10) toluene solutions were prepared. All solutions were filtered with 200-nm filter. The spherical lenses and silicon (Si) substrates were cleaned by the mixture of sulfuric acid and Nochromix™. Subsequently, they were rinsed with DI water extensively and blow-dried with N2.

Confined geometry: To construct a confined geometry, a spherical lens made from fused silica with a radius of curvature ˜2 cm and a Si wafer were used. The sphere and Si were firmly fixed at the top and the bottom of sample holders, respectively. To implement a confined geometry, an inchworm motor with a step motion of a few micrometers was used to place the upper sphere into contact with the lower stationary Si surface. Before they contacted (i.e., separated by approximately a few hundred micrometers apart), a drop of ˜20 μL polymer toluene solutions were loaded and trapped within the gap between the sphere and Si due to the capillary force. The sphere was finally brought into contact with Si substrate by the inchworm motor such that a capillary-held polymer solution (i.e., capillary bridge) forms with evaporation rate highest at the extremity (FIG. 3.1).

Characterizations: An Olympus BX51 optical microscope (OM) in the reflection mode was used to monitor the patterns formation in real time. Atomic force microscopy (AFM) images on patterns formed on Si surface were performed using a Dimension 3100 scanning force microscope in the tapping mode (Digital Instruments). BS-tap300 tips (Budget Sensors) with spring constants ranging from 20 to 75N/m were used as scanning probes.

### Figure Captions

FIG. 3.1. Confined geometry. Cross-sectional view of a capillary-held solution containing nonvolatile solutes placed in a sphere-on-Si geometry (i.e., capillary bridge). X is the radial distance of a formed pattern away from the center of sphere/Si contact, h is the thickness of the thin film, H is the height of the capillary bridge at the liquid-vapor interface, and L is the distance from the capillary entrance to the meniscus (the liquid-vapor interface).

FIG. 3.2. Gradient concentric ring patterns formation. (a) Schematic drawing illustrating sequential formation of gradient concentric rings of PMMA during the solvent evaporation in the geometry shown in FIG. 3.1. Left panel: PMMA rings with largest λ_{C-C} are formed at the early stage. Middle and right panels: As the solution front propagates toward the center of sphere/Si contact, λ_{C-C} decreases. The sphere/Si contact area is marked as “Contact Center” in the right panel. (b) Optical micrograph of gradient concentric rings of PMMA. The rings (light green thin PMMA ring on Si substrate (yellowish background)) are periodic over a large distance. The concentration of PMMA toluene solution is c=0.25 mg/ml. The scale bar is 50 μm. (c-e) 3D AFM height images of PMMA rings as the ‘stick-slip’ motion progressively approaches the center of sphere/Si contact, corresponding to the stages in (a), respectively. The image size is 100×100 μm². The z scale is 1000 nm.

FIG. 3.3. Fingers and punch-hole structures formation. (a) Schematic illustrations of sequential formation of rings, rings with fingers, and punch-hole-like structures of PS as the solution front moves inward. (b) Optical micrograph of surface patterns of PS formed by drying mediated self-assembly in the sphere-on-Si geometry (FIG. 3.1). The fingers and the punch-hole-like structures (blue PS patterns on Si substrate (colorless background)) are observed. The concentration of PS toluene solution is c=0.25 mg/ml. The scale bar is 50 μm. (c-e) 2D AFM height images of PS surface patterns. The coexistence of rings and fingering instabilities is seen in (c) at larger X. As the solution front moved inward (i.e., reducing X) due to the evaporative loss of the solvent, fingering instabilities appear at both sides of a ring in (d and e). With increasing proximity to the center of sphere/Si contact, the punch-hole-like structures are formed in (e). The image size is 120×120 μm². The z scale is 1000 nm.

FIG. 3.4 Optical micrograph of gradient concentric surface pattern of PS-b-PMMA diblock copolymer formed from a 0.25 mg/ml PS-b-PMMA toluene solution. As the solution front progresses inward, the transition from rings to the coexistence of rings with fingering instabilities are clearly evident. However, punch-hole-like structures are not observed.

FIG. 3.5-Snapshots of evaporation induced dynamic self-assembly of PS in the sphere-on-Si geometry. The time interval between sequential image is one minute.

### REFERENCES FOR EXAMPLE 3

[1] Y. Lin, A. Boker, J. He, K. Sill, H. Xiang, C. Abetz, X. Li, J. Wang, T. Emrick, S. Long, Q. Wang, A. Balazs, T. P. Russell, Nature 2005, 434, 55.
[2] M. Gleiche, L. F. Chi, H. Fuchs, Nature 2000, 403, 173.
[3] J. Huang, F. Kim, A. R. Tao, S. Connor, P. D. Yang, Nature Mater 2005, 4, 896.
[4] R. D. Deegan, O. Bakajin, T. F. Dupont, G. Huber, S. R. Nagel, T. A. Witten, Nature 1997, 389, 827.
[5] R. D. Deegan, Phys. Rev. E 2000, 61, 475.
[6] R. D. Deegan, O. Bakajin, T. F. Dupont, G. Huber, S. R. Nagel, T. A. Witten, Phys. Rev. E 2000, 62, 756.
[7] O. Karthaus, L. Grasjo, N. Maruyama, M. Shimomura, Chaos 1999, 9, 308.
[8] E. Rabani, D. R. Reichman, P. L. Geissler, L. E. Brus, Nature 2003, 426, 271.
[9] Z. Mitov, E. Kumacheva, Phys. Rev. Lett. 1998, 81, 3427.
[10] E. Adachi, A. S. Dimitrov, K. Nagayama, Langmuir 1995, 11, 1057.
[11] L. Shmuylovich, A. Q. Shen, H. A. Stone, Langmuir 2002, 18, 3441.
[12] T. P. Bigoni, X. M. Lin, T. T. Nguyen, E. I. Corwin, T. A. Witten, H. M. Jaeger, Nature Materials 2006, 5.
[13] H. Hu, R. G. Larson, Langmuir 2005, 21, 3963.
[14] V. X. Nguyen, K. J. Stebe, Phys. Rev. Lett. 2002, 88, 164501.
[15] M. Maillard, L. Motte, M. P. Pileni, Adv. Mater. 2001, 13, 200.
[16] A. J. F. Carvalho, M. A. Pereira-da-Silva, R. M. Faria, Eur. Phys. J. E 2006, 20,
[17] H. Yabu, M. Shimomura, Adv. Funct. Mater. 2005, 15, 575.
[18] Z. Q. Lin, S. Granick, J. Am. Chem. Soc. 2005, 127, 2816.
[19] S. W. Hong, J. Xu, J. Xia, Z. Q. Lin, F. Qiu, Y. L. Yang, Chem. Mater. 2005, 17,
[20] J. Xu, J. Xia, S. W. Hong, Z. Q. Lin, F. Qiu, Y. L. Yang, Phys. Rev. Lett. 2006, 96, 066104.
[21] S. W. Hong, J. Xu, Z. Q. Lin, Nano Lett. 2006, 6.
[22] S. W. Hong, S. Giri, V. S. Y. Lin, Z. Q. Lin, Chem. Mater. 2006, 18, 5164.
[23] A. M. Cazabat, F. Heslot, S. M. Troian, P. Carles, Nature 1990, 346, 824.
[24] N. V. Churaev, Liquid and vapor flows in porous bodies: surface phenomena, Vol. 13, Gordon and Breach Science, University of Salford, UK, 2000.
[25] A. V. Lyushnin, A. A. Golovin, L. M. Pismen, Phys. Rev. E 2002, 65, 021602.
[26] I. Leizerson, S. G. Lipson, A. V. Lyushnin, Langmuir 2004, 20, 291.
[27] A. Sharma, Langmuir 1993, 9, 861.
[28] Z. Q. Lin, T. Kerle, T. P. Russell, E. Schaffer, U. Steiner, Macromolecules 2002, 35, 6255.
[29] M. D. Morariu, E. Schaffer, U. Steiner, Eur. Phys. J 2003, 12, 375.
[30] G. Reiter, Phys. Rev. Lett. 1992, 68, 75.
[31] R. Xie, A. Karim, J. F. Douglas, C. C. Han, R. A. Weiss, Phys. Rev. Lett. 1998, 81, 1251.
[32] W. Zhao, M. H. Rafailovich, J. Sokolov, L. J. Fetters, R. Palno, M. K. Sanyal, S. K. Sinha, B. B. Sauer, Phys. Rev. Lett. 1993, 70, 1453.
[33] Z. Q. Lin, D. H. Kim, X. D. Wu, L. Boosahda, D. Stone, L. LaRose, T. P. Russell, Adv. Mater. 2002, 14, 1373.
[34] J. Scheuer, W. M. J. Green, A. Yariv, Photonics Spectra May, 2005.
[35] G. M. Gratson, M. Xu, J. A. Lewis, Nature 2004, 428, 386.
[36] J. A. Lewis, G. M. Gratson, Materials Today 2004, July/August, 32.

### 4. Example 4

### Overview

The goal of this project is to create highly regular structures without hierarchical order by controlling the flow of an evaporating droplet containing homopolymers in restricted geometries.⁵⁻⁷ The effect of the molecular weight of semicrystalline polymers and subsequent isothermal crystallization on the structure formation is systematically investigated.⁵ The well-defined concentric rings composed of an amorphous polymer are exploited as templates to direct the formation of highly ordered multiwalled carbon nanotube rings with controlled density.⁶ The results derived from this one-year project will provide invaluable insight into the hierarchically ordered structure formation.

### Research Discussion

1. Overview and Objectives

The use of spontaneous self-assembly as a lithography- and external fields-free means to construct well-ordered, often intriguing structures has received much attention for its ease of producing complex, large-scale structures with small feature sizes. These self-organized structures promise new opportunities for developing miniaturized optical, electronic, optoelectronic, and magnetic devices.⁸⁻¹¹ In this regard, several elegant methods based on self-assembly have emerged, including controlled anisotropic wetting,¹²⁻¹⁵ self-directed self-assembly,¹⁰ controlled dewetting by dip-coating,¹⁶⁻¹⁸ electrostatic self-assembly,¹⁹⁻²¹ a “bricks and mortar” approach,²² recognition-directed orthogonal self-assembly,²³ and DNA-based self-assembly.²⁴⁻³³ Another extremely simple route to intriguing structures is the drying-mediated self-assembly of nonvolatile solutes (polymers, nanoparticles, colloids, and DNA) through the irreversible solvent evaporation of a sessile droplet on a solid substrate (i.e., unbound droplet).³⁴⁻³⁷ However, flow instabilities within the evaporating droplet often result in non-equilibrium and irregular dissipative structures, e.g., randomly organized convection patterns, stochastically distributed multi-rings, and so on. Therefore, fully utilizing evaporation as a simple tool for creating well-ordered structures that have numerous technological applications requires delicate control over several factors, including the evaporative flux, solution concentration, interfacial interaction between the solute and the substrate, etc. To date, very few attempts have been made to control droplet evaporation in confined geometries (for instance, confined between two plates, i.e., forming a bound droplet), in which, by controlling the speed of the upper sliding plate, self-organized mesoscale patterns (e.g., dots, stripes, and ladders) could be formed continuously at the receding meniscus on the stationary lower substrate.³⁸

Hierarchical structures are common throughout nature and technology. For many applications, controlling the spatial arrangement of components (i.e., forming hierarchically ordered structures) is desirable. To date, many studies have focused on generating hierarchical structures using lithographic techniques. However, lithographic methods require an iterative, multi-step procedure, making the structure formation process more complex and less reliable. Several elegant methods for achieving hierarchical structures have recently emerged, including a template-assisted self-assembly, a combination of the reaction-and-diffusion process with lithography, and a combination of self-assembly with breath figure formation. However, most of these still invoke the use of lithography or other methods as a first step to acquiring either an ordered template or patterns that will be subsequently implemented to guide the self-assembly or reaction-diffusion process. The combination of dynamic self-assembly via irreversible solvent evaporation with smaller-scale molecular self-assembly, e.g., ligand functionalized quantum dots or block copolymers, may lead to hierarchical structures that offer new opportunities in optical and optoelectronic materials and devices. However, this technique has yet to be explored.

The long-term goal of the proposed work is to develop a simple, yet robust, one-step method via evaporation for creating nanostructured polymeric materials possessing high regularity with hierarchical order over two or multi-length scales in a precisely controllable manner that dispenses with the need for lithography techniques and external fields. We will design hierarchical structures consisting of either diblock copolymers or quantum dots self-assembled at the nanoscale that can serve as multifunctional materials for potential applications with unique optical, electronic, optoelectronic, and sensory properties. With length scales ranging from nanometers to micrometers, the hierarchically ordered structures could be considered novel materials. Accordingly, they serve as ideal models for education in nanomaterials science and engineering.

The two specific research objectives of this proposal are to:
Create hierarchically ordered structures via the synergy of drying-mediated self-assembly at the microscopic scale and spontaneous self-assembly at the nanoscopic scale. Hierarchical structures with well-defined dimensions are formed due to the controlled solvent evaporation and the associated capillary flow of the solute in restricted geometries that consist of a sphere on a flat substrate. These structures may exhibit two or more independent characteristic dimensions: microscale concentric rings or web-like structures and self-organized nanoscopic constituents, residing along the rings or web-like structures.
Develop theoretical models to understand the mechanisms of structure formation. The ability to predict the length scale of periodicity, height, and width and compare them with experimental observations is key to our understanding of structure formation. We will also illustrate how two or more dynamic, synergistic self-assemblies in restricted geometries can be combined to finely regulate the hierarchically ordered structure formation.
   The central hypothesis of this research is that restricted geometries provide a unique environment for controlling the flow within an evaporating droplet, which, in turn, regulates structure formation.

2. Expected Significance

The significance of the proposed project lies in its promise to further enhance current approaches to creating highly regular structures with hierarchical order in a simple, controllable, and cost-effective manner for use in photonics,³⁹ electronics,⁴⁰ optical materials,³⁸ magnetic materials,⁹ optoelectronics, nanotechnology, and biotechnology.⁴¹⁻⁴⁷ The work may also shed some light on microfluidic devices,⁴⁸⁻⁵⁵ which generally need an external electrical control and power device, by providing a perspective on the use of capillary force to drive the flow without relying on the mechanical and electrical driving force.⁵¹ Finally, by eliminating the expensive and time-concuming electron-beam lithography process, the proposed work may inspire a new processing approach for fabricating annular Bragg resonators for advanced optical communications systems⁵⁶⁻⁵⁹ and ring resonator lasers for use as tunable laser systems in integrated-photonic platforms.⁶⁰⁻⁶¹

3. Review of Literature Relevant to the Project

3.1. Evaporation-Induced Dynamic Self-Assembly

Drying-mediated self-assembly of dispersions through irreversible solvent evaporation of an evaporating drop (i.e., unbound liquid) from a solid substrate is widely recognized as a non-lithography route to producing intriguing patterns.^{34-38, 62-88} It is, in principle, a non-equilibrium process.³⁷ Two main characteristic patterns are often observed, as outlined below.

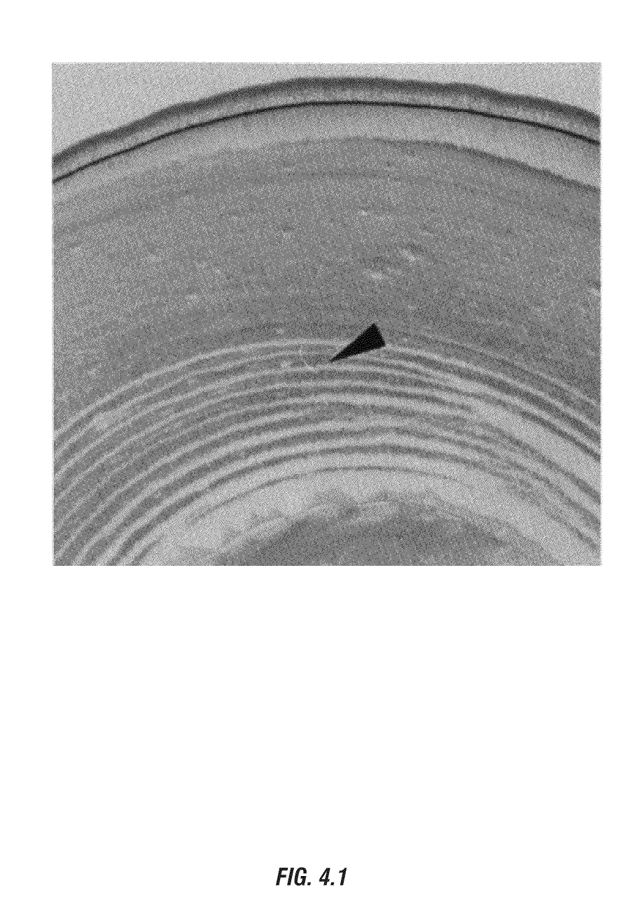

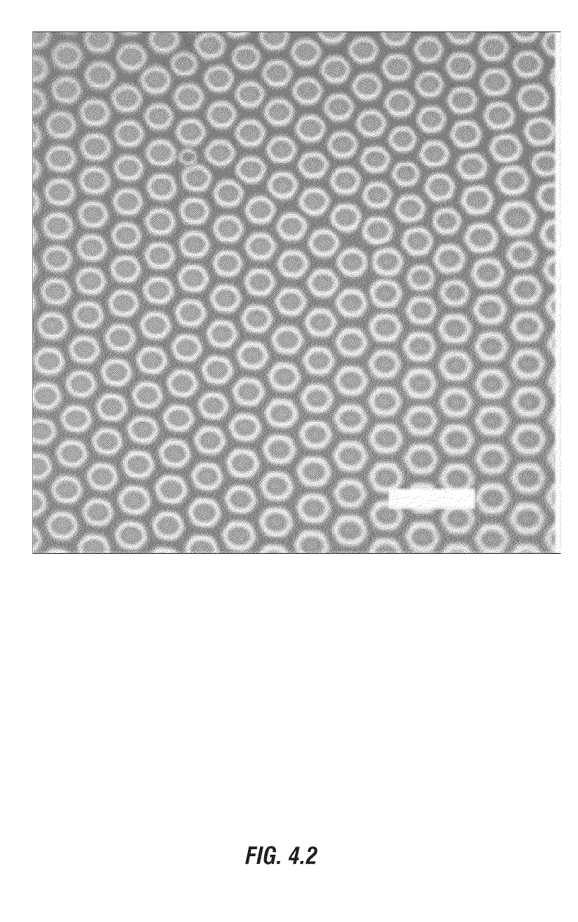

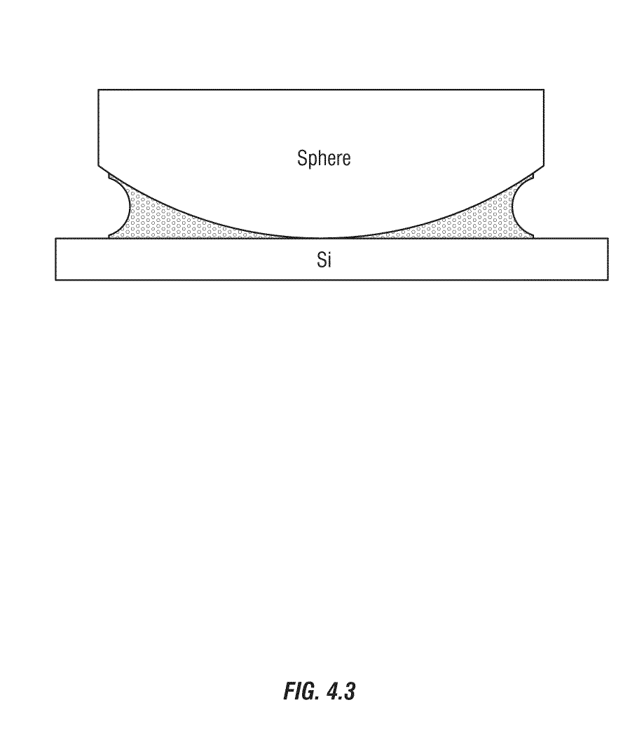

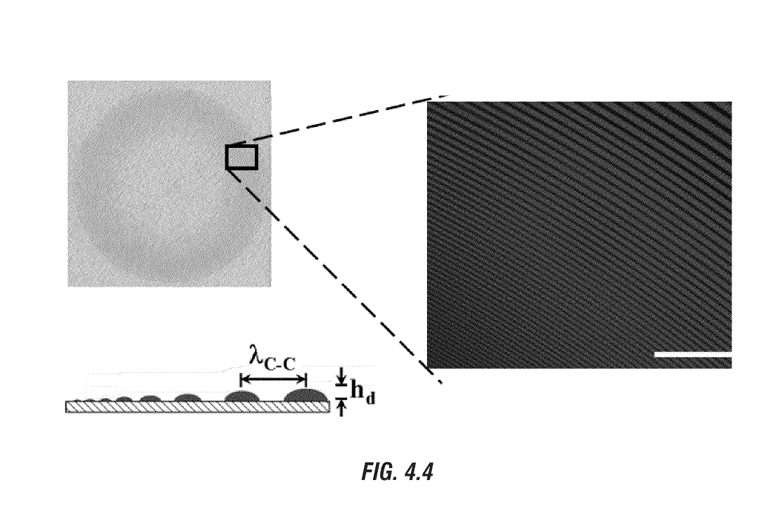

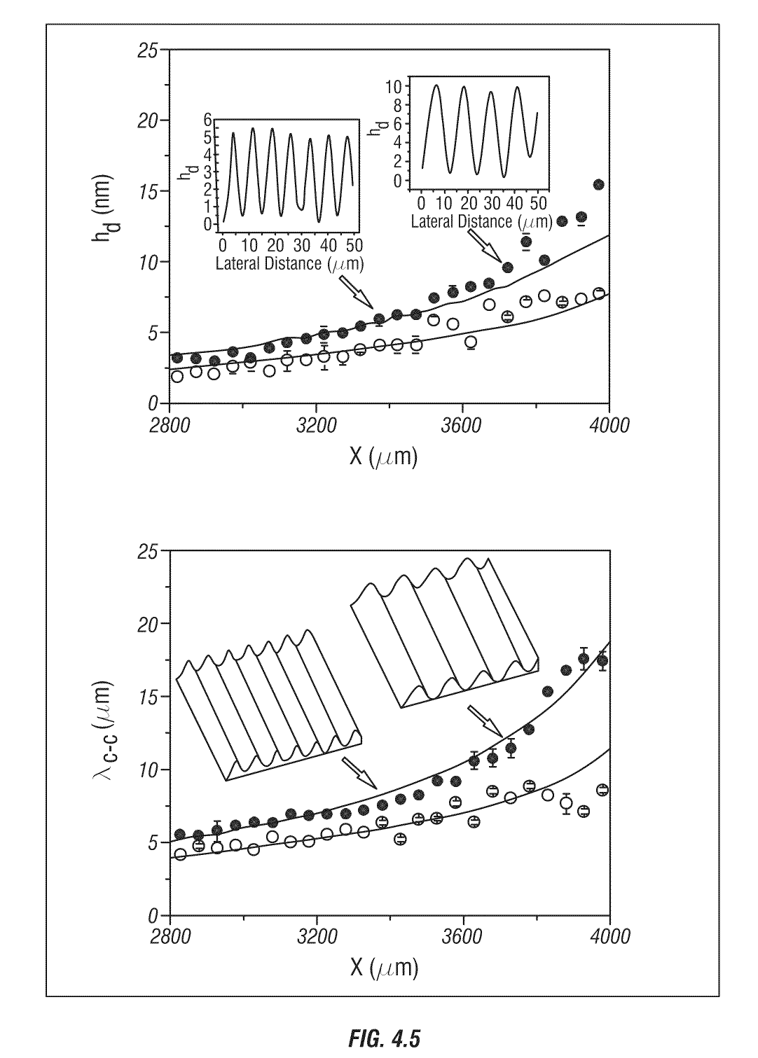

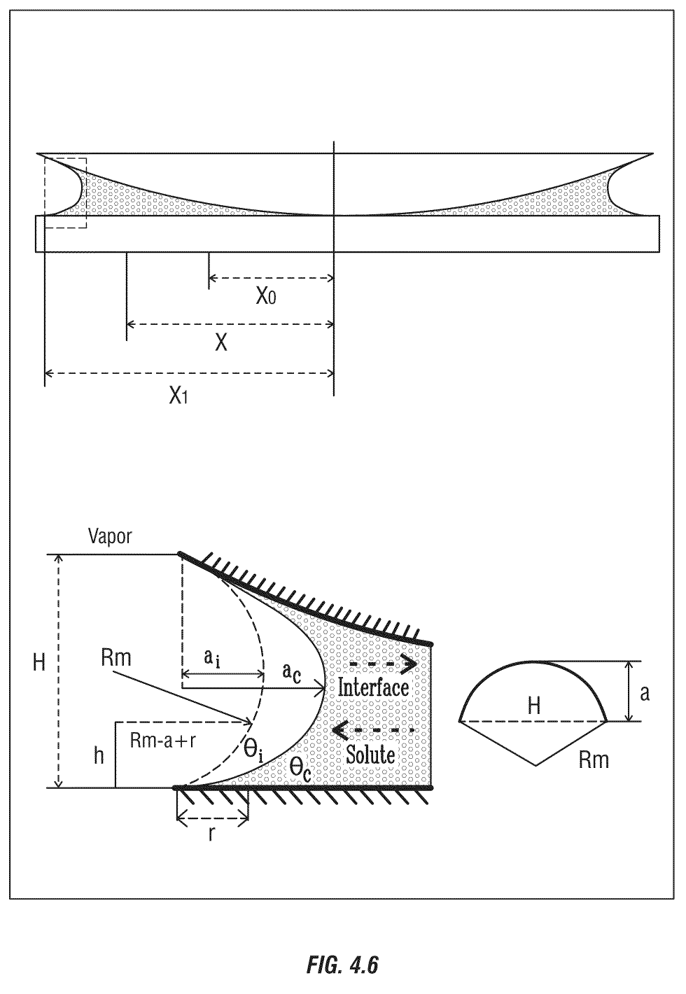

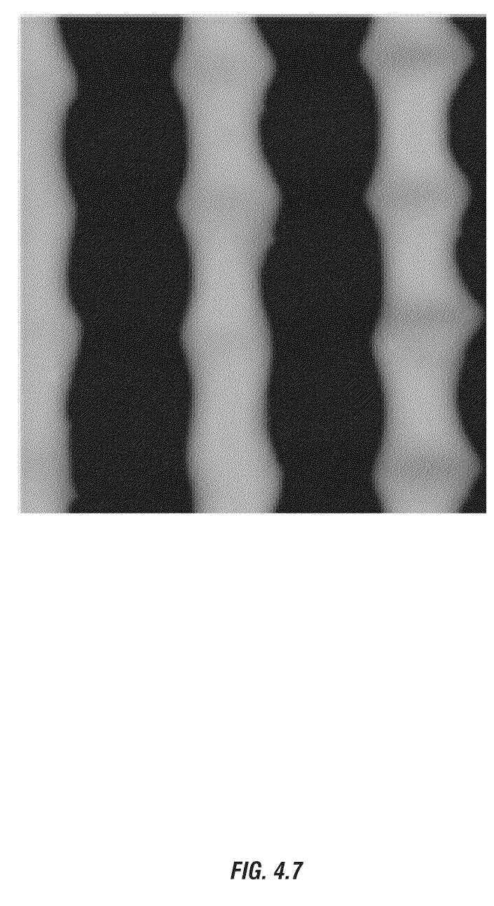

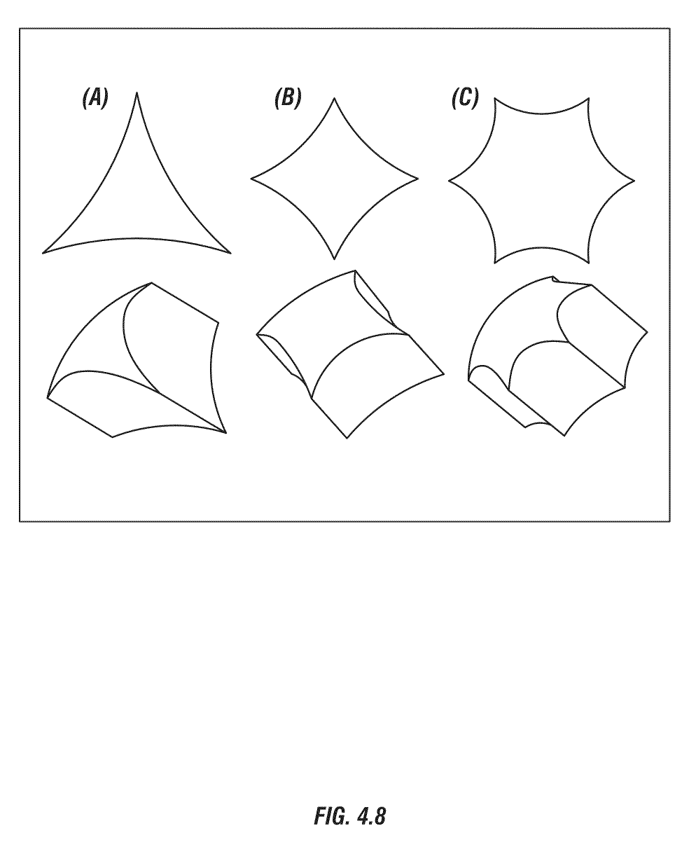

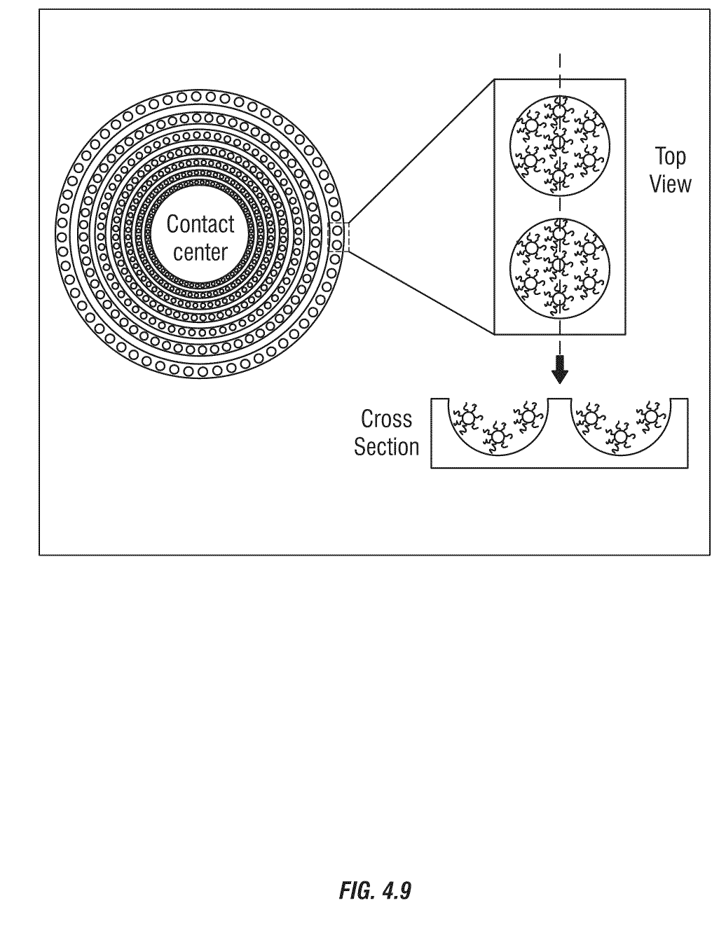

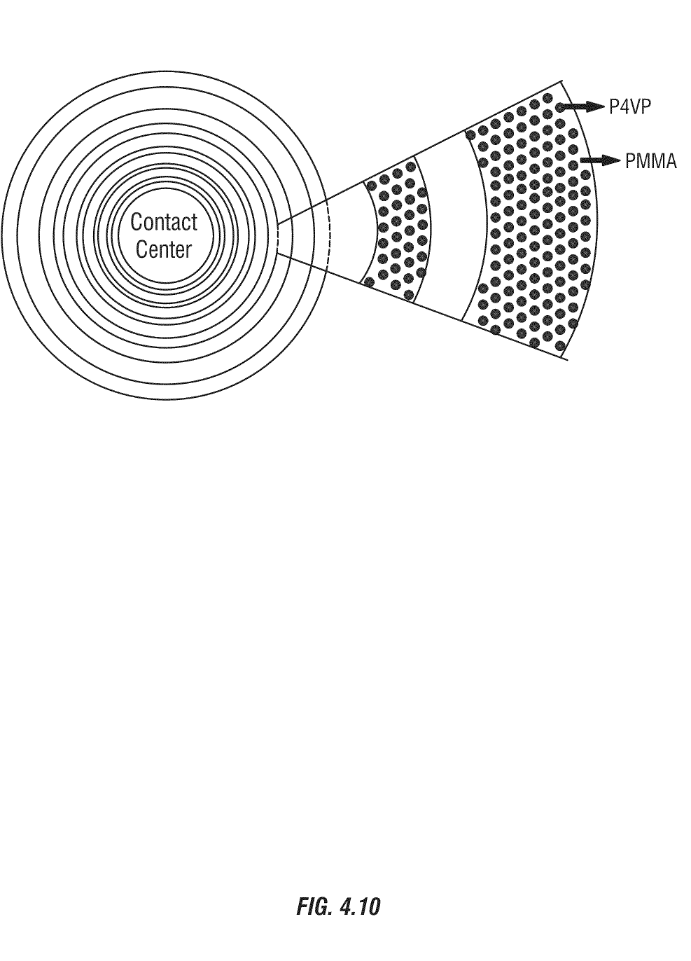

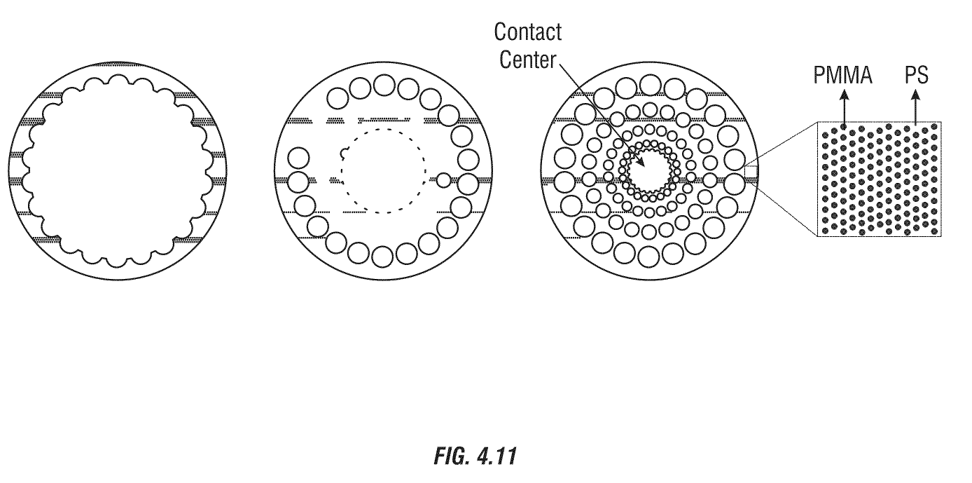

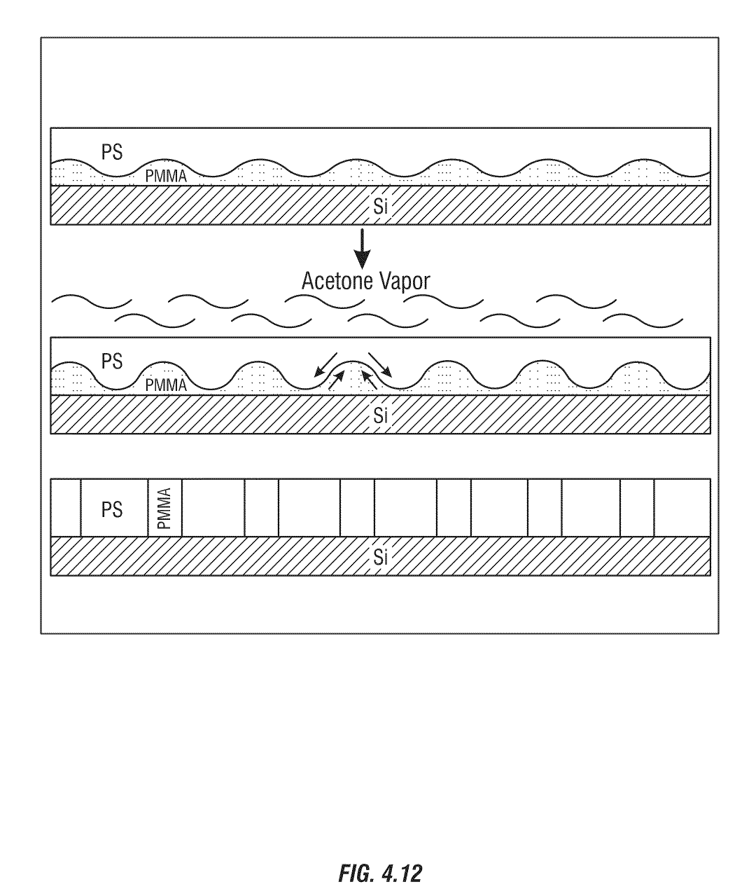

Coffee ring: A coffee ring forms when, in the absence of natural convection, the contact line of an evaporating drop becomes pinned. This ensures that liquid evaporating from the edge is replenished by liquid from the interior, so that outward flow carries the nonvolatile dispersions to the edge.^{34-36, 89-91} The evaporation flux varies spatially with the highest flux observed at the edge of the drop.^{34-37, 92, 93} A subset of the coffee ring phenomena is the concentric rings formed by repeated microscopic pinning and depinning events (i.e., “stick-slip motion”) of the contact line,⁹⁴⁻⁹⁷ that is, the competition between the friction force and surface tension of the solution. However, stochastic concentric rings are generally formed as shown in FIG. 4.1.^{94, 95}

Moreover, the bulk of current theoretical work, based on Navier-Stokes equations with lubrication approximation, has centered on understanding a single ring formation using either analytical^{36, 98} or numerical methods.^{99, 100} Only very few elegant theoretical studies have focused, either analytically⁹⁵ or numerically,⁹⁷ on the formation ofperiodic multi-rings (i.e., concentric rings) during droplet evaporation on a substrate.

Convection-assisted dynamic self-assembly: A gradient of temperature normal to the droplet surface due to solvent evaporation can induce a Marangoni-Benard convection (i.e., closed-loop circular convection),^{64, 91, 101-110} which results in irregular polygonal network structures (i.e., Benard cells) due to an upward flow of the warmer lower liquid. Therefore, in order to form well-organized, spatially periodic patterns, these instabilities must be delicately harnessed.

3.2. Evaporation of a Droplet in a Restricted Geometry

To date, few attempts have been made to control droplet (solution^{38, 111, 112} or pure liquid¹¹³) evaporation in a restricted geometry (i.e., bound droplet). It has been demonstrated that controlling the speed of the upper sliding plate allows self-organized, mesoscale polymer patterns (e.g. dots, stripes, and ladders)³⁸ to form continuously at the receding meniscus on the stationary lower substrate. On the other hand, models of evaporating pure liquid in a capillary tube or parallel glass plates have been developed.¹¹³⁻¹¹⁷ However, no theoretical studies have been performed on a solution containing nonvolatile solute evaporating in confined geometries.

3.3. Hierarchical Structure Formation

Hierarchically ordered structures are formed when microscopic structures are generated from materials that have a self-assembling nature at the nanometer scale. Such materials include ligand functionalized quantum dots and diblock copolymers. In addition to assembling via biomimetic pathways,^{118, 119} several other processes have been used to create hierarchical structures, including a template-assisted self-assembly,^{8, 14, 120-123} a combination of self-assembly and breath figure formation,¹²⁴⁻¹³⁵ and a combination of the reaction-and-diffusion process with lithography.¹³⁶⁻¹⁴⁹ Following are brief descriptions of each of these processes.
Template-assisted self-assembly: In template-assisted self-assembly,^{8, 14, 120-123, 150} the size of structures is determined by the choice of a template. This process involves extensive preparation of templates from lithographies,¹⁵¹ holography,¹²³ electrochemical anodization,¹⁵²⁻¹⁶⁵ and self-organized mesoporous silica.¹⁶⁶⁻¹⁷⁰ The complexity of this process underscores the need for a simple, nonphotolithographic, and less expensive route to hierarchical structures.
Combination of self-assembly and breath figures formation: Hexagonally ordered bubble arrays, termed breath figures, are formed when a stream of moist air flows across a polymer solution evaporating the volatile solvent.^{77, 87, 124-135, 171-177} The self-assembled, micron-sized arrays of holes are permanently vitrified after drying, as shown in FIG. 4.2. Recently, an elegant study demonstrated that hierarchical nanoparticle assemblies can be formed by decorating breath figures: well-ordered hexagonal arrays of breath figures made by the condensation of micron-sized water droplets on the surface of a polymer solution were combined with the self-assembly of nanoparticles at the polymer solution/water interface.¹²⁷ Upon complete evaporation of solvent and water, the nanoparticles decorated the internal surface of arrays of spherical holes formed from the breath figures process.¹²⁷ These facile microstructures show great promise as matrices for microlens, or as micro light-emitting-diode (LED) arrays to direct energy and/or charge transfer.^{124, 125}
Combination of self-assembly and reaction-and-diffusion process: The reaction-and-diffusion process^{178, 179} combined with lithography has been elegantly utilized to transfer the complex microscopic patterns of chemicals from a hydrogel stamp containing a salt, e.g., silver nitrate (AgNO₃), into thin films of dry gels doped with a second salt, e.g., potassium hexacyanoferrate (K₄Fe(CN)₆).^{136-149, 180, 181} The precipitation reaction between Ag cation diffusing into gel and Fe(CN)₆ anion results in a faithful transfer of intriguing patterns, such as microlenses,¹³⁸ into gels. This process uses lithography as the first step to generate ordered stamps that will be subsequently utilized to guide the reaction-diffusion process.

Based on the above literature review, the proposed study intends to establish a simple, one-step method via evaporation for creating nanostructured materials possessing high regularity with hierarchical order in a precisely controllable and cost-effective manner, dispensing with the need for lithography techniques and external fields. Such ordered structures will be produced by solvent evaporation from restricted geometries (i.e., from a confined solution). Numerous applications for use in optical and optoelectronic devices, nanotechnology, and biotechnology are envisioned.

4. Experiment Equipment

A device capable of imposing a restricted geometry is used. It consists of a spherical lens on a flat substrate (e.g., Si or indium tin oxide ITO-coated glass) (FIG. 4.3). This device also allows pumping or shearing of the upper surface while keeping the lower surface stationary. It has been integrated with an optical microscope (OM), thereby facilitating real-time monitoring of structure formation during the course of solvent evaporation. Other lab equipment was used, including atomic force microscope (AFM), fluorescence microscope (FM), laser scanning confocal microscope (LSCM), scanning electron microscope (SEM), transmission electron microscope (TEM), X-ray photoelectron spectroscopy, and a contact angle instrument.

5. Preliminary Studies

As a proof-of-concept, we have applied the concept of drying-mediated self-assembly via irreversible solvent evaporation from a restricted geometry to successfully produce well-ordered structures consisting of homopolymers^{5-7, 199-204} and nanoparticles.²⁰⁵ A restricted geometry was constructed as follows: a spherical lens made from fused silica with a diameter of ˜1 cm and a radius of curvature of ˜2 cm sitting on a Si substrate (i.e., a sphere-on-flat geometry) (FIG. 4.3).^{199, 200} Both sphere and Si were firmly fixed at the top and the bottom of the sample holders, respectively.

5.1. Gradient Concentric Rings Formed by Droplet Evaporation from a Restricted Geometry

A conjugated polymer, poly[2-methoxy-5-(2-ethylhexyloxy)-1,4-phenylenevinylene] (MEH-PPV) (molecular weight, MW=50-300 kg/mole) dissolved in toluene at concentration c=0.075 mg/ml was used as the nonvolatile solute. The choice of system was motivated by the relevance of conjugated polymers, including MEH-PPV, for use in the areas of LEDs,²⁰⁶⁻²¹⁸ photovoltaic cells,²¹⁹⁻²³⁰ thin-film transistors,²³¹⁻²³⁷ molecular diode,²³⁸⁻²³⁹ solid state lasers,²⁴⁰ and bio-sensors.²⁴¹⁻²⁴⁸ A drop of MEH-PPV solution was inserted and trapped within the gap between the sphere and Si due to the capillary force. Subsequently, the sphere was brought into contact with the Si substrate by an inchworm motor with a step motion of a few micrometers. As shown in

FIG. 4.3, this produced a capillary-held polymer solution (i.e., confined solution). The experiments were performed inside a homemade chamber so that the evaporation rate of the solvent was controlled and the temperature gradient was eliminated. The structure formation was monitored in situ by optical microscope (OM).

The key improvement over past procedures is that droplet evaporation was guided through the use of a restricted geometry (FIG. 4.3), rather than allowing solvent evaporation over the entire droplet area from a drop sitting on a single solid surface, as in copious past work.^{34-37, 62, 67, 68, 70, 95, 102-104, 107}

The in situ OM observation revealed that over time the contact line of the droplet moved in a controlled, repetitive “stick-slip” fashion (i.e., a competition between pinning force and depinning force (capillary force))^{94, 95, 97} toward the center of the sphere/Si contact. The solution front (i.e., liquid-vapor interface) was arrested at the spherical lens and Si surfaces for a certain period of time during which an MEH-PPV ring was formed. It then jumped a short distance to the next position where it was arrested again and a new ring was deposited. The jumping distance decreased slowly with increasing proximity to the sphere/Si contact center. After evaporation was complete, the two surfaces were separated and examined by OM and AFM. Highly ordered gradient concentric rings (both the center-to-center distance between the rings, λ_{C-C}, and the width of the ring) (FIG. 4.4, right panel) were observed, spanning the entire surfaces of both the sphere and Si, with the exception of the region where the sphere was in contact with Si, as seen in the digital image (FIG. 4.4, left panel). Only the structures on Si were evaluated. It is noteworthy that the ring patterns were highly reproducible.

FIG. 4.5 shows λ_{C-C} and the height of the ring, hd, obtained from dynamic self-assembly of two MEH-PPV toluene solutions at the different concentrations, as a function of X. As c decreased from 0.075 to 0.05 mg/ml, both λ_{C-C} and h_{d} were reduced. Two representative 3D AFM height images and corresponding profiles, obtained from the 0.075 mg/ml solution, are shown in FIG. 4.5(a) and 4.5(b) as insets, respectively. The strategy described here constitutes a simple yet novel approach to preparing gradient features of high regularity and fidelity.

5.2. Theoretical Model

To quantitatively uncover the nature of the formation of concentric rings exhibiting gradient in both λ_{C-C} and hd, we performed a theoretical calculation based on mass conservation.²⁰⁰ As toluene evaporates, MEH-PPV jams into the edge of the solution next to the contact line, preventing it from retracting (i.e., “stick”). The deposition (jamming) creates local surface roughness at the sphere and Si surfaces.²⁴⁹ During the deposition, the initial contact angle, θᵢ, decreases gradually, owing to the evaporative volume loss of toluene, ΔV, to a critical angle, θ_{C} (FIG. 4.6), at which the capillary force becomes larger than the pinning force.^{35, 36, 98, 99, 250} This causes the contact line to jump to a new position (i.e., “slip”). The ΔV during the formation of the MEH-PPV ring (i.e., a changing from aᵢ to a_{c}) is given by

$$Δ V = π XH \{ H [ arctan ( \frac{2 {a}_{c}}{H} ) - arc tan ( \frac{2 {a}_{i}}{H} ) ] + ( {a}_{c} - {a}_{i} ) \} \qquad ( 1 )$$

where H is the surface separation at the liquid-vapor interface of the solution and can be calculated based on H≈X²/2R, where R is the radius of the curvature of the spherical lens (R˜2 cm) and aᵢ and a_{c} are the height of the meniscus at contact angles θᵢ and θ_{C}, respectively. The relation of θ and a can be established from the geometry of the capillary edge defined in FIG. 4.6.

$$θ \approx tan θ = \frac{\partial h}{\partial r} {\vert}_{x = 0} \approx \frac{H - 2 a}{H} \qquad ( 2 )$$

The volume of confined solution V_{Liq} (light gray area in FIG. 4.6) is

$${V}_{Liq} = π {X}^{2} H - π {RH}^{2} - π {XH}^{2} arctan \frac{2 a}{H} + \frac{π {XH}^{2}}{2} - π XaH \\ and \\ {V}_{Liq}^{new} = {V}_{Liq} - Δ V \qquad ( 3 )$$

The initial contact angle, θᵢ, is ˜18°, calculated from eqs. (2) and (3) since the initial loading volume, V_{Liq}, and initial X (i.e., X₁ in FIG. 4.6) are known from the experiment. It agrees well with the value determined experimentally by using a contact angle instrument. Combining eqs. (1)-(3), the new position X_{new}, at which a contact line is arrested, can be identified by iterative calculation until a best fit (lines in the left panel in FIG. 4.5) with experimental data (symbols in the left panel in FIG. 4.5) is reached. The calculated λ_{C-C}=X−X_{new} can thus be obtained. In the lubrication approximation after considering the evaporation process, the evolution equation of the local thickness of the capillary edge is given by^{36, 97, 99}

$$ρ \frac{d h}{d t} = - ρ \frac{1}{r} \frac{d}{d r} ( rhv ) - J \qquad ( 4 )$$

where ρ is the density of the solvent (ρ≈1) and J is the mass of solvent evaporating per unit area unit time and assumed to be a constant. When the time, t=r/v, is smaller than the pinning time, the solute is allowed to transport, deposit, and form a ring with a height h_{d} at the contact line

h_{d}=[V_{deposit}=/(2πX(α−cos α sin α))]^{1/2}(1−cos α). (5)

The solid lines in FIG. 4.5 represent the calculated values of λ_{C-C} and hd based on the model discussed above, yielding θ_{C} of 15.6° and 16.1° for MEH-PPV solutions at c=0.075 mg/ml and c=0.05 mg/ml, respectively. Good agreement between experimental data and theoretical fits is clearly evident.²⁰⁰ The pinning force is directly related to the surface roughness.²⁴⁹ An increase in hd during MEH-PPV deposition results in a decrease in θ_{C}.^{36, 99, 249, 250} A smaller θ_{C} implies a longer pinning time, tₚ, which, in turn, causes a greater volume loss, ΔV, during pinning. As a result, it leads to a larger pull away of the contact line to reach initial contact angle, θᵢ, at a new position. Thus, a larger λ_{C-C} was observed at c=0.075 mg/ml as shown in FIG. 4.5.

5.3. Other Intriguing, Well-Ordered Structures Formed in Restricted Geometries

Polystyrene rings with fingers:²⁰⁴ The synergy of controlled self-assemblies of solutes and their destabilization mediated by the interfacial interaction between the solutes and substrates during the solvent evaporation can lead to the formation of intriguing, ordered structures. A drop of poly(methyl methacrylate) (PMMA; MW=534 kg/mole) and polystyrene (PS; MW=420 kg/mole) toluene solution was loaded in the sphere-on-Si geometry, respectively. A periodic family of concentric rings of PMMA was formed, resembling the findings on the self-assembly of MEH-PPV as discussed in Section 5.1.^{200, 204} In contrast, considerable fingering instabilities were observed in the deposition of PS as toluene evaporated, characterized by the appearance of surface perturbation with a well-defined wavelength at the edges of a ring,^{12, 16, 38, 62, 108, 251} as revealed in the 2D AFM height image (FIG. 4.7). This can be attributed to the simultaneous occurrence of the “stick-slip” motion of the contact line and the fingering instabilities of the rings.³⁸

It has been shown both experimentally and theoretically that a PMMA thin film is stable on a Si surface with 2-nm thick native silicon oxide at the surface due to the favorable interfacial interaction between PMMA and Si substrate.^{185, 252-258} In contrast, a PS thin film is unstable due to an unfavorable interaction between PS and Si.²⁵²⁻²⁵⁸ Therefore, PMMA rings were stable on the Si substrate while PS rings destabilized and formed fingers (FIG. 4.7).²⁰⁴

Spokes composed of CdSe/ZnS quantum dots:²⁰⁵ Recently, we have demonstrated that, in addition to concentric rings, spokes of cadmium selenide/zinc sulfide (CdSe/ZnS) quantum dots (QDs) can be produced throughout the dying process when a smaller tri-n-octylphosphine oxide (TOPO)-functionalized CdSe/ZnS QD (diameter, D=4.4 nm; synthesized^{3, 4, 193, 205}) was used as the nonvolatile solute. The dynamic formation of spokes can be attributed to the “fingering instabilities” of the evaporating front.^{12, 16, 62, 251, 259, 260} Each spoke was 22 nm high, 1.8 μm wide, and millimeters long. The distance between adjacent spokes was 5 μm.²⁰⁵

In summary, our preliminary studies and findings^{5-7, 199-205} reveal that dynamic self-assembly via irreversible solvent evaporation in restricted geometries can be exploited as an effective approach to mediate the flow in a capillary-held droplet, thereby resulting in the periodic structure form anion.^{5-7, 199-205}

6. Research Specifications

The nonvolatile solutes selected for the proposed work include two homopolymers (i.e., PMMA and MEH-PPV), two diblock copolymers (i.e., poly(4-vinyl pyridine)-block-poly(methyl methacrylate) (P4VP-b-PMMA) and polystyrene-block-poly(methyl methacrylate) (PS-b-PMMA)), and two quantum dots (i.e., CdSe and CdSe/ZnS).

Restricted geometry (i.e., sphere-on-Si geometry; a spherical lens sitting on a Si substrate) will be used to produce a capillary-held droplet. The spatial-temporal evolution of structure formation during the drying process will be visualized by in situ optical microscope (OM) and/or fluorescence microscope (FM). The contact angle profile at the capillary edge (i.e., meniscus in FIGS. 4.3 and 4.6) were monitored in real time to provide direct evidence for building a more complete model of relationship between the change of the contact angle and the forces (e.g., capillary force and pinning force) associated with it. The hierarchically ordered structures were characterized using OM, FM, AFM, SEM, and TEM. The migration of one block in diblock copolymers after selective solvent vapor treatments were confirmed by XPS, in addition to AFM and water contact angle measurements (Section 6.2.2). The nanodomains in diblock copolymers that are oriented normal to the film surface (i.e., ring surface in Section 6.2.2a and web surface in Section 6.2.2b) were examined by TEM (cross section) and AFM (topography).

6.1. Parameters Tailored

In addition to the concentration effect as discussed in Sections 5.1 and 5.2, a number of other parameters can be delicately tailored to provide detailed insight into the ordered structure formation (see Sections 6.2 and 6.3). All of these will modulate the tradeoff between the stable and unstable contact line pinning on which these structures appear to depend.

Molecular weight (MW) effect: When the MW of polymers is low, the viscosity of the solution front is so low that no contact line will be pinned, leading to the rupture of a liquid-like thin film (i.e., dewetting) and eventually forming stochastic structures.²⁰³

Solvent effect: A slow solvent evaporation suppresses instabilities, thereby giving rise to regular patterns.²⁰⁰ Rapid evaporation increases the convective force due to evaporative cooling, resulting in the formation of convection cells, fractal branches, fingering instabilities, etc.^{64, 101-107}

Curvature effect: The curvature of the sphere will be changed (FIG. 4.3). A smaller curvature may result in finer features, e.g., gradient concentric rings with smaller μ_{C-C.}²⁰³

Humidity effect: Wet airflow will be introduced into the sealed chamber. We anticipate condensation of micron-size water droplets on individual ring surfaces in a way that resembles the formation of “breath figures”. 124-130

Surface chemistry effect: The surface hydrophobicity of the restricted geometry, which is related to the interfacial interaction between the solutes and substrates, will predictably govern the structure formation and will be manipulated. The surfaces of the spherical lens and Si are hydrophilic.¹⁸ Studies will also be performed on a droplet of solution confined between adjoining hydrophobic and hydrophilic surfaces (i.e., a Janus interface²⁶¹). To accomplish this, a self-assembled monolayer of condensed octadecyltriethoxysiloxane (OTE) will be deposited to render one surface hydrophobic while keeping another surface hydrophilic.

External perturbation: An external perturbation will be applied to modulate the dynamic self-assembly process. a. Pump vertically (i.e., hydrodynamic drainage²⁶²⁻²⁶⁵): Pumping is achieved by periodically moving the upper sphere at proper amplitude and frequency while keeping the lower Si surface stationary, thereby squeezing fluid out of (or into) the intervening gap. Pumping generates the symmetric flow that may radially direct structure formation, which is analogous to dynamic combing of DNA. 266-270 b.

Shear laterally:²⁷¹⁻²⁷⁴ Unidirectional oscillatory, saw-tooth, or simple shear with proper amplitude and frequency will be applied, which may either perturb or impart the structure formation by modifying the flow unidirectionally.

Temperature effect: Heating the lower Si substrate while keeping the upper sphere cool will impose a temperature gradient, ΔT. The magnitude of ΔT will be varied. The ΔT-induced Marangoni-Benard convection^{64, 101-107, 275} is expected to affect the controlled solvent evaporation in the restricted geometry, thereby leading to the formation of intriguing structures.

Shape effect: A family of well-ordered structures may emerge by allowing the solution to evaporate from a sliced-sphere-on-Si geometry that is constructed by solely replacing the upper sphere with a tailor-made one, for example, triangular-slice sphere, quadrangular-slice sphere, or hexagonal-slice sphere, as shown in FIG. 4.8. The repetitive “stick-slip” motion of the contact line is expected to be guided by the shape of the modified spheres, thereby yielding gradient surface patterns with triangular, quadrangular, or hexagonal shape.

6.2. Create Hierarchical Structures in Restricted Geometries

The first objective of the proposal is to create hierarchically ordered structures in restricted geometries that may have numerous potential applications for use in optics, optoelectronics, nanotechnology, biotechnology, etc.

6.2.1. “Stick-Slip” Motion and Water Condensation Induced Hierarchical Structure

A striking pattern arose from the “stick-slip” motion in conjunction with water condensation. A drop of PMMA (or MEH-PPV) toluene solution was confined in the sphere-on-Si geometry (i.e., spherical lens sitting on a Si substrate) in a sealed chamber. A moist airflow was introduced into the chamber to promote toluene evaporation. Bubbles of micron-sized water droplets condense at the surface of micrometer-wide concentric rings in a process analogous to “breathfigures” formation as discussed in Section 3.3.¹²⁴⁻¹³⁵ After drying, the self-assembled, micron-sized holes are permanently formed along the ring as depicted in the left panel of FIG. 4.9. The size of the holes can be tuned by varying the speed of airflow, polymer concentration, and humidity.^{125, 276-281}

The approach can be extended to incorporate CdSe and CdSe/ZnS quantum dots (QDs). QDs are highly emissive, spherical nanoparticles with a few nanometers in diameter.²⁸²⁻²⁸⁵ They provide a functional platform for a new class of materials for use in LED,²⁸⁶⁻²⁹³ photovoltaic cells,^{294, 301} biosensors,^{302, 307} and bio-imaging.³⁰⁷⁻³¹⁰ Due to their quantum-confined nature,^{282, 311} the variation of nanoparticle size provides continuous changes in fluorescence emission. By passivating most of the vacancies and trap sites on the CdSe surface with ZnS, the resulting CdSe/ZnS core/shell QDs possess a strong photoluminescence,^{306, 312-316} which is particularly important for use in biological applications.^{302, 308, 309, 313} A toluene solution of TOPO-functionalized QDs and PMMA will be prepared and placed in restricted geometries. Hierarchical QDs assemblies may form by decorating the internal wall of concave holes due to the segregation of QDs to the PMMA solution/water interface,¹²⁷ thereby exhibiting three independent length scales, as schematically illustrated in the right panel (i.e., a zoom in) of FIG. 4.9.

The aforementioned approach may provide a simple strategy for large-area, superficial, concave holes organized in a gradient fashion that can be used as a template for preparing microlens arrays to form image arrays from a common object.^{134, 317-324} In addition, such gradient surfaces may be useful in biotechnology for studying the directional migration of cells,⁴² confinement of transmembrane cell receptors,⁴³ and biological recognition processes.⁴¹ It could act as a diode to provide a driving force for cells to move radially from the edge of the gradient rings toward the center, or vice versa, with no need for external field. The hierarchical structures that consist of QDs may offer great promise for use as novel micro LED arrays,^{124, 125} micro-reactors for chemical processes, and for the sensory applications.¹²⁷

Alternative strategies. If there are difficulties in achieving the condensation of water droplets with the PMMA (or MEH-PPV) toluene solution, chloroform, tetrahydrofuran (THF) or carbon disulfide (CS₂) will be used to prepare a PMMA (or MEH-PPV) solution instead.¹³⁰ Evaporation of chloroform, THF, and CS₂ under the exposure to a flow of moist air (i.e., evaporative cooling) will be faster than toluene and would lead to the formation of water droplets on the liquid-like PMMA (or MEH-PPV) rings.

The parameters, including the solution concentration, MW, solvent, external perturbation (pumping or shearing), curvature of sphere, shape effect (i.e., using sliced-sphere-on-Si geometry (FIG. 4.8)), and surface chemistry of restricted geometries as described in Section 6.1, will be delicately tuned to yield a thorough understanding of hierarchical structure formation, which, in turn, directs the engineering of the novel structures in practical applications.

6.2.2. Combination of “Stick-Slip” Motion and/or Controlled Fingering Instabilities at the Microscopic Scale with Self-Assemblies of Diblock Copolymers at the Nanoscale

The choice of diblock copolymers in the proposed study is justified as follows: diblock copolymers, comprised of two chemically distinct chains covalently linked at one end, spontaneously self-assemble into a range of well-ordered nanostructures (e.g., spheres, cylinders, lamellae, etc.), depending on the volume fractions of the components.^{9, 150, 189-191, 325-346} In addition, their size is dictated by molecular weight, typically in a range of 10 to 100 nm, which promises a density of ˜(1-10)×10¹² nanostructures per inch². This offers an attractive alternative to fabricating nanometer-scale structures.^{9, 150, 189-191, 325-328, 334}

As the first attempts, diblock copolymers of P4VP-b-PMMA and PS-b-PMMA with cylindrical morphology are used as nonvolatile solutes. Both diblock copolymers with mono-dispersed MW distribution are commercially available. The hydrophilic P4VP block forms nanoscopic cylindrical domains within the hydrophobic PMMA matrix in P4VP-b-PMMA. The hydrophobic PMMA block forms cylindrical nanodomains within the hydrophobic PS matrix in PS-b-PMMA.

6.2.2a Concentric Rings Formed by Combination of “Stick-Slip” Motion with Self-Assembly of Diblock Copolymers.

A dilute P4VP-b-PMMA toluene solution will be loaded in the sphere-on-Si geometry. When the solvent is completely evaporated, the hierarchically ordered structures will form as a direct consequence of two concurrent self-assembly processes, that is, the formation of well-ordered hexagonal arrays of P4VP in the PMMA matrix produced by spontaneous self-assembly at the nanometer scale coupled with the controlled dynamic self-assembly of gradient concentric rings of P4VP-b-PMMA formed at the micrometer scale (FIG. 4.10). Based on our preliminary studies on drying-mediated self-assembly of homopolymers as discussed in Section 5,¹⁹⁹⁻²⁰⁵ the ring of P4VP-b-PMMA will typically be a few to tens of micrometers wide and 10-100 nm high (i.e., a very flat ring), which is dictated by the solution concentration.^{99, 200} This makes the thickness of the rings and the characteristic length scale, L₀, of diblock copolymer commensurable.³²⁸

6.2.2b. Web Pattern Formed Via the Synergy of “Stick-Slip” Motion, Controlled fingering Instabilities, and Self-Assembly of Block Copolymers.

A drop of PS-b-PMMA toluene solution will be placed in the sphere-on-Si geometry. Rather than concentric rings as illustrated in FIG. 4.10, a web pattern may be anticipated due to the simultaneous occurrence of the “stick-slip” motion of the contact line and the fingering instability^{12, 16, 38, 62, 108, 251, 259, 260} of the rings as depicted schematically in FIG. 4.11. The drop pins and fingering instabilities are set in due to unfavorable interfacial interaction between the PS block and Si (Section 5.3). The drop then depins and forms a new ring with fingers. This process leads to the formation of circular (or ellipsoidal) holes residing between two adjacent rings (second panel in FIG. 4.11). Finally, the drop depins and forms fingers again, contracting the drop interface toward the sphere/Si contact center. Eventually, the solution dries up and patterns are locked in (third panel in FIG. 4.11).

Outcome: The above intriguing structures (i.e., concentric rings and web pattern) can be utilized as templates for (1) producing a positive or negative replica composed of metals or metal oxides that may be used for combinatorial studies of dewetting of polymer thin films,³⁴⁷ phase separation of polymer blends,³⁴⁸ as well as polymer/liquid crystal mixtures^{349, 350} to explore the finite size (i.e., confinement) effects in one step, owing to the intrinsic gradient nature of structures in size and shape; and (2) creating hierarchically ordered nanowires by selectively removing cylindrical nanodomains in diblock copolymers, followed by deposition of magnetic materials⁹ or QDs.³⁵¹ They may also find applications as tissue engineering scaffolds.⁴⁴⁻⁴⁶ Moreover, the stability of the rings can be utilized as a sensitive tool to explore surface and interfacial forces in detail.²⁵⁸ Finally, the present hierarchically ordered structures may serve as a platform to study cell adhesion and motility, neuron guidance, cell mechanotransduction, and other biological processes.^{42, 352}

Alternative strategies. (1) A key to the use of block copolymers for producing hierarchically ordered materials is controlling the orientation of nanodomains.^{328, 353, 354} The preferential interactions of one block with the substrates (i.e., sphere and Si) and the lower surface energy of another block may force an orientation of cylindrical nanodomains parallel to the substrate (FIG. 4.12a). In order to achieve hexagonally packed nanocylinders oriented normal to the film surface as depicted in FIG. 4.10 and FIG. 4.11,^{9, 120, 344, 355-367} which is more technologically relevant, two approaches will be taken. They are: (a) Selective solvent vapor annealing for an appropriate time,^{120, 358-365} in conjunction with or after the formation of microscopic concentric rings and web. For example, the formation of PMMA nanocylinders normal to the substrate in PS-b-PMMA diblock can be realized by annealing the web structure with acetone (or chloroform) vapor, which is a selective solvent for PMMA block^{355, 356, 358} (FIG. 4.12). Similarly, for P4VP-b-PMMA, the methanol vapor annealing will be performed to “pull” P4VP block, which preferentially interacts with the substrates,368 to orient normal to the film surface. Methanol is a selective solvent for P4VP;^{369, 370} (b) Pre-modification of the substrates with a layer of end-functionalized random copolymer. For example, a PS-r-PMMA will be deposited to balance the interfacial interactions of PS and PMMA blocks with the substrates in PS-b-PMMA diblock.^{9, 357, 371} (2) Fingering instabilities at the contact line of the drop are crucial for the web formation. If the fingers fail to connect two adjacent rings to produce isolated holes, to effectively achieve a well-defined web pattern (FIG. 4.11), the upper surface will be vertically “pumped” (Section 6.1). A radial flow will be generated that facilitates the formation of holes by promoting the fingering instabilities.

In addition to cylinder-forming diblocks, lamellae- and sphere-forming diblocks can also be used to obtain self-assembled nanosheets (i.e., lamellae) and nanospheres in micrometer-sized concentric rings and web. Changes in the solution concentration, MW, solvent, curvature of sphere, shape of upper surface (i.e., applying sliced-sphere-on-Si geometry), and surface chemistry of restricted geometries (including the Janus interface), as well as application of external perturbation (pumping or shearing) and temperature gradient as described in Section 6.1 are expected to dramatically impact the two self-assembly processes at the different length scales and will be systematically studied.

6.3. Theoretical Modeling of the Formation of Web Structures

In addition to the understanding of the formation of concentric rings in the sphere-on-flat geometry as detailed in Section 5.2,²⁰⁰ efforts were made to establish a model to elucidate the mechanism of the formation of microscopic web patterns. The characteristic distance between two adjacent fingers on a ring in the web pattern (FIG. 4.11), λ_{finger}, can be predicted as follows. A linear stability analysis of a liquid-like thin film with small fluctuations Bexp(iqx+t/τ) (i.e., the capillary edge in FIGS. 4.3 and 4.6) yields the dispersion relation^{183, 185, 260, 372-376}

$$\frac{1}{τ} = \frac{{h}^{3}}{3 η} ( - γ {q}^{4} + \frac{A}{2 π {h}^{4}} {q}^{2} ) \qquad ( 6 )$$

where B is the amplitude, q is the growth mode, 1/τ is the growth rate, γ is the surface tension of solute, h is the thickness of the capillary edge, η is the viscosity, and A is the Hamaker constant, signifying the interfacial interaction between the solute and substrate.

The condition for equilibrium between a wetting film and a meniscus in a capillary-held solution (FIGS. 4.3 and 4.6) is the equality of the capillary pressure, P_{c}, and the disjoining pressure, Π(h) (i.e., van der Waals interaction),³⁷⁷ yielding

$${P}_{c} = Π ( h ) ⇒ \frac{2 {γ}_{solvent}}{H} ≅ \frac{\vert A \vert}{6 π {h}^{3}} \qquad ( 7 )$$

where γₛₒₗᵥₑₙₜ is the surface tension of the solvent and H is the surface separation at the liquid-vapor interface (FIG. 4.6).

The fingering instabilities are caused by the concentration-gradient-induced surface tension gradient for the drying-mediated pattern formation in the sphere-on-flat geometry.^{199, 200} The deposition of polymers to form a finger on a ring (FIG. 4.11) reduces local surface tension of the solution, thereby causing the solution to spread to the region with higher concentration.²⁰⁰ The film at the capillary edge destabilizes and leads to longitudinal periodic fingers formation with a fastest growth mode, corresponding to the maximum in eq. (6)

$$\frac{\partial ( 1 / τ )}{\partial q} = 0 ⇒ {q}_{max} = {( \frac{A}{2 π γ {h}^{4}} )}^{1 / 2} \qquad ( 8 )$$

Substituting eq. (7) into eq. (8), the finger wavelength, λ_{finger}, is thus found from^{260, 374, 377, 378}

$${λ}_{finger} = \frac{2 π}{{q}_{max}} = 2 {π ( \frac{γ hH}{6 {γ}_{solvent}} )}^{1 / 2} \qquad ( 9 )$$

The λ_{finger} calculated from eq. (9) can be compared with experimental observations.

Knowledge generated by this project may lead to the creation of novel devices and materials for use in optics, microelectronics, optoelectronics, nanotechnology, and biotechnology, which exhibit unique functions due to hierarchical arrangement of nanoscopic building blocks, thereby transitioning fundamental scientific discoveries into useful technologies that benefit society.

### Figure Captions

FIG. 4.1—Concentric rings form from the drying of 0.002 vol % polystyrene (PS) latex water solution. The diameter of PS particle is 144 nm.⁹⁵ The image size is 1 mm².

FIG. 4.2—Optical microscope image of breath figures obtained from solvent-casting a polystyrene film from chloroform.¹²⁷ Scale bar=16 μm.

FIG. 4.3—Schematic illustration of the sphere-on-flat geometry in which a drop of solution containing nonvolatile solute is constrained, bridging the gap between the spherical lens and Si substrate.^{199, 200}

FIG. 4.4—Left: Digital image of entire gradient concentric ring patterns formed by the deposition of MEH-PPV from 0.075 mg/ml toluene solution in a sphere-on-flat geometry. Right: A small zone of the fluorescent image of MEH-PPV ring patterns. The scale bar is 200 μm. As the solution front moves inward, rings become smaller and the height decreases as illustrated in lower left schematic.²⁰⁰

FIG. 4.5—Concentration effect. λ_{C-C} (left) and hd (right) are plotted as a function of X at the different concentrations (solid and open circles corresponding to the data obtained from toluene solutions at c=0.075 mg/ml and 0.05 mg/ml, respectively), where X is the distance away from the center of the sphere/Si contact.²⁰⁰

FIG. 4.6—Left: Schematic cross section of a capillary-held solution containing nonvolatile solute placed in a sphere-on-flat configuration. X₁, X, and X₀ are the radii of outermost, intermediate, and innermost rings from the center of sphere/Si contact, respectively. Right: The close-up of the capillary edge marked in the left panel. The parameters used in the calculation are illustrated.²⁰⁰

FIG. 4.7—AFM height image of PS rings where fingering instabilities appear at both sides of a ring.²⁰⁴ The image size is 100×100 μm².

FIG. 4.8—: (a) Triangular-slice sphere, (b) quadrangular-slice sphere, and (c) hexagonal-slice sphere. Top panel: Top view. Bottom panel: Side view at a tilted angle.

FIG. 4.9—Left: Schematic illustration of concave holes residing within microscopic rings formed by a combination of “stick-slip” motion and water droplet condensation (top view) in the sphere-on-Si geometry. The spherical lens/Si contact area is marked as “Contact Center”. Right: TOPO-functionalized QDs decorating the internal wall of concave holes after incorporating QDs with polymer (upper: top view; lower: cross section view via cutting through the dash line).

FIG. 4.10—Schematic illustration of gradient concentric rings composed of P4VP-b-PMMA (top view). The right side shows the close-up of well-ordered nanocylinders of P4VP in the PMMA matrix in two individual rings.

FIG. 4.11—Stepwise representation of the formation of a web pattern of PS-b-PMMA by concurrent interplay of “stick-slip” motion of the contact line and controlled fingering instabilities (top view). The last panel shows the close-up of well-ordered nanocylinders of PMMA in the PS matrix in the web.

FIG. 4.12—Schematic illustration of formation of vertically aligned PMMA nanocylinders in the PS matrix by exposing the web pattern of PS-b-PMMA (FIG. 11) to acetone vapor (cross-section view of the PS-b-PMMA thin film locally on the web). The solvent annealing imparts the mobility of PMMA chains and transitions the featureless topography (due to lower surface energy of PS (γ_{PS}=40.7 mN/m) than PMMA (γ_{PMMA}=41.1 mN/m)^{360, 366, 367}) to nanocylinders of PMMA normal to the surface, thereby reducing differences in the surface energies of the component.

### REFERENCES FOR EXAMPLE 4

### Note: Some of the References Listed Below are not Specifically Mentioned in Example 4, But are Supplied for Background Purposes

1. Lin, Y. S., Jiang, C. Y., Xu, J., Lin, Z. Q. & Tsukruk, V. V. Freely suspended, conjugated polyelectrolyte based nanomembranes as highly sensitive sensors. Soft Matter 3, 432 (2007).
2. Lin, Y.-H., Jiang, C. Y., Xu, J., Lin, Z. Q. & Tsukruk, V. V. Sculptured layer-by-layer films. Adv. Mater. 19, 3827 (2007).
3. Zimnitsky, D., Jiang, C., Xu, J., Lin, Z. Q. & Tsukruk, V. V. Substrate- and time-dependent photoluminescence of quantum dots inside the ultrathin polymer LbL film. Langmuir 23, 4509 (2007).
4. Zimnitsky, D. et al. Photoluminescence of a freely suspended monolayer of quantum dots encapsulated into layer-by-layer films”. Langmuir 23, 10176 (2007).
5. Byun, M., Hong, S. W., Zhu, L. & Lin, Z. Q. Self-assembling semicrystalline polymer into highly ordered, microscopic concentric rings by evaporation. Langmuir, (in press).
6. Hong, S. W. et al. Directed self-assembly of gradient concentric carbon nanotube rings. Adv. Funct. Mater., (submitted).
7. Byun, M., Hong, S. W. & Lin, Z. Well-ordered dissipative structures formed by retarded evaporation of polymer blend solution. Adv. Mater., (submitted).
8. Whitesides, G. M. & Grzybowski, B. Self-assembly at all scales. Science 295, 2418 (2002).
9. Thurn-Albrecht, T. et al. Ultrahigh-density nanowire arrays grown in self-assembled diblock copolymer templates. Science 290, 2126 (2000).
10. Lin, Y. et al. Self-directed self-assembly of nanoparticle/copolymer mixtures. Nature 434, 55 (2005).
11. Park, S., Lim, J.-H., Chung, S.-W. & Mirkin, C. A. Self-assembly of mesoscopic metal-polymer amphiphiles. Science 303, 348 (2004).
12. Gleiche, M., Chi, L. F. & Fuchs, H. Nanoscopic channel lattices with controlled anisotropic wetting. Nature 403, 173 (2000).
13. Gleiche, M., Chi, L. F., Gedig, E. & Fuchs, H. Anisotropic contact-angle hysteresis of chemically nanostructured surfaces. Chem. Phys. Chem. 2, 187 (2001).
14. Chen, X., Rogach, A. L., Talapin, D. V., Fuchs, H. & Chi, L. F. Hierarchical luminescence patterning based on multiscaled self-assembly. J. Am. Chem. Soc. 128 (2006).
15. Chen, X., Hirtz, M., Fuchs, H. & Chi, L. F. Self-organized patterning: regular and spatially tunable luminescent submicrometer stripes over large areas. Adv. Mater. 17, 2881 (2005).
16. Huang, J., Kim, F., Tao, A. R., Connor, S. & Yang, P. D. Spontaneous formation of nanoparticle stripe patterns through dewetting. Nature Mater 4, 896 (2005).
17. Huang, J., Tao, A. R., Connor, S., He, R. & Yang, P. D. A general method for assembling single colloidal particle lines. Nano Lett. 6, 524 (2006).
18. Huang, J., Fan, R., Connor, S. & Yang, P. D. One-step patterning of aligned nanowire arrays by programmed dip coating. Angew. Chem. Int. Ed. 46, 2414 (2007).
19. Yoo, P. J. et al. Spontaneous assembly of viruses on multilayered polymer surfaces. Nature Mater. 5, 234 (2006).
20. Kalsin, A. M. et al. Electrostatic self-assembly of binary nanoparticle crystals with a diamond-like lattice. Science 312, 420 (2006).
21. Decher, G. Fuzzy nanoassemblies: toward layered polymeric multicomposites. Science 277, 1232 (1997).
22. Boal, A. K. et al. Self-assembly of nanoparticles into structured spherical and network aggregates. Nature 404, 746 (2000).
23. Xu, H., Hong, R., Lu, T., Uzun, 0. & Rotello, V. M. Recognition-directed orthogonal self-assembly of polymers and nanoparticles on patterned surfaces. J. Am. Chem. Soc. 128, 3162 (2006).
24. Seeman, N. C. DNA in a material world. Nature 421, 427 (2003).
25. Seeman, N. C. DNA components for molecular architecture. Acc. Chem. Res. 30, 357 (1997).
26. Braun, E. & Keren, K. From DNA to transistor. Adv. in Phys. 53, 441 (2004).
27. Li, H., Park, S. H., Reif, J. H., LaBean, T. H. & Yan, H. DNA-templated self-assembly of protein and nanoparticle linear arrays. J. Am. Chem. Soc. 126, 418 (2004).
28. Park, S. H., Yan, H., Reif, J. H., LaBean, T. H. & Finkelstein, G. Electronic nanostructures templated on self-assembled DNA scaffolds. Nanotechnology 15, S525 (2004).
29. Park, S. H. et al. Programmable DNA self-assemblies for nanoscale organization of ligands and proteins. Nano Lett. 5, 729 (2005).
30. Liu, Y. & Yan, H. Modular self-assembly of DNA lattices with tunable periodicity. Small 3, 327 (2005).
31. Sharma, J., Chhabra, R., Liu, Y., Ke, Y. & Yan, H. DNA-templated self-assembly of two-dimensional and periodical gold nanoparticle arrays. Angew. Chem. Int. Ed. 45, 730 (2006).
32. Zhang, J., Liu, Y., Ke, Y. & Yan, H. Periodic square-like gold nanoparticle arrays templated by self-assembled 2D DNA nanogrids on a surface. Nano Lett. 6, 248 (2006).
33. Yan, H., Park, S. H., Finkelstein, G., Reif, J. H. & LaBean, T. H. DNA-templated self-assembly of protein arrays and highly conductive nanowires. Science 301, 1882 (2003).
34. Deegan, R. D. et al. Capillary flow as the cause of ring stain from dried liquid drops. Nature 389, 827 (1997).
35. Deegan, R. D. Pattern formation in drying drops. Phys. Rev. E 61, 475 (2000).
36. Deegan, R. D. et al. Contact line deposits in an evaporating drop. Phys. Rev. E 62, 756 (2000).
37. Rabani, E., Reichman, D. R., Geissler, P. L. & Brus, L. E. Drying-mediated self-assembly of nanoparticles. Nature 426, 271 (2003).
38. Yabu, H. & Shimomura, M. Preparation of self-organized mesoscale polymer patterns on a solid substrate: continuous pattern formation from a receding meniscus. Adv. Funct. Mater. 15, 575 (2005).
39. Joannopoulos, J. D., Meade, R. D. & Winn, J. N. Photonic crystals-modeling the flow of light. (Princeton University Press, Princeton, N.J.; 1995).
40. Jacobs, H. O. & Whitesides, G. M. Submicrometer patterning of charge in thin-film electrets. Science 291, 1763 (2001).
41. Delamarche, E., Bernard, A., Schmid, H., Michel, B. & Biebuyck, H. Patterned delivery of immunoglobulins to surfaces using microfluidic networks. Science 276, 779 (1997).
42. Kumar, G., Ho, C. C. & Co, C. C. Guiding cell migration using one-way micropattern arrays. Adv. Mater. 19, 1084 (2007).
43. Purrucker, O., Fortig, A., Ludtke, K., Jordan, R. & Tanaka, M. Confinement of transmembrane cell receptors in tunable stripe micropatterns. J. Am. Chem. Soc. 127, 1258 (2005).
44. Gratson, G. M., Xu, M. & Lewis, J. A. Direct writing of three dimensional webs. Nature 428, 386 (2004).
45. Smay, J. E., Cesarano III, J. & Lewis, J. A. Colloidal inks for directed assembly of 3-D periodic structures. Langmuir 18, 5429 (2002).
46. Lewis, J. A. & Gratson, G. M. Direct writing in three dimensions. Materials Today July/August, 32 (2004).
47. Chen, X., Hirtz, M., Fuchs, H. & Chi, L. Fabrication of gradient mesostructures by langmuir-blodgett rotating transfer. Langmuir 23, 2280 (2007).
48. Garstecki, P., Sone, H. & Whitesides, G. M. Mechanism for flow-rate controlled breakup in confined geometries: a route to monodisperse emulsion. Phys. Rev. Lett 94, 164501 (2005).
49. Chen, D. L., Gerdts, C. J. & Ismagilov, R. F. Using microfluidics to observe the effect of mixing on nucleation of protein crystals. J. Am. Chem., Soc. 127, 9672 (2005).
50. Berg, J. M. et al. A two-stage discrete peristaltic micropump. Sensors and actuators a 104, 6 (2003).
51. Ichikawa, N., Hosokawa, K. & Maeda, R. Interface motion of capillary-driven flow in rectangular microchannel. J. Colloid Interface Sci. 280, 155 (2004).
52. Koch, M., Chatelain, D., Evans, A. G. R. & Brunnschweiler, A. Two simple micromixers based on silicon. J. Micromech. Microeng. 8, 123 (1998).
53. Makino, E., Mitsuya, T. & Shibata, T. Micromachining of TiNi shape memory thin film for fabrication of micropump. Sensors and actuators 79, 251 (2000).
54. Olsson, A. et al. Valve-less diffuser micropumps fabricated using thermoplastic replication. Sensors and actuators a 64, 63 (1998).
55. Yang, Z., Matsumoto, S., Goto, H., Matsumoto, M. & Maeda, R. Ultrasonic micromixer for microfluidic systems. Sensors and actuators a 93, 266 (2001).
56. Scheuer, J., Green, W. M. J. & Yariv, A. Annular Bragg resonators: beyond the limits of total internal reflection. Photonics Spectra (May, 2005).
57. Scheuer, J., Green, W. M. J., DeRose, G. A. & Yariv, A. InGaAsP annular Bragg lasers: theory, applications, and modal properties. IEEE Journal of Selected Topics in Quantum Electronics 11, 476 (2005).
58. Green, W. M. J., Scheuer, J., DeRose, G. A., Yariv, A. & Scherer, A. Assessment of lithographic process variation effects in InGaAsP annular Bragg resonator lasers. J. Vac. Sci. & Tech. B 22, 3206 (2004).
59. Scheuer, J. & Yariv, A. Two-dimensional optical ring resonators based on radial Bragg resonance. Opt. Lett. 28, 1528 (2003).
60. Pauzauskie, P. J., Sirbuly, D. J. & Yang, P. D. Semiconductor nanowire ring resonator laser. Phys. Rev. Lett. 96, 143903 (2006).
61. O'Carroll, D., Lieberwirth, I. & Redmond, G. Microcavity effects and optically pumped lasing in single conjugated polymer nanowires. Nature Nanotech. 2, 180 (2007).
62. Karthaus, O., Grasjo, L., Maruyama, N. & Shimomura, M. Formation of ordered mesoscopic polymer arrays by dewetting. Chaos 9, 308 (1999).
63. Ma, X. et al. Crsut effect on multiscale pattern formations in drying micelles solution drops on solid substrates. Langmuir 21 (2005).
64. Wang, H., Wang, Z., Huang, L., Mitra, A. & Yan, Y. Surface patterned porous films by convection-assisted dynamic self-assembly of zeolite nanoparticles. Langmuir 17, 2572 (2001).
65. de Gennes, P. G. Solvent evaporation of spin cast films: “crust” effects. Eur. Phys. J. E 7, 31. (2002).
66. Uno, K., Hayashi, K., Hayashi, T., Ito, K. & Kitano, H. Particle adsorption in evaporating droplets of polymer latex dispersions on hydrophilic and hydrophobic surfaces. Coll. Surf. 276, 810 (1998).
67. Okubo, T., Kanayama, S. & Kimura, M. Dissipative structures formed in the course of drying the aqueous solution of n-dodecyltrimethylammonium chloride on a cover glass. Colloid Polym. Sci. 282, 486 (2004).
68. Okubo, T., Kimura, M. & Kimura, H. Dissipative structures formed in the course of drying the colloidal crystals of monodispersed polystyrene spheres on a cover glass. Colloid Polym. Sci. 280, 1001 (2002).
69. Lee, W. P. & Routh, A. F. Why do drying films crack? Langmuir 21 (2005).
70. Kimura, M., Minsner, M., Xu, T., Kim, S. H. & Russell, T. P. Long-range ordering of diblock copolymers induced by droplet pinning. Langmuir 19, 9910 (2003).
71. Allain, C. & Limat, L. Regular patterns of cracks formed by directional drying of a colloidal suspension. Phys. Rev. Lett. 74, 2981 (1995).
72. Vyawahare, S., Craig, K. M. & Scherer, A. Patterning lines by capillary flows. Nano Lett. 6, 271 (2006).
73. Sztrum, C. G., Hod, O. & Rabani, E. Self-assembly of nanoparticles in three-dimensions: formation of stalagmites. J. Phys. Chem. B 109, 6741 (2005).
74. Mathur, A., Brown, A.-D. & Erlebacher, J. Self-Ordering of Colloidal Particles in Shallow Nanoscale Surface Corrugations. Langmuir 21 (2005).
75. Bormashenko, E. et al. Mesoscopic patterning in evaporated polymer solutions: new experimental data and physical mechanisms. Langmuir 21, 9604 (2005).
76. Rio, E., Daerr, A., Lequeux, F. & Limat, L. Moving contact lines of a colloidal suspension in the presence of drying. Langmuir 22, 3186 (2006).
77. Bormashenko, E. et al. Self-assembly in evaporated polymer solutions: influence of the solution concentration. J. Coll. Interface Sci. 297, 534 (2006).
78. Bigioni, T. P. et al. Kinetically driven self assembly of highly ordered nanoparticle monolayers. Nature Mater. 5, 265 (2006).
79. Ghezelbash, A., Koo, B. & Korgel, B. A. Self-assembled stripe patterns of CdS nanorods. Nano Lett. 6, 1832 (2006).
80. Park, J. & Moon, J. Control of colloidal particle deposit patterns within picoliter droplets ejected by ink-jet printing. Langmuir 22, 3506 (2006).
81. Ohara, P. C. & Gelbart, W. M. Interplay between hole instability and nanoparticle array formation in ultrathin liquid films. Langmuir 14, 3418 (1998).
82. Kuncicky, D. M., Bose, K., Costa, K. D. & Velev, O. D. Sessile droplet templating of miniature porous hemispheres from colloid crystals. Chem. Mater. 19, 143 (2007).
83. Bae, C., Shin, H. & Moon, J. Facile route to aligned one-dimensional arrays of colloidal nanoparticles. Chem. Mater. 19, 1531 (2007).
84. Harris, D. J., Hu, H., Conrad, J. C. & Lewis, J. A. Patterning colloidal films via evaporative lithography. Phys. Rev. Lett. 98, 148301 (2007).
85. Yosef, G. & Rabani, E. Self-assembly of nanoparticles into rings: a lattice-gas model. J. Phys. Chem. B 110, 20965 (2006).
86. Martin, C. P., Blunt, M. O. & Moriarty, P. Nanoparticle networks on silicon: self-organized or disorganized? Nano Lett. 4, 2389 (2004).
87. Khanal, B. P. & Zubarev, E. R. Rings of nanorods. Angew. Chem. Int. Ed. 46, 2195 (2007).
88. Younes-Metzler, O., Ben, R. N. & Giorgi, J. B. Pattern formation of antifreeze glycoproteins via solvent evaporation. Langmuir 23, 11355 (2007).
89. Govor, L. V. et al. Self-assembly of CoPt3 nanoparticles rings based on phase-separated hexadecylamine droplet structure. Langmuir 19, 9573 (2003).
90. Govor, L. V., Reiter, G., Bauer, G. H. & Parisi, J. Nanoparticle ring formation in evaporating micron-size droplets. Appl. Phys. Lett. 84, 4774 (2004).
91. Hu, H. & Larson, R. G. Marangoni effect reverses coffee-ring depositions. J. Phys. Chem. B 110, 7090 (2006).
92. Tiruinkudulu, M. S. & Russel, W. B. Role of capillary stresses in film formation. Langmuir 20, 2947 (2004).
93. Hu, H. & Larson, R. G. Evaporation of a sessile droplet on a substrate. J. Phys. Chem. B 106, 1334 (2002).
94. Shmuylovich, L., Shen, A. Q. & Stone, H. A. Surface morphology of drying latex films: multiple ring formation. Langmuir 18, 3441 (2002).
95. Adachi, E., Dimitrov, A. S. & Nagayama, K. Stripe patterns formed on a glass surface during droplet evaporation. Langmuir 11, 1057 (1995).
96. Ray, M. A., Kim, H. & Jia, L. Dynamic self-assembly of polymer colloids to form linear patterns. Langmuir 21, 4786 (2005).
97. Nonomura, M., Kobayashi, R., Nishiura, Y. & Shimomura, M. Periodic precipitation during droplet evaporation on a substrate. J. Phys. Soc. Japan 72, 2468 (2003).
98. Popov, Y. O. Evaporative deposition patterns: spatial dimensions of the deposit. Phys. Rev. E 71, 036313 (2005).
99. Fisher, B. J. Particle convection in an evaporating colloidal droplet. Langmuir 18, (2002).
100. Ozawa, K., Nishitani, E. & Doi, M. Modeling of the drying process of liquid droplet to form thin film. Japanese J. Appl. Phys. 44, 4229 (2005).
101. Li, M. Q., Xu, S. Q. & Kumacheva, E. Convection patterns trapped in the solid state by UV-induced polymerization. Langmuir 16, 7275 (2000).
102. Xu, S. Q. & Kumacheva, E. Ordered morphologies in polymeric films produced by replication of convection patterns. J. Am. Chem., Soc. 124, 1142 (2002).
103. Maillard, M., Motte, L. & Pileni, M. P. Rings and hexagons made of nanocrystals. Advanced Materials 13, 200 (2001).
104. Mitov, Z. & Kumacheva, E. Convection-induced patterns in phase-separating polymeric fluids. Phys. Rev. Lett. 81, 3427 (1998).
105. Gonuguntla, M. & Sharma, A. Polymer patterns in evaporating droplets on dissolving substrates. Langmuir 20, 3456 (2004).
106. Kang, E. S., Takahashi, M., Tokuda, Y. & Yoko, T. Template-free magnesium oxide hollow sphere inclusion in organic-inorganic hybrid films via sol-gel reaction. Langmuir 22, 5220 (2006).
107. Nguyen, V. X. & Stebe, K. J. Patterning of small particles by a surfactant-enhanced Maragoni-Benard Instability. Phys. Rev. Lett. 88, 164501 (2002).
108. Hu, H. & Larson, R. G. Analysis of the effects of Marangoni stresses on the microflow in an evaporating sessile droplet. Langmuir 21, 3963 (2005).
109. Maillard, M., Motte, L., Ngo, A. T. & Pileni, M. P. Ring and hexagons made of nanocrystals: a Marangoni effect. J. Phys. Chem. B 104, 11871 (2000).
110. Bormashenko, E. et al. Mesoscopic and submicroscopic patterning in thin polymer films: Impact of the solvent. Mater. Lett. 59, 2461 (2005).
111. Zhang, J., Xue, L. & Han, Y. Fabrication of gradient colloidal topography. Langmuir 21, 5667 (2005).
112. Abkarian, M., Nunes, J. & Stone, H. A. Colloidal crystallization and banding in a cylindrical geometry. J. Am. Chem. Soc. 126, 5978 (2004).
113. Clement, F. & Leng, J. Evaporation of liquids and solutions in confined geometry. Langmuir 20, 6538 (2004).
114. Khrustalev, D. & Faghri, A. Fluid flow effects in evaporation from liquid-vapor meniscus. J. Heat Transfer 118, 725 (1996).
115. Bennacer, R., Sefiane, K., El-Ganaoui, M. & Buffone, C. Numerical investigation of the role of non-uniform evaporation rate in initiating Marangoni convection in capillary tubes. International Journal of Numerical Methods for Heat & Fluid Flow 14, 877 (2003).
116. Schaffer, E. & Wong, P. Contact line dynamics near the pinning threshold: a capillary rise and fall experiment. Phys. Rev. E. 61, 5257 (2000).
117. Stange, M., Dreyer, M. E. & Rath, H. J. Capillary driven flow in circular cylindrical tubes. Phys. Fluids 15, 2587 (2003).
118. Aksay, I. A., Trau, M. & Manne, S. Biomimetic pathways for assembling inorganic thin films. Science 273, 892 (1996).
119. Pouget, E. et al. Hierarchical architectures by synergy between dynamical template self-assembly and biomineralization. Nature Mater. 6, 434 (2007).
120. Kim, S. H., Minser, M. J., Xu, T., Kimura, M. & Russell, T. P. Highly oriented and ordered arrays from block copolymers via solvent evaporation. Adv. Mater. 16, 226 (2004).
121. Segalman, R. A., Yokoyama, H. & Kramer, E. J. Graphoepitaxy of spherical domain block copolymer films. Adv. Mater. 13, 115 (2001).
122. Brinker, C. J. Evaporation-induced self-assembly: functional nanostructures made easy. MRS Bulletin/September, 631 (2004).
123. Kossyrev, P. A., Bockstaller, M. R. & Thomas, E. L. 2D spatially periodic architectures via the drying of 1D holographically photopatterned polymer solution. Langmuir 21, 814 (2005).
124. Erdogan, B. et al. Permanent bubble arrays from a cross-linked poly(para-phenyleneethynylene): picoliter holes without microfabrication. J. Am. Chem., Soc. 126, 3678 (2004).
125. Song, L. et al. Facile microstructuring of organic semiconducting polymers by the breath figure method: hexagonally ordered bubble arrays in rigid-rod polymers. Adv. Mater. 16, 115 (2004).
126. Park, M. S. & Kim, J. K. Breath figure patterns prepared by spin coating in a dry environment. Langmuir 20, 5347 (2004).
127. Boker, A. et al. Hierarchical nanoparticle assemblies formed by decorating breath figures. Nature Mater. 3, 302 (2004).
128. Widawski, G., Rawiso, M. & Francois, B. Self-organized honey-comb morphology of star-polymer polystyrene film. Nature 369, 387 (1994).
129. Jenekhe, S. A. & Chen, X. L. Self-assembly of ordered microporous materials from rod-coil block copolymers. Science 283, 372 (1999).
130. Bunz, U. H. F. Breath figures as a dynamic templating method for polymers and nanomaterials. Adv. Mater. 18, 973 (2006).
131. Park, M. S. & Kim, J. K. Broad-band antireflection coating at near-infrared wavelengths by a breath figure. Langmuir 21, 11404 (2005).
132. Ohzono, T., Nishikawa, T. & Shimomura, M. One-step fabrication of polymer thin films with lithographic bas-relief micro-pattern and self-organized micro-porous structure. J. Mater. Sci. 39, 2243 (2004).
133. Gomez-Segura, J. et al. Self-organization of Mn12 single-molecule magnets into ring structures induced by breath-figures as templates. Chem. Comm., 5615 (2005).
134. Yabu, H. & Shimomura, M. Mesoscale pincushions, microrings, and microdots prepared by heating and peeling of self-organized honeycomb-patterned films deposited on a solid substrate. Langmuir 22, 4992 (2006).
135. Li, J. et al. Ordered honeycomb-structured gold nanoparticle films with changeable pore morphology: from circle to ellipse. Langmuir 21, 2017 (2005).
136. Bensemann, I. T., Fialkowski, M. & Grzybowski, B. A. Wet stamping of microscale periodic precipitation patterns. J. Phys. Chem. B 109, 2774 (2005).
137. Bitner, A., Fialkowski, M., Smoukov, S. K., Campbell, C. J. & Grzybowski, B. A. Amplification of changes of a thin film's macromolecular structure into macroscopic reaction-diffusion patterns. J. Am. Chem. Soc. 127, 6936 (2005).
138. Campbell, C. J., Baker, E., Fialkowski, M. & Grzybowski, B. A. Arrays of microlenses of complex shapes prepared by reaction-diffusion in thin films of ionically doped gels. Appl. Phys. Lett. 85, 1871 (2004).
139. Campbell, C. J., Fialkowski, M., Klajn, R., Bensemann, I. T. & Grzybowski, B. A. Color micro- and nanopatterning with counter-propagating reaction-diffusion fronts. Adv. Mater. 16, 1912 (2004).
140. Campbell, C. J., Klajn, R., Fialkowski, M. & Grzybowski, B. A. One-step multilevel microfabrication by reaction-diffusion. Langmuir 21, 418 (2005).
141. Campell, C. J., Smoukov, S. K., Bishop, K. J. M. & Grzybowski, B. A. Reactive surface micropatterning by wet stamping. Langmuir 21, 2637 (2005).
142. Fialkowski, M., Bitner, A. & Grzybowski, B. A. Wave optics of Liesegang rings. Phys. Rev. Lett 94, 018303 (2005).
143. Fialkowski, M., Campbell, C. J., Bensemann, I. T. & Grzybowski, B. A. Absorption of water by thin, ionic films of gelatin. Langmuir 20, 3513 (2004).
144. Smoukov, S. K., Bishop, K. J. M., Campbell, C. J. & Grzybowski, B. A. Freestanding three-dimensional copper foils prepared by electroless deposition on micropatterned gels. Adv. Mater. 17, 751 (2005).
145. Smoukov, S. K., Bishop, K. J. M., Klajn, R., Campbell, C. J. & Grzybowski, B. A. Cutting into solids with micropatterned gels. Adv. Mater. 17, 1361 (2005).
146. Fialkowski, M. et al. Principles and implementations of dissipative (dynamic) self-assembly. J. Phys. Chem. B 110, 2482 (2006).
147. Smoukov, S. K., Bitner, A., Campbell, C. J. K., Grzybowska, K. & Grzybowski, B. A. Nano- and microscopic surface wrinkles of linearly increasing heights prepared by periodic precipitation. J. Am. Chem. Soc. 127, 17803 (2005).
148. Bishop, K. J. M., Fialkowski, M. & Grzybowski, B. A. Micropatterning chemical oscillations: waves, autofocusing, and symmetry breaking. J. Am. Chem. Soc. 127, 15943 (2005).
149. Grzybowski, B. A., Bishop, K. J. M., Campbell, C. J., Fialkowski, M. & Smoukov, S. K. Micro- and nanotechnology via reaction/diffusion. Soft Matter 1, 114 (2005).
150. Cheng, J. Y., Ross, C. A., Smith, H. I. & Thomas, E. L. Templated self-assembly of block copolymers: top-down helps bottom-up. Adv. Mater. 18, 2505 (2006).
151. Shimomura, M. & Sawadaishi, T. Bottom-up strategy of materials fabrication: a new trend in nanotechnology of soft materials. Cur. Opin. Coll. Inter. Sci. 6, 11 (2001).
152. Diggle, J. W., Downie, T. C. & Goulding, C. W. Anodic Oxide Films on Aluminum. Chem. Rev. 69, 365 (1969).
153. Hennesthal, C. & Steinem, C. Pore-spanning lipid bilayers visualized by scanning force microscopy. J. Am. Chem. Soc. 122, 8085 (2000).
154. Masuda, H. & Fukuda, K. Ordered metal nanohole arrays made by a two-step replication of honeycomb structures of anodic alumina. Science 268, 1466 (1995).
155. Mirkin, C. A., Letsinger, R. L., Mucic, R. C. & Storhoff, J. J. A DNA-based method for rationally assembling nanoparticles into macroscopic materials. Nature 382, 607 (1996).
156. Nicewarner-Pena, S. R. et al. Submicrometer metallic barcodes. Science 294, 137 (2001).
157. Pan, S. & Rothberg, L. J. Interferometric sensing of biomolecular binding using nanoporous aluminum oxide templates. Nano Lett. 3, 811 (2003).
158. Pan, S., Zeng, D. D., Zhang, H. L. & Li, H. L. Preparation of ordered array of nanoscopic gold rods by template method and its optical properties. Appl. Phys. A 70, 637 (2000).
159. Qi, D. F., Kwong, K., Rademacher, K., Wolf, M. & Young, J. F. Optical emission of conjugated polymers adsorbed to nanoporous alumina. Nano Lett. 3, 1265 (2003).
160. Routkevich, D., Bigioni, T., Moskovits, M. J. & Xu, J. M. Electrochemical fabrication of CdS nanowire arrays in porous anodic aluminum oxide. J. Phys. Chem. 100, 14037 (1996).
161. Steinhart, M. et al. Polymer nanotubes by wetting of ordered porous templates. Science 296, 1997 (2002).
162. Xu, T. T., Fishet, F. T., Brinson, L. C. & Ruoff, R. S. Bone-shaped nanomaterials for nanocomposite applications. Nano Lett. 3, 1135 (2003).
163. Shin, K. et al. Curving and frustrating flatland. Science 306, 76 (2004).
164. Xiang, H. Q. et al. Block copolymers under cylindrical confinement. Macromolecules 37, 5660 (2004).
165. Xiang, H. Q. et al. From cylinders to helices upon confinement. Macromolecules 38, 1055 (2005).
166. Lin, V. S.-Y., Motesharei, K., Dancil, K. S., Sailor, M. J. & Ghadiri, M. R. A porous silicon-based optical interferometric biosensor. Science 278, 840 (1997).
167. Nguyen, T. Q., Wu, J., Doan, V., Schwartz, B. J. & Tolbert, S. H. Control of energy transfer in oriented conjugated polymer-mesoporous silica composites. Science 288, 652 (2000).
168. Nguyen, T. Q., Wu, J., Schwartz, B. J. & Tolbert, S. H. Control of energy transport in conjugated polymers using an ordered mesoporous silica matrix. Adv. Mater. 13, 609 (2000).
169. Tolbert, S. H., Firouzi, A., Stucky, G. D. & Chmelka, B. F. Magnetic field alignment of ordered silicate-surfactant composites and mesoporous silica. Science 278, 264 (1997).
170. Tolbert, S. H., Wu, J., Gross, A. F., Nguyen, T. Q. & Schwartz, B. J. Directional energy migration in an ordered nanometer-scale host/guest composite: semiconducting polymers threaded into mesoporous silica. Microporous and Mesoporous Materials 44-45, 445 (2001).
171. Liu, C., Gao, C. & Yan, D. Honeycomb-patterned photoluminescent films fabricated by self-assembly of hyperbranched polymers. Angew. Chem. Int. Ed. 46, 4128 (2007).
172. Tian, Y., Ding, H., Jiao, Q. & Shi, Y. Influence of solvents on the formation of honeycomb films by water droplets templating. Macromol. Chem. Phys. 207, 545 (2006).
173. Pitois, 0. & Francois, B. Crystallization of condensation droplets on a liquid surface. Colloid Polym. Sci. 277, 574 (1999).
174. Bormashenko, E., Pogreb, R., Stanevsky, O., Bormashenko, Y. & Gendelman, O. V. Formation of honeycomb patterns in evaporated polymer solutions: influence of the molecular weight. Mater. Lett. 59, 3553 (2005).
175. Saunders, A. E. et al. Breath figure templated self-assembly of porous diblock copolymer films. Phys. Rev. E 73, 031608 (2006).
176. Deepak, V. D. & Asha, S. K. Self-organization-induced three-dimensional honeycomb pattern in structure-controlled bulky methacrylate polymers: synthesis, morphology, and mechanism of pore formation. J. Phys. Chem. B 110, 21450 (2006).
177. Park, J. S., Lee, S. H., Han, T. H. & Kim, S. O. Hierarchically ordered polymer films by templated organization of aqueous droplets. Adv. Funct. Mater. 17 (2007).
178. Henisch, H. K. Liesegang ring formation in gels. J. Crystal Growth 76, 279 (1986).
179. Krug, H. & Brandstadter, H. Morphological characteristics of Liesegang rings and their simulations. J. Phys. Chem. A 103, 7811 (1999).
180. Bishop, K. J. M. & Grzybowski, B. A. Localized chemical wave emission and mode switching in a patterned excitable medium. Phys. Rev. Lett. 97, 128702 (2006).
181. Bishop, K. J. M., Gray, T. P., Fialkowski, M. & Grzybowski, B. A. Microchameleons: nonlinear chemical microsystems for amplification and sensing. Chaos 16, 037102 (2006).
182. Leach, K. A., Lin, Z. Q. & Russell, T. P. Early stages in the growth of electric field-induced surface fluctuations. Macromolecules 38, 4868 (2005).
183. Lin, Z. Q. et al. Electric field induced instabilities at liquid/liquid interfaces. J. Chem. Phys. 114, 2377 (2001).
184. Lin, Z. Q., Kerle, T., Russell, T. P., Schaffer, E. & Steiner, U. Structure formation at the interface of liquid/liquid bilayer in electric field. Macromolecules 35, 3971 (2002).
185. Lin, Z. Q., Kerle, T., Russell, T. P., Schaffer, E. & Steiner, U. Electric field induced dewetting at polymer/polymer interfaces. Macromolecules 35, 6255 (2002).
186. Morariu, M. D. et al. Hierarchical structure formation and pattern replication induced by an electric field. Nature Mater. 2, 48 (2003).
187. Russell, T. P., Lin, Z. Q., Schaffer, E. & Steiner, U. Aspects of electrohydrodynamic instabilities at polymer interfaces. Fibers and Polymers 4, 1 (2003).
188. Lin, Z. Q. & Granick, S. Patterns formed by droplet evaporation from a restricted geometry. J. Am. Chem. Soc. 127, 2816 (2005).
189. Lin, Z. Q. et al. A rapid route to arrays of nanostructures in thin films. Adv. Mater. 14, 1373 (2002).
190. Kim, D. H., Jia, X. Q., Lin, Z. Q., Guarini, K. W. & Russell, T. P. Growth of silicon oxide in thin film block copolymer scaffolds. Adv. Mater. 16, 702 (2004).
191. Kim, D. H., Lin, Z. Q., Kim, H. C., Jeong, U. & Russell, T. P. On the replication of block copolymer templates by poly(dimethylsiloxane) elastomers. Adv. Mater. 15, 811 (2003).
192. Benoit, D., Hawker, C. J., Huang, E., Lin, Z. q. & Russell, T. P. One-step formation of functionalized block copolymers. Macromolecules 33, 1505 (2000).
193. Xu, J., Xia, J., Wang, J., Shinar, J. & Lin, Z. Q. Quantum dots confined in nanoporous alumina membranes. Appl. Phys. Lett. 89, 133110 (2006).
194. Xu, J. et al. Organic-inorganic nanocomposites via directly grafting conjugated polymers onto quantum dots. J. Am. Chem. Soc. 129, 12828 (2007).
195. Wang, J. et al. A simple biphasic route to water soluble dithiocarbamate functionalized quantum dots. Chem. Mater., (submitted) (2008).
196. Granick, S., Lin, Z. Q. & Bae, S. C. Molecules squeezed and stroked. Nature 425, 467 (2003).
197. Bae, S. C., Lee, H. J., Lin, Z. & Granick, S. Chemical imaging in a surface forces apparatus: confocal Raman spectroscopy of confined poly(dimethylsiloxane). Langmuir 21, 5685 (2005).
198. Bae, S. C., Lin, Z. & Granick, S. Conjugated polymers aligned by confinement and shear. Macromolecules 38, 9275 (2005).
199. Hong, S. W. et al. Drying mediated pattern formation in a capillary-held oganometallic polymer solution. Chem. Mater. 17, 6223 (2005).
200. Xu, J. et al. Self-assembly of gradient concentric rings via solvent evaporation from a capillary bridge. Phys. Rev. Lett. 96, 066104 (2006).
201. Hong, S. W., Giri, S., Lin, V. S. Y. & Lin, Z. Q. Simple route to gradient concentric metal and metal oxide rings. Chem. Mater. 18, 5164 (2006).
202. Hong, S. W., Xu, J. & Lin, Z. Q. Template assisted formation of gradient concentric gold rings. Nano Lett. 6, 2949 (2006).
203. Hong, S. W., Xia, J., Byun, M., Zou, Q. & Lin, Z. Q. Mesoscale patterns formed by evaporation of a polymer solution in the proximity of a sphere on a smooth substrate: molecular weight and curvature effects. Macromolecules 40, 2831 (2007).
204. Hong, S. W., Xia, J. & Lin, Z. Q. Spontaneous formation of mesoscale polymer patterns in an evaporating bound solution. Adv. Mater. 19, 1413 (2007).
205. Xu, J., Xia, J. & Lin, Z. Q. Evaporation-induced self-assembly of nanoparticles from a sphere-on-flat geometry. Angew. Chem., Int. Ed. 46, 1860 (2007).
206. Schwartz, B. J. Conjugated polymers as molecular materials: How chain conformation and film morphology influence energy transfer and interchain interaction. Annu. Rev. Phys. Chem. 54, 141 (2003).
207. Burroughes, J. H., Bradley, D. D. C., Brown, A. R., Marks, R. N. & Mackay, K. Light-emitting-diodes based on conjugated polymers. Nature 347, 539 (1990).
208. Gustafasson, G. et al. Flexible light-emitting-diodes made from soluble conducting polymers. Nature 357, 477 (1992).
209. Ho, P. K. H. et al. Molecular-scale interface engineering for polymer light-emitting diodes. Nature 404, 481 (2000).
210. Friend, R. H. et al. Electroluminiscence in conjugated polymers. Nature 397, 121 (1999).
211. Bao, Z. N. & Campbell, S. Patterned multiple color polymer light-emitting diodes. Thin Solid Films 352, 239 (1999).
212. Bao, Z. N., Peng, Z. H., Galvin, M. E. & Chandross, E. A. Novel oxadiazole side chain conjugated polymers as single-layer light-emitting diodes with improved quantum efficiencies. Chem. Mater. 10, 1201 (1998).
213. Lee, T. W., Zaumseil, J., Bao, Z. N., Hsu, J. P. & Rogers, J. A. Organic light-emitting diodes formed by soft contact lamination. Proc. Natl. Acad. Sci. USA 101, 429 (2004).
214. Peng, Z. H., Bao, Z. N. & Galvin, M. E. Oxadiazole-containing conjugated polymers for light-emitting diodes. Adv. Mater. 10, 680 (1998).
215. Son, S., Dodabalapur, A., Lovinger, A. J. & Galvin, M. E. Luminescence enhancement by the introduction of disprder into poly(p-phenylene vinylene). Science 269, 376 (1995).
216. Bernards, D. A. et al. Organic light-emitting devices with laminated top contacts. Appl. Phys. Lett. 84, 3675 (2004).
217. Groenendaal, L. B., Jonas, F., Freitag, D., Pielartzik, H. & Reynolds, J. R. Poly(3,4-ethylenedioxythiophene) and its derivatives: past, present, and future. Adv. Mater. 12, 481 (2000).
218. Iyengar, N. A., Harrison, B., Duran, R. S., Schanze, K. S. & Reynolds, J. R. Morphology evolution in nanoscale light-emitting domains in MEH-PPV/PMMA blends. Macromolecules 36, 8978 (2003).
219. Smilowitz. L et al. Photoexcitation spectroscopy of conducting-polymer-C60 composites: photoinduced electron transfer. Phys. Rev. B. 47, 13835 (1993).
220. Sariciftci, N. S. et al. Semiconducting polymer-buckminsterfullerene heterojunctions: diodes, photodiodes, and photovoltaic cells. Appl. Phys. Lett. 62, 585 (1993).
221. Yu, G., Gao, J., Hummelen, J. C., Wudl, F. & Heeger, A. J. Polymer photovoltaic cells: enhanced efficiencies via a network of internal donor-acceptor heterojunctions. Science 270, 1789 (1995).
222. Yu, G. & Heeger, A. J. Charge separation and photovoltaic conversion in polymer composites with internal donor/acceptor heterojunctions. J. Appl. Phys. 78, 4510 (1995).
223. Halls, J. J. M., Pichler, K., Friend, R. H., Moratti, S. C. & Holmes, A. B. Exciton diffusion and dissociation in a poly(p-phenylenevinylene)/C60 heterojunction photovoltaic cell. Appl. Phys. Lett. 68, 3120 (1996).
224. Shaheen, S. E. et al. 2.5% efficient organic plastic solar cells. Appl. Phys. Lett. 78, 841 (2001).
225. Ago, H., Petritsch, K., Shaffer, M. S. P., Windle, A. H. & Friend, R. H. Composites of carbon nanotubes and conjugated polymers for photovoltaic devices. Adv. Mater. 11, 1281 (1999).
226. Coakley, K. M., Liu, Y. X., Goh, C. & McGehee, M. D. Ordered organic-inorganic bulk heterojunction photovoltaic cells. MRS Bulletin 30, 37 (2005).
227. Coakley, K. M., Liu, Y. X., McGehee, M. D., Findell, K. L. & Stucky, G. D. Infiltrating semiconducting polymers into self-assembled mesoporous titania films for photovoltaic applications. Adv. Funct. Mater. 13, 301 (2003).
228. Coakley, K. M. & McGehee, M. D. Conjugated polymer photovoltaic cells. Langmuir 16, 4533 (2004).
229. Coakley, K. M. & McGehee, M. D. Photovoltaic cells made from conjugated polymers infiltrated into mesoporous titania. Appl. Phys. Lett. 83, 3380 (2003).
230. Liu, J. S., Kadnikova, E. N., Liu, Y. X., McGehee, M. D. & Frechet, J. M. J. Polythiophene containing thermally removable solubilizing groups enhances the interface and the performance of polymer-titania hybrid solar cells. J. Am. Chem. Soc. 126, 9486 (2004).
231. Bao, Z. N. & Lovinger, A. J. Soluble regioregular polythiophene derivatives as semiconducting materials for field-effect transistors. Chem. Mater. 11, 2607 (1999).
232. Bao, Z. N., Rogers, J. A. & Katz, H. E. Printable organic and polymeric semiconducting materials and devices. J. Mater. Chem. 9, 1895 (1999).
233. Loo, Y. L. et al. Soft, conformable electrical contacts for organic semiconductors: High-resolution plastic circuits by lamination. Proc. Natl. Acad. Sci. USA 99, 10252 (2002).
234. Meng, H. et al. Oligofluorene-thiophene derivatives as high-performance semiconductors for organic thin film transistors. Chem. Mater. 15, 1778 (2003).
235. Xu, G. F., Bao, Z. N. & Groves, J. T. Langmuir-Blodgett films of regioregular poly(3-hexylthiophene) as field-effect transistors. Langmuir 16, 1834 (2000).
236. Blancheta, G. B., Loo, Y. L., Rogers, J. A., Gao, F. & Fincher, C. R. Large area, high resolution, dry printing of conducting polymers for organic electronics. Appl. Phys. Lett. 82, 463 (2003).
237. Lee, K. S., Blancheta, G. B., Gao, F. & Loo, Y. L. Direct patterning of conductive water-soluble polyaniline for thin-film organic electronics. Appl. Phys. Lett . 86, 074102 (2005).
238. Ng, M. K., Lee, D. C. & Yu, L. P. Molecular diodes based on conjugated diblock co-oligomer. J. Am. Chem . Soc. 41, 3598 (2002).
239. Ng, M. K. & Yu, L. P. Synthesis of amphiphilic conjugated diblock oligomers as molecular diodes. Angew. Chem. Int. Ed. 41, 3598 (2002).
240. McGehee, M. D. & Heeger, A. J. Semiconducting (conjugated) polymers as materials for solid-state lasers. Adv. Mater. 12, 1655 (2000).
241. Chen, L. et al. Highly sensitive biological and chemical sensors based on revisible fluorescence quenching in a conjugated polymer. Proc. Natl. Acad. Sci. USA 96, 12287 (1999).
242. Fan, C. H. et al. Beyond superquenching: hyper-efficient energy transfer from conjugated polymers to gold nanoparticles. Proc. Natl. Acad. Sci. USA 100, 6297 (2003).
243. Gaylord, B. S., Heeger, A. J. & Bazan, G. C. DNA detection using water-soluble conjugated polymers and peptide nucleic acid probes. Proc. Natl. Acad. Sci. USA 99, 10954 (2003).
244. Gaylord, B. S., Heeger, A. J. & Bazan, G. C. DNA hybridization detection with water-soluble conjugated polymers and chromophore-labeled single-stranded DNA. J. Am. Chem . Soc. 125, 896 (2003).
245. Harrison, B. S., Ramey, M. B., Reynolds, J. R. & Schanze, K. S. Amplified fluorescence quenching in a poly(p-phenylene)-based cationic polyelectrolyte. J. Am. Chem. Soc. 122, 8561 (2000).
246. Peter, K., Nilsson, R. & Inganas, O. Chip and solution detection of DNA hybridization using a luminescent zwitterioinic polythiophene derivative. Nature Mater. 2, 419 (2003).
247. Pinto, M. R. & Schanze, K. S. Amplified fluorescence sensing of protease activity with conjugated polyelectrolytes. Proc. Natl. Acad. Sci. USA 101, 7505 (2004).
248. Stork, M., Gaylord, B. S., Heeger, A. J. & Bazan, G. C. Energy transfer in mixtures of water-soluble oligomers: effect of charge, aggregation, and surfactant complexation. Adv. Mater. 14, 361 (2002).
249. de Gennes, P. G. Wetting: statics and dynamics. Rev. Mod. Phys. 57, 827 (1985).
250. Popov, Y. O. & Witten, T. A. Characteristic angles in the wetting of an angular region: deposit growth. Phys. Rev. E 68, 036306 (2003).
251. Cazabat, A. M., Heslot, F., Troian, S. M. & Carles, P. Fingering instability of thin spreading film driven by temperature gradient. Nature 346, 824 (1990).
252. Xie, R., Karim, A., Douglas, J. F., Han, C. C. & Weiss, R. A. Spinodal dewetting of thin polymer films. Phys. Rev. Lett. 81, 1251 (1998).
253. Reiter, G. Dewetting of thin polymer film. Phys. Rev. Lett. 68, 75 (1992).
254. Lambooy, P., Phelan, K. C., Haugg, O. & Krausch, G. Dewetting at the liquid-liquid interface. Phys. Rev. Lett. 76, 1110 (1996).
255. Qu, S. et al. Dewetting dynamics at a polymer-polymer interface. Macromolecules 30, 3640 (1997).
256. Higgins, A. M. et al. The timescale of spinodal dewetting at a polymer/polymer interface. Eur. Phys. J. E 8, 137 (2002).
257. Wang, C., Krausch, G. & Geoghegan, M. Dewetting at a polymer-polymer interface: film thickness dependence. Langmuir 17, 6269 (2001).
258. Morariu, M. D., Schaffer, E. & Steiner, U. Capillary instabilities by fluctuation induced forces. Eur. Phys. J 12, 375 (2003).
259. Lyushnin, A. V., Golovin, A. A. & Pismen, L. M. Fingering instability of thin evaporating liquid films. Phys. Rev. E 65, 021602 (2002).
260. Leizerson, I., Lipson, S. G. & Lyushnin, A. V. Finger instability in wetting-dewetting phenomena. Langmuir 20, 291 (2004).
261. Zhang, X. Y., Zhu, Y. X. & Granick, S. Hydrophobicity at a Janus interface. Science 295, 663 (2002).
262. Zhu, Y. X. & Granick, S. Limits of the hydrodynamic no-slip boundary condition. Phys. Rev. Lett. 88, 106102 (2002).
263. Zhu, Y. X. & Granick, S. Apparent slip of Newtonian fluids past adsorbed polymer layers. Macromolecules 35, 4658 (2002).
264. Zhu, Y. X. & Granick, S, No-slip boundary condition switches to partial slip when fluid contains surfactant. Langmuir 18, 10058 (2002).
265. Zhu, Y. X. & Granick, S. Rate-dependent slip of Newtonian liquid at smooth surfaces. Phys. Rev. Lett. 87, 096105 (2001).
266. Allemand, J. F., Bensimon, D., Jullien, L., Bensimon, A. & Croquette, V. PH-dependent specific binding and combing of DNA. Biophys. J. 73, 2064 (1997).
267. Michalet, X. et al. Dynamic molecular combing: stretching the whole human genome for high-resolution studies. Science 277, 1518 (1997).
268. Jing, J. P. et al. Automated high resolution optical mapping using arrayed, fluid-fixed DNA molecules. Proc. Natl. Acad. Sci. USA 95, 8046 (1998).
269. Gueroui, Z., Place, C., Freysingeas, E. & Berge, B. Observation by fluorescence microscopy of transciption on single combed DNA. Proc. Natl. Acad. Sci. USA 99, 6005 (2002).
270. Smalyukh, I. I., Zribi, O. V., Butler, J. C., Lavrentovich, O. D. & Wong, G. C. L. Structure and dynamics of liquid crystalline pattern formation in drying droplets of DNA. Phys. Rev. Lett. 96, 177801 (2006).
271. Homola, A. M., Israelachvili, J. N., McGuiggan, P. M. & Gee, M. L. Measurements of and relation between the adhesion and friction of 2 surfaces separated by molecularly thin liquid-films. J. Tribology 111, 675 (1989).
272. Peachey, J., Van Alsten, J. & Granick, S. Design of an apparatus to measure the shear response of ultrathin liquid films. Rev. Sci. Instrum. 62, 463 (1991).
273. Van Alsten, J. & Granick, S. Molecular tribometry of ultrathin liquid film. Phys. Rev. Lett. 61, 2570 (1988).
274. Van Alsten, J. & Granick, S. Origin of static friction in ultrathin liquid films. Langmuir 6, 876 (1990).
275. Girard, F., Antoni, M., Faure, S. & Steinchen, A. Evaporation and Marangoni driven convection in small heated water droplets. Langmuir 22, 11085 (2006).
276. Maruyama, N. et al. Mesoscopic patterns of molecular aggregates on solid substrates. Thin Solid Films 327-329, 854 (1998).
277. Francoisr, B., Ederle, Y. & Mathis, C. Honeycomb membranes made from C60(PS)6. Synth. Met. 103, 2362 (1999).
278. Srinivasarao, M., Collings, D., Philips, A. & Patel, S. Three-dimensionally ordered array of air bubbles in a polymer film. Science 292, 79 (2001).
279. Stenzel, M. H. Formation of regular honeycomb-patterned porous film by self-organization. Aust. J. Chem. 55, 239 (2002).
280. Barrow, M. S. et al. Physical characterisation of microporous and nanoporous polymer films by atomic force microscopy, scanning electron microscopy and high speed video microphotography. Spectroscopy 18, 577 (2004).
281. Hernandez-Guerrero, M., Davis, T. P., Barner-Kowollik, C. & Stenzel, M. H. Polystyrene comb polymers built on cellulose or poly(styrene-co-2-hydroxyethylmethacrylate) backbones as substrates for the preparation of structured honeycomb films. Eur. Polym. J. 41, 2264 (2005).
282. Alivisatos, A. P. Semiconductor clusters, nanocrystals, and quantum dots. Science 271, 933 (1996).
283. Brus, L. Chemical Approach to semiconductor nanocrystals. J. Phys . Chem . Solid 59, 459 (1998).
284. Murray, C. B., Norris, D. J. & Bawendi, M. G. Synthesis and characterization of nearly monodisperse CdE (E=sulfur, selenium, tellurium) semiconductor nanocrystallites. J. Am. Chem ., Soc. 115, 8706 (1993).
285. Peng, X. G., Schlamp, M. C., Kadavanich, A. V. & Alivisatos, A. P. Epitaxial growth of highly luminescent CdSe/CdS core/shell nanocrystals with photostability and electronic accessibility. J. Am. Chem . Soc. 119, 7019 (1997).
286. Colvin, V. L., Schlamp, M. C. & Alivisatos, A. P. Light-emitting diodes made from cadmium selenide nanocrystals and a semiconducting polymer. Nature 370, 354 (1994). Dabbousi, B. O., Bawendi, M. G., Onitsukaa, O. & Rubner, M. F. Electroluminescence from CdSe quantum-dot/polymer composites. Appl. Phys. Lett. 66, 1316 (1995).
288. Schlamp, M. C., Peng, X. & Alivisatos, A. P. Improved efficiencies in light emitting diodes made with CdSe(CdS) core/shell type nanocrystals and a semiconducting polymer. J. Appl. Phys . 82, 5837 (1997).
289. Gao, M. Y., Richter, B. & Kirstein, S. White-light electroluminescence from self-assembled Q-CdSe/PPV multilayer structures. Adv. Mater. 9, 802 (1997).
290. Gao, M. Y., Richter, B. & Kirstein, S. Electroluminescence and photoluminescence in CdSe/poly(p-phenylene vinylene) composite films. Synth. Met. 102, 1213 (1999).
291. Mattoussi, H. et al. Electroluminescence from heterostructures of poly(phenylene vinylene) and inorganic CdSe nanocrystals. J. Appl. Phys . 83, 7965 (1998).
292. Lee, J., Sundar, V. C., Heine, J. R., Bawendi, M. G. & Jensen, K. F. Full color emission from II-VI semiconductor quantum dot-polymer composite. Adv. Mater. 12, 1102 (2000).
293. Coe, S., Woo, W. K., Bawendi, M. & Bulovis, V. Electroluminescence from single monolayers of nanocrystals in molecular organic devices. Nature 420, 800 (2002).
294. Greenham, N. C., Peng, X. & Alivisatos, A. P. Charge separation and transport in conjugated-polymer/semiconductor-nanocrystal composites studied by photoluminescence quenching and photoconductivity. Phys. Rev. B. 54, 17628 (1996).
295. Huynh, W. U., Dittmer, J. J. & Alivisatos, A. P. Hybrid nanorod-polymer solar cells. Science 295, 2425 (2002).
296. Huynh, W. U., Dittmer, J. J., Libby, W. C., Whiting, G. L. & Alivisatos, A. P. Controlling the morphology of nanocrystal-polymer composites for solar cells. Adv. Funct. Mater. 13, 73 (2003).
297. Milliron, D. J., Alivisatos, A. P., Pitois, C., Edder, C. & Frechet, J. M. J. Electroactive surfactant designed to mediate electron transfer between CdSe nanocrystals and organic semiconductors. Adv. Mater. 15, 58 (2003).
298. Milliron, D. J., Gur, I. & Alivisatos, A. P. Hybrid organic-nanocrystal solar cells. MRS Bulletin 30, 41 (2005).
299. Wormser, P. & Gaudiana, R. in NCPV and solar program review meeting 307 (NREL, 2003).
300. Kang, Y. M., Park, N. G. & Kinm, D. W. Hybrid solar cells with vertically aligned CdTe nanorods and a conjugated polymer. Appl. Phys. Lett . 86, 113101 (2005).
301. Qi, D. F., Fischbein, M., Drndic, M. & Selmic, S. Efficient polymer-nanocrystal quantum-dot photodetectors. Appl. Phys. Lett . 86, 093103-093101 (2005).
302. Chan, W. C. W. & Nie, S. Quantum dot bioconjugates for ultrasensitive nonisotopic detection. Science 281, 2016 (1998).
303. Ishii, D. et al. Chaperonin-mediated stablization and ATP-triggered release of semiconductor nanoparticles. Nature 423, 2003 (2003).
304. Pathak, S., Choi, S. K., Arnheim, N. & Thompson, E. L. Hydroxylated quantum dots as luminescent probes for in situ hybridization. J. Am. Chem . Soc. 123, 4103 (2001).
305. Mattoussi, H. et al. Bioconjugation of highly luminescent colloidal CdSe—ZnS quantum dots with an engineered two-domain recombinant protein. Phys. Stat. Sol. (b) 224, 277 (2001).
306. Mattoussi, H. et al. Self-assembly of CdSe—ZnS quantum dot bioconjugates using an engineered recombination protein. J. Am. Chem . Soc. 122, 12142 (2000).
307. Medintz, I. L., Uyeda, H. T., Goldman, E. R. & Mattoussi, H. Quantum dot bioconjugates for imaging, labelling and sensing. Nature Mater. 4, 435 (2005).
308. Larson, D. R. et al. Water-soluble quantum dots for multiphoton fluorescence imaging in vivo. Science 300, 1434 (2003).
309. Santra, S., Yang, H., Holloway, P. H., Stanley, J. T. & Mericle, R. A. Synthesis of water-dispersible fluorescent, radio-opaque, and paramagnetic CdS: Mn/ZnS quantum dots: a multifunctional probe for bioimaging. J. Am. Chem . Soc. 127, 1656 (2005).
310. Alivisatos, A. P. The use of nanocrystals in biological detection. Nature Biotech. 22, 47 (2004).
311. Peng, X. G., Wilson, T. E., Alivisatos, A. P. & Schultz, P. G. Synthesis and isolation of a homodimer of cadmium selenide nanocrystals. Angew. Chem. Int. Ed. Engl. 36, 145 (1997).
312. Dabbousi, B. O. et al. CdSe(ZnS) core-shell quantum dots: synthesis and characterization of a size series of highly luminescent nanocrystallites. J. Phys . Chem. B 101, 9463 (1997).
313. Hines, M. A. & Guyot-Sionnest, P. Synthesis and characterization of strongly luminescing ZnS-capped CdSe nanocrystals. J. Phys . Chem . B 100, 468 (1996).
314. Komoto, A., Maenosono, S. & Yamaguchi, Y. Oscillating fluorescence in an unstable colloidal dispersion of CdSe/ZnS core/shell quantum dots. Langmuir 20, 8916 (2004).
315. Kortan, A. R. et al. Nucleation and growth of CdSe on ZnS quantum crystallite seeds, and vice versa, in inverse micelle media. J. Am. Chem . Soc. 112, 1327 (1990).
316. Kuno, M., Lee, J. K., Dabbousi, B. O., Mikulec, F. V. & Bawendi, M. G. The band edge luminescence of surface modified CdSe nanocrystallites: probing the luminescing state. J. Chem. Phys. 106, 9869 (1997).
317. Shi, Q., Wang, J. F., Wyrsta, M. D. & Stucky, G. D. Vesicle array-templated large-area silica surface patterns. J. Am. Chem . Soc. 127, 10154 (2005).
318. Yabu, H. & Shimomura, M. Simple fabrication of micro lens arrays. Langmuir 21, 1709 (2005).
319. Jones, C. D., Serpe, M. J., Schroeder, L. & Lyon, L. A. Microlens formation in microgel/gold colloid composite materials via photothermal patterning. J. Am. Chem. Soc. 125, 5292 (2003).
320. Kim, J. S., Serpe, M. J. & Lyon, L. A. Photoswitchable microlens arrays. Angew. Chem. Int. Ed. 44, 1333 (2005).
321. Wu, M. C. Micromachining for optical and optoelectronic systems. Proc. IEEE 85, 1833 (1997).
322. Yaegashi, M., Kinoshita, M., Shishido, A. & Ikeda, T. Direct fabrication of microlens arrays with polarization selectivity. Adv. Mater. 19, 801 (2007).
323. Nam, H. J., Jung, D.-Y., Yi, G.-R. & Choi, H. Close-packed hemispherical microlens array from two-dimensional ordered polymeric microspheres. Langmuir 22, 7385 (2006).
324. Chan, E. P. & Crosby, A. J. Fabricating microlens arrays by surface wrinkling. Adv. Mater. 18, 3238 (2006).
325. Lazzari, M. & Lopez-Quintela, M. A. Block copolymer as a tool for nanomaterials fabrication. Adv. Mater. 15, 1583 (2003).
326. Park, C., Yoon, J. & Thomas, E. L. Enabling nanotechnology with self assembled block copolymer patterns. Polymer 44, 6725 (2003).
327. Bockstaller, M. R., Mickiewicz, R. A. & Thomas, E. L. Block copolymer nanocomposites: perspectives for tailored functional materials. Adv. Mater. 17, 1331 (2005).
328. Hawker, C. J. & Russell, T. P. Block copolymer lithography: merging “bottom-up” with “top-down” processes. MRS Bulletin 30, 952 (2005).
329. Bates, F. S. & Fredrickson, G. H. Block copolymers-designer soft materials. Physics Today 52, 32 (1999).
330. De Rosa, C., Park, C., Thomas, E. L. & Lotz, B. Microdomain patterns from directional eutectic solidication and epitaxy. Nature 405, 433 (2000).
331. Yoon, J., Lee, W. & Thomas, E. L. Highly oriented thin-film Microdomain patterns of ultrahigh molecular weight block copolymers via directional solidification of a solvent. Adv. Mater. 18, 2691 (2006).
332. Segalman, R. A., Hexemer, A. & Kramer, E. J. Edge effects on the order and freezing of a 2D array of block copolymer spheres. Phys. Rev. Lett. 91, 196101 (2003).
333. Stein, G. E., Kramer, E. J., Li, X. & Wang, J. Single-crystal diffraction from two-dimensional block copolymer arrays. Phys. Rev. Lett. 98, 086101 (2007).
334. Malenfant, P. R. L., Wan, J., Taylor, S. T. & Manoharan, M. Self-assembly of an organic-inorganic block copolymer for nano-ordered ceramics. Nature Nanotech. 2, 43 (2007).
335. Hayward, R. C., Chmelka, B. F. & Kramer, E. J. Crosslinked poly(styrene)-block-poly(2-vinylpyridine) thin films as swellable templates for mesostructured silica and titania. Adv. Mater. 17, 2591 (2005).
336. Kim, S. O. et al. Epitaxial self-assembly of block copolymers on lithographically defined nanopatterned substrates. Nature 424, 411 (2003).
337. Daoulas, K. C. et al. Fabrication of complex three-dimensional nanostructures from self-assembling block copolymer materials on two-dimensional chemically patterned templates with mismatched symmetry. Phys. Rev. Lett. 96, 036104 (2006).
338. Edwards, E. W., Stoykovich, M. P., Solak, H. H. & Nealey, P. F. Long-range order and orientation of cylinder-forming block copolymers on chemically nanopatterned striped surfaces. Macromolecules 39, 3598 (2006).
339. Zhu, L. et al. Crystallization temperature-dependent crystal orientations within nanoscale confined lamellae of a self-assembled crystalline-amorphous diblock copolymer. J. Am. Chem . Soc. 122, 5957 (2000).
340. Du, P. et al. Additive-driven phase-selective chemistry in block copolymer thin films: the convergence of top-down and bottom-up approaches. Adv. Mater. 16, 953 (2004).
341. Stein, G. E. et al. Symmetry breaking of in-plane order in confined copolymer mesophases. Phys. Rev. Lett. 98, 158302 (2007).
342. Templin, M. et al. Organically modified aluminosilicate mesostructures from block copolymer phases. Science 278, 1795 (1997).
343. Ulrich, R., Du Chesne, A., Templin, M. & Wiesner, U. Nano-objects with controlled shape, size, and composition from black copolymer mesophases. Adv. Mater. 11, 141 (1999).
344. Huang, E., Rockford, L., Russell, T. P. & Hawker, C. J. Nanodomain control in copolymer thin films. Nature 395, 757 (1998).
345. Mansky, P. et al. Interfacial Segregation in Disordered Block Copolymers: Effect of Tunable Surface Potentials. Phys. Rev. Lett. 79, 237 (1997).
346. Cheng, J. Y., Mayes, A. M. & Ross, C. A. Nanostructure engineering by templated self-assembly of block copolymers. Nature Mater. 3, 823 (2004).
347. Kargupta, K. & Sharma, A. Templating of thin films induced by dewetting on patterned surfaces. Phys. Rev. Lett. 86, 4536 (2001).
348. Boiltau, M., Walheim, S., Mlynek, J., Krausch, G. & Steiner, U. Surface-induced structure formation of polymer blends on patterned substrates. Nature 391, 877 (1998).
349. xia, J. F., Wang, J., Lin, Z. Q., Qiu, F. & Yang, Y. L. Phase separation kinetics of polymer dispersed liquid crystals confined between two parallel walls. Macromolecules 39, 2247 (2006).
350. Wang, J. et al. Phase separation of polymer dispersed liquid crystals on chemically patterned substrate. Langmuir 23, 7411 (2007).
351. Misner, M. J., Skaff, H., Ernrick, T. & Russell, T. P. Directed deposition of nanoparticles using diblock copolymer. Adv. Mater. 15, 221 (2003).
352. Chen, X., Hirtz, M., Fuchs, H. & Chi, L. Fabrication of gradient mesostructures by langmuir-blodgett rotating transfer. Langmuir 23 (2007).
353. Temple, K. et al. Spontaneous vertical ordering and pyrolytic formation of nanoscopic ceramic patterns from poly(styrene-b-ferrocenylsilane). Adv. Mater. 15, 297 (2003).
354. Segalman, R. A. Patterning with block copolymer thin films. Mater. Sci. Eng. R 48, 191 (2005).
355. Thurn-Albrecht, T., DeRouchey, J., Russell, T. P. & Jaeger, H. M. Overcoming interfacial interactions with electric fields. Macromolecules 33, 3250 (2003).
356. Jeong, U. et al. Enhancement in the orientation of the microdomain in block copolymer thin films upon the addition of homopolymer. Adv. Mater. 16, 533 (2004).
357. Mansky, P., Liu, Y., Huang, E., Russell, T. P. & Hawker, C. J. Controlling polymer-surface interactions with random copolymer brushes. Science 275, 1458 (1997).
358. Kim, G. & Liber, M. Morphological development in solvent-cast polystyrene-polybutadiene-polystyrene (SBS) triblock copolymer thin films. Macromolecules 31, 2569 (1998).
359. Knoll, A. et al. Phase behavior in thin films of cylinder-forming block copolymers. Phys. Rev. Lett. 89, 035501 (2002).
360. Xuan, Y. et al. Morphology development of ultrathin symmetric diblock copolymer film via solvent vapor treatment. Macromolecules 37, 7301 (2004).
361. Chen, Y., Huang, H., Hu, Z. & He, T. Lateral nanopatterns in thin diblock copolymer films induced by selective solvents. Langmuir 20, 3805 (2004).
362. Zhao, J., Jiang, S., Ji, X., An, L. & Jiang, B. Study of the time evolution of the surface morphology of thin asymmetric diblock copolymer films under solvent vapor. Polymer 46, 6513 (2005).
363. Peng, J. et al. Morphologies in solvent-annealed thin films of symmetric diblock copolymer. J. Chem. Phys. 125, 064702 (2006).
364. Peng, J., Wei, Y., Wang, H., Li, B. & Han, Y. Solvent induced sphere development in symmetric diblock copolymer thin films. Macromol. Rapid Commun. 26, 738 (2005).
365. Peng, J. et al. Controlling the size of nanostructures in thin films via blending of block copolymers and homopolymers. J. Chem. Phys. 122, 114706 (2005).
366. Costa, A. C., Geoghegan, M., Vlcek, P. & Composto, R. J. Block copolymer adsorption from a homopolymer melt to silicon oxide: effects of nonadsorbing block length and anchoring block-substrate interaction. Macromolecules 36, 9897 (2003).
367. Niu, S. & Saraf, R. F. Stability of order in solvent-annealed block copolymer thin films. Macromolecules 36, 2428 (2003).
368. Kim, Y. S., Baek, S. J. & Hammond, P. T. Physical and chemical nanostructure transfer in polymer spin-transfer printing. Adv. Mater. 16, 581 (2004).
369. Faircloth, B., Rohrs, H., Tiberio, R., Ruoff, R. & Krchnavek, R. R. Bilayer, nanoimprint lithography. J. Vac. Sci. Technol. B 18, 1866 (2000).
370. Nugay, N. & Nugay, T. Inter polymer complexes of poly(methyl methacrylate)-block-poly(4-vinylpyridine) with polyacrylic acid and polyacrylic acid-block-poly(methyl methacrylate). Euro. Polym. J. 36, 1027 (2000).
371. Jing, J. et al. Automated high resolution optical mapping using arrayed, fluid-fixed DNA molecules. Proc. Natl. Acad. Sci. U.S.A. 95, 8046 (1998).
372. Brochard-Wyart, F., Martin, P. & Redon, C. Liquid/liquid dewetting. Langmuir 9, 3682 (1993).
373. Brochard-Wyart, F. & Daillant, J. Drying of solids wetted by thin liquid films. Can. J. Phys . 68, 1084 (1990).
374. Sharma, A. Relationship of thin film stability and morphology to macroscopic parameters of wetting in the apolar and polar system. Langmuir 9, 861 (1993).
375. Schaffer, E., Thurn-Albrecht, T., Russell, T. P. & Steiner, U. Electrohydrodynamic instabilities on polymer films. Europhys. Lett., 35 (2001).
376. Schaffer, E., Thurn-Albrecht, T., Russell, T. P. & Steiner, U. Electrically induced structure formation and pattern transfer. Nature 403, 874 (2000).
377. Churaev, N. V. Liquid and vapor flows in porous bodies: surface phenomena, Vol. (Gordon and Breach Science, University of Salford, UK, 2000).
378. Zhao, W. et al. Wetting properties of thin liquid polyethylene films. Phys. Rev. Lett. 70, 1453 (1993).
379. http://www.pwse.iastate.edu/about/about.html.
380. www.pse.umass.edu/mrsec/ret 2001.html.
381. www.pse.umass.edu/mrsec/ret 2002.html.
382. http://www.iacad.org.
383. http://www.nano.gov.
384. Roco, M. C. National Nanotechnology Initiative to advance broad societal goals. MRS Bulletin 28, 416 (2003).
385. http://www.eng.i astate.edu/explorer/.
386. Genalo, L. J., Athreya, K. A. & Dieterich, A. K. in Proceedings of the ASEE Annual Conference on CD-Session # 16921998).

### 5. Example 5

### Overview

A drop of semicrystalline polymer, poly(ethylene oxide) (PEO) solution was placed in a restricted geometry consisting of a sphere on a flat substrate (i.e., sphere-on-flat geometry). Upon solvent evaporation from the sphere-on-flat geometry, microscopic concentric rings of PEO with appropriate high molecular weight were produced via controlled, repetitive pinning (“stick”) and depinning (“slip”) cycles of the contact line. The evaporation-induced concentric rings of PEO exhibited a fibrillar-like surface morphology. Subsequent isothermal crystallization of rings at 40° C. and 58° C. led to the formation of multilayer of flat-on lamellae (i.e., spiral morphology). In between adjacent spirals, depletion zones were developed during crystallization, as revealed by AFM measurements. The present highly ordered, concentric PEO rings may serve as a platform to study cell adhesion and motility, neuron guidance, cell mechanotransduction, and other biological processes.

### Introduction

Drying droplets containing nonvolatile solutes (polymers, nanoparticles, single walled carbon nanotubes, etc.) on a solid surface have been utilized to yield self-assembled, dissipative structures. These structures, including polygonal network structures (Benard Cells),¹⁻⁴ fingering instabilities,^{5, 6} concentric “coffee rings”⁷⁻⁹ are, in general, irregular and far from equilibrium.¹⁰ Maximum evaporative loss of solvent at the edge of droplet triggers the accumulation of solutes and creates a local roughness, thus, the solutes transport to the edge and pin the contact line (i.e., “stick”), thereby forming a “coffee ring”⁷⁻⁹ The droplet then jerks (i.e., “slip”) to a new position and a new “coffee ring” is deposited. The pinning and depinning processes alternate as solvent evaporates and, ultimately, lead to the formation of concentric “coffee rings” that are governed by the competition between the capillary force and the pinning force. However, since the evaporation process is usually not controlled, stochastic concentric “coffee rings” are formed.⁷⁻⁹ Therefore, to utilize evaporation as a simple route to producing intriguing, well ordered structures, it is essential to control the evaporation flux, the solution concentration, the interfacial interaction between the solute and substrate, etc.

We have previously demonstrated that constrained evaporation (i.e., drying in a confined geometry to provide control over the solvent evaporation and associated capillary flow) can be utilized to produce concentric rings of amorphous polymers and nanoparticles of high regularity over a large area in one step.¹¹⁻¹⁹ A drop of amorphous polymer or nanoparticle solutions was confined either between two crossed cylinders covered with single crystals of mica sheets¹¹ or between a spherical lens and a Si substrate (i.e., sphere-on-flat geometry), forming a capillary-held solution (i.e., capillary edge).¹²⁻¹⁸ Experiments were performed inside a home-made chamber so that the evaporation rate of solvent was controlled and temperature gradient was eliminated. The evaporation in the sphere-on-flat geometry was restricted to the edge of droplet, the controlled, repeated “stick-slip” motion resulted in hundreds of concentric rings with regular spacing.¹²⁻¹⁹

Semicrystalline polymers, when cooled from the melt, can organize into microscopic crystalline structures (e.g., spherulites; they are optically anisotropic objects). Spherulites composed of splaying and branching thin lamellae with thickness on the order of 10 nm are often produced in thick films (h>1 μm),²⁰ where the crystallizable phase possesses a sufficient diffusivity, and thus an edge-on orientation is favorable (i.e., crystalline lamellae are perpendicular to the substrate).^{21, 22} Spiral structures, on the other hand, can be readily created in thinner films (h<300 nm), where the molecular mobility is reduced, and a flat-on orientation is dominated (i.e., crystalline lamellae are parallel to the substrate).^{21, 22, 21, 29} Recently, polymer crystallization has been exploited to develop crystallization-enabled nanotechnology.^{23, 24} It is of considerable interest to study polymer crystallization confined at the micro- or nanoscale, including in ultrathin films,²⁵⁻³² semicrystalline/amorphous polymer blends,³³ dewetting of semicrystalline polymer solutions,³⁴⁻³⁷ and semicrystalline block copolymers.³⁸⁻⁴⁰ Furthermore, the use of microscopic and/or nanoscopic patterned surfaces made it possible to examine the effects of confinement on the primary nucleation, crystal morphologies, crystal growth rates, and crystal orientations of semicrystalline polymers.⁴¹⁻⁴³

Here, we extend the nonvolatile solute to semincrystalline polymer, i.e., poly(ethylene oxide) (PEO). The choice of PEO was motivated by its widely known crystallization and melting behavior, low melting temperature, and simple chain conformation. We demonstrate that dynamic self-assembly of semicrystalline polymers in sphere-on-flat geometry allowed the formation of periodically ordered concentric rings, which was dependent on the molecular weight of PEO and the solution concentration. The rings were micrometers wide and a few hundred nanometers high. Subsequent isothermal crystallization of PEO concentric rings at the elevated temperatures (i.e., 40° C. and 58° C.) transformed the originally formed fibrillar-like morphology at room temperature into spiral morphology within a ring. In between adjacent spirals, depletion zones were developed during crystallization, as revealed by AFM measurements.

### Experimental Section

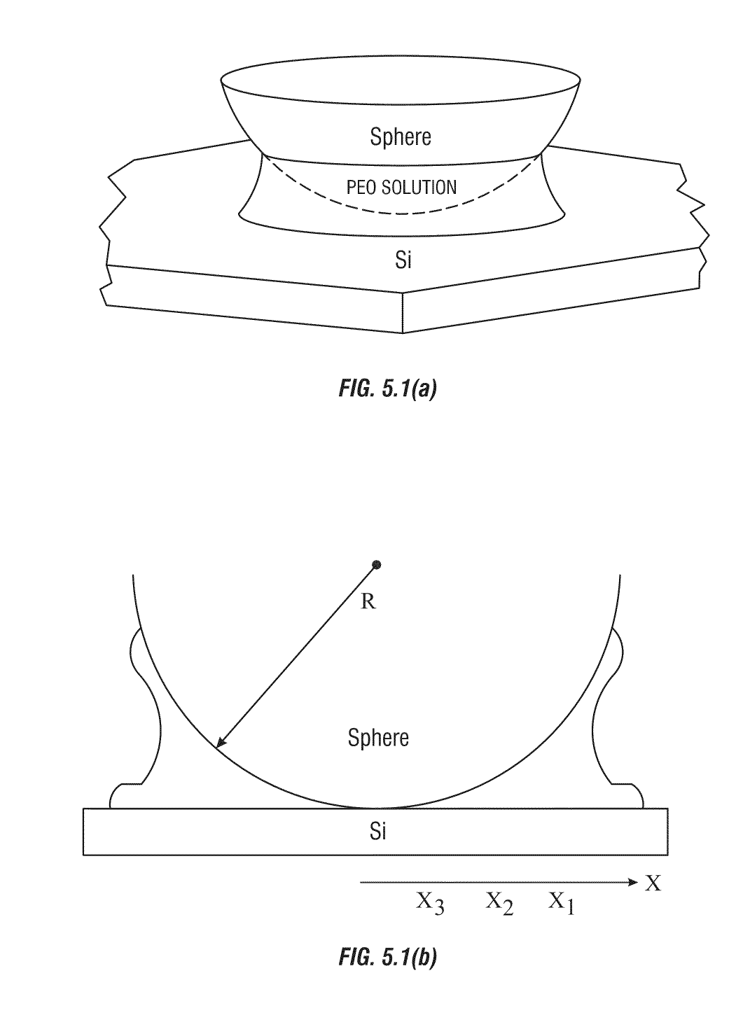

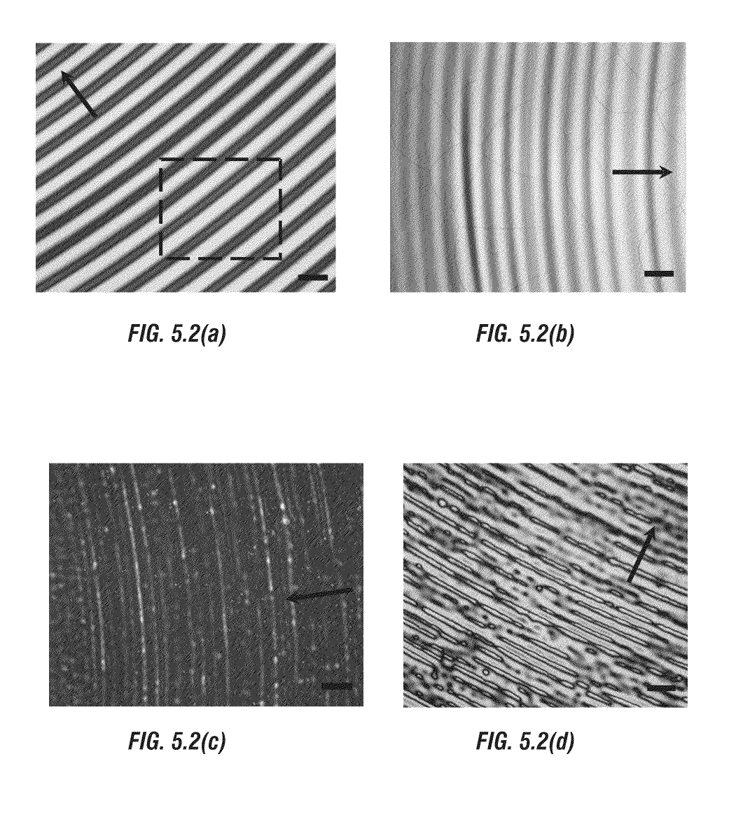

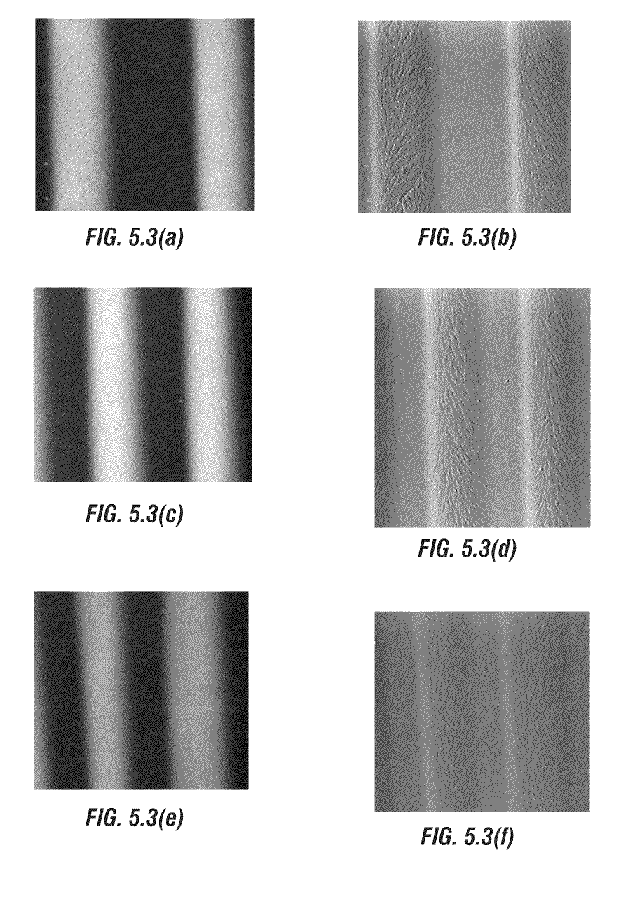

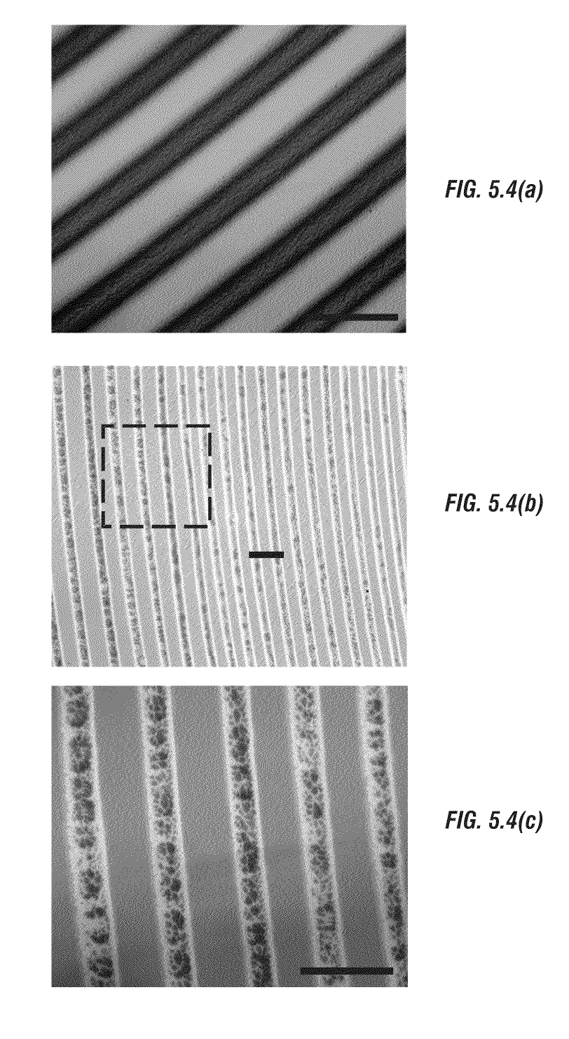

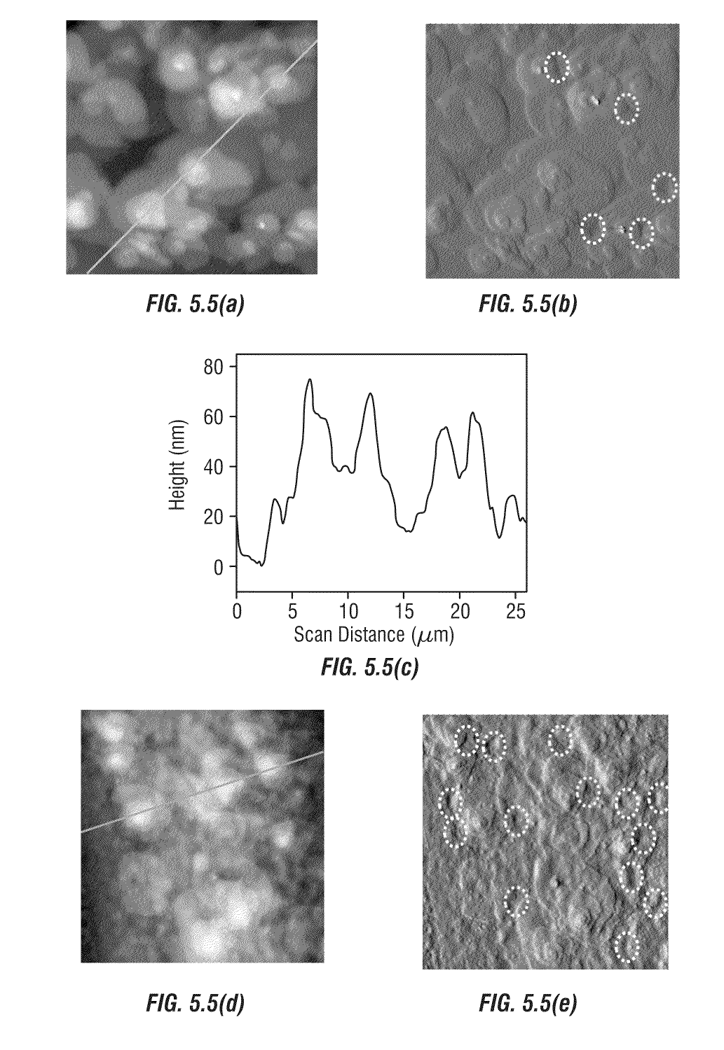

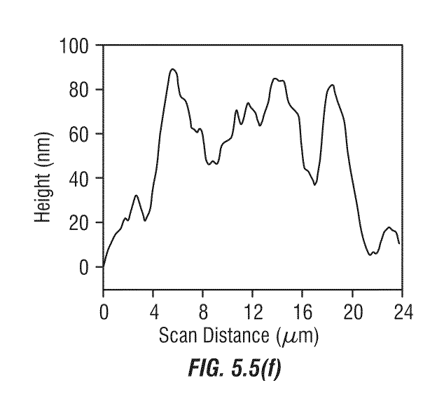

Materials. Two PEO with different molecular weight (MW) (Sigma-Aldrich) were used in the studies. The viscosity average MW, Mᵥ were 100 K and 600 K, and denoted PEO-100K and PEO-600K, respectively. These two PEO were dissolved in acetonitrile to prepare the PEO acetonitrile solutions at different concentrations (c=0.5 and 1.0 mg/ml). Subsequently, the solutions were purified with 0.2 μm hydrophilic membrane filters.
Sample Preparation. To construct a restricted geometry, a spherical lens and a Si wafer were used. The spherical lens made from fused silica with a radius of curvature, R˜2.0 cm, and Si substrate with [111] crystallographic orientation were cleaned by a mixture of sulfuric acid and Nonchromix™. Subsequently, they were rinsed with DI water and blow-dried with N₂. The sphere and Si were firmly fixed at the top and bottom of sample holders inside a sealed chamber, respectively. To implement a restricted geometry, an inchworm motor with a step motion of a few micrometers was used to place the upper sphere into contact with the lower stationary Si surface. Before they contacted (i.e., separated by approximately a few hundred micrometers apart), a drop of ˜23 μL PEO acetonitrile solutions were loaded and trapped within the gap between the sphere and Si due to the capillary force. The sphere was finally brought into contact with Si substrate by the inchworm motor such that a capillary-held PEO solution formed with evaporation rate highest at the extremity (FIG. 5.1). The use of a sealed chamber eliminated the possible external influences such as the humidity in an open space and air convection.

The evaporation took about half an hour to complete. Afterward, the sphere and Si were separated. The structures (e.g., concentric “coffee rings” composed of PEO) were produced on both the sphere and Si surfaces. Due to the curving effect of the sphere, only the patterns formed on Si were evaluated by the optical microscope (OM; Olympus BX51 in the reflection mode) and the atomic force microscopy (AFM; Dimension 3100 scanning force microscope in the tapping mode (Digital Instruments)). BS-tap300 tips (Budget Sensors) with spring constants ranging from 20 to 75N/m were used as scanning probes. Subsequently, all samples on Si substrates were transferred into a vacuum oven and kept for 12 h at room temperature to remove residual solvent from the patterns. The samples were then placed on the heat stage for isothermal annealing at certain temperature, as detailed in the following. The samples were heated up to 80° C. and held at that temperature for 30 min to ensure complete melting of PEO crystals. Subsequently, the melted PEO patterns were rapidly cooled to 40° C. and 58° C. (below melting temperature, Tₘ=65° C.), corresponding to high and low degree of supercooling, respectively, and allowed to isothermally crystallized at these temperatures for two days. Finally, the samples were quenched to room temperature and examined by OM and AFM to evaluate the effect of crystallization temperature on the surface morphology of the concentric PEO rings.

### Results and Discussion

### 1. Formation of Concentric “Coffee Rings” Composed of PEO

Semicrystalline polymer, PEO was chosen as the nonvolatile solute due to its widely known crystallization and melting behavior, low melting temperature, and simple chain conformation. FIG. 5.2 shows typical optical micrographs of PEO formed by drying the PEO acetonitrile solutions with different MW of PEO (PEO-100K and PEO-600K) and different solution concentrations (c=0.5 and 1.0 mg/ml for both PEO-100K and PEO-600K) from a sphere-on-flat geometry (i.e., from a bound solution as shown in FIG. 5.1). When high MW PEO was used (i.e., PEO-600K), microscopic concentric rings of PS-600K were obtained (FIG. 5.2a-b). It should be noted that only a small zone of the entire concentric ring pattern is shown in these images. The formation of concentric rings was resulted from controlled “stick-slip” cycles of the contact line, that is, the competition between the pinning force (“stick”) and depinning force (“slip”) toward the sphere/Si contact center with elapsed time as discussed in our previous work.^{12, 13, 16-18} The Marangoni flow was suppressed in the sphere-on-flat geometry.^{44, 45} The solution front was arrested at the capillary edge as acetonitrile evaporated (FIG. 5.1). The local viscosity of the contact line was then increased with time. This led to the solidification of a PEO-600K ring before the solution front jumped to the next position, where it was arrested again. Moreover, PEO is a hydrophilic molecule. The interfacial interaction between PEO and hydrophilic Si substrate is energetically favorable, thereby promoting the adsorption of PEO at the contact line. Taken together, distinct PEO rings were resulted in, and no PEO-600K was deposited between the rings (FIG. 5.2a; c=0.5 mg/ml). The center-to-center distance between adjacent rings, λ_{C-C} and the height of ring, h are 50 μm and 100 nm, respectively (FIG. 5.2a). It is worth noting that the microscopic concentric rings composed of semicrystalline polymers with well-defined lateral dimension can be readily produced by the evaporation-induced self-assembly in sphere-on-flat geometry, which dispenses with the need for lithography and external fields. This is in contrast with the micropatterning of semicrystalline polymer solution⁴⁶ or polymer melt,^{47, 48} in which micro- or nanomold (e.g., PDMS mold prepared by soft lithographyl⁴⁶) was used to pattern semicrystalline polymers.

In comparison to periodic concentric rings formed in sphere-on-flat geometry (FIG. 5.2a), highly irregular concentric rings were produced (data not shown) by allowing a drop of PEO solution to evaporate from a single surface (i.e., on a Si substrate, thereby forming an unbound droplet). The use of sphere-on-flat geometry in a sealed chamber eliminated the hydrodynamic instabilities and convection over the course of solvent evaporation (i.e., suppressing the Marangoni flow), thereby facilitating the formation of ordered structures.^{12, 13, 16-18} In marked contrast with the distinct concentric rings observed at c=0.5 mg/ml (FIG. 5.2a), self-assembly of semicrystalline PEO from c=1.0 mg/ml solution showed a connectivity between the adjacent concentric rings through the underlying continuous film (FIG. 5.2b). The impingement of crystals is clearly evident, represented as interconnected curves superimposed on the blue background of concentric rings (FIG. 5.2b).

Comparison of the optical micrographs of PEO surface morphologies obtained at different MW revealed that MW has a marked effect on the ring pattern formation. In the case of low MW PEO (PEO-100K) used at both c=0.5 mg/ml and 1.0 mg/ml, ring-like patterns superimposed on a continuous film were yielded. These observations suggested that the depinning force (i.e., capillary force) was not strong enough to cause the three-phase contact line to jump to a new position inward.¹³ It cannot completely overcome the pinning force exerted by the deposition of PEO-100K. Thus, a rather continuous film of PEO-100K was formed. It is noteworthy that, as a model system for studying polymer crystallization, low MW PEO with MW in the range of 1000-10,000 has been widely utilized for several decades.^{49, 50} Although the use of low MW PEO generally produces pretty crystals (e.g., square-shaped crystals and finger-like crystals), in the present study no clear concentric rings were produced when it was used as the nonvolatile solute (i.e., MW<100 K).

To explore the details of polymer crystals within microscopic rings, AFM measurements were performed only on the PEO-600K rings obtained from dynamic self-assembly of the 0.5 mg/ml PEO-600K acetonitrile solution (FIG. 5.2a). Locally, the rings appeared as parallel stripes. As the solution front moved toward the sphere/Si contact center due to evaporative loss of acetonitrile, the center-to-center distance between adjacent PEO-600K rings, λ_{C-C} and the height of ring, h decreased progressively from λ_{C-C}=50.31 μm and h=100.27 nm at X₁ (FIG. 5.3a) to λ_{C-C}=37.03 μm and h=76.40 nm at X₂ (FIG. 5.3c) to λ_{C-C}=33.29 μm and h=71.24 nm at X₃ (FIG. 5.3e), where X is the distance away from the sphere/Si contact center, as depicted in FIG. 5.1. So it is clear that concentric PEO-600K rings were gradient in spacing and height. The measurements revealed the formation of fibrillar-like crystals (FIG. 5.3). This contrasts with featureless surface morphology within the ring when amorphous polymers were used.¹³⁻¹⁷ The evaporative loss of acetonitrile at the capillary edge triggered the accumulation of PEO and generated a local roughness to pin the contact line, during which PEO crystallization took place. However, due to relatively quick solvent evaporation (the boiling point of acetonitrile is 81.6° C.), the PEO crystals were trapped in the meta-stable state, leading to the formation of PEO fibrillae inside the ring (FIG. 5.3). Notably, PEO fibrillae were oriented, to some extent, along the rings (i.e., parallel to the edge of rings) (FIG. 5.3b, d, and f).

### 2. Morphological Changes of Crystallized PEO in the Ring Pattern.

Isothermal annealing at 40° C. and 58° C. were performed only on PEO-600K sample in which highly ordered concentric rings were obtained from 0.5 mg/ml acetonitrile solution (FIG. 5.2a and 5.3). The optical micrographs of PEO rings before and after isothermal crystallization are shown in FIG. 5.4. Although the integrity of originally formed ring patterns (FIG. 5.2a and 5.4a) was retained after annealing (FIG. 5.4b-c), surface topology of individual ring was altered. The fibrillar-like morphology formed from the solution state via evaporation-induced self-assembly process (FIG. 5.4a: a close-up of FIG. 5.2a) transformed into patch-like surface patterns (FIG. 5.4c: a close-up of FIG. 5.4b). In particular, AFM measurements revealed that the crystalline fibrillae tuned into multilayer of crystals (i.e., forming spiral structures), presumably formed via screw dislocation, when isothermally crystallized from the molten state to 40° C. and 58° C., as evidenced in FIG. 5.5. Within a spiral, the lamellar crystals were oriented parallel to the substrate (FIG. 5.5), which is more thermodynamically stable.⁴⁹ This flat-on lamellar orientation was due to annealing-induced film thickness reduction. It is well-known that crystallization in thicker film often exhibits a spherulite morphology, consisting of lamellae grow radially from a nucleation center.⁴⁷ As film thickness decreases, a transition to spiral structures are often resulted in due to restricted chain mobility.^{26, 30, 31} In the present study, the average width, w and height, h of originally formed rings were 26.25 μm and 100.27 nm respectively (FIG. 5.4a). After annealing, the values changed to 28.48 μm and 67.67 nm, respectively (FIG. 5.4b-c and FIG. 5.5a-c), thus facilitating the spiral structure formation.

The morphology of isothermally crystallized PEO-600K at 40° C. and 58° C. inside the ring showed difference in the density of nucleation sites. Since high MW PEO was used, which makes it difficult to grow into bigger crystals, the size of spiral structures (FIG. 5.5) was small as compared to the crystals formed from low MW counterparts. The PEO spirals are randomly dispersed within the microscopic rings. This is due to the fact that the nucleation number and sites were hard to control in polymer crystallization, and the width of microscopic ring was large, thereby imposing no confinement effect on the crystal growth. In the crystallization of polymer thin film insufficient transport of crystallizable molecules, in general, leads to the formation of depletion zones at the crystal front.^{26, 30, 31, 35} In the present study the depletion zones, as marked in FIG. 5.5, were caused by the diffusion of PEO chains to the fold surfaces of the flat-on lamellae and the specific volume decrements between the melt and crystals.⁵¹ The number of nucleation sites at 40° C. were more than that at 58° C., which in turn resulted in more depletion zones (FIG. 5.5d-e). High supercooling (i.e., low crystallization temperature at 40° C.) tended to activate the nucleation rate and retarded the chain diffusion rate, eventually giving rising to a considerable number of the depletion zones. In contrast, low supercooling (i.e., high crystallization temperature at 58° C.) promoted a higher diffusion rate and thus formed relatively fewer nucleation sites. The root mean square (rms) surface roughness of PEO crystals obtained from isothermal annealing at 40° C. and 58° C. were 22.25 nm and 16.06 nm, respectively.

### Conclusion

The confined, axial symmetric geometry (i.e., sphere-on-flat geometry) provided unique environment for controlling the flow within the evaporating droplet, which, in turn, regulated the formation of concentric rings of a semicrystalline polymer, PEO. The formation of distinct microscopic rings depended on the MW and the solution concentration. Upon the completion of solvent evaporation, a continuous PEO thin film was left behind at low MW, while at high MW concentric PEO rings of high regularity were produced.

Subsequent isothermal crystallization of ring patterns transformed originally formed fibrillar-like PEO crystals into spirals as a result of the reduction in height of the rings by annealing. The formation of spiral terraces suggested a flat-on orientation of the lamellae. A high supercooling of PEO (corresponding to low crystallization temperature, T=40° C.) generated more depletion zones than a low supercooling counterpart (T=58° C.). We envisage that, by applying the upper spherical lens with a larger radius of curvature,¹⁶ concentric rings of PEO with much smaller width (a few micron or submicron) and height (tens of nanometers or a few nanometers) could be produced in such a dimension that is comparable to lateral size of a PEO spiral. Thus, hierarchically ordered structures may be anticipated, in which only a single row of PEO spirals are allowed to form, and they are adjacent to one another residing along a ring in a concentric ring mode. Since the confinement imposed by the width of the ring may dramatically affect the nucleation and growth of crystals, crystal morphology, and crystal orientation, some intriguing surface morphologies other than spirals may also form. This work is currently under investigation. PEO is a biocompatible polymer suitable for biological application since surfaces covered with PEO have shown to be non-antigenic, non-immunogenic, and protein resistant. Therefore, the present highly ordered concentric PEO rings may serve as a platform to study cell adhesion and motility, neuron guidance, cell mechanotransduction, and other biological processes.^{53, 54}

### Figure Captions

FIG. 5.1. (a) Three dimensional illustration of a drop of semicrystalline polymer (i.e., PEO) acetonitrile solution trapped between a sphere and a Si substrate (i.e., a sphere-on-flat geometry). (b) Cross section of the capillary-held PEO solution in (a). The radius of curvature of the upper sphere is R. The concentric rings were formed by controlled, repetitive “stick-slip” motion of the contact line. The distance of rings away from the sphere/Si contact center is X. (a) ring formed at outermost region (i.e., X₁), (b) ring formed at intermediate region (i.e., X₂), and (c) ring formed at innermost region (i.e., X₃).

FIG. 5.2. Optical micrographs of PEO concentric ring patterns formed at intermediate region (i.e., X₂) from PEO-600K acetonitrile solution at (a) c=0.5 mg/ml, (b) c=1.0 mg/ml, respectively, and from PEO-100K acetonitrile solution at (c) c=0.5 mg/ml, (d) c=1.0 mg/ml, respectively. The arrow indicates the movement of solution front toward the center of the sphere/Si contact. Scale bar=70 μm.

FIG. 5.3. AFM images (height images: a, c, and e; phase images: b, d, f) of concentric rings produced from the drying-mediated self-assembly of the 0.5 mg/ml PEO-600K acetonitrile solution at room temperature. As solution front progressed toward the sphere/Si contact center, the center to center distance between adjacent rings, λ_{C-C} was reduced. (a-b) outermost region (i.e., X₁); (c-d) intermediate region (i.e., X₂); and (e-f) innermost region (i.e., X₃). The image size is 80×80 μm².

FIG. 5.4. Optical micrographs of concentric PEO-600K rings (a) before (i.e., at room temperature) and (b-c) after isothermal crystallization at 58° C. The PEO rings were formed from the 0.5 mg/ml PEO-600K acetonitrile solution. Optical micrographs of (a) and (c) are the close-ups of the black boxes in FIG. 5.2a and FIG. 5.4b, respectively. Scale bar=70 μm.

FIG. 5.5. Surface morphologies of PEO crystals in a microscopic PEO-600K ring. (a-b) AFM height and phase images of spiral structures of PEO crystals after isothermal annealing at 58° C. The section analysis of PEO crystal is shown in (c). (d-e) AFM height and phase images of spiral structures of PEO crystals after isothermal annealing at 40° C. The section analysis of PEO crystal is shown in (f). The image size is 20×20 μm².

### REFERENCES FOR EXAMPLE 5

1. Nguyen, V. X.; Stebe, K. J. Phys. Rev. Lett. 2002, 88, 164501.
2. Maillard, M.; Motte, L.; Pileni, M. P. Adv. Mater. 2001, 13, 200.
3. Bormashenko, E.; Pogreb, R.; Stanevsky, O.; Bormashenko, Y.; Stein, T.; Gaisin, V.-Z.; Cohen, R.; Gendelman, O. V. Macromol. Mater. Eng. 2005, 290, 114.
4. Grigoriev, R. O. Phys. Fluids 2002, 14, 1895.
5. Karthaus, O.; Grasjo, L.; Maruyama, N.; Shimomura, M. Chaos 1999, 9, 308.
6. Cazabat, A. M.; Heslot, F.; Troian, S. M.; Carles, P. Nature 1990, 346, 824.
7. Deegan, R. D.; Bakajin, O.; Dupont, T. F.; Huber, G.; Nagel, S. R.; Witten, T. A. Nature 1997, 389, 827.
8. Deegan, R. D. Phys. Rev. E 2000, 61, 475.
9. Deegan, R. D.; Bakajin, O.; Dupont, T. F.; Huber, G.; Nagel, S. R.; Witten, T. A. Phys. Rev. E 2000, 62, 756.
10. Rabani, E.; Reichman, D. R.; Geissler, P. L.; Brus, L. E. Nature 2003, 426, 271.
11. Lin, Z. Q.; Granick, S. J. Am. Chem . Soc. 2005, 127, 2816.
12. Hong, S. W.; Xu, J.; Xia, J.; Lin, Z. Q.; Qiu, F.; Yang, Y. L. Chem. Mater. 2005, 17, 6223.
13. Xu, J.; Xia, J.; Hong, S. W.; Lin, Z. Q.; Qiu, F.; Yang, Y. L. Phys. Rev. Lett. 2006, 96, 066104.
14. Hong, S. W.; Giri, S.; Lin, V. S. Y.; Lin, Z. Q. Chem. Mater. 2006, 18, 5164.
15. Hong, S. W.; Xu, J.; Lin, Z. Q. Nano Lett . 2006, 6, 2949.
16. Hong, S. W.; Xia, J.; Byun, M.; Zou, Q.; Lin, Z. Q. Macromolecules 2007, 40,
17. Hong, S. W.; Xia, J.; Lin, Z. Q. Adv. Mater. 2007, 19, 1413.
18. Xu, J.; Xia, J.; Lin, Z. Q. Angew. Chem., Int. Ed. 2007, 46, 1860.
19. Wang, J.; Xia, J.; Hong, S. W.; Qiu, F.; Yang, Y.; Lin, Z. Q. Langmuir 2007, 23,
20. Hu, Z. J.; Baralia, G.; Bayot, V.; Gohy, J. F.; Jonas, A. M. Nano Lett . 2005, 5,
21. Wunderlich, B. Academic Press: New York 1976.
22. Langer, J. S. Rev. Mod. Phys. 1980, 52, 1.
23. Li, B.; Li, C. Y. J. Am. Chem . Soc. 2007, 129, 12.
24. Li, L.; Yang, Y.; Yang, G.; Chen, X.; Hsiao, B. S.; Chu, B.; Spanier, J. E.; Li, C. Y. Nano Lett . 2006, 6.
25. Pearce, R.; Vancso, G. J. Macromolecules 1997, 30, (19), 5843.
26. Schultz, J. M.; Miles, M. J. J. Polym. Sci. Part B Polym. Phys. 1998, 36, 2311.
27. Chen, E. Q.; Xue, G.; Jin, S.; Lee, S. W.; Mann, I.; Moon, B. S.; Harris, F. W.; Cheng, S. Z. D. Macromol. Rapid Comm. 1999, 20, 431.
28. Dalnoki-Veress, K.; Forrest, J. A.; Massa, M. V.; Pratt, A.; Williams, A. J. Polym. Sci. Part B-Polym. Phys. 2001, 39, 2615.
29. Beekmans, L. G. M.; van der Meer, D. W.; Vancso, G. J. Polymer 2002, 43, 1887.
30. Schonherr, H.; Frank, C. W. Macromolecules 2003, 36, 1188.
31. Schonherr, H.; Frank, C. W. Macromolecules 2003, 36, 1199.
32. Chen, E. Q.; Jing, A. J.; Weng, X.; Huang, P.; Lee, S. W.; Cheng, S. Z. D.; Hsiao, B. S.; Yeh, F. J. Polymer 2003, 44, 6051.
33. Ferreiro, V.; Douglas, J. F.; Warren, J. A.; Karim, A. Phys. Rev. E 2002, 65, 0428021.
34. Reiter, G. Phys. Rev. Lett. 2001, 87, 1861011.
35. Reiter, G.; Sommer, J. U. Phys. Rev. Lett. 1998, 80, 3771.
36. Massa, M. V.; Carvalho, J. L.; Dalnoki-Veress, K. Phys. Rev. Lett. 2006, 97, 247802.
37. Massa, M. V.; Dalnoki-Veress, K. Phys. Rev. Lett. 2004, 92.
38. Loo, Y. L.; Register, R. A.; Ryan, A. J. Phys. Rev. Lett. 2000, 84, 4120.
39. Reiter, G.; Castelein, G.; Sommer, J.; Rottele, A.; Thurn-Albrecht, T. Phys. Rev. Lett. 2001, 87, 226101.
40. Chen, W. Y.; Li, C. Y.; Zheng, J. X.; Huang, P.; Zhu, L.; Ge, Q.; Quirk, R. P.; Lotz, B.; Deng, L. F.; Wu, C.; Thomas, E. L.; Cheng, S. Z. D. Macromolecules 2004, 37, 5292.
41. Despotopoulou, M. M.; Frank, C. W.; Miller, R. D.; Rabolt, J. F. Macromolecules 1996, 29, 5797.
42. Beers, K. L.; Douglas, J. F.; Amis, E. J.; Karim, A. Langmuir 2003, 19, 3935.
43. Steinhart, M.; Goring, P.; Dernaika, H.; Prabhukaran, M.; Gosele, U.; Hempel, E.; Thurn-Albrecht, T. Phys. Rev. Lett. 2006, 97, 027801.
44. Hu, H.; Larson, R. G. J. Phys . Chem . B 2006, 110, 7090.
45. Hu, H.; Larson, R. G. Langmuir 2005, 21, 3963.
46. Park, Y. J.; Kang, Y. S.; Park, C. Eur. Polym. J. 2005, 41, 1002.
47. Okerberg, B. C.; Soles, C. L.; Douglas, J. F.; Ro, H. W.; Karim, A.; Hines, D. R. Macromolecules 2007, 40, 2968.
48. Hu, Z.; Baralia, G.; Bayot, V.; Gohy, J.-F.; Jonas, A. M. Nano Lett . 2005, 5, 1738.
49. Huang, Y.; Liu, X.; Zhang, H. L.; Zhu, D. S.; Sun, Y.; Yan, S.; Wang, J.; Chen, X. F.; Wan, X. H.; Chen, E. Q.; Zhou, Q. F. Polymer 2006, 47, 1217.
50. Cheng, S. Z. D.; Lotz, B. Philos. Trans. R. Soc. London A 2003, 361, 517.
51. Wang, Y.; Chan, C.-M.; Li, L.; Ng, K.-M. Langmuir 2006, 22, 7384.
52. Nikolic, M. S.; Krack, M.; Aleksandrovic, V.; Kornowski, A.; Forster, S.; Weller, H. Angew. Chem. Int. Ed. 2006, 45, 6577.
53. Chen, X.; Hirtz, M.; Fuchs, H.; Chi, L. Langmuir 2007, 23.
54. Kumar, G.; Ho, C. C.; Co, C. C. Adv. Mater. 2007, 19, 1084.

### 6. Example 6

### Overview

The use of spontaneous self-assembly as a lithography- and external fields-free means to construct well-ordered, often intriguing structures has received many attentions due to the ease of producing complex structures with small feature sizes. Self-assembly via irreversible solvent evaporation of a droplet containing nonvolatile solutes (polymers, nanoparticles, and colloids) represents one such case.¹⁻⁶ Recently, self-organized gradient concentric ring patterns have been produced by constraining a drop of polymer solution in a confined geometry composed of either two cylindrical mica surfaces placed at a right angle to one another or a sphere on a flat surface.⁷⁻⁹ Rather than allowing the solvent to evaporate over the entire droplet area as in the traditional approach, in which droplets evaporate from a single surface,¹⁻³ the evaporation is restricted at the droplet edges.⁷⁻⁹ The concentric rings are formed by controlled, repetitive pinning and depinning of the contact line (i.e., “stick-slip” motion).⁷⁻⁹

### Discussion

Ring structures have some unique features compared to their linear counterpart of the same size. For example, persistent currents can be induced by magnetic fields in conducting rings.¹⁰ The ability to produce ring structures consisting of metals has been demonstrated on many occasions. Mesoscopic gold rings have been prepared via filling the porous membrane with a solution of gold precursor followed by calcination.^{10, 11} Highly ordered honeycomb-structured gold nanoparticles films with both circular and ellipitic pores have been fabricated in the presence of moist air flowing across the surface of the solution.¹² However, to the best of our knowledge, no well-ordered concentric rings (i.e., multi-rings) based on metal and metal oxide have been reported. The rings organized in a concentric mode many offer possibilities for many applications, including annular Bragg resonators for advanced optical communications systems.¹³

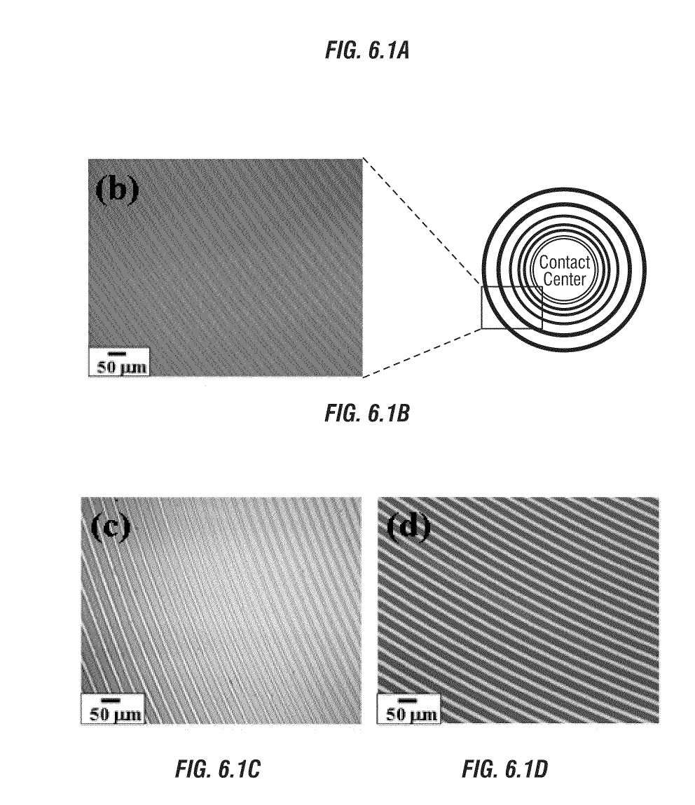

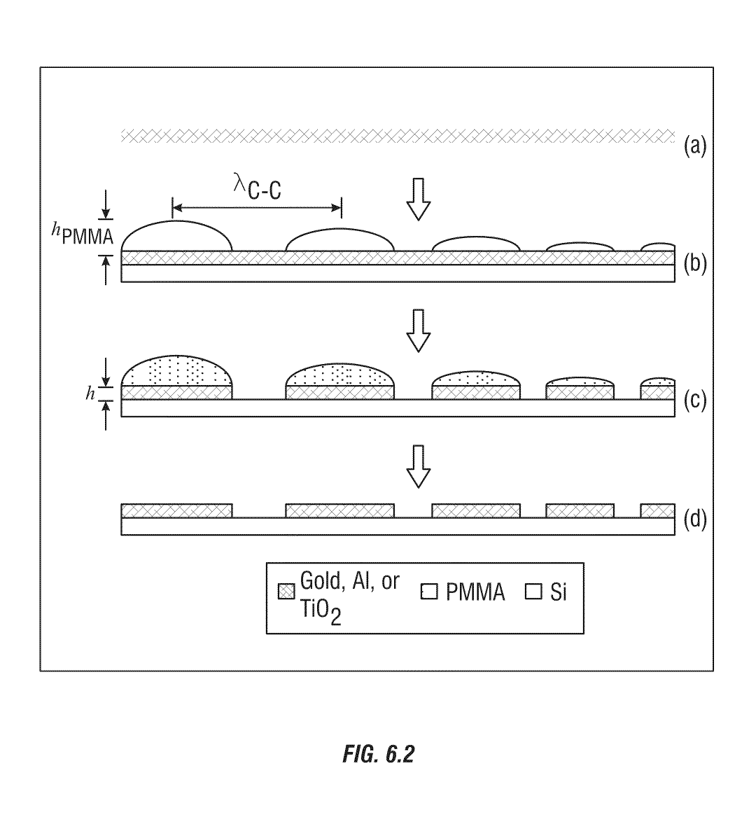

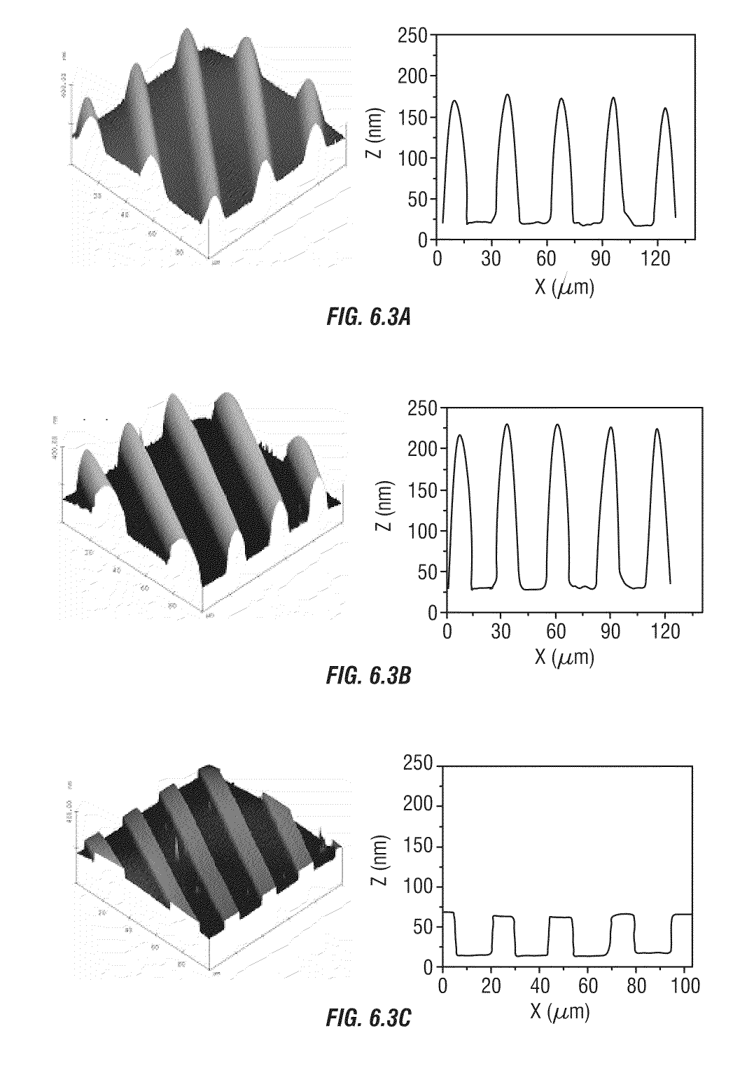

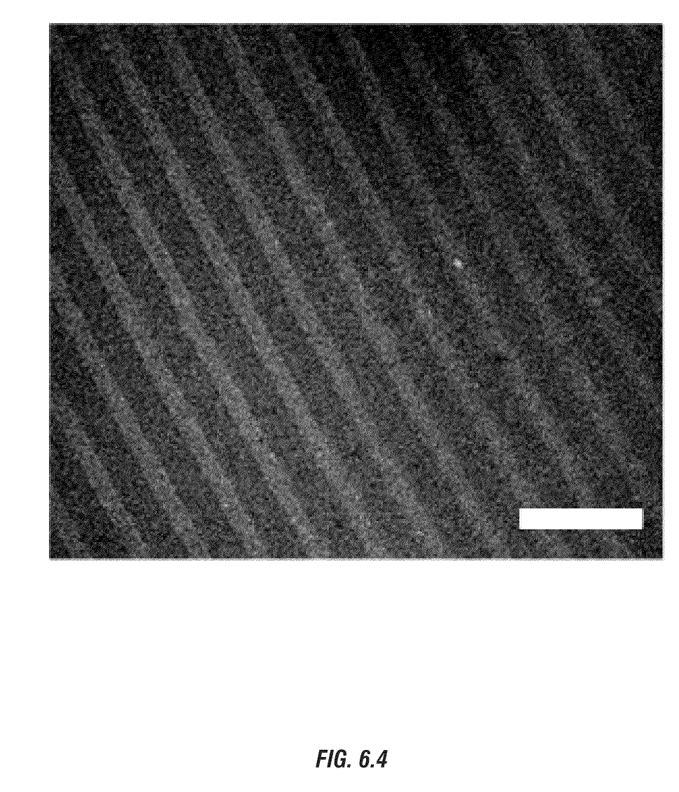

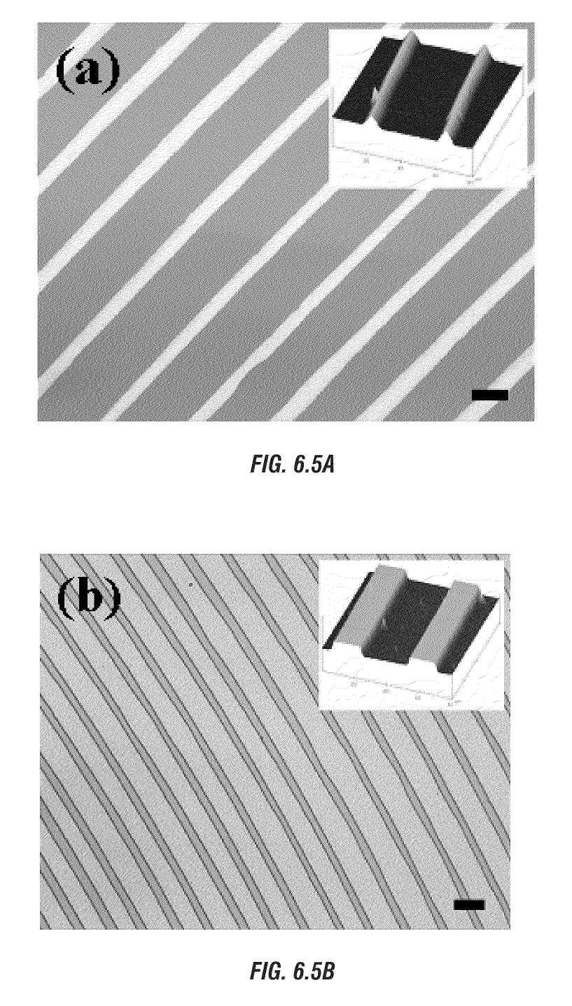

Herein, we report on a simple route to concentric rings of metals or metal oxide. The gradient concentric polymer rings with unprecedented regularity were self-organized on metals-(or metal oxide-) coated Si substrate via the evaporation-induced dynamic self-assembly of polymer in a confined geometry (FIG. 6.1a). Subsequently, the rings were utilized as templates for the preparation of ordered metal or metal oxide rings by removing metal or metal oxide between polymer rings, followed by eliminating polymer rings as depicted in FIG. 6.2. This method is fast and cost-effective, dispensing with the need for lithography and external electric fields. Moreover, there is no restriction on metal and metal oxide materials that can be used for the formation of concentric rings.

A thick layer of gold (Au; 45 nm), aluminum (Al; 1 μm), or titania (TiO₂; 140 nm) was thermally deposited on Si substrates. To ensure good adhesion between Au (or Al) and Si, a 2-nm thick TiO₂ was firstly evaporated on Si substrates. To construct a sphere-on-Si geometry inside a chamber, a spherical lens made from fused silica with a radius of ˜1 cm and an abovementioned metal-(or metal oxide-) coated Si were used. Both sphere and Si were firmly fixed at the top and the bottom of sample holders in the chamber, respectively. To implement a confined geometry, an inchworm motor with a step motion of a few micrometers was used to place the upper sphere into contact with the lower stationary Si substrate. Before they contacted (i.e., separated by approximately a few hundred micrometers apart), 23 μl poly(methyl methacrylate) (PMMA; number average molecular weight, Mₙ=534 kg/mole and polydispersity, PDI=1.57) toluene solution (c=0.25 mg/ml on Au-coated Si and c=1.0 mg/ml on Al- and TiO₂-coated Si) was loaded and trapped within the gap between the sphere and Si due to the capillary force. The sphere was finally brought into contact with Si substrate by the inchworm motor such that a capillary-held PMMA solution forms with evaporation rate highest at the extremity as schematically illustrated in FIG. 6.1a.

The evaporation of toluene at the capillary edge simply triggered the pinning of the contact line (i.e., “stick” and forming the first ring).¹ This led to an outward flow that carried nonvolatile PMMA to the edge.¹ During the deposition of PMMA, the initial contact angle of the capillary edge decreased gradually due to the evaporative volume loss of toluene to a critical angle at which the capillary force (depinning force) becomes larger than the pinning force.⁹ This caused the jump of the contact line (i.e., “slip”) to a new position at which a new ring developed.^{3, 8, 9} Repetitive deposition and recession cycles of the contact line in the sphere-on-Si geometry resulted in the formation of periodic concentric rings of PMMA (left panel in FIG. 6.1b in which an Au-coated Si substrate was used). The center to center distance, λ_{C-C} between PMMA rings (left panel in FIG. 6.1b) and height of the ring, h decreased with increased proximity to the center of sphere/Si contact (i.e., Contact Center in FIG. 6.1b), attributing to the competition between linear pinning force and nonlinear capillary force.⁹ It is noteworthy that to form a periodic family of concentric ring patterns of PMMA, the solvent evaporation must be homogenous. This was realized by applying a symmetric geometry (sphere-on-Si) in conjunction with the use of sealed chamber that eliminate the hydrodynamic instabilities and convection^{14, 15} over the course of solvent evaporation. Thus, as opposed to a stochastic “stick-slip” motion that was responsible for the formation of irregular rings,³ the ring patterns of PMMA with unprecedented regularity were deposited on both sphere and Si surfaces. Only patterns formed on Si surface were evaluated (left panel in FIG. 6.1b). It is of interest to note that the gradient concentric ring patterns described here were highly reproducible.

The periodic organization of PMMA rings makes them an intriguing template for producing metal and metal oxide rings as schematically illustrated in FIG. 6.2. PMMA rings formed at the surface of metal- or metal oxide-coated Si (FIG. 6.2b) were treated with a selective solution to remove metal or metal oxide layer between PMMA rings (FIG. 6.2c). Subsequently, the sample was rinsed with acetone thoroughly to remove PMMA, thereby exposing underlying metal or metal oxide (FIG. 6.2d), replicating the gradient feature of PMMA rings in terms of λ_{C-C}. The optical micrographs of PMMA rings on the Au-coated Si surface, PMMA rings after treated with KI/I₂ mixed solution to remove Au between adjacent rings, and Au rings formed (i.e., exposed) after final removal of PMMA on their top with excessive acetone are shown in FIG. 6.1(b) (left panel), FIG. 6.1(c), and FIG. 6.1(d), respectively. The order of Au rings (FIG. 6.1d) was reminiscent of the arrangement of PMMA rings (left panel in FIG. 6.1b) and was not disrupted during the successive eliminations of Au and PMMA (FIG. 6.1c and 1d). The integrity (i.e., shape and size) of Au rings (FIG. 6.1d) was unchanged in comparison to that of PMMA rings (left panel in FIG. 6.1b).

To verify the accessibility of the sequence demonstrated in optical micrographs (FIG. 6.1b-1d; corresponding to the steps in FIG. 6.2b-2d), AFM measurements were performed. FIG. 6.3 shows 3D AFM height images (left) and corresponding cross sections taken perpendicular to the rings (right). Locally, the rings appeared as the stripes. The height of PMMA ring on Au-coated Si substrate, h_{PMMA} is ˜155 nm (FIG. 6.3a). The width of the ring, w is ˜13.2 μm and the center-to-center distance between adjacent rings, λ_{C-C} is ˜27.7 μm. Upon selective removal of Au, the height of the stripe is expected to increase. The section analysis of the AFM image yields h+h_{PMMA}˜199 nm, w˜13.5 μm, and λ_{C-C}˜27.8 μm, respectively (FIG. 6.3b). Thus, the thickness of Au, h is 44 nm. This is in excellent agreement with the value obtained after removing PMMA on the top of buried Au (h˜45 nm from FIG. 6.3c). Rather than humplike stripes (FIG. 6.3a and 6.3b), stepwise stripes are clearly evident (FIG. 6.3c). It should be noted that lower values of w (˜11.7 μm) and λ_{C-C} (˜24.8 μm) were found in FIG. 6.3c, owing to the AFM image taken at the location that was closer to the center of sphere/Si contact than those in FIG. 6.3a and 6.3b.

The gradient concentric Au sample was then reacted with 25 μl 6-FAM-Q-labeled (green emitting fluorescent dye) thiolated oligonucleotides (purchased from Operon Biotechnologies, Inc) DI water solution. A cover glass was placed on the top of Au sample sealed with PDMS gasket to prevent water evaporation. Subsequently, the sample was put in a humidified chamber for 24 hr. The absorption and emission maxima of green-emitting dye, 6-FAM-Q are 494 nm and 520 nm, respectively (6-FAM-Q: 1-Dimethoxytrityloxy-3-[O-(N-carboxy-(di-O-pivaloyl-fluorescein)-3-aminopropyl)]-propyl-2-O-succinoyl-long chain alkylamino-CPG)). As a result, Au rings were modified with oligonucleotides through the formation of Au—S bond (FIG. 6.4), emitting green fluorescence. The oligonucleotide-deposited Au surface was rinsed with DI water to wash away unbonded oligonucleotide. The thickness of oligonucleotide adsorbed on Au rings was 7 nm, determined by AFM. The oligonucleotides adsorbed physically on Si surfaces (between Au rings) also caused fluorescence, but were much weaker. In the future, extensive rinse with phosphate-buffered solution will be conducted and the PH of the solution and the rinsing time will be optimized to achieve clear fluorescence image exclusively on Au rings.¹⁶

To demonstrate that a wide variety of metal or metal oxide can be used to make rings in gradient concentric mode, Al and TiO₂ (semiconductor) coated Si substrates were employed. TiO₂ possesses the highest known dielectric constant of the oxide materials that renders a variety of applications in electronics, optics, and solar cells.¹⁷ FIG. 6.5 shows optical micrographs of Al rings and TiO₂ rings created in a way similar to the process of preparing Au rings. Al and TiO₂ between PMMA rings were selectively removed with 20 wt % potassium hydroxide (KOH) DI water solution for 2 min and 5 v % hydrofluoric acid (HF) DI water solution for less than 1 min, respectively. Finally, PMMA rings were completely rinsed off with acetone, thereby exposing Al and TiO₂ underneath. The height of Al and TiO₂ rings are 410 nm and 140 nm in FIG. 6.5a and 6.5b, respectively. Representative 3D AFM height images are shown in FIG. 6.5a and 6.5b as insets, respectively. The λ_{C-C} of the metal and semiconductor rings can be easily tuned by varying the concentration of PMMA toluene solution.^{8, 9} A larger λ_{C-C} is clearly evident due to the use of PMMA toluene solution with a higher concentration (c=1 mg/ml) (FIG. 6.5) as compared to 0.25 mg/ml solution used for preparing Au rings (FIG. 6.1b-1d).⁹ The height of rings is mainly dictated by the thickness of metal and semiconductor sputtered on Si substrates prior to drying-mediated self-assembly of PMMA rings as seen in Au and TiO₂ rings, possessing a smooth ring surface (FIG. 6.3c and the inset in FIG. 6.5b). However, in the first step of preparation of Al rings, due to fast reaction of Al and KOH, Al between PMMA rings (see schematic in FIG. 6.2b and 6.2c) was removed very quickly. In the meantime, partial dissolution of intact Al underneath PMMA rings occurred, thereby reducing the width and the height of intact Al. Consequently, humplike Al rings were obtained (inset in FIG. 6.5a).

In conclusion, a rational construction of simple sphere-on-flat geometry provides remarkable control and flexibility over the preparation of gradient concentric rings of nonvolatile solutes produced by repeated “stick-slip” motion of the contact line. This simple, lithography-free route allows subsequent preparation of a great variety of metal and metal oxide concentric ring patterns with controlled spacing, size, and thickness. The utilization of such gradient replica to engineer biopolymers (i.e., oligonucleotides) has been demonstrated. We envision that, owing to intrinsic gradient nature in spacing and width together with well-controlled physical and chemical surface properties, metal and metal oxide rings may provide the basis for combinatorial study of dewetting of polymer thin films,18 phase separation of polymer blends¹⁹ as well as polymer/liquid crystal mixtures, and long range ordering of block copolymers²¹ to explore finite size (i.e., confinement) effects in one step. These rings may also be employed as unique surfaces for studying the confinement of transmembrane cell receptors²² and biological recognition process.²³

### Figure Captions

FIG. 6.1.—(a) Schematic cross section of a capillary-held solution containing nonvolatile solute placed in a sphere-on-Si geometry. (b) Schematic representation of gradient concentric rings of PMMA formed during solvent evaporation in the geometry shown in (a). The sphere/Si contact area is marked as “Contact Center”. The optical micrograph of PMMA rings formed on Au-coated Si surface is shown on the left side. (c)-(d) Optical micrographs of PMMA rings after dissolving Au between the rings (c), followed by subsequent removal of PMMA (d). The scale bar is 50 μm.

FIG. 6.2-Schematic illustration of formation of gradient concentric metal or metal oxide rings (cross-sectional view). (a) A layer of metal or metal oxide was evaporated on Si surface. (b) Evaporation induced self-assembly of PMMA rings from PMMA toluene solution, showing a decrease in the center-to-center distance between adjacent rings, λ_{C-C} and the height of the ring, h_{PMMA} from outermost ring (left) toward the “Contact Center” (right).⁹ (c) Removal of metal or metal between PMMA rings with a selective solution (e.g., KI/I₂ for Au removal). (d) Formation of metal or metal oxide rings upon removal of PMMA with acetone.

FIG. 6.3—AFM images of rings (i.e., stripes locally) (left) and corresponding profiles (right). (a) PMMA rings formed on an Au-coated Si surface via controlled, repetitive “stick-slip” motion of the contact line (c=0.25 mg/ml). (b) PMMA rings after removal of Au between adjacent PMMA rings with KI/I₂ mixed solution. (c) Au rings obtained after completely rinsing PMMA off with excessive acetone. These images correspond to the stages shown in FIG. 1b-d, respectively. The image size is 100×100 μm².

FIG. 6.4—Fluorescence image of 6-FAM-Q-labeled thiolated oligonucleotide patterns formed on Au rings. The scale bar is 100 μm.

FIG. 6.5—Optical micrographs of gradient concentric rings of (a) Al and (b) TiO₂. The scale bar is 20 μm in (a) and 50 μm in (b), respectively. Representative 3D AFM images (80×80 μm²) are given as insets. The z scale is 1 μm in (a) and 400 nm in (b). The concentration of PMMA toluene solution used to produce PMMA rings is c=1 mg/ml.

### REFERENCES FOR EXAMPLE 6

(1) Deegan, R. D.; Bakajin, O.; Dupont, T. F.; Huber, G.; Nagel, S. R.; Witten, T. A. Nature 1997, 389, 827.
(2) Karthaus, O.; Grasjo, L.; Maruyama, N.; Shimomura, M. Chaos 1999, 9, 308.
(3) Adachi, E.; Dimitrov, A. S.; Nagayama, K. Langmuir 1995, 11, 1057.
(4) Rabani, E.; Reichman, D. R.; Geissler, P. L.; Brus, L. E. Nature 2003, 426, 271.
(5) Yabu, H.; Shimomura, M. Adv. Funct. Mater. 2005, 15, 575.
(6) Bigioni, T. P.; Lin, X. M.; Nguyen, T. T.; Corwin, E. I.; Witten, T. A.; Jaeger, H. M. Nature Materials 2006, 5, 265.
(7) Lin, Z. Q.; Granick, S. J. Am. Chem . Soc. 2005, 127, 2816.
(8) Hong, S. W.; Xu, J.; Xia, J.; Lin, Z. Q.; Qiu, F.; Yang, Y. L. Chem. Mater. 2005, 17,
(9) Xu, J.; Xia, J.; Hong, S. W.; Lin, Z. Q.; Qiu, F.; Yang, Y. L. Phys. Rev. Lett. 2006, 96, 066104.
(10) Yan, F.; Goedel, W. A. Angew. Chem. Int. Ed. 2005, 44, 2084.
(11) Yan, F.; Goedel, W. A. Nano Lett ers 2004, 4, 1193.
(12) Li, J.; Peng, J.; Huang, W.; Wu, Y.; Fu, J.; Cong, Y.; Xue, L.; Han, Y. Langmuir 2005, 21, 2017.
(13) Scheuer, J.; Green, W. M. J.; Yariv, A. Photonics Spectra May, 2005.
(14) Maillard, M.; Motte, L.; Ngo, A. T.; Pileni, M. P. J. Phys . Chem . B 2000, 104, 11871.
(15) Nguyen, V. X.; Stebe, K. J. Phys. Rev. Lett. 2002, 88, 164501.
(16) Matsumoto, F.; Harada, M.; Nishio, K.; Masuda, H. Adv. Mater. 2005, 17, 1609.
(17) Mor, G. K.; Shankar, K.; Paulose, M.; Varghese, 0. K.; Grimes, C. A. Nano Lett ers 2006, 6, 215-218.
(18) Kargupta, K.; Sharma, A. Phys. Rev. Lett. 2001, 86, 4536.
(19) Boltau, M.; Walheim, S.; Mlynek, J.; Krausch, G.; Steiner, U. Nature 1998, 391,
(20) Xia, J. F.; Wang, J.; Lin, Z. Q.; Qiu, F.; Yang, Y. L. Macromolecules 2006, 39,
(21) Kim, S. H.; Minser, M. J.; Xu, T.; Kimura, M.; Russell, T. P. Adv. Mater. 2004, 16,
(22) Purrucker, O.; Fortig, A.; Ludtke, K.; Jordan, R.; Tanaka, M. J. Am. Chem . Soc. 2005, 127, 1258.
(23) Delamarche, E.; Bernard, A.; Schmid, H.; Michel, B.; Biebuyck, H. Science 1997, 276, 779.

### 7. Example 7

### Overview

Gradient concentric rings of polymers with unprecedented regularity were formed by repeated “stick-slip” motion of the contact line in a sphere-on-flat geometry. Subsequently, polymer rings served as templates to direct the formation of concentric Au rings.

Gradient concentric rings of polymers, including (poly[2-methoxy-5-(2-ethylhexyloxy)-1,4-phenylenevinylene] (MEH-PPV) and poly(methyl methacrylate) (PMMA), with unprecedented regularity were formed by repeated “stick-slip” motion of the contact line in a sphere-on-flat geometry. Subsequently, polymer rings served as templates to direct the formation of concentric Au rings. Three methods were described. The first two methods made use of either UV (i.e., on MEH-PPV) or thermal treatment (i.e., on PMMA) on Au-sputtered polymer rings, followed by ultrasonication. The last method, however, was much simple and robust, involving selective removal of Au and polymer (i.e., PMMA) consecutively.

### Discussion

Two-dimensional (2D) periodic structures are attractive for a wide range of applications in optics,² optoelectronics,^{3, 4} photonics,⁵ electronics,⁶ magnetic materials⁷ and biotechnology. A variety of self-assembled systems have been utilized as templates to produce well-ordered 2D structures with no need of lithography, including microphase-separated block copolymers,^{7, 9} hexagonally ordered arrays (i.e., breath figures) made by the condensation of micron size water droplets on the surface of a polymer solution,¹⁰ self-assembly of colloidal crystals,¹¹ and self-organized mesoporous silica.¹²

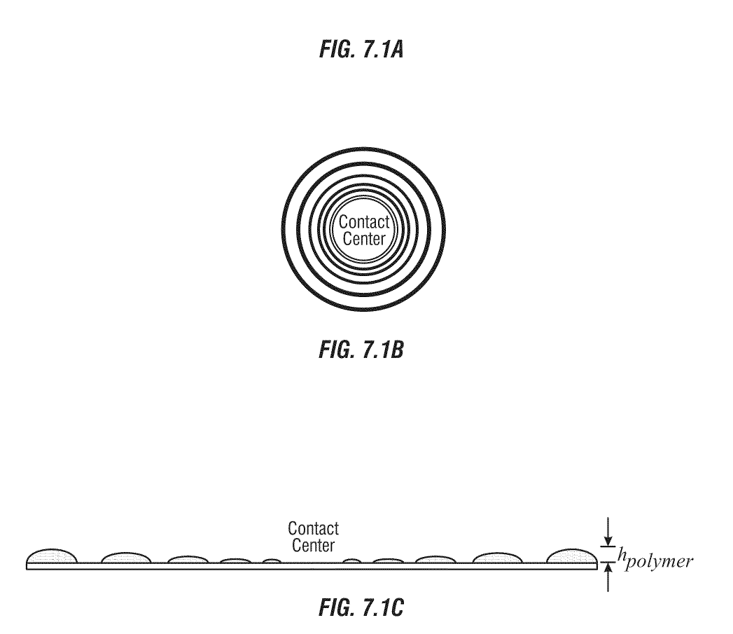

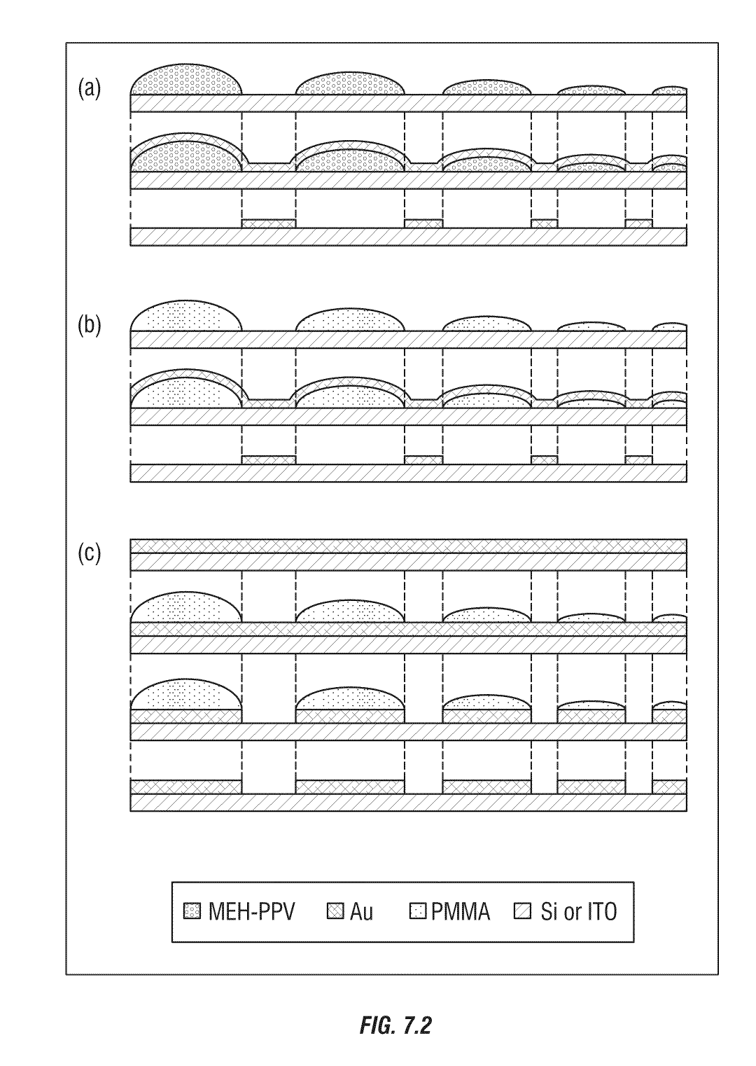

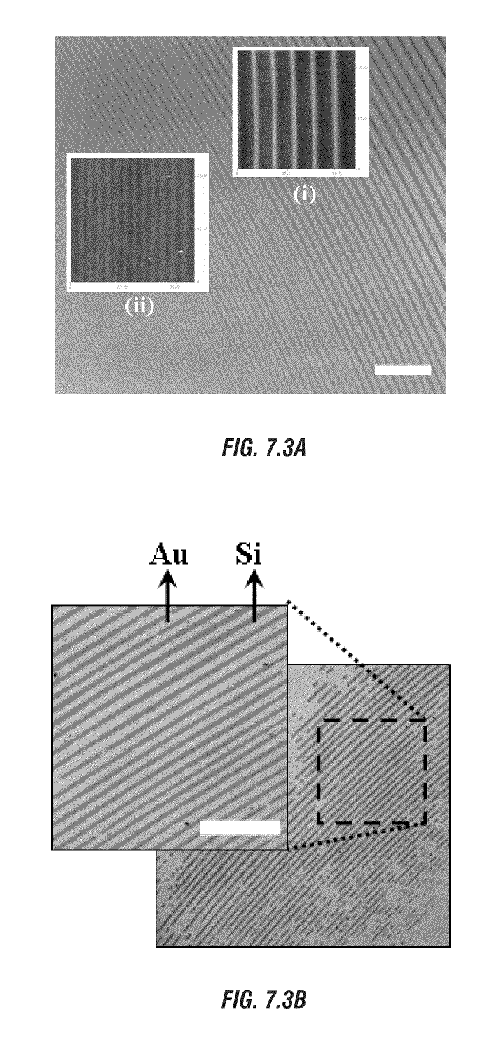

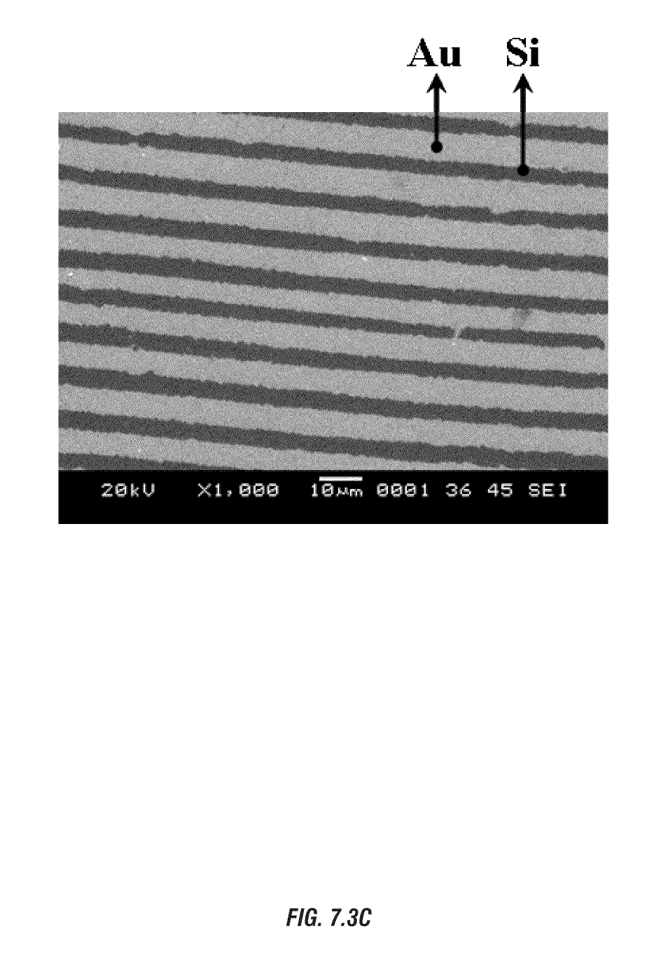

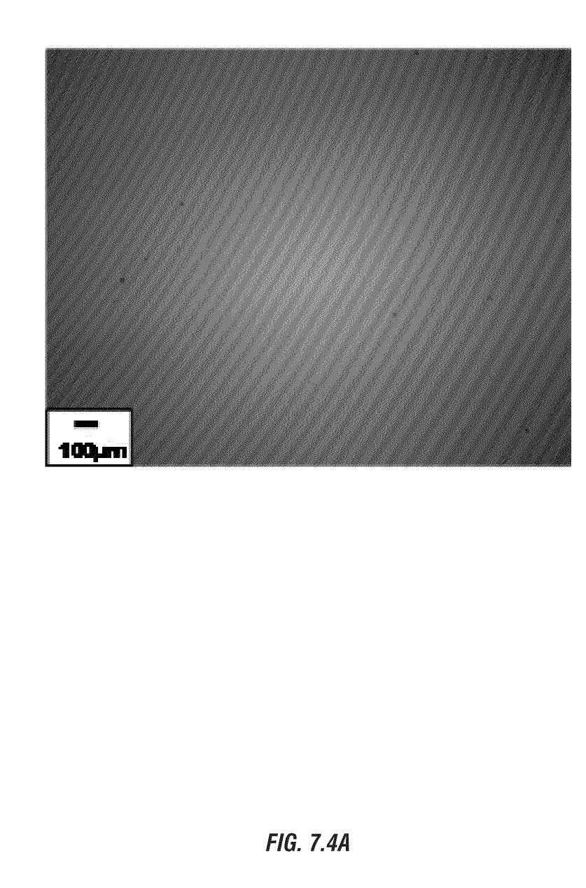

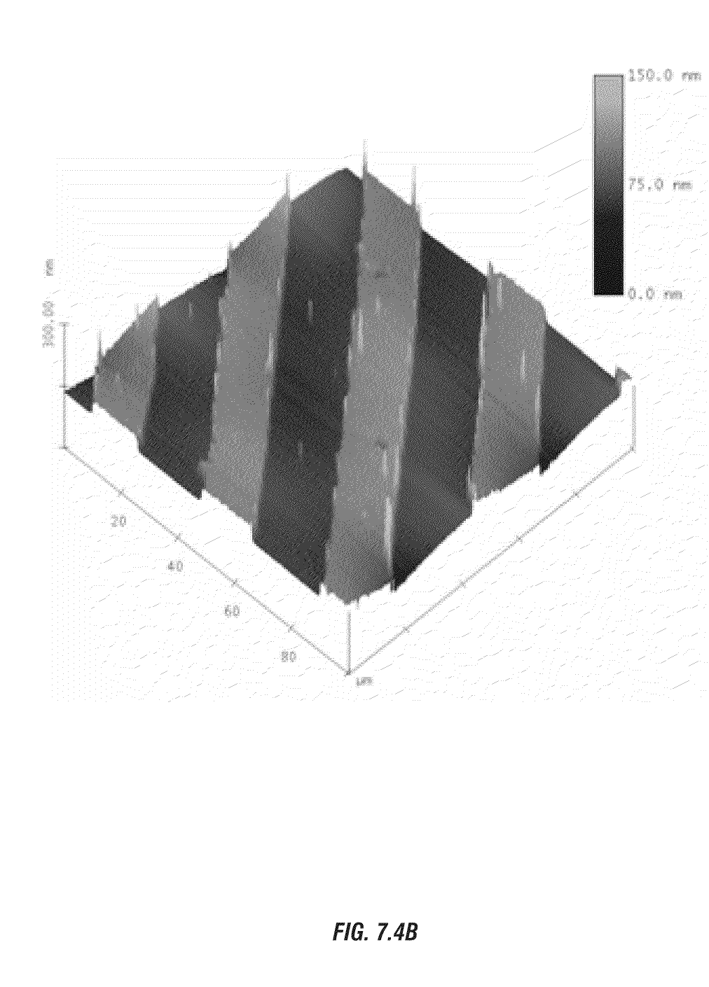

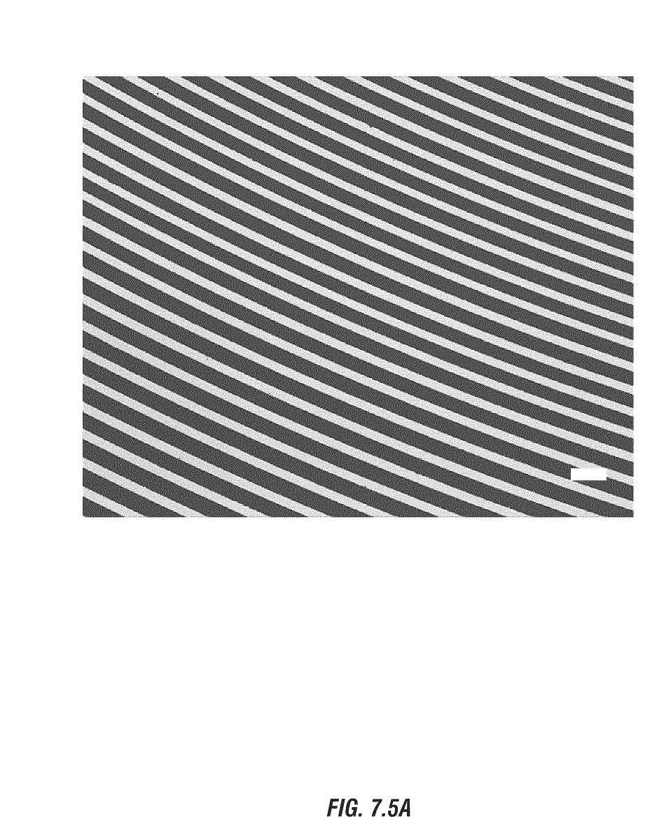

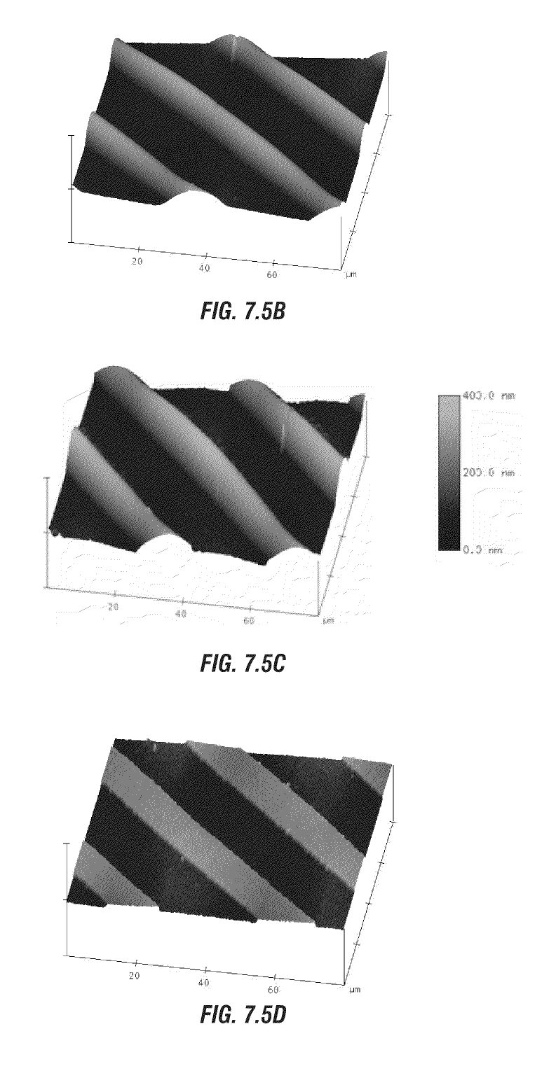

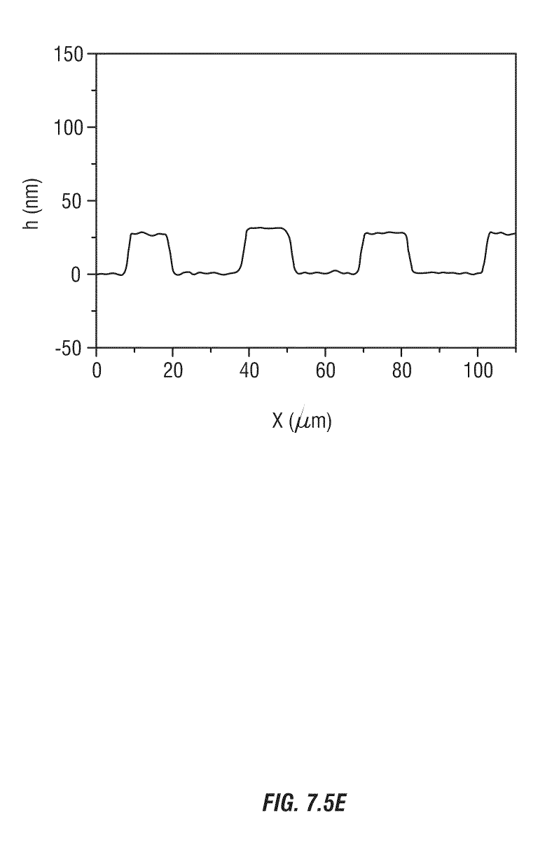

Dynamic self-assembly of dispersions through irreversible solvent evaporation of a drop from a solid substrate is widely recognized as a non-lithography route for one-step creation of complex, large-scale structures.¹³⁻¹⁵ The flow instabilities within the evaporating droplet, however, often result in non-equilibrium and irregular dissipative structures,¹⁶ e.g., convection patterns, fingering instabilities, and so on. Therefore, to fully utilize evaporation as a simple tool for achieving well-ordered 2D structures, it requires delicate control over flow instabilities and evaporation process. Recently, self-organized gradient concentric ring patterns have been produced by constraining a drop of polymer solution in a restricted geometry composed of either two cylindrical mica surfaces placed at a right angle to one another or a sphere on a flat surface (i.e., two surfaces).¹⁷⁻¹⁹ The unprecedented regularity makes these polymer rings intriguing templates for producing concentric metal rings. Here, we report on fabrications of gradient concentric gold (Au) rings with nanometers in height and microns in width, replicated from templates of polymer rings. The gradient concentric polymer rings¹⁷⁻¹⁹ were formed on Si or Au-coated ITO substrate via drying mediated self-assembly from a capillary-held polymer solution in the sphere-on-flat geometry (FIG. 7.1a). Two polymers were employed as nonvolatile solutes: (poly[2-methoxy-5-(2-ethylhexyloxy)-1,4-phenylenevinylene] (MEH-PPV) and poly(methyl methacrylate) (PMMA). Subsequently, polymer rings served as templates for making Au rings by several methods as schematically illustrated in FIG. 7.2.

### Experimental Section

### Evaporation Induced Self-Assembly of Polymer Rings in a Sphere-on-Flat Geometry

Si substrates and spherical lenses made from fused silica (radius of curvature ˜1 cm) were cleaned with a mixture of sulfuric acid and Nochromix™. The indium tin oxide (ITO) glasses were cleaned with acetone, DI water and filtered ethanol, and then blow-dried with N₂. A sphere-on-flat geometry inside a chamber was constructed and implemented as follows. Both spherical lens and Si (or ITO) were firmly fixed at the top and the bottom of sample holders in the chamber, respectively. An inchworm motor was used to bring the upper sphere into contact with the lower stationary Si (or ITO) substrate. Before they contacted (i.e., separated by a few hundred micrometers), 25 μl polymer toluene solution was loaded and trapped between the sphere and Si (or ITO) due to the capillary force. The sphere was finally brought into contact with Si (or ITO) substrate by the inchworm motor such that a capillary-held polymer solution forms with evaporation rate highest at the extremity as schematically illustrated in FIG. 7.1a. This leads to controlled, repetitive “stick-slip” motion of the three-phase contact line, which moves toward the center of the sphere/Si contact (i.e., Contact Center in FIG. 7.1b) during the course of solvent evaporation. As a result, gradient concentric polymer rings were formed. Two polymers were used as nonvolatile solute to produce gradient concentric rings: a linear conjugated polymer, poly[2-methoxy-5-(2-ethylhexyloxy)-1,4-phenylenevinylene] (MEH-PPV) (molecular weight, MW=50-300 kg/mole) and poly(methyl methacrylate) (PMMA) (number average MW, Mₙ=534 kg/mole and polydispersity, PDI=1.57). The concentration of MEH-PPV toluene solution is 0.05 mg/ml. For PMMA, the concentrations of the solutions are 0.5 mg/ml and 0.125 mg/ml, used in Method b and c, respectively. Only the ring patterns on Si or ITO substrates were utilized as templates.

### Template Assisted Formation of Concentric Au Rings

Method a: use of MEH-PPV rings on Si as templates A 16-nm thick gold (Au) was sputtered on MEH-PPV rings on Si substrate (FIG. 7.2a). The sample was then exposed to UV radiation (Mineralight® Lamp; Model: UVGL-25; λ=254 nm) for 15 hr to degrade MEH-PPV buried underneath Au. Afterward, the sample was ultrasonicated in toluene for 10 min to remove degraded MEH-PPV. Au replica was thus obtained (FIG. 7.3). Finally, the Au replica was cleaned up with sulfuric acid.

Method b: use of PMMA rings on Si as templates Similar to Method a, a 36-nm thick Au was sputtered on PMMA rings on Si substrate (FIG. 7.2b). To achieve Au rings, the sample was then placed in a furnace at 400° C. for 2 hr to thermally decompose buried PMMA, followed by extensive ultrasonication in toluene for 15 min.

Method c: use of PMMA rings on Au-coated ITO glass as templates In this method, a 36-nm thick Au was firstly thermally deposited on ITO glass. To ensure good adhesion between Au and ITO, a 2-nm thick TiO₂ was evaporated on ITO glass. PMMA rings were then formed on Au-coated ITO substrate. Afterward, Au between PMMA rings were selectively removed with a mixture of potassium iodide/iodide DI water solution (KI: 12: DI water=5 g: 1.25 g: 50 ml) for Au for 1 min. Finally, PMMA rings were completely rinsed off with acetone, thereby exposing Au underneath.

Characterizations: An Olympus BX51 optical microscope (OM) in the reflection mode was used to investigate the patterns deposited on Si or ITO substrate. Atomic force microscopy (AFM) images on patterns on Si (or ITO) surface were obtained using a Digital instruments Dimension 3100 scanning force microscope in the tapping mode. BS-tap300 tips from Budget Sensors with spring constants ranging from 20 to 75N/m were used as scanning probes. The scanning electron microscopy (SEM) studies were performed on a JOEL 6060LV SEM, operating at 5 kV accelerating voltage.

### Results and Discussion

A drop of MEH-PPV or PMMA toluene solution bridged the gap between a spherical lens and a Si (or ITO) substrate, forming a capillary-held solution (FIG. 7.1a) (see Experimental Section).¹⁷⁻¹⁹ The evaporation is restricted at the capillary edges.¹⁷⁻¹⁹ Evaporative loss of toluene at the capillary edges caused the pinning of the contact line (i.e., “stick”), thereby forming outmost polymer ring. As solvent evaporated, the initial contact angle of the capillary edge decreased gradually to a critical angle at which the capillary force (depinning force) became larger than the pinning force,¹⁹ leading the contact line to hop to a new position (i.e., “slip”) so that a new ring deposited. Repetition of the “stick-slip” motion of the contact line resulted in the formation of concentric rings of the polymer toward the center of sphere/Si (or ITO) contact (i.e., Contact Center in FIG. 7.1b). The patterns chronicled the moments of arrested contact line motion in the capillary bridge. The center to center distance, λ_{C-C} between polymer rings and height of the ring, h were found to decrease with increasing proximity to the Contact Center (FIG. 7.1c) as a result of the competition of linear pinning force and nonlinear capillary force.¹⁹ It is noteworthy that the restricted geometry (i.e., sphere-on-flat) carries the advantage over cases in which a droplet is allowed to evaporate on a single surface,¹³⁻¹⁵ namely, providing a unique environment for controlling the flow within an evaporating droplet, which, in turn, regulates the structure formation with excellent reproducibility.

Subsequently, the polymer ring patterns served as templates for producing Au rings using three methods as depicted in FIG. 7.2. Method a utilized MEH-PPV rings formed by evaporation-induced self-assembly from MEH-PPV toluene solution confined in the sphere-on-flat geometry (FIG. 7.2a). Gradient concentric rings are clearly evident (FIG. 7.3a). The λ_{C-C} and h were observed to decrease as the evaporation front moved toward the sphere/Si contact center (i.e., from upper right to lower left). The section analysis of two representative 2D AFM height images (insets in the optical micrograph) yields that λ_{C-C}=9.6 μm, and h=7.6 nm at location (i) and λ_{C-C}=4.3 μm, and h=1.3 nm at location (ii). It is of interest to note that the width of MEH-PPV rings is much smaller than the space between the rings. After sputtering a layer of 16-nm Au on the surface of MEH-PPV rings, the sample was subjected to UV irradiation (see Experimental). Finally, MEH-PPV rings together with Au covering on their top were removed by ultrasonication, leaving behind Au rings that were originally deposited between MEH-PPV rings. Incomplete removal of buried MEH-PPV was observed as shown in FIG. 7.3b, which was most likely due to very low power of UV source used so that MEH-PPV was not readily photodegraded completely. Locally, Au rings appeared as the stripes (SEM image in FIG. 7.3c). The width of Au stripes is much wider than that of Si stripes (a close-up view of optical micrograph in FIG. 7.3b and FIG. 7.3c), which correlates well with the optical microscopy observation before the deposition of Au (FIG. 7.3a). The energy dispersive X-ray analysis (EDX) on the Au replica revealed that no Au signal were detected in the region between original MEH-PPV rings, indicating that MEH-PPV rings together with Au on the top were completely detached from Si substrate.

In Method b (FIG. 7.2b), gradient concentric PMMA rings produced by controlled, repetitive “stick-slip” motion in the restricted geometry consisting of a spherical lens and a Si substrate were utilized as templates. A 36-nm Au was sputtered. Instead of applying UV radiation to degrade PMMA due to rather low UV power, PMMA rings buried under Au were thermally decomposed at 400° C. The Au-ring replica was obtained eventually after ultrasonication in toluene (optical micrograph; FIG. 7.4a). The order of Au rings was reminiscent of the arrangement of PMMA rings and was not affected by the thermal treatment and subsequent ultrasonication. A typical 3D AFM height image of Au replica is shown in FIG. 7.4b. The λ_{C-C} and h are 30 μm and 36 nm, respectively. It should be noted that complete removal of pyrolyzed PMMA was achieved by sonication as compared to the case in MEH-PPV (FIG. 7.3b), however, prolonged sonication was found to cause Au rings to delaminate from Si substrate.

Rather than performing the sputtering of Au on polymer ring patterns to achieve Au rings as demonstrated in Method a and b (FIG. 7.3 and 7.4), a much simpler method (Method c) was to firstly thermally evaporate a thick layer of Au on ITO, followed by the formation of concentric polymer rings and successive removal of Au (between the polymer rings) and polymer on the top of buried Au.²⁰ As depicted in FIG. 7.2c, PMMA rings were formed at the surface of Au-coated ITO. The sample was then treated with the KI/I₂ DI water solution to selectively dissolve Au between PMMA rings. Finally, the sample was rinsed with acetone thoroughly to remove PMMA, thereby exposing underlying Au as shown in FIG. 7.5a. The 3D AFM height images corresponding to the steps illustrated in FIG. 2c are shown in FIG. 7.5b-d. The PMMA rings were humplike with the height, h, the width, w, and the center-to-center distance between PMMA rings, λ_{C-C} are 114 nm, 14 μm, and 31 μm, respectively as determined by the AFM (FIG. 7.5b). After the treatment with the KI/I₂ aqueous solution, h increased to 150 nm, while w and λ_{C-C} were unchanged (FIG. 7.5c). The height of Au underneath PMMA rings was, thus, found to be 36 nm, which agreed well with the value obtained after removal of PMMA (FIG. 7.5d). Rather than humplike rings (FIG. 7.5b and 7.5c), stepwise rings were obtained as are evidenced in FIG. 7.5d and 7.5e. Slightly lower values of w (13.5 μm) and λ_{C-C} (30 μm) were obtained due to the fact that the AFM image was taken at the location that was slightly closer to the center of sphere/ITO contact. Compared to the Method a and b in which extensive UV degradation (Method a), high-temperature treatment (Method b), and ultrasonication were applied (Method a and b), this method is much simple, fast and robust.

In conclusion, gradient concentric rings of polymers with unprecedented regularity were formed by repeated “stick-slip” motion of the contact line in a sphere-on-flat geometry. There is no restriction on polymer materials that can be used for forming highly ordered concentric rings and on substrates where polymer rings deposited. Subsequently, polymer rings served as templates to direct the formation of concentric Au rings. Three methods were described. The first two methods made use of either UV (i.e., on MEH-PPV) or thermal treatment (i.e., on PMMA) on Au-sputtered polymer rings, followed by ultrasonication. The last method, however, was much simple and robust, involving selective removal of Au and polymer consecutively. The resulting metal rings organized in a concentric mode may offer possibilities for many applications, including annular Bragg resonators for advanced optical communications systems. It has been demonstrated that λ_{C-C} and h decrease nonlinearly with increasing polymer concentration.¹⁹ Studies in order to dynamically tune the formation of gradient concentric rings of polymers by proper choice of the solvent, the interaction between the polymer and the substrate, and the curvature of the sphere, which, in turn, regulate the dimension of Au rings, are currently underway. The methods described should readily extend to the fabrication of gradient concentric rings of other metals²¹ and metal oxides (e.g., zinc oxide) for biomedical applications with little toxicity.22 We envision that metal and/or metal oxide microstructures other than concentric rings, for example, spoke patterns, can be easily obtained from corresponding polymer templates produced in the sphere-on-flat geometry. Gradient concentric metal and/or metal oxide rings can serve as etching barriers for transferring patterns into Si substrate by reaction ion etching with SF₆ gas. A detailed study using organized metal and/or metal oxide rings as well as the abovementioned pattern-transferred Si as channels for microfluidic devices is currently underway.

### Figure Captions

FIG. 7.1: Schematic illustrations of (a) a drop of polymer solution placed in a sphere-on-flat geometry, (b) gradient concentric polymer rings produced by solvent evaporation in the geometry shown in (a), and (c) side view of polymer rings formed in (b), exhibiting a gradient in the center-to-center distance between adjacent rings, λ_{C-C} and the height of the ring, h_{polymer} from leftmost across the “Contact Center” to rightmost. The sphere/Si (or ITO) contact area is marked as “Contact Center”.

FIG. 7.2: Schematic stepwise representation of formation of gradient concentric Au rings. (a) Evaporation induced self-assembly of MEH-PPV rings on Si substrate from MEH-PPV toluene solution, showing a decrease in λ_{C-C} and h from outermost ring (left) toward the “Contact Center” (right). Then a layer of Au was thermally evaporated, followed by UV degradation of MEH-PPV and final removal by ultrasonication. (b) Gradient concentric PMMA rings formed in the same way as illustrated in (a). Subsequently, a layer of Au was deposited, followed by pyrolysis of PMMA and final removal by ultrasonication. (c) A layer of Au was deposited on ITO substrate. Then PMMA rings were formed. Afterward, Au between PMMA rings was selectively removed with the KI/I₂ DI water solution. Finally, concentric Au rings were achieved by washing off PMMA on their top with acetone.

FIG. 7.3: (a) Optical micrograph of gradient concentric MEH-PPV rings formed via controlled, repetitive “stick-slip” motion of the contact line in the sphere-on-flat geometry (FIG. 7.1a). The scale bar is 200 μm. Two representative 2D AFM height images are shown as insets, demonstrating a decrease in λ_{C-C} and h with increasing proximity to the center of sphere/Si contact (i.e., from location (i) to (ii)). The AFM image size is 60×60 μm². The z scale is 50 nm. (b) Optical micrograph of Au rings after ultrasonicating off degraded MEH-PPV, in which MEH-PPV was not completely removed. A close-up is shown in the upper left. The dark and yellow stripes are Si rings and Au rings, respectively. The scale bar is 70 μm. (c) SEM image of Au rings. The dark and grey stripes correspond to Si rings and Au rings, respectively.

FIG. 7.4: (a) Optical micrograph of gradient concentric Au rings on Si substrate fabricated using Method b (i.e., schematic b in FIG. 7.2). The scale is 100 μm. (b) A representative 3D AFM height image of Au rings. The image size is 100×100 μm. The z scale is 150 nm.

FIG. 7.5: (a) Optical micrograph of concentric Au rings on ITO surface. The scale bar is 50 μm. (b)-(d) Representative 3D AFM height images (80×80 μm²), corresponding to the stages illustrated in FIG. 7.2c. The z scale is 400 nm. (b) PMMA rings on Au-coated ITO substrate. (c) PMMA rings after removal of Au between the rings with the KI/I₂ DI water solution. (d) Au rings obtained after rinsing with acetone to eliminate PMMA. (e) Typical cross-section of Au rings in (d).

### REFERENCES FOR EXAMPLE 7

1. Yabu, H.; Shimomura, M. Langmuir 2005, 21, 1709.
2. Yabu, H.; Shimomura, M. Adv. Funct. Mater. 2005, 15, 575.
3. Erdogan, B.; Song, L.; Wilson, J. N.; Park, J. O.; Srinivasarao, M.; Bunz, U. H. F. J. Am. Chem ., Soc. 2004, 126, 3678.
4. Song, L.; Bly, R. K.; Wilson, J. N.; Bakbak, S.; Park, J. O.; Srinivasarao, M.; Bunz, U. H. F. Adv. Mater. 2004, 16, 115.
5. Joannopoulos, J. D.; Meade, R. D.; Winn, J. N., Photonic crystals-modeling the flow of light. Princeton University Press: Princeton, N.J., 1995.
6. Jacobs, H. O.; Whitesides, G. M. Science 2001, 291, 1763.
7. Thurn-Albrecht, T.; Schotter, J.; Kastle, C. A.; Emley, N.; Shibauchi, T.; Krusin-Elbaum, L.; Guarini, K.; C. T., B.; Tuominen, M. T.; Russell, T. P. Science 2000, 290,
8. Ostuni, E.; Chen, C. S.; Ingber, D.; Whitesides, G. M. Langmuir 2001, 17, 2828.
9. Misner, M. J.; Skaff, H.; Emrick, T.; Russell, T. P. Adv. Mater. 2003, 15, 221.
10. Bunz, U. H. F. Adv. Mater. 2006, 18, 973.
11. Holland, B. T.; Stein, A. Science 1998, 281, 538.
12. Lin, V. S.-Y.; Motesharei, K.; Dancil, K. S.; Sailor, M. J.; Ghadiri, M. R. Science 1997, 278, 840.
13. Deegan, R. D.; Bakajin, O.; Dupont, T. F.; Huber, G.; Nagel, S. R.; Witten, T. A. Nature 1997, 389, 827.
14. Deegan, R. D. Phys. Rev. E 2000, 61, 475.
15. Deegan, R. D.; Bakajin, O.; Dupont, T. F.; Huber, G.; Nagel, S. R.; Witten, T. A. Phys. Rev. E 2000, 62, 756.
16. Rabani, E.; Reichman, D. R.; Geissler, P. L.; Brus, L. E. Nature 2003, 426, 271.
17. Lin, Z. Q.; Granick, S. J. Am. Chem . Soc. 2005, 127, 2816.
18. Hong, S. W.; Xu, J.; Xia, J.; Lin, Z. Q.; Qiu, F.; Yang, Y. L. Chem. Mater. 2005, 17, 6223.
19. Xu, J.; Xia, J.; Hong, S. W.; Lin, Z. Q.; Qiu, F.; Yang, Y. L. Phys. Rev. Lett. 2006, 96, 066104.
20. Hong, S. W.; Giri, S.; Lin, V. S. Y.; Lin, Z. Q. Chem. Mater. 2006, 18, 5164.
21. Xu, Q.; Perez-Castillejos, R.; Li, Z.; Whitesides, G. M. Nano Lett . 2006, 6, 2163.
22. Wang, Z. L.; Song, J. H. Science 2006, 312, 242.

### 8. Example 8

### Overview

Hundreds of gradient concentric rings of linear conjugated polymer with remarkable regularity over large areas were produced by controlled “stick-slip” motions of the contact line in a confined geometry consisting of a sphere on a flat substrate (i.e., sphere-on-flat geometry). Subsequently, they were exploited as a template to direct the formation of gradient concentric rings of multiwalled carbon nanotubes (MWNTs) with controlled density.

Hundreds of gradient concentric rings of linear conjugated polymer, (poly[2-methoxy-5-(2-ethylhexyloxy)-1,4-phenylenevinylene], i.e., MEH-PPV) with remarkable regularity over large areas were produced by controlled “stick-slip” motions of the contact line in a confined geometry consisting of a sphere on a flat substrate (i.e., sphere-on-flat geometry). Subsequently, MEH-PPV rings were exploited as a template to direct the formation of gradient concentric rings of multiwalled carbon nanotubes (MWNTs) with controlled density. This method is simple, cost effective, and robust, combining two consecutive self-assembly processes, namely, evaporation-induced self-assembly of polymers in a sphere-on-flat geometry, followed by subsequent directed self-assembly of MWNTs on the polymer-templated surfaces.

### Introduction

Spontaneous self-assembly of nanoscale materials to form well ordered, often intriguing complex structures via irreversible solvent evaporation from a solution containing nonvolatile solutes (e.g., nanoparticles, colloids, and DNA) provides a simple route to functional materials.^{[1-11]} When compared with other conventional techniques (e.g., photolithography, e-beam lithography, soft-lithography, and nanoimprint lithography), the surface patterning by controlled solvent evaporation is simple and cost-effective. It offers a lithography- and external field-free means of organizing nanoscopic materials into ordered microscopic structures over large surface areas in a facile routine.

Carbon nanotubes (CNTS) have been widely recognized as a potential material for use as semiconducting or conducting elements in nanoelectronics, sensors, and nanoscale transistors due to their outstanding electrical, optical, mechanical, and structural properties.^{[12-23]} The physicochemical properties of CNT-based materials strongly depend on the order and orientation of CNTs.^{[14, 15, 24-28]} To this end, impressive recent studies have centered on developing techniques for patterning and depositing CNTs on the surface by arranging them into well-ordered arrays with controlled coverage, including electric-field-assisted growth,^{[29, 31]} the use of controlled flocculation in laminar microfluidic networks,^{[14]} selective laser ablation,^{[24]} guided chemical vapor deposition growth on single-crystal quartz substrates using patterned stripes of iron catalyst,^{[31]} and blown bubble film process^{[32]} to fabricate nanotube-based devices, e.g., high density sensor arrays and thin film transistors.^{[31-34]} Successful implementation of CNTs also requires strategies to deposit and pattern CNTs over large areas, which still remains challenging especially if gradient variation of patterning (e.g., spacing) is desirable.

Recently, self-organized gradient concentric ring patterns have been produced by confining a drop of polymer solution in a restricted geometry composed of a sphere on a flat surface.^{[35-42]} Rather than allowing the solvent to evaporate over the entire droplet area as in copious past work, in which droplets evaporated from a single surface,^{[43-45]} the evaporation was restricted at the droplet edges.^{[35, 36]} Concentric rings were formed by controlled, repetitive pinning and depinning of the contact line (i.e., “stick-slip” motion).^{[35, 36]} However, to the best of our knowledge, gradient concentric rings composed of CNTs with unprecedented regularity have not been reported to date. CNTs organized in a gradient concentric ring mode may offer possibilities for mass production of CNT-based electronic devices to explore the channel length effect on the mobility of CNTs in one step.

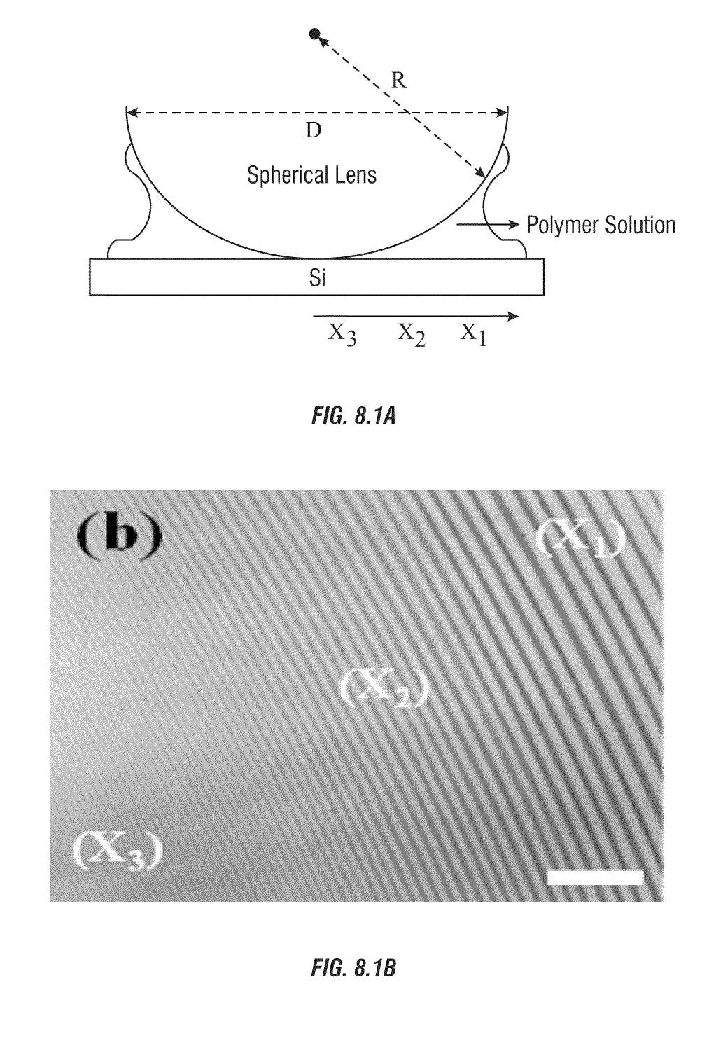

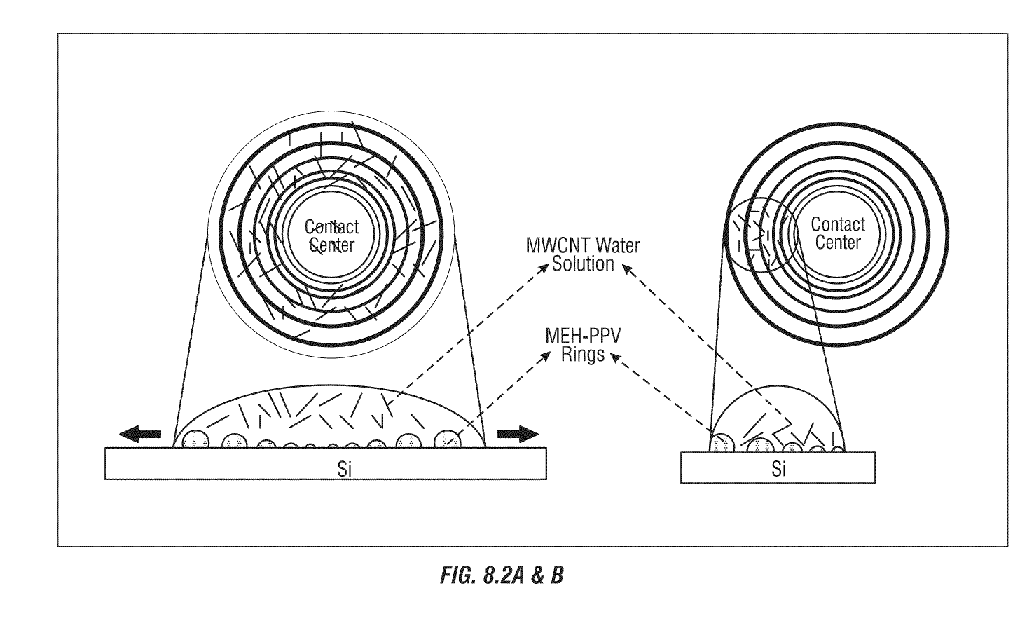

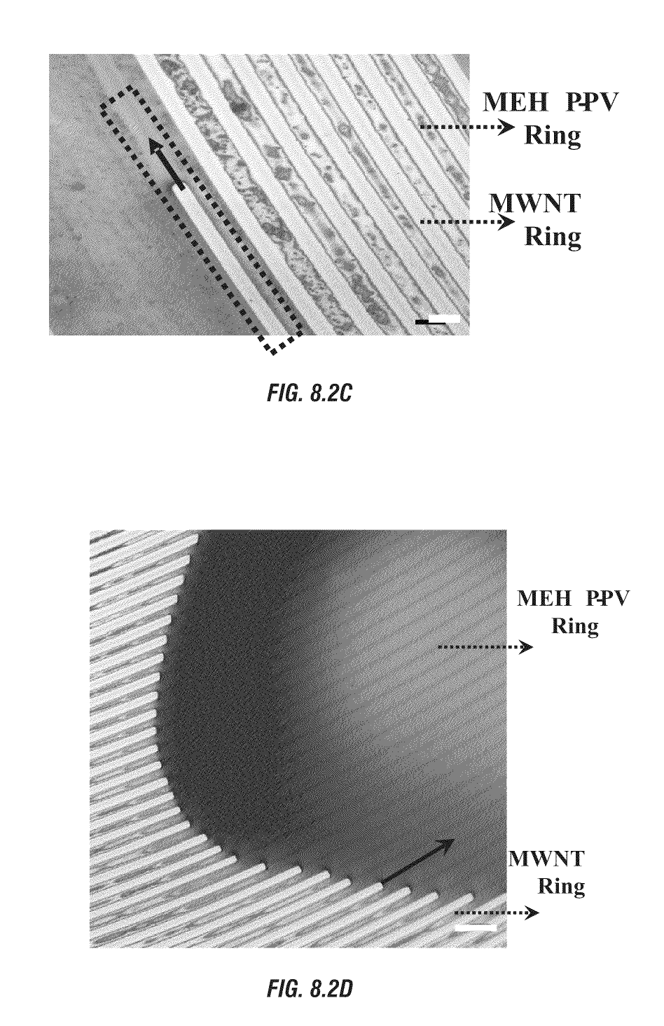

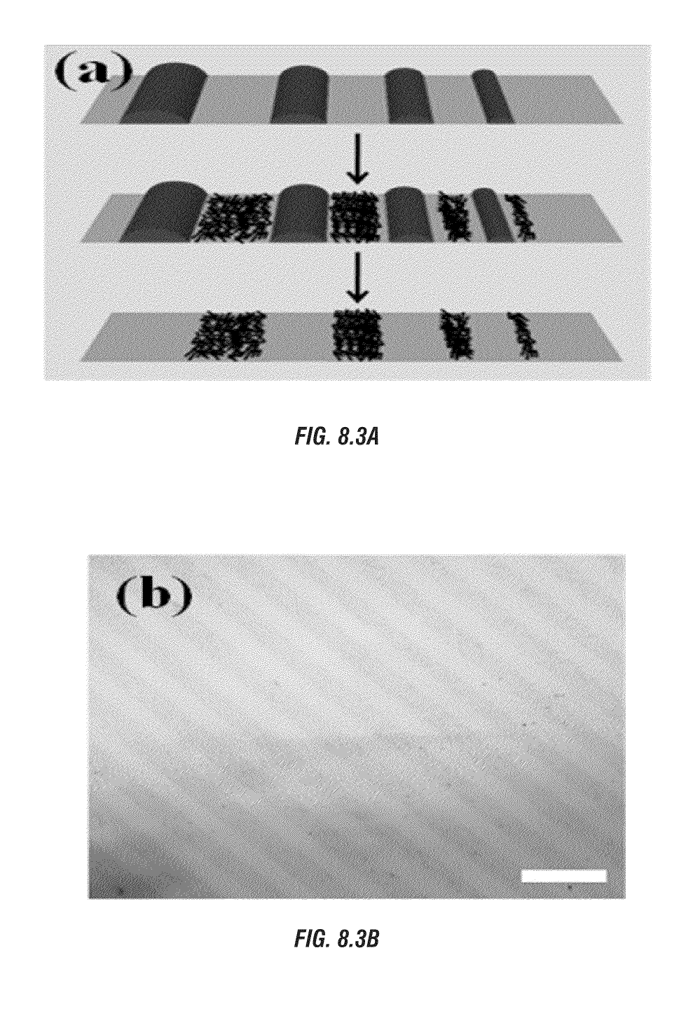

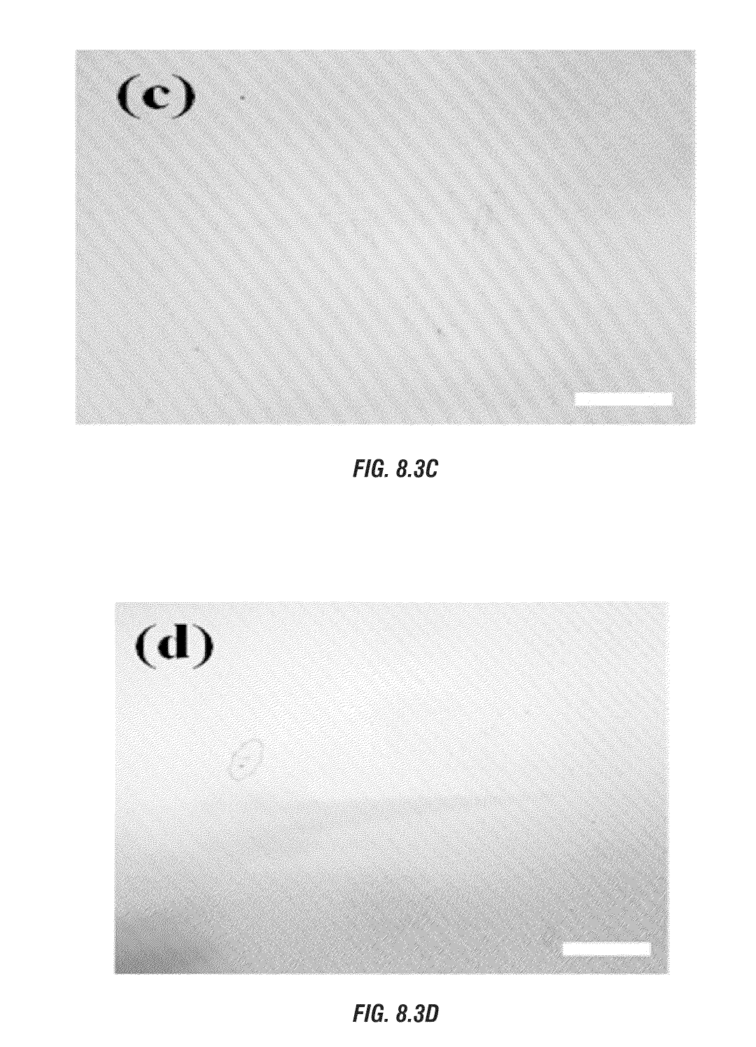

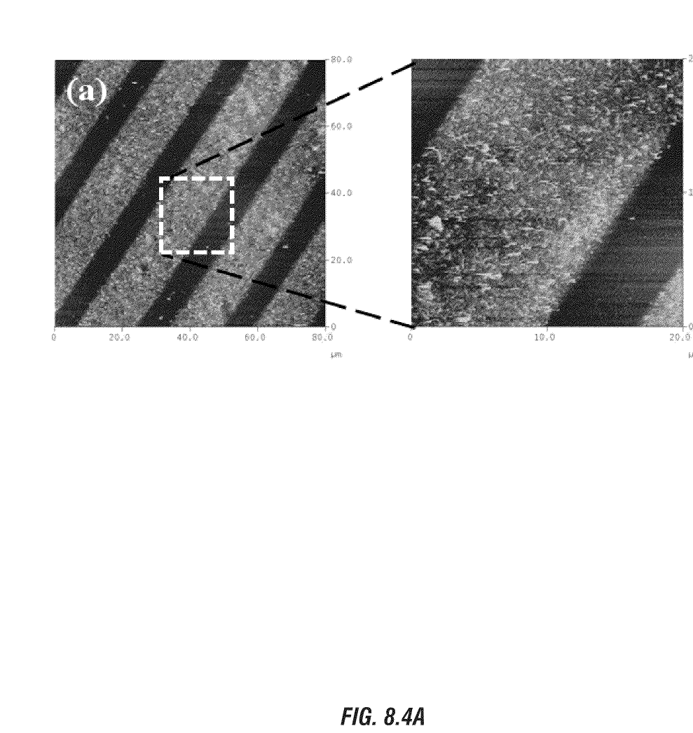

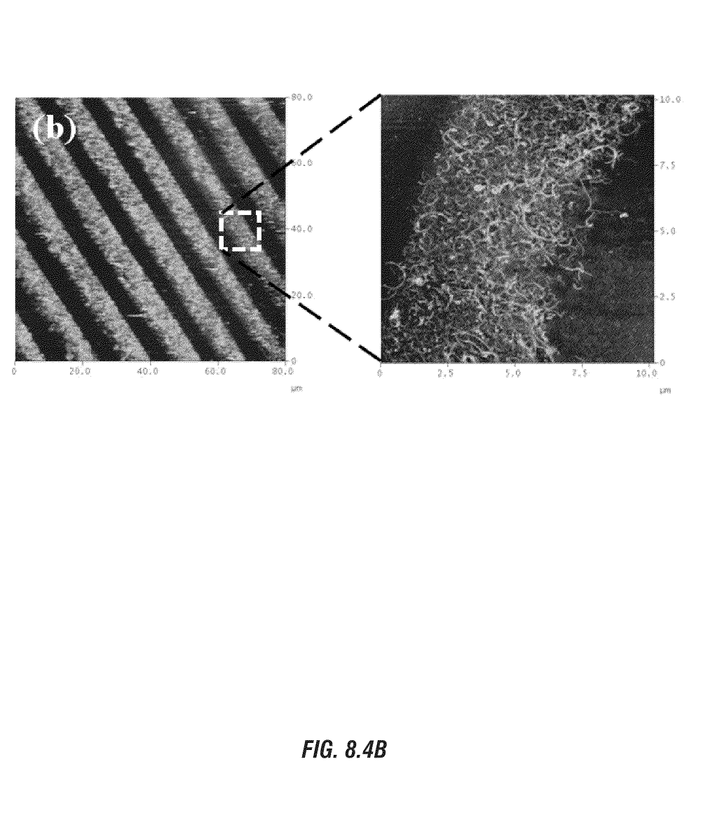

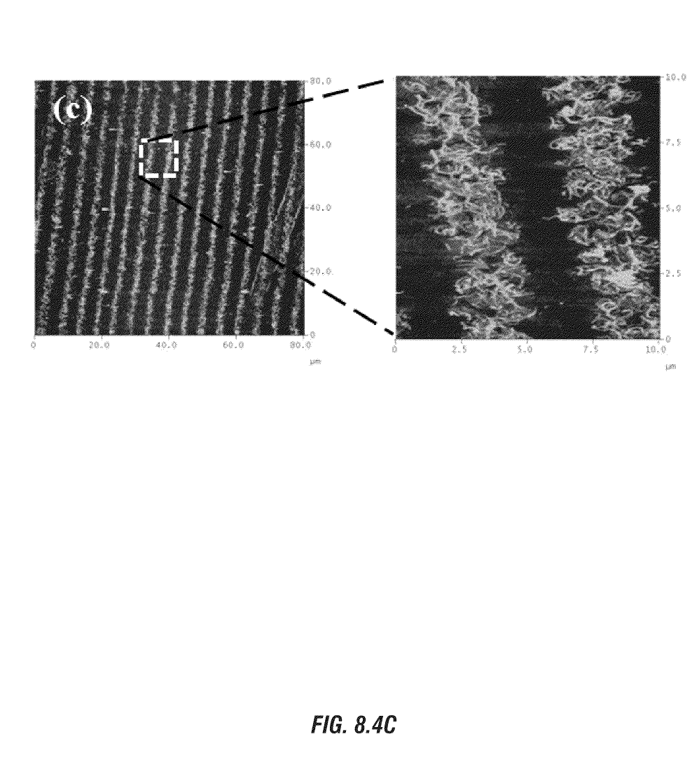

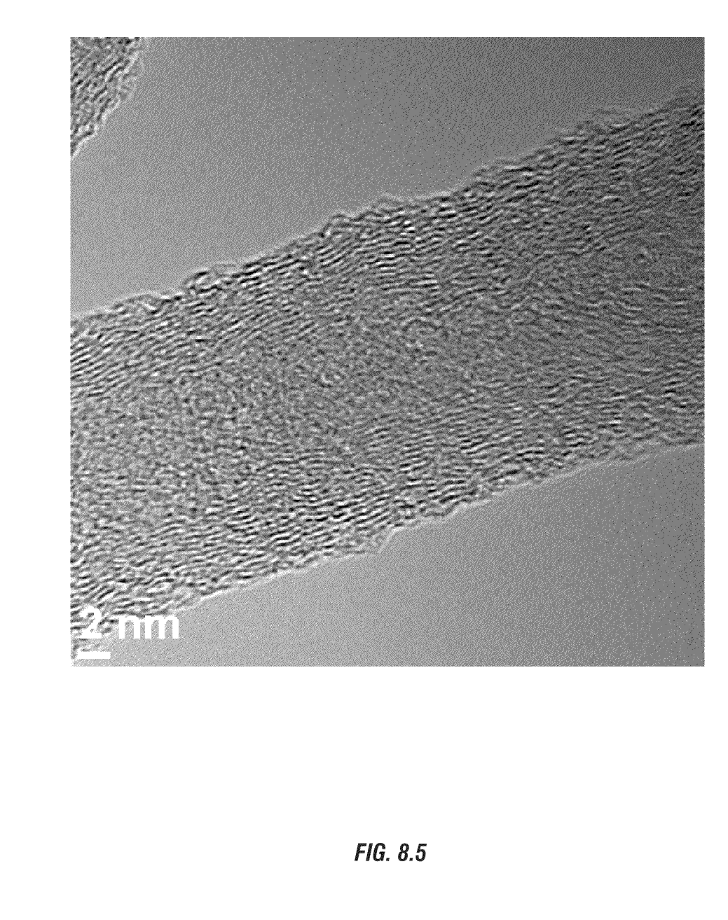

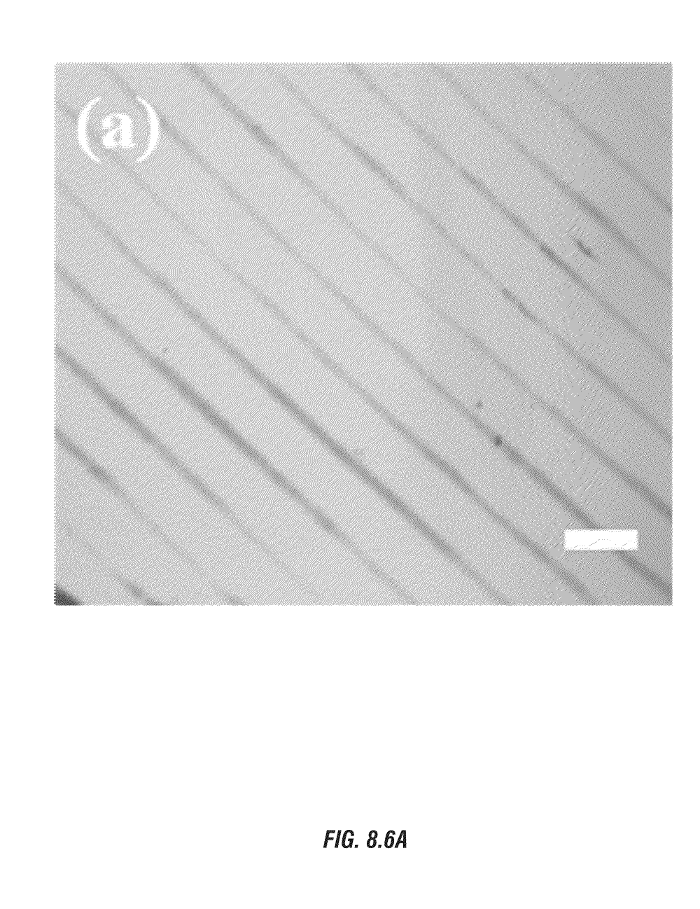

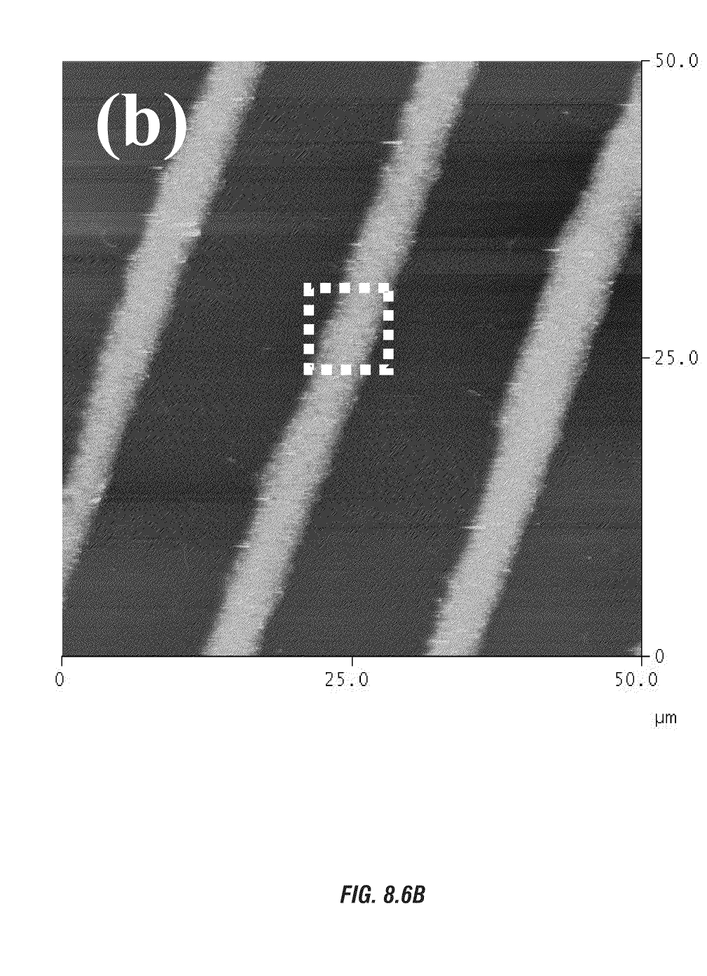

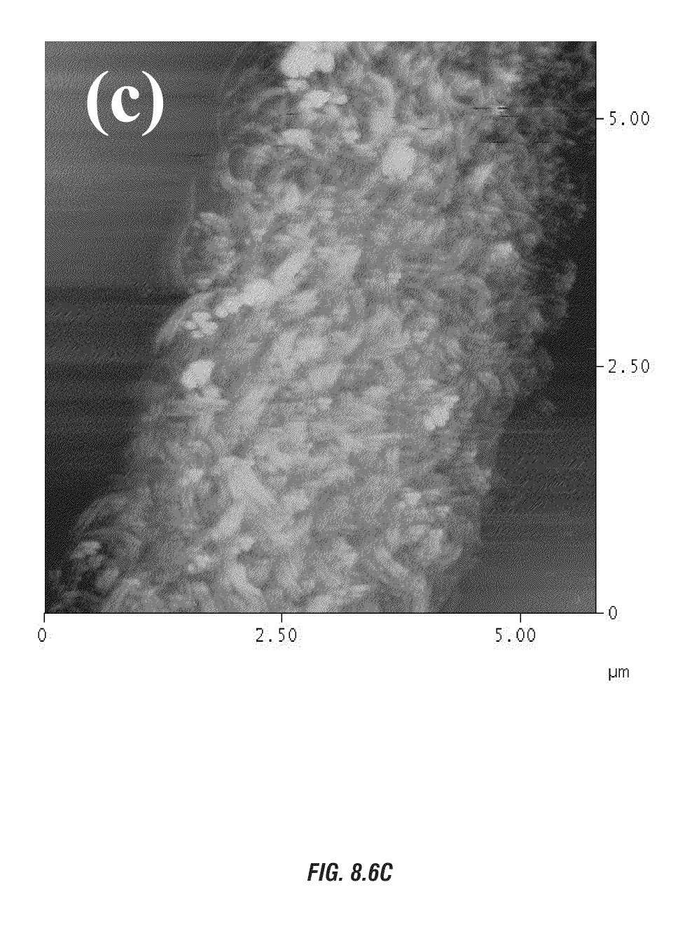

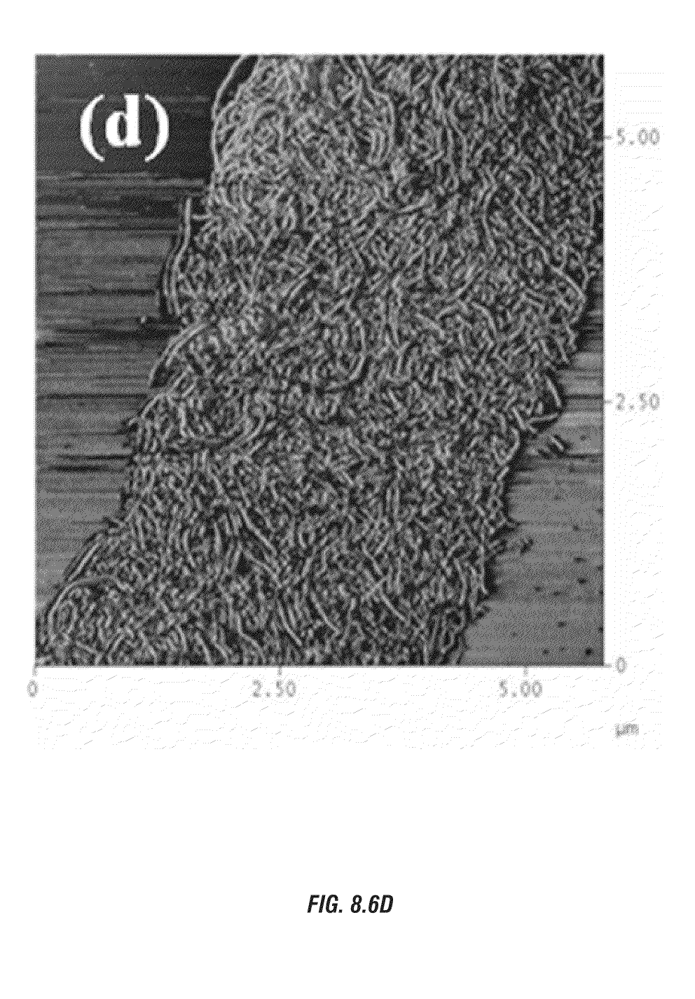

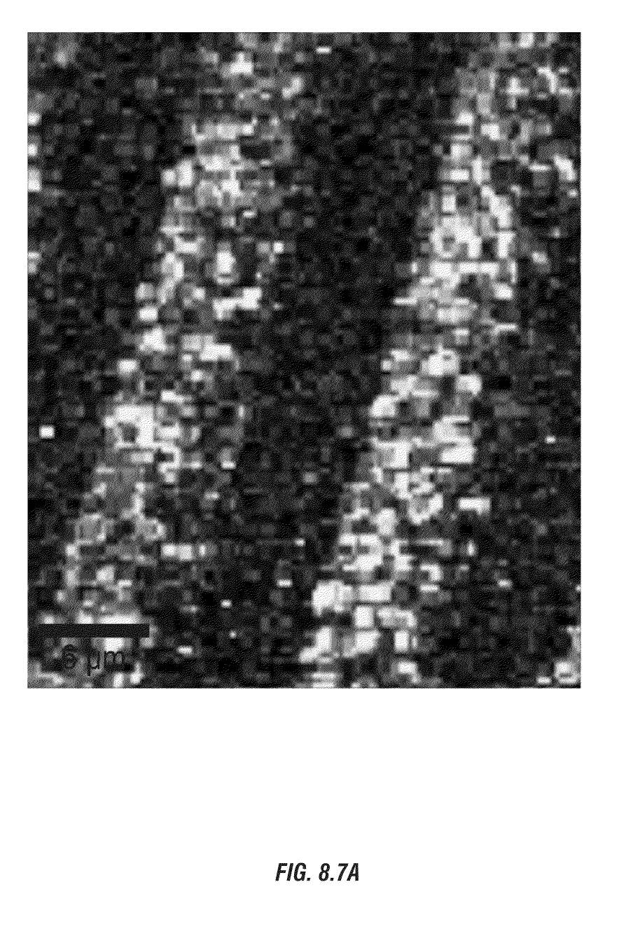

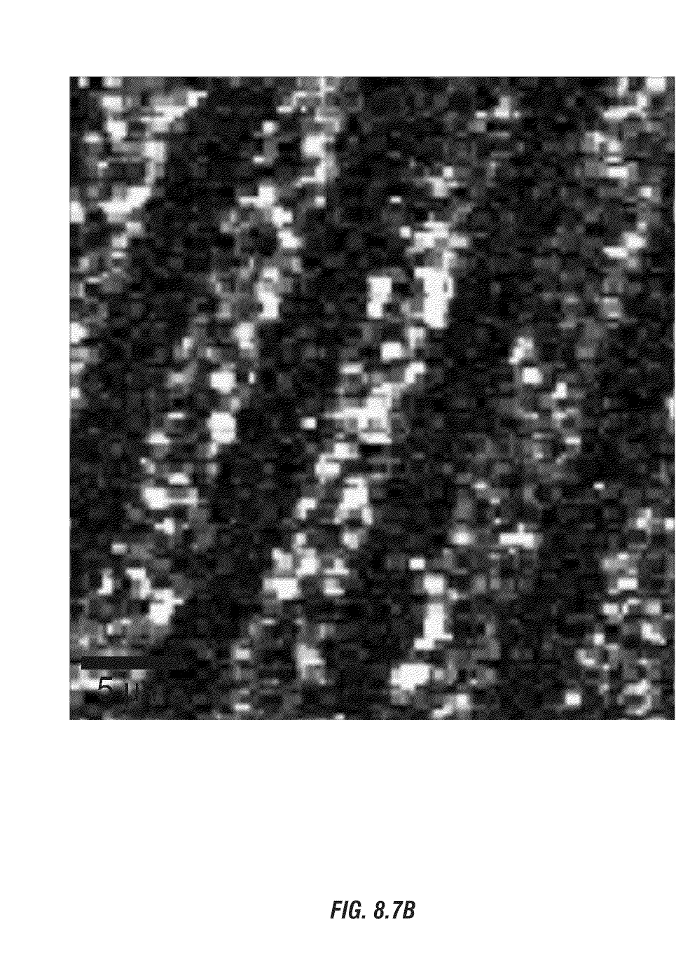

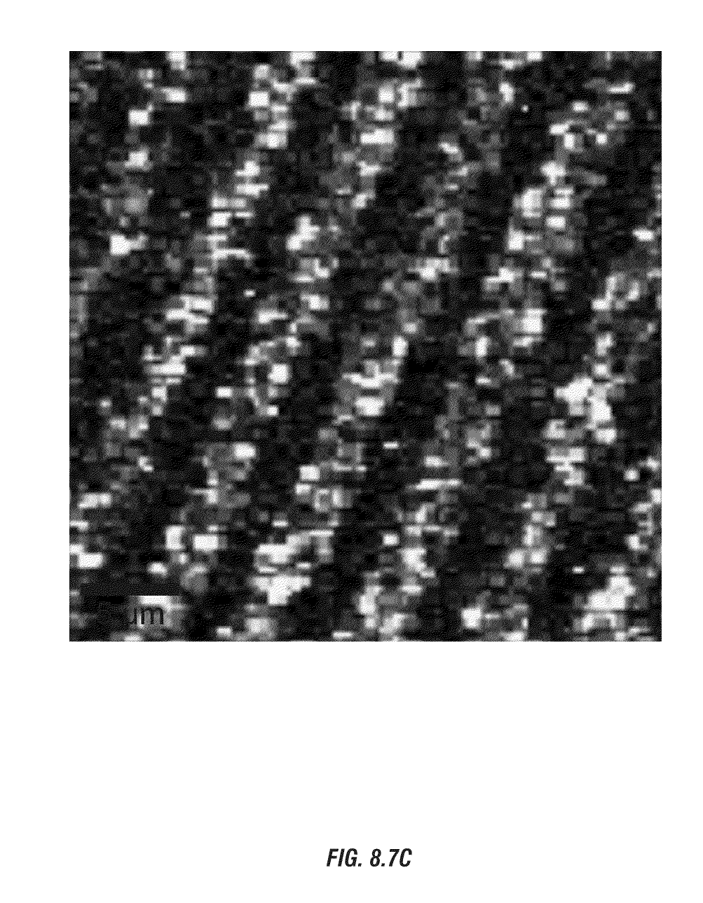

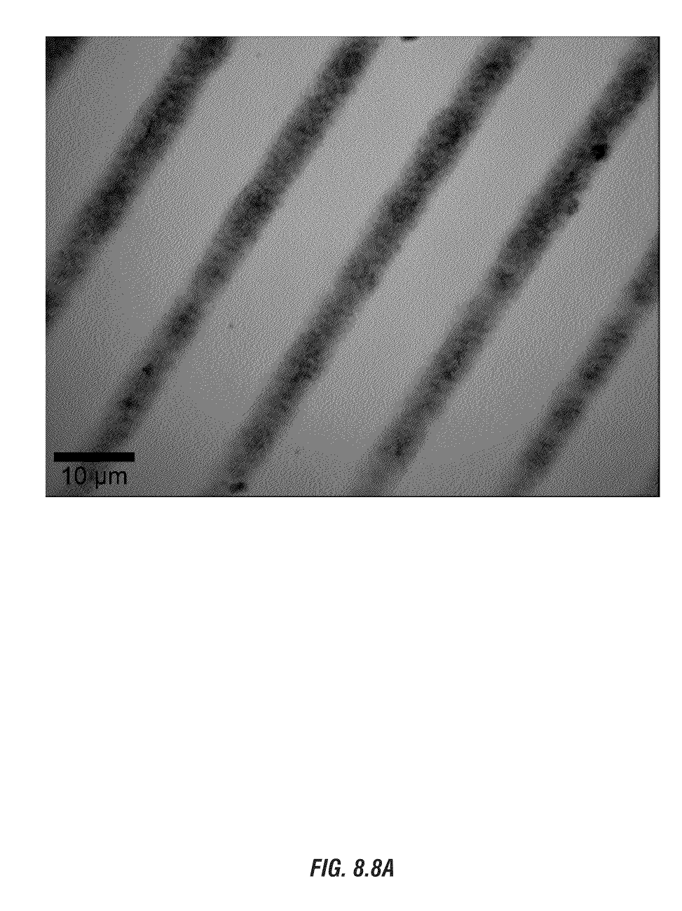

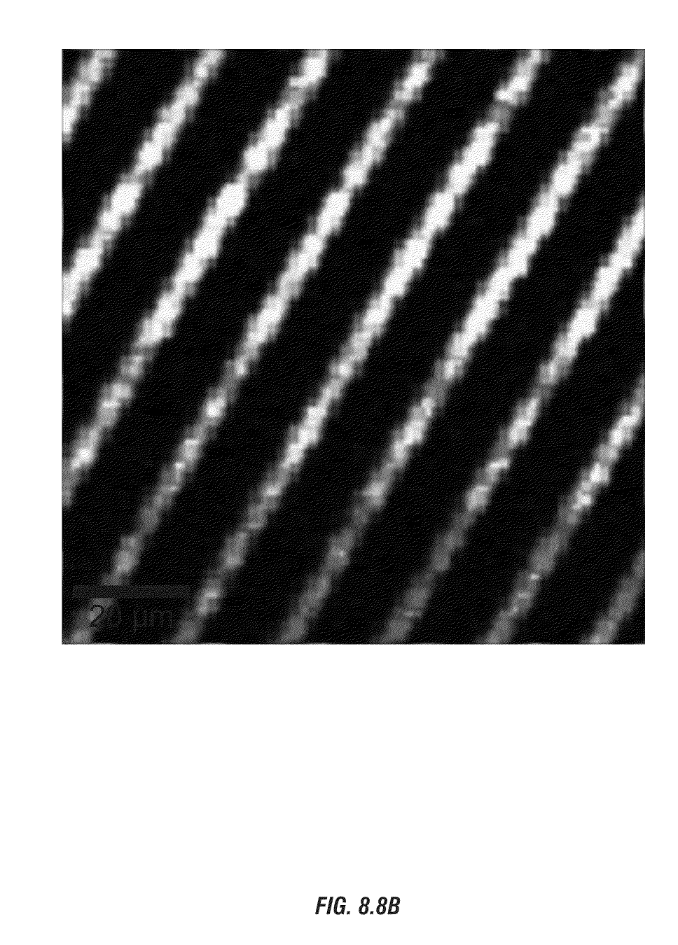

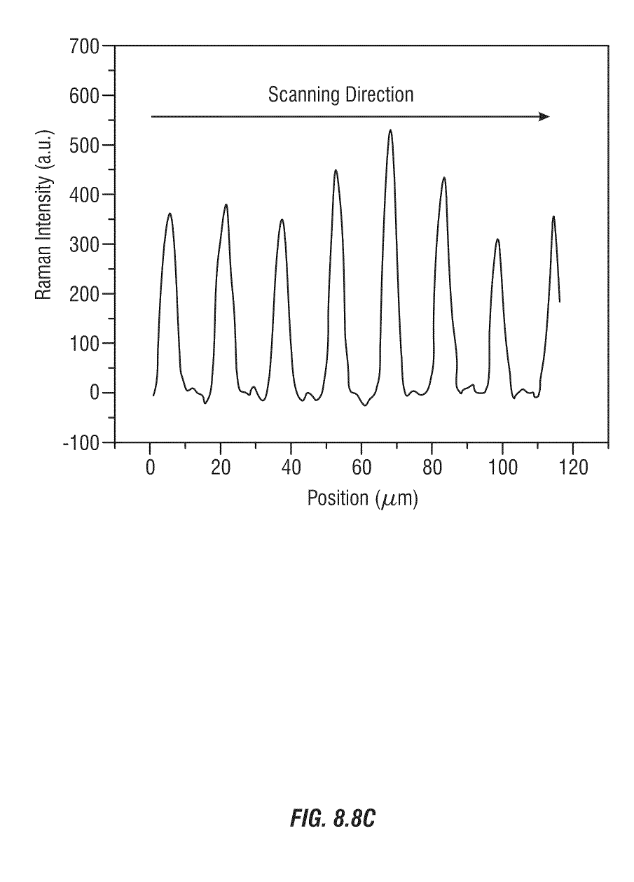

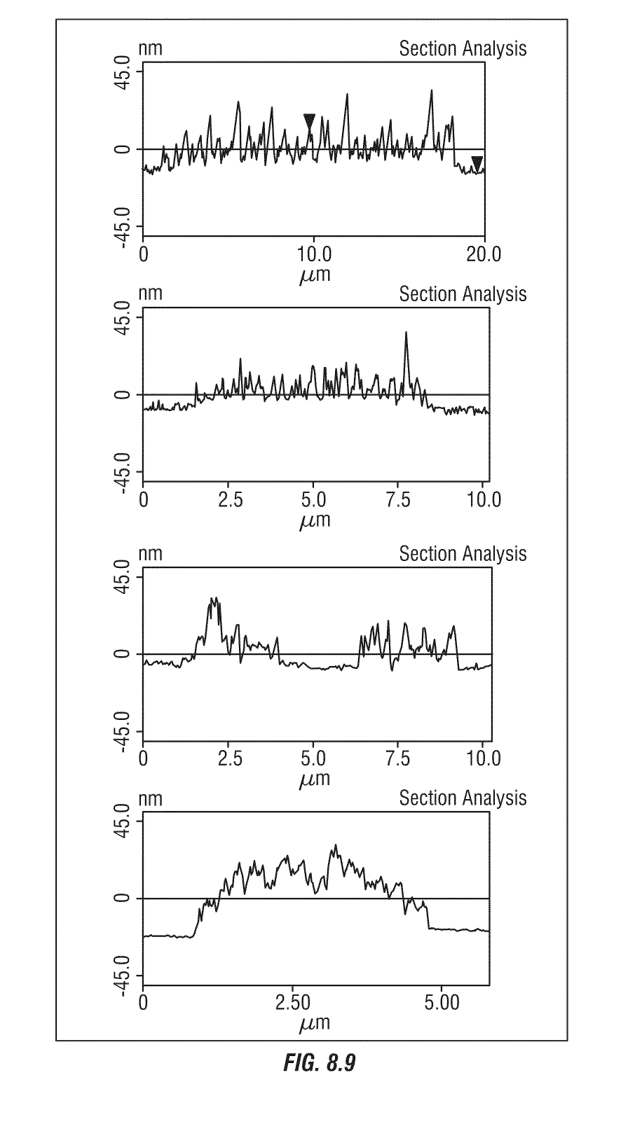

Herein, we present a simple and straightforward method to create gradient concentric rings of CNTs over very large surface areas by combining two consecutive self-assembly processes. Hundreds of gradient concentric polymer rings with remarkable regularity were spontaneously formed on Si substrate via evaporation-induced self-assembly of polymer in a confined geometry consisting of a sphere on a flat Si substrate (FIG. 8.1). The concentric polymer rings on the Si were then exploited as a chemically patterned surface to guide the formation of multiwalled carbon nanotube (MWNT) rings (i.e., directed self-assembly). Specifically, a drop of water-dispersed MWNTs mixed with poly (diallyl dimethylammonium) chloride (PDDA) was cast on the surface of the template polymer rings. The periodically alternating hydrophobic polymer rings and hydrophilic Si substrate (i.e., Si rings) provided different wettabilities for the MWNT/PDDA solution. As water evaporated, the MWNT solution dewetted the polymer rings while forming MWNT rings on the Si rings. The combination of spontaneous evaporation-induced self-assembly and subsequent directed self-assembly offers a new means of patterning microscopic CNT rings over large areas. This method is fast and cost-effective, eliminating the need for multistage lithography and externally applied forces.

### Results and Discussion

In the evaporation-induced self assembly (where MEH-PPV toluene solution was loaded between a spherical lens and a Si substrate (FIG. 8.1a)) evaporative loss of toluene at the capillary edge triggered the pinning of the contact line (i.e., “stick”). The outermost MEH-PPV ring was thus formed. During the deposition of MEH-PPV, the initial contact angle of the capillary edge decreased gradually due to evaporation of toluene to a critical angle, at which the capillary force (depinning force) becomes larger than the pinning force.^{[36]} This caused the contact line to jump to a new position (i.e., “slip”), and a new ring was developed.^{[35, 36, 43]} Repeated pinning and depinning cycles of the contact line led to the formation of gradient concentric rings of MEH-PPV (FIG. 1b). Notably, the center to center distance between adjacent rings, λ_{C-C} decreased with increased proximity to the sphere/Si contact center (i.e., from X₁ to X₃), which can be attributed to the competition between linear pinning force and nonlinear capillary force.^{[36}] At the outermost region, X₁, both λ_{C-C} and MH-PPV ring height, h_{MEH-PPV} decreased progressively from λ_{C-C}=20.6 μm, h_{MEH-PPV}=14.8 nm (X₁ in FIG. 8.1b) to 11.2 μm and 7.6 nm at the intermediate region (X₂ in FIG. 8.1b) to 4.3 μm and 1.5 nm at the innermost region (X₃ in FIG. 8.1b), as measured by atomic force microscope (AFM). Only a small zone of the entire gradient concentric ring pattern is shown in FIG. 8.1b. The entire ring pattern was formed over

$$π \cdot {( \frac{{D}^{′}}{2} )}^{2} = π \cdot {( 8 / 2 )}^{2} = 50.24 {mm}^{2}$$

surface areas, where D′ is the diameter of the outermost ring in the present study (D′=8 mm), dictated by the volume of the MEH-PPV solution and the diameter of the spherical lens used, D (D=1 cm in FIG. 8.1a). The axially symmetric sphere-on-flat geometry provides a unique environment (i.e., a bound solution) for controlling the flow within an evaporating droplet, which in turn regulates the structure formation.^{[35-41]} Thus, in sharp contrast to the irregular concentric rings formed due to stochastic “stick-slip” cycles of the contact line when a droplet evaporates from a single surface (i.e., an unbound solution),^{[43, 44, 46, 47]} highly ordered, gradient concentric rings of MEH-PPV are produced using the sphere-on-flat geometry.

Gradient concentric MEH-PPV rings are intriguing templates to guide self-assembly of nanoscale materials, i.e., MWNTs, as schematically illustrated in FIG. 8.2. The pristine MWNTs showed poor dispersibility in water. To improve the water solubility, the MWNT surface was functionalized with carboxylic acid groups (—COOH) via repeated oxidation and ultrasonication treatment (see Experimental). The 0.5 wt % positively charged poly (diallyl dimethylammonium) chloride (PDDA) was added to the MWNT solution to further improve the water dispersibility and enhance the adhesion of MWNTs to the Si substrate^{[48]} before drop-casting the solution onto the MEH-PPV ring-patterned Si substrate using Method a and Method b. In Method a, the droplet was free to spread on Si outside the MEH-PPV rings, during which the contact angle decreased without the pinning of the contact line while the droplet maintained the circular shape. As a result, the solution film thickness reduced to a thickness comparable to the height of MEH-PPV rings during water spreading and evaporation. The periodically alternating hydrophobic MEH-PPV ring and hydrophilic Si substrate between the MEH-PPV rings (i.e., Si rings) provided different wettabilities for the MWNT/PDDA solution. The interaction between hydrophilic MWNT/PDDA and hydrophilic Si facilitated the deposition of MWNTs onto Si rings, while MWNT/PDDA dewetted hydrophobic MEH-PPV rings. As water evaporated, the water meniscus receded from the MEH-PPV rings (red arrow in FIG. 8.2c), driven by the capillary force. The MWNTs were pushed to Si rings in a direction perpendicular to the receding water front as a result of evaporation-induced capillary flow. Furthermore, the electrostatic interaction between positively charged PDDA and negatively charged MWNT promoted both CNT-CNT electrostatic repulsion and CNT hydrophilicity.^{[48}] The electrostatic interaction between SiO— groups and the positively charged PDDA enhanced MWNT adhesion to the Si substrate to form a uniform ring.^{[48-50]} The synergy of capillary force and electrostatic interaction effectively directed the self-assembly of the MWNTs onto the Si rings over the entire MEH-PPV template.

In Method b, where a drop of MWNT/PDDA solution covered only a small part of MEH-PPV ring pattern, the droplet maintained its circular shape and was confined within hydrophobic concentric rings, resulting in a larger, fixed contact angle than in Method a (FIG. 8.2b). During water evaporation the water meniscus retreated along concentric MEH-PPV rings driven by the capillary force, leaving behind rake-like MWNTs deposited on the Si rings as shown in the left portion of FIG. 8.2d. The MWNTs were tethered to Si rings through the electrostatic interaction facilitated by positively charged PDDA (i.e., forming a MWNTs/PDDA/Si layer).^{[48-50]}

The dimension of the microscopic concentric MWNT rings was significantly affected by the geometric constraints imposed by the MEH-PPV rings. Due to the gradient nature of the template of MEH-PPV rings, gradient concentric MWNT rings were achieved after selective removal of MEH-PPV with toluene, as schematically illustrated in FIG. 8.3a. FIG. 8.3b-d shows optical micrographs of gradient concentric MWNT rings obtained (via Method a), corresponding to the location of original MEH-PPV rings at the outermost (X₁), intermediate (X₂), and innermost (X₃) regions, respectively, from FIG. 8.1b. The size and shape of the MWNT rings was highly complementary to those of original MEH-PPV rings and were not disrupted during the successive dissolving of MEH-PPV with toluene.

To quantify the dimension of adsorbed MWNT rings in FIG. 8.3b-d, AFM measurements were performed. FIG. 8.4 shows AFM height images corresponding to optical micrographs in FIG. 8.3b-d. Locally, the rings appear as parallel stripes. The number of stripes in the 80×80 μm² scanning area increases from 5 (left panel in FIG. 8.4a) to 9 (FIG. 8.4b) to 16 (FIG. 8.4c). Section analysis of these AFM images revealed that the width of rings, w decreased from w=15.1 μm at X₁, to w=8.2 μm at X₂, to w=2.5 μm at X₃ (see FIG. 8.9a-c). This correlated well with the values obtained from the template of MEH-PPV rings. The thickness of MWNTs, h_{MWNT} was rather constant in all locations (i.e., h_{MWNT}=˜19 nm in X₁, X₂, and X₃), suggesting the formation of a monolayer of MWNT on the Si substrate given that the thickness of a MWNT was approximately 20 nm, as determined by TEM (FIG. 8.5).

Further scrutiny of each individual MWNT ring obtained by Method a revealed a random network of densely packed MWNTs (right panels in FIG. 8.4). The formation of a random network of MWNTs can be rationalized as follows. Complete water evaporation from MEH-PPV ring-patterned Si substrate was over a course of 4 h, rather than 30 min as in the case of MEH-PPV in which toluene was used. Thus, the evaporation-induced capillary flow was slow and could not orient the MWNT along the flow direction during the drying process. Consequently, the MWNTs were randomly dispersed within a ring.

FIG. 8.6 shows the optical micrograph and AFM images of MWNT rings formed at the region in between X₁ and X₂ prepared by Method b. In comparison to monolayer of MWNT rings produced by Method a (FIG. 8.4), densely packed MWNT bundles were observed (FIG. 8.6b-d), manifested in a larger value of thickness, h_{MWNT}=˜42 nm (see FIG. 8.9d). This is attributed to the larger initial contact angle formed by using Method b as depicted in FIG. 8.2b. A larger contact angle due to unfavorable interfacial interaction between hydrophobic MEH-PPV rings and hydrophilic MWNT/PDDA allowed more MWNTs to deposit on Si rings, thereby yielding thicker, densely packed MWNTs. The width of the rings was 4.0 μm, smaller than 8.2-15.1 μm (corresponding to the width in X₁ and X₂ regions) values obtained using Method a. This may be explained by the fact that, due to larger initial contact angle, the MWNTs deposited on Si rings right after the solution front receded from the MEH-PPV rings while the deposition was still liquid-like. The residual amount of water in the liquid-like MWNT rings further evaporated and retracted in a direction perpendicular to the ring from both edges, thereby leading to rings with a smaller width. This perpendicular flow may partially contribute to the larger thickness of the MWNTs obtained (FIG. 8.6c-d). This process also promoted the ordering of MWNTs inside the microscopic ring. The orientation of MWNTs within the ring was improved (i.e., aligned along the ring in FIG. 8.6d) as compared with rings obtained by Method a in which MWNTs formed a random network (FIG. 8.4).

To verify the formation of periodic MWNT rings, Raman mapping was conducted. For the MWNT rings produced by Method a, the high-resolution Raman mapping obtained with typical Raman G mode of MWNT (1586 cm-1) at three different locations (i.e., X₁, X₂, and X₃ in FIG. 8.1a) confirmed the formation of gradient concentric MWNT rings with decreased periodicity as clearly evidenced in FIG. 8.7. The contrast of Raman image reflects the monolayer coverage of MWNTs produced by Method a. On the other hand, the densely-packed MWNT rings formed by Method b exhibited much higher contrast in optical microscope image (FIG. 8.8a) and corresponding Raman mapping (FIG. 8.8b). The well-defined MWNT rings visible in the Raman G mode provided enhanced contrast in Raman intensity variation across eight MWNT rings (FIG. 8.8b) as compared to that of monolayer MWNT rings in FIG. 8.7. The presence of intense Raman peaks on the MWNT rings while zero counts in between the MWNT rings (i.e., on the Si rings) validated that there were no MWNTs on the Si rings which were formed after the removal of MEH-PPV rings (FIG. 8.8c). This was consistent with optical microscopy observation (FIG. 8.8a).

### Conclusions

In summary, we have demonstrated that the use of sphere-on-flat geometry provides remarkable control over the evaporative flux, thereby leading to evaporation-induced self-assembly of gradient concentric rings of polymers with unprecedented regularity by repeated “stick-slip” cycles of the contact line. Subsequently, the polymeric rings were exploited as templates to direct self assembly of MWNTs from the water solution (i.e., deposition on hydrophilic Si substrate and dewetting on hydrophobic polymer rings). After water evaporation followed by selective removal of the template of polymer rings, gradient concentric MWNT rings over very large areas were achieved (i.e., 50 mm² in the present study, which was dictated by the initial volume of polymer solution loaded and the diameter of spherical lens used, D. By increasing D and placing loading a larger amount of polymer solution, MWNT rings with even larger areas can ultimately be achieved). The spacing, width, and height of MWNT rings can be finely tailored by using different casting methods. This facile technique opens up a new avenue for high throughput, lithography- and external field-free patterning of microscopic CNT rings over large areas. We envisage that, by replacing MWNTs with single-walled carbon nanotubes (SWNTs), the formation of gradient concentric SWNT rings from solution-based SWNTs may be suitable for applications in electrics, optics, and sensors, for example, mass production of SWNT-based electronic devices to explore the channel length effect on the mobility of SWNTs in one step.

### Experimental Section

Evaporation-Induced Self-Assembly of MEH-PPV Rings in a Sphere-on-Flat Geometry: Linear conjugated polymer, poly[2-methoxy-5-(2-ethylhexyloxy)-1,4-phenylenevinylene] (MEEH-PPV; molecular weight=50-300 kg/mol; American Dye Sources) was selected as the nonvolatile solute to prepare a 0.075 mg/ml MEH-PPV toluene solution. Si wafers and spherical lenses made from fused silica (the radius of curvature, R=1.65 cm, and the diameter, D=1 cm (FIG. 8.1a)) were cleaned with a mixture of sulfuric acid and Nochromix. They were rinsed extensively with DI water and then blown dry with N₂. A sphere-on-flat geometry was constructed and implemented as follows. Both the spherical lens and Si substrate were firmly fixed at the top and bottom of sample holders, respectively. An inchworm motor was used to bring the upper sphere into near contact with lower stationary Si substrate. Before contact, with just a few hundred micrometers between the surfaces, 20 μL of MEH-PPV toluene solution was loaded and trapped between the sphere and Si due to capillary forces. The sphere was finally moved into contact with the Si substrate. Thus, a capillary-held MEH-PPV toluene solution was formed with evaporation rate highest at the extremity, as schematically illustrated in FIG. 8.1a. This geometry led to a controlled, repetitive “stick-slip” motion of the three phase contact line, which moved toward the sphere/Si contact center (FIG. 8.1a) during the course of toluene evaporation. As a result, gradient concentric MEH-PPV rings were formed on both the spherical lens and the Si substrate. Only the ring patterns formed on the Si substrate were utilized as templates in this study (FIG. 8.1b).

Directed Self-Assembly of Gradient Concentric MWNT Rings: To prepare oxidized MWNTs (i.e., MWNTs with surface and end carboxyl groups), as-supplied MWNTs (20 mg, O.D.×I.D., 15-20 nm×5-10 nm; Sigma-Aldrich) were added to nitric acid (60%, ml), and sonicated for 10 min for initial dispersion, followed by a 12 h reflux at 130° C. The dispersion was cooled to room temperature and filtered using a 1 μm-pore PTFE membrane filter. The purified MWNTs were rinsed extensively with DI water. The reflux with nitric acid produced carboxyl, hydroxyl, and carbonyl groups at the defect sites of the MWNTs. Subsequently, purified MWNTs were dispersed in DI water again and further oxidized with potassium permanganate perchloric acid solution.^{[51-53]} Finally, the dispersion was filtered and rinsed with HCl solution. As a result, carboxylic acid functionalized MWNTs were obtained (i.e., MWNT-COOH; 14 mg)[⁵⁴] and dried at 70° C. under vacuum for 24 h. A 0.05 mg/ml MWNT-COOH DI water solution was prepared after ultrasonication for 1 h. To improve the processibility and facilitate electrostatic compatibility, 25 μL of 20% aqueous positively charged polyelectrolyte, poly(diallyl dimethylammonium) chloride (PDDA, molecular weight=200-350 kg/mol; Aldrich) was added into the above mentioned 0.25 mg MWNT in 5 ml DI water. The MWNT/PDDA water solution was cast on the MEH-PPV ring-patterned Si substrate by two different methods: overspreading the entire MEH-PPV ring patterned surface (Method a) and partially covering the MEH-PPV rings (Method b) as depicted in FIG. 8.2a and 8.2b, respectively. In Method a, a 50 μl drop of the MWNT/PDDA water solution was cast at the center of the MEH-PPV rings. The solution spread freely and exceeded the outermost MEH-PPV ring (FIG. 8.2a). In Method b, only a 10 μl drop of solution was applied on the top of MEH-PPV rings locally and was trapped between the inner- and outer-most rings (FIG. 8.2b). The experiments were performed inside a sealed chamber. It took about 4 h and 8 h to allow the water to completely evaporate in Method a and Method b, respectively. After drying, the samples were immersed in toluene for 40 min to selectively dissolve the MEH-PPV rings. Finally, the samples were rinsed extensively with ethanol, sonicated for 1 min, and blow-dried with N₂.
Characterizations: An Olympus BX51 optical microscope (OM) in the reflection mode was used to investigate the ring patterns deposited on the Si substrate. Atomic force microscopy (AFM) images of the rings were obtained using a Digital instruments Dimension 3100 scanning force microscope in the tapping mode. BS-tap300 tips from Budget Sensors with spring constants ranging from 20 to 75 N/m were used as scanning probes. Raman measurements were performed (confocal Raman microscope alpha300R (WiTec); exited with a 514 nm Ar⁺ laser at 4 mW) to confirm the formation of periodic MWNT rings. A Raman mapping of MWNT rings was acquired by using 100× objective and integration time of 0.2-1 s for each 360×360 nm pixel in Raman image.

### Figure Captions

FIG. 8.1—(a) Schematic illustration of a drop of polymer solution trapped between a sphere and a Si substrate (i.e., a sphere-on-flat geometry), forming a capillary-held polymer solution. During the course of solvent evaporation, concentric rings composed of polymer were formed by controlled, repetitive “stick-slip” motion of the contact line. X₁, X₂, and X₃ are the distances of ring away from the sphere/Si contact center at outermost region (X>), intermediate region (X₂), and innermost region (X₃), respectively. (b) Optical micrograph of gradient concentric MEH-PPV rings formed in the sphere-on-flat geometry (FIG. 8.1a). A decrease in center-to-center distance between the rings, λ_{C-C} with increasing proximity to the center of sphere/Si contact (i.e., from location X₁ to X₂ to X₃ (FIG. 8.1a)) is clearly evident.

FIG. 8.2—a) and (b) Methods used to cast the MWNT/PDDA water solution (c=0.05 mg/ml). (a) Solution overspread the entire surface of ring patterns (Method a). (b) Solution covered only a small part of ring pattern (Method b). (c) Optical micrograph during the formation of MWNT rings by Method a. The water meniscus retreated along the MEH-PPV ring surface (i.e., dewetting on hydrophobic MEH-PPV ring), as indicated by a red arrow in a blue dashed box, thereby forming two MWNT rings adjacent to each other. Scale bar=30 μm. (d) Optical micrograph during the formation of MWNT rings by Method b. The solution was confined within the MEH-PPV rings. As water evaporated (direction indicated by a red arrow), a periodic family of MWNT rings were left behind on the Si substrate. Scale bar=70 μm.

FIG. 8.3'(a) Schematic stepwise representation of formation of gradient concentric MWNT rings. Evaporation-induced self-assembly of MEH-PPV rings on Si substrate from MEH-PPV toluene solution in sphere-on-flat geometry, showing a decrease in λ_{C-C} and height of the rings, h, from outermost ring (left) toward the original sphere/Si contact center (right) (first panel). Then a drop of MWNT/PDDA water solution was drop-cast onto the MEH-PPV ring-patterned Si substrate. Upon completion of water evaporation, MWNT rings were formed in between MEH-PPV rings (second panel). After selective removal of MEH-PPV with toluene, gradient concentric MWNT rings can be revealed (last panel). (b-d) Optical micrographs of highly ordered, gradient MWNT rings on Si substrate over large areas produced by template-assisted self-assembly as described in (a) (Method a). The locations of MWNT rings corresponding to original MEH-PPV templates are (a) at X₁, (b) at X₂, and (c) at X₃ (FIG. 8.1b), respectively. Scale bars=45 μm.

FIG. 8.4—AFM height images corresponding to optical micrographs shown in FIG. 8.3b-8.3d. (a) at outermost region, X₁, (b) at intermediate region, X₂, and (c) at innermost region X₃. Close-ups of individual ring are shown in the right panel, in which MWNTs formed random network and were densely packed. The image size is 80×80 μm² for the left panels, 20×20 μm² for the right panel of (a), 10×10 μm² for the right panel of (b) and (c). The z scale is 50 nm for all images.

FIG. 8.5—TEM image of a MWNT with a thickness of 20 nm.

FIG. 8.6—a) Optical micrograph of highly ordered MWNT rings at the region in between X₁ and X₂ produced by Method b. Locally, they appeared as parallel stripes. Scale bar=20 μm. (b) Corresponding AFM height image. (c-d) The close-up AFM images marked in (b), where (c) and (d) are phase and height images, respectively. Densely packed MWNTs bundles are clearly evident in (d). The image size is 50×50 μm² in (b), and 5.8×5.8 μm² in (c) and (d). The z scale is 50 nm for all images.

FIG. 8.7—Raman images of MWNT rings on Si substrate produced by Method a, acquired by integration of Raman intensity at G mode (1586 cm⁻¹). (a) at outermost region, X₁, (b) at intermediate region, X₂, and (c) at innermost region X₃. The scale bars are 6 μm, 5 μm, and 5 μm in (a), (b), and (c), respectively. The Raman intensity varied from dark (low) to bright (high) color.

FIG. 8.8—(a) Optical micrograph of MWNT rings produced by Method b. (b) Corresponding Raman image acquired by integration of Raman intensity at G mode (1586 cm⁻¹). The Raman intensity varies from dark (low) to bright (high) color. (c) The Raman intensity variation at G mode across the MWNT rings on Si substrate. The measurements were performed in a direction perpendicular to the ring pattern as indicated by a white dotted line in Raman image (b). The scale bars are 10 μm and 20 μm in (a) and (b), respectively.

FIG. 8.9—(a)-(c) Section analysis of an individual MWNT ring in the right panel of FIG. 8.4 (a)-(c), respectively. (d) Section analysis of a MWNT ring in FIG. 8.6(c).

### REFERENCES FOR EXAMPLE 8

[1] J. Huang, F. Kim, A. R. Tao, S. Connor, P. D. Yang, Nature Mater 2005, 4, 896.
[2] J. Huang, R. Fan, S. Connor, P. D. Yang, Angew. Chem. Int. Ed. 2007, 46, 2414.
[3] J. Huang, A. R. Tao, S. Connor, R. He, P. D. Yang, Nano Lett . 2006, 6, 524.
[4] M. Gleiche, L. F. Chi, H. Fuchs, Nature 2000, 403, 173.
[5] T. P. Bigioni, X. M. Lin, T. T. Nguyen, E. I. Corwin, T. A. Witten, H. M. Jaeger, Nature Mater. 2006, 5, 265.
[6] E. Rabani, D. R. Reichman, P. L. Geissler, L. E. Brus, Nature 2003, 426, 271.
[7] B. P. Khanal, E. R. Zubarev, Angew. Chem. Int. Ed. 2007, 46, 2195.
[8] J. Guan, L. J. Lee, Proc. Natl. Acad. Sci. U.S.A. 2005, 102, 18321.
[9] V. V. Tsukruk, H. Ko, S. Peleshanko, Phys. Rev. Lett. 2004, 92, 065502.
[10] C. P. Martin, M. O. Blunt, E. Pauliac-Vaujour, A. Stannard, P. Moriarty, Phys. Rev. Lett. 2007, 99, 116103.
[11] H. Ko, S. Peleshanko, V. V. Tsukruk, J. Phys . Chem . 2004, 108, 4385.
[12] S. Iijima, Nature 1991, 354, 56.
[13] P. M. Ajiyan, Chem. Rev. 1999, 99, 1787.
[14] J.-U. Park, M. A. Meitl, S.-H. Hur, M. L. Usrey, M. S. Strano, P. J. A. Keins, J. A. Rogers, Angew. Chem. Int. Ed. 2006, 45, 581.
[15] S. G. Rao, L. Huang, W. Setyawan, S. Hong, Nature 2003, 425, 36.
[16] R. H. Baughman, A. A. Zakhidov, W. A. de Heer, Science 2002, 297, 787.
[17] A. A. Mamedov, N. A. Kotov, M. Prato, D. M. Guldi, J. P. Wicksted, A. Hirsch, Nature Mater. 2002, 1, 190.
[18] P. M. Ajayan, Chem. Rev. 1999, 99, 1787.
[19] D. Mann, Y. K. Kato, A. Kinkhabwala, E. Pop, J. Cao, X. Wang, L. Zhang, Q. Wang, J. Guo, H. Dai, Nature Nanotech. 2007, 2, 33.
[20] C. Y. Li, L. Y. Li, W. W. Cai, S. L. Kodjie, K. K. Tenneti, Adv. Mater. 2005, 17,
[21] W. Song, I. A. Kinloch, A. H. Windle, Science 2003, 302, 1363.
[22] S. J. Oh, Y. Cheng, J. Zhang, H. Shimoda, O. Zhou, Appl. Phys. Lett . 2003, 82,
[23] H. Shimoda, S. J. Oh, H. Z. Geng, R. J. Walker, X. B. Zhang, L. E. McNeil, O. Zhou, Adv. Mater. 2002, 14, 899.
[24] C. Kocabas, M. A. Meitl, A. Gaur, M. Shim, J. A. Rogers, Nano Lett . 2004, 4,
[25] R. Sharma, C. Y. Lee, J. H. Choi, K. Chen, M. S. Strano, Nano Lett . 2007, 7,
[26] C. Kocabas, N. Pimparkar, O. Yesilyurt, S. J. Kang, M. A. Alam, J. A. Rogers, Nano Lett . 2007, 7, 1195.
[27] H. Ko, V. V. Tsukruk, Nano Lett . 2006, 6, 1443.
[28] Y. Wang, D. Maspoch, S. Zou, G. C. Schatz, R. E. Smalley, C. A. Mirkin, Proc. Natl. Acad. Sci. USA. 2006, 103, 2026.
[29] Y. Zhang, A. Chang, J. Cao, Q. Wang, W. Kim, Y. Li, N. Morris, E. Yenilmez, J. Kong, H. Dai, Appl. Phys. Lett . 2001, 79, 3155.
[30] E. Joselevich, C. M. Lieber, Nano Lett . 2002, 2, 1137.
[31] S. J. Kang, C. Kocabas, T. Ozel, M. Shim, N. Pimparkar, M. A. Alam, S. V. Rotkin, J. A. Rogers, Nature Nanotech. 2007, 2, 230.
[32] G. Yu, A. Cao, C. M. Lieber, Nature Nanotech. 2007, 2, 372.
[33] H. Ko, C. Jiang, H. Shulha, V. V. Tsukruk, Chem. Mater. 2005, 17, 2490.
[34] C. Kocabas, S.-H. Hur, A. Gaur, M. A. Meitl, M. Shim, J. A. Rogers, Small 2005, 1, 1110.
[35] S. W. Hong, J. Xu, J. Xia, Z. Q. Lin, F. Qiu, Y. L. Yang, Chem. Mater. 2005, 17,
[36] J. Xu, J. Xia, S. W. Hong, Z. Q. Lin, F. Qiu, Y. L. Yang, Phys. Rev. Lett. 2006, 96, 066104.
[37] S. W. Hong, S. Giri, V. S. Y. Lin, Z. Q. Lin, Chem. Mater. 2006, 18, 5164.
[38] S. W. Hong, J. Xu, Z. Q. Lin, Nano Lett . 2006, 6, 2949.
[39] S. W. Hong, J. Xia, M. Byun, Q. Zou, Z. Q. Lin, Macromolecules 2007, 40, 2831.
[40] S. W. Hong, J. Xia, Z. Q. Lin, Adv. Mater. 2007, 19, 1413.
[41] J. Xu, J. Xia, Z. Q. Lin, Angew. Chem., Int. Ed. 2007, 46, 1860.
[42] J. Wang, J. Xia, S. W. Hong, F. Qiu, Y. Yang, Z. Q. Lin, Langmuir 2007, 23,
[43] E. Adachi, A. S. Dimitrov, K. Nagayama, Langmuir 1995, 11, 1057.
[44] R. D. Deegan, O. Bakajin, T. F. Dupont, G. Huber, S. R. Nagel, T. A. Witten, Nature 1997, 389, 827.
[45] O. Karthaus, L. Grasjo, N. Maruyama, M. Shimomura, Chaos 1999, 9, 308.
[46] R. D. Deegan, Phys. Rev. E 2000, 61, 475.
[47] R. D. Deegan, O. Bakajin, T. F. Dupont, G. Huber, S. R. Nagel, T. A. Witten, Phys. Rev. E 2000, 62, 756.
[48] D.-Q. Yang, J.-F. Rochette, E. Sacher, J. Phys . Chem . B 2005, 109, 4481.
[49] J. H. Rouse, P. T. Lillehei, Nano Lett . 2003, 3, 59.
[50] B. Kim, W. M. Sigmund, Langmuir 2003, 19, 4848.
[51] M. Burghard, V. Krstic, G. S. Duesberg, G. Philipp, J. Juster, S. Roth, Synthetic Metals 1999, 103, 2540.
[52] T. Sainsbury, D. Fitzmaurice, Chem. Mater. 2004, 16, 2174.
[53] K. Kordas, T. Mustonen, G. Toth, H. Jantunen, M. Lajunen, C. Soldano, S. Talapatra, S. Kar, R. Vajtai, P. M. Ajayan, Small 2006, 2, 1021.
[54] J. Chen, M. A. Hamon, H. Hu, Y. Chen, A. M. Rao, P. C. Eklund, R. C. Haddon, Science 1998, 282, 95.

D. Options and Alternatives

As can be appreciated by those skilled in the art, the present invention can take many forms and embodiments. The examples presented herein are for illustration only and do not limit the invention. Variations obvious to those skilled in the art will be included within the invention.

As can be further appreciated by those skilled in the art, the present invention can be used in many applications. A few have been mentioned, such as optoelectronics, light emitting diodes, solar cells, nanotechnology, optics, photonics, electronics, magnetic materials, optoelectrical, nanotesting, optical microlens arrays and optical gratings, novel photonic crystals (when high dielectric constant nanoparticles are used as nonvolatile solutes), ultrahigh density data storage (especially the rotating-disk medium) (when organometallic block copolymers are used), multi-scale masks; microfluidic devices (when a layer of thin film is coated on the flat substrate prior to the evaporation process, followed by selective washing and the encapsulation), annular Bragg resonators (when combined with reactive iron etching technique), and ring resonator lasers (when quantum dots or quantum wires are used as nonvolatile solutes). However, these are not limiting but for purposes of example only.

Moreover, the nanostructures are not limited to nanoparticles and diblock copolymers. It is readily extended to others, including but not limited to, semiconductors, conjugated polymers and biomacromolecules, or other constituents, for a variety of applications.

The processes are conducive to automation. Concurrent formation of plural structures could be implemented by depositing plural spaced-apart solution droplets on a flat substrate surface with a conventional injection printer, such as are well-known and commercially available. A precision robotic or mechanism translation mechanism could bring another surface holding correspondingly spaced apart, downward facing spherical lenses towards the flat substrate with the droplets. Movement could be controlled for extreme accuracy and to avoid splattering or other substantial disruption of the droplets other than entering the droplets. This step could be accomplished in a variety of ways and with a variety of components.

What is claimed is:

1. A method of formation of micro- and sub-micro-sized structures comprising:
a. preparing a solution of pre-selected concentration of:
i. a volatile solvent and
ii. a non-volatile solute;
b. placing a droplet of the solution on a substrate;
c. geometrically restricting the droplet by imposition of a spherical lens in contact with the droplet; and
d. forming micro- or sub-micro structures in one step by irreversible solvent evaporation at a controlled rate.

2. The method of claim 1 wherein the structures comprise rings, spokes, rings with fingering instabilities, punch-hole like structures, spirals within rings, or hierarchically ordered structures.

3. The method of claim 1 wherein the solvent comprises toluene or actonitrile.

4. The method of claim 1 wherein the solute comprises a polymer.

5. The method of claim 4 wherein the polymer comprises a homopolymer, a diblock copolymer, or a semicrystalline polymer.

6. The method of claim 5 wherein the homopolymer comprises polystyrene (PS), n poly(methyl methacrylate) (PMMA)), or poly[2-methoxy-5-(2-ethylhexyloxy)-1,4-phenylenevinylene] (MEH-PPV).

7. The method of claim 5 wherein the block copolymer comprises a cylinder-forming or a lamellar-forming diblock copolymer.

8. The method of claim 57 wherein the diblock copolymer comprises (poly(4-vinyl pyridine)-blockpoly(methyl methacrylate) (P4VP-b-PMMA) or polystyrene-block-poly(methyl methacrylate)(PS-b-PMMA)).

9. The method of claim 5 wherein the semicrystalline polymer comprises poly(ethylene oxide) (PEO).

10. The method of claim 1 wherein the solute comprises nanomaterials.

11. The method of claim 10 wherein the nanomaterials comprise nanoparticles.

12. The method of claim 11 wherein the nanoparticles are selected based on size.

13. The method of claim 11 wherein the nanoparticles comprise CdSe or CdSe/ZnS nanoparticles.

14. The method of claim 10 wherein the nanomaterials comprise at least one of:
a. quantum dots (QDs);
b. a spontaneously self-assembling block copolymer (BCP);
c. semiconductors;
d. biomacromolecules;
e. nanoparticles; or
f. carbon nanotubes.

15. The method of claim 1 wherein the solute comprises nanoparticles and the structures comprise rings and/or spokes.

16. The method of claim 15 further comprising self-assembly of the nanoparticles by introduction of a ligand into the solution.

17. The method of claim 1 wherein the solute comprises a homopolymer and the structures comprise concentric rings, rings with fingering instabilities, or punch-hole-like structures.

18. The method of claim 1 wherein the solute comprises a diblock copolymer and the structures comprise rings or hierarchically ordered structures comprising (a) concave holes residing within microscopic rings, (b) nanocylinders in concentric rings, or (c) nanocylinders in webs.

19. The method of claim 1 wherein the solute comprises a semicrystalline polymer and the structures comprise rings or spiral within rings.

20. The method of claim 1 further comprising controlling characteristics of the structure by one or more parameters comprising:
a. concentration;
b. solvent;
c. molecular weight;
d. humidity;
e. external perturbations;
f. curvature of the spherical lens;
g. surface chemistry comprising interfacial interaction between solute and substrate;
h. temperature of substrate and/or spherical lens.

21. The method of claim 20 further comprising predicting or designing the structures based on one or more of the parameters.

22. The method of claim 1 wherein the structures comprise regular structures.

23. The method of claim 1 further comprising introducing a moist airflow into a sealed chamber holding the droplet.

24. An apparatus for formation of micro- and sub-micro-sized ordered or hierarchically ordered structures comprising:
a. a flat surface on a substrate;
b. a spherical lens shape having a pre-determined curvature;
so that structures can be formed in one step by placing a droplet of solution on the flat surface, bringing the geometric constraining lens into contact with the flat surface through the droplet during irreversible solvent evaporation at a controlled rate.

25. A system for formation of micro- and sub-micro-sized ordered or hierarchically ordered structures comprising:
a. a flat surface;
b. a plurality of spaced apart spherical lenses on a moveable carriage;
c. an injection printing mechanism adapted to deposit a plurality of solution droplets on the flat surface at positions corresponding to the spaced apart spherical shapes;
d. a mechanism to translate the moveable carriage towards the flat surface;
so that structures are concurrently formed on the flat surface in one step by placing the plurality of droplets of solution on the flat surface, bringing the spherical lenses into contact with the droplets during irreversible solvent evaporation at a controlled rate.

26. A method of forming concentric metal rings at a micro- or sub-micro-scale comprising:
a. forming a set of concentric rings by irreversible solvent evaporation from a solution droplet placed on a substrate and confined by a spherical lens brought into contact with the droplet;
b. forming a metal layer over the rings and substrate;
c. removing either the metal layer between rings or the metallized rings.

27. A method of forming concentric metal rings at a micro- or sub-micro-scale comprising:
a. providing a substrate;
b. forming a metal layer over the substrate;
c. forming a set of concentric rings by irreversible solvent evaporation from a solution droplet placed on the metallized substrate wherein the droplet is confined by a spherical lens brought into contact with the droplet;
d. removing the metal between the rings;
e. removing the rings.

28. A method of forming structures by irreversible solvent evaporation comprising:
a. confining the droplet by a spherical lens brought into contact with the droplet;
b. controlling a parameter of the evaporation, the parameter comprising one or more of;
i. concentration;
ii. solvent;
iii. molecular weight;
iv. humidity;
v. curvature of the spherical lens; or
vi. surface chemistry comprising interfacial interaction between solute and substrate; and
c. predicting one or more characteristics of the structures.

29. The method of claim 28 wherein the one or more characteristics comprises:
a. spacing; or
b. height.

30. The method of claim 28 further comprising using the prediction to design characteristics of the structures.
